(19) United States
(12) Patent Application Publication
(10) Pub. No.: US 2024/0150867 A1
(43) Pub. Date: May 9, 2024

(54) METHODS FOR LEACHING AND RECOVERY OF PLATINUM GROUP METALS IN ORGANIC SOLVENTS

(71) Applicant: Excir Works Corp., Calgary (CA)

(72) Inventors: Hiwa SALIMI, Calgary (CA); Loghman MORADl, Calgary (CA)

(21) Appl. No.: 18/019,166

(22) PCT Filed: Aug. 9, 2021
(86) PCT No.: PCT/CA2021/051102

§ 371 Date: Feb. 1, 2023

Related U.S. Application Data
(60) Provisional application No. 63/062,469, filed on Aug. 7, 2020.
(60) Provisional application No. 63/062,470, filed on Aug. 7, 2020.
(60) Provisional application No. 63/062,471, filed on Aug. 7, 2020.
(60) Provisional application No. 63/062,473, filed on Aug. 7, 2020.
(60) Provisional application No. 63/062,474, filed on Aug. 7, 2020.
(60) Provisional application No. 63/062,475, filed on Aug. 7, 2020.
(60) Provisional application No. 63/062,477, filed on Aug. 7, 2020.
(60) Provisional application No. 63/062,479, filed on Aug. 7, 2020.
(60) Provisional application No. 63/062,481, filed on Aug. 7, 2020.
(60) Provisional application No. 63/062,482, filed on Aug. 7, 2020.
(60) Provisional application No. 63/062,484, filed on Aug. 7, 2020.
(60) Provisional application No. 63/062,485, filed on Aug. 7, 2020.
(60) Provisional application No. 63/062,487, filed on Aug. 7, 2020.
(60) Provisional application No. 63/062,488, filed on Aug. 7, 2020.
(60) Provisional application No. 63/062,489, filed on Aug. 7, 2020.
(60) Provisional application No. 63/062,492, filed on Aug. 7, 2020.
(60) Provisional application No. 63/062,493, filed on Aug. 7, 2020.
(60) Provisional application No. 63/062,494, filed on Aug. 7, 2020.
(60) Provisional application No. 63/062,495, filed on Aug. 7, 2020.
(60) Provisional application No. 63/062,497, filed on Aug. 7, 2020.
(60) Provisional application No. 63/062,498, filed on Aug. 7, 2020.
(60) Provisional application No. 63/062,499, filed on Aug. 7, 2020.

(51) Int. Cl. C22B 11/00; C22B 3/44; C22B 7/00

(52) U.S. Cl. CPC C22B 11/048; C22B 3/44; C22B 7/007

(57) ABSTRACT

Methods for leaching and extraction of precious metals. For example, methods of leaching palladium, rhodium, platinum from a substance comprising palladium, rhodium, and/or platinum (such as a platinum group metal (PGM) concentrate, and a catalytic converter) using an organic solvent that is water-miscible

### CROSS-REFERENCE TO RELATED APPLICATIONS

This application claims priority to United States provisional application numbers U.S. 63/062,470; U.S. 63/062,473; U.S. 63/062,477; U.S. 63/062,482; U.S. 63/062,484; U.S. 63/062,488; U.S. 63/062,489; U.S. 63/062,492; U.S. 63/062,493; U.S. 63/062,497; U.S. 63/062,499; U.S. 63/062,469; U.S. 63/062,471; U.S. 63/062,474; U.S. 63/062,475; U.S. 63/062,479; U.S. 63/062,481; U.S. 63/062,485; U.S. 63/062,487; U.S. 63/062,494; U.S. 63/062,495; U.S. 63/062,498; each filed Aug. 7, 2020, the entire contents of each of which is hereby incorporated by reference.

### FIELD

The present disclosure relates to methods for leaching and extraction of precious metals. For example, the present disclosure relates to methods of leaching palladium, platinum, and/or rhodium from a substance comprising such precious metals (such as a platinum group metal (PGM) concentrate, spent catalysts) using an organic solvent that is water-miscible.

### BACKGROUND

Platinum group metals (PGMs) is a group of elements in the periodic table that includes platinum (Pt), palladium (Pd), rhodium (Rh), ruthenium (Ru), iridium (Ir) and osmium (Os). Ore deposits containing PGMs are generally found with an average concentration of 2-10 ppm (g/t), with hundreds of tonnes of PGMs being produced worldwide from mining and recycled sources (e.g., in 2018, approximately 606.5 tonnes of PGMs were produced).

Gold is an element in the periodic table which belongs to the same group as silver and copper. It is usually found in combination with these metals in ores. The average concentration of copper and silver in Earth's crust is 50 and 0.07 ppm (parts per million) respectively while for gold it is just 0.005 ppm¹.

Ore deposits with a concentration of 0.5 ppm or higher are considered to be economically recoverable. Due to its limited sources, gold recovery not only from ores, but also from secondary sources has become more and more important during the last decades. The annual production of gold from the gold mining industry is more than 2500 to 3300 tonnes worldwide². In addition, about 900 to 1178 tonnes of secondary gold is recovered from different sources such as but not limited to anode slime and jewelry, dentistry and electronic scraps³.

Application of Platinum Group Metals (PGMs)

PGMs are used in a wide variety of areas due to their unique properties such as strong catalytic properties, thermal stability, resistance to corrosion and high melting points. PGMs are often used as the active part of a catalyst in some common industrial applications such as petroleum refining, chemical and automotive industries. For example, platinum-group metals such as palladium, platinum, and rhodium are used as metallic catalysts in catalytic converters for reduction of harmful gases from vehicle exhaust emissions. Palladium, platinum and rhodium are also used in jewelry, electrical and electronics industry (e.g., in multilayer ceramic capacitors and in computer hard disks to increase storage capacity), as well as investments in the form of bars and coins.

Catalytic Converters

About 393 tonnes of PGMs, accounting for approximately 65% of annual production, are used in catalytic converters. A catalytic converter uses honeycomb ceramics coated in platinum group metals (PGMs) to reduce toxic emissions from an internal combustion engine. A catalytic converter converts harmful gases such as NOx, CO, and hydrocarbons into less harmful N₂, CO₂, and H₂O gases. Catalytic converters have been required for vehicles, hydrocarbon power plants, and petro-chemical plants in North America since the 1970s, and were mandatory in Europe since the 1990s. Autocatalysts have a range of PGM content between 140-12,000 ppm, but worldwide average is 4-5 grams per car with a range of 1-15 g/car. Because PGMs are present in much higher concentrations in catalytic converters than are found naturally in the earth, the catalytic converter market is a large driver of PGM production and recycling. The recycling market is considered “open-loop”: the PGMs are returned to the market via a network of scrap yards, collectors, processors and smelters and refiners. This differs from PGMs used for industrial applications where the metal is not returned to the market but instead removed, recycled, and replaced (continuous “closed-loop” cycle).

Waste from Electrical and Electronic Equipment (WEEE) or Electronic Waste (E-Waste)

Advancing technologies and innovation has increased demand and production of electrical and electronic equipment (EEE), which in turn has increased generation of waste from electrical and electronic equipment (WEEE) or electronic waste (e-waste). For example, the global production of e-waste/WEEE includes upwards of 20 to 50 million tons per year of e-waste, and it is expected that these amounts will only increase.

Electrical and E-waste is generally classified as a hazardous material, examples of which include printed circuit boards (PCBs), solder in PCBs, glass panels and gaskets in computer monitors, chip resistors and semiconductors, relays and switches, corrosion protection for untreated galvanized steel plates, decorator or hardener for steel housing, cabling and computer housing, plastic housing of electronic equipment and circuit boards, front panel of cathode ray tubes, motherboards, large/small household appliances, IT and telecommunications equipment, electrical and electronic tools, medical devices, lighting equipment, computer monitors, TVs, CPU/hard disk of computers, cables and wires, capacitors, and condensers. Such wastes often contain precious metals (PMs) such as gold (Au), silver (Ag), platinum (Pt), Gallium (Ga), palladium (Pd), tantalum (Ta), tellurium (Te), germanium (Ge) and selenium (Se), which can make it viable for recycling. Generally, pyrometallurgical and hydrometallurgical processes are commonly employed to recover PMs.

Recovery of PGMs from Ore

Extracting PGMs from ore involves smelting, followed by hydrometallurgical refining. Generally, extraction, concentration and purification of PGMs from natural deposits can be capital, time and energy intensive processes that result in significant amounts of solid and liquid wastes. In recovering PGMs from ore, PGM-bearing substances are first crushed and grinded into fine particles. Froth flotation, as a wet chemical treatment, is then applied to produce a concentrate (0.01-0.02% w/w platinum-group elements) which is further dried and smelted in an electric furnace at temperatures, e.g., over 1500° C. The out-coming solid is leached in hydrochloric acid (e.g., 6M) using chlorine gas as oxidant. The aqueous solution is further processed using hydrometallurgical techniques, such as solvent extraction and ion-exchange to produce individual high purity metals.

Current Processes for Recovery of PGMs from Spent Catalysts

Recycling of spent automobile catalyst allows for the economization of valuable resources, and for the minimization of the environmental pollution connected with PGMs production. For example, around 65.4 tonnes of platinum, 97.2 tonnes of palladium and 10.4 tonnes of rhodium worth $17.4B CDN was recovered from catalytic converters in 2018. Pyrometallurgical methods are the dominant autocatalyst recycling process, but pyrometallurgy involves melting material at very high temperatures (above 1500° C.) for long periods of time to burn off impurities and concentrate PGMs. This raises concerns such as release of toxic gases (SO₂, NOx, CO₂), large energy consumption, and the potential health risks for the workers in the workplace.

Metallurgical Processes for the Extraction of Metals (e.g., from Spent Catalysts, E-Waste)

Hydrometallurgical Processes

Extraction of metals from, e.g., e-waste can involve hydrometallurgical routes that comprise the steps of acid or caustic leaching for selective dissolution of precious metals from e-waste e.g., using aqua regia for leaching. Generally, the pregnant leach solution is then separated and purified for enrichment of metal content whereby impurities are removed as gangue materials. Isolating the precious metals can be conducted through solvent extraction, adsorption, and/or ion exchange enrichment processes; and recovery of the metals from solution can be conducted through electrorefining (electrometallurgy) or chemical reduction processes. Leaching solutions such as halides, cyanides, thiourea, and thiosulfates are used for leaching of precious metals from their primary ores (for example, see above).

In a hydrometallurgical process, the waste or scrap containing PGMs (for example, from waste autocataysts or e-waste) is first pre-processed by manually dismantling and isolating individual components containing PGMs. For example the scrap may be shredded into pieces using hammer mills, and metals and non-metals separated using screening, magnetic, eddy current, and density separation techniques. Such screening processes allow for separation of an iron/steel fraction and an aluminum fraction from PGM-containing residue.

The PGM-containing fraction is then further processed using hydrometallurgical, pyrometallurgical, electrometallurgical, or biometallurgical processes, individually or in combination. For example, the processing may consist of solder leaching for separation of a non-metallic fraction and a solder recovery (electrowinning) fraction. PGM-containing residue from the solder leaching is treated by an additional leaching step. Leaching solutions such as aqua regia, halides, cyanides, thiourea and thiosulfates may be used for the leaching or PGMs from their primary ores. PGMs are recovered from the leached solution by cementation, solvent extraction, adsorption on activated carbon or ion exchange methods.

However, there are limitations to hydrometallurgical processes, such as: (i) being a slow and time consuming process; (ii) loss of precious metals during mechanical processing of waste (e.g., loss of upwards of 20%); (iii) using toxic chemicals such as cyanide as a leachant, thereby requiring high safety standards and protocols, to avoid environmental contamination and human health risks; (iv) using halide leachants, which can be difficult to use in such processes due to strong corrosive acids and oxidizing conditions; and (v) there being a risk of further loss of precious metal during subsequent dissolution and separation steps, which impacts the overall metal recovery.

Pyrometallurgical Processes

Pyrometallurgical techniques include conflagrating, smelting in a plasma arc furnace, drossing, sintering, melting, and varied reactions in a gas phase at high temperatures. Generally, pyrometallurgical processes include the steps of liberation, separation/upgrading, and purification, which are similar to those of hydrometallurgical processes. However, in contrast to hydrometallurgical processes, pyrometallurgical processes do not rely on leaching but rather smelting in furnaces at high temperatures. PGMs may therefore be sorted based on chemical and metallurgical properties. In respect of e-waste management and recycling, smelting in furnaces, incineration, combustion, and pyrolysis is generally used.

An example of a pyrometallurgical process is the lead smelting route, which involves sintering (ores), reduction, and refining stages. Sintering is carried out to reduce sulfur contents of feed materials. The reduction process is carried out in blast furnaces using coke, from which molten lead (85% purity) can be isolated. In the refining stage, metal and sulfur dross is separated and treated separately (e.g., in a reverberatory furnace). Heating lead dross in a reverberatory furnace leads to the separation of lead bullion (rich in lead), matte (copper and other metals sulfides) and speiss (high in arsenic and antimony contents), wherein the matte and speiss can be treated in copper smelters for the extraction of copper and other metals. When processing, e.g., e-waste by the lead smelting route, precious metals and other elements are separated from the lead bullion. Precious metals can be separated by forming an insoluble intermetallic compound using zinc (e.g., the Parkes process). Another example of a pyrometallurgical process involves copper smelting routes, which are used to recycle and extract precious metals from, e.g., e-waste. In copper smelting routes, precious metals are collected in copper matte or black copper. The copper and precious metals are separated from each other via an electrorefining process that produces pure copper metal, with the PMs being separated into slimes. The precious metals are then recovered from the slimes via hydrometallurgical routes.

Limitations of pyrometallurgical processes include: (i) not being able to recover and/or recycle plastics, as they are sometimes used in place of coke as a fuel source; (ii) reduced iron and aluminum recovery, as they end up as oxides in slag phases; (iii) generation of hazardous emissions, such as dioxins, during smelting of certain feed materials (e.g, halogenated flame retardants) requiring special installations to minimize environmental pollution; (iv) high costs of implementing integrated e-waste recycling plants that maximize recovery of valuable metals while also controlling hazardous gas emissions and protecting the environment; (v) burning of fine dust generated from non-metallic portions of e-wastes must be controlled and/or minimized to avoid the health risk posed by fine dust particles; (vi) only a partial recovery and purity of precious metals are affected by pyrometallurgical routes, therefore requiring additional hydrometallurgical and electrochemical techniques to extract pure metals; and (vii) managing smelting and refining is challenging due to the complexity of feed materials and the thermodynamics of possible reactions.

Processes for Gold Recovery

The most commonly used process for gold recovery from ore includes the use of highly toxic inorganic cyanides (e.g., NaCN, KCN) to convert gold(0) into a water-soluble Au(CN)₂ coordination complex by a process known as leaching. An example of a known process 10 for gold recovery using cyanide leaching is shown in FIG. 1. In process 10, low grade ore 12 is crushed and ground 14 then leached 16 with a basic solution of NaCN for 16 to 48 hours depending on ore type. Because of some environmental accidents in various gold mines around the world, gold leaching by cyanidation has been prohibited in many countries⁴. Therefore, considerable efforts have been made to find an alternative to cyanide and a variety of leaching reagents have been studied and proposed^{5,6}.

Generally, following gold dissolution in the cyanide solution, gold is recovered by activated carbon adsorption (e.g. step 18 in process 10 of FIG. 1 wherein, for example 0.1 to 1 kg activated carbon per ton ore is used), or by the zinc cementation process. The activated carbon adsorption process is considerably more common^{7,8}. For example, 4 to 8 kg gold can be adsorbed by 1 ton activated carbon in 4 to 8 steps over a time period of 4 to 8 hours.

As shown in FIG. 1, following the carbon adsorption step 18, the loaded activated carbon is washed 20 with low concentrated HCl to remove impurities such as adsorbed Zn, Ca, Fe, Cu and Ag then gold desorption (elution) 22 is done by using, for example 1% NaOH and 0.1 to 0.2% NaCN solution at a high temperature (e.g. 110° C.) for 36 to 72 hours. Pure gold 24 can be obtained, for example by electrowinning or reduction. The whole process time for gold recovery using a process like the process 10 shown in FIG. 1 is 46-110 hours.

Processes for gold recovery which use activated carbon may suffer from several drawbacks such as but not limited to low selectivity, very long procedures, loss of gold product, high temperature requirements, and further consumption of cyanide for desorption of gold from activated carbon, all of which may bring additional costs during the gold recovery process⁹.

Although considerable effort has been undertaken to replace cyanide, none of the reported leaching reagents has been used in the industrialization of gold production due, for example to drawbacks such as (i) high reagent consumption, (ii) complex chemistry, (iii) lack of industrial techniques for the recovery of gold from their resulting solutions, and (iv) low rate of gold recovery compared to cyanide. Drawbacks such as toxicity, cost, long reaction times and poor selectivity are also associated with known systems. Thus, it may be desirable to develop more effective leachants with, for example, higher efficiency and/or lower toxicity from both an environmental and an economical viewpoint.

Cyanide Leaching

For more than a century, cyanidation has remained the dominant process for extraction and recovery of gold from ore. Metallic gold can be dissolved in an alkaline solution of potassium or sodium cyanide in the presence of dissolved molecular oxygen (reaction 1):

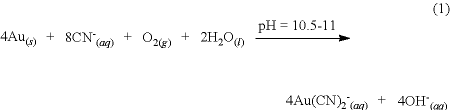

In neutral or acidic conditions, over 99% of the cyanide will exist as highly poisonous HCN gas. By increasing pH, it is converted to free cyanide ion so that at a pH of 9.3, CN⁻ and HCN are in equilibrium, with 50% of each present. At a pH of 11, over 99% of the cyanide remains in solution as CN⁻.¹⁰ The free cyanide ion is a very strong ligand which can form a highly stable complex with gold, Au(CN)₂⁻, in aqueous solution. With stoichiometric ratios, gold dissolution in alkaline cyanide solution is slow, but by increasing the cyanide concentration, the leaching rate will increase until a maximum is reached (0.075 w/w % KCN or 0.06% NaCN) and after that the rate of dissolution remains constant¹¹.

Before cyanide treatment, the gold ore is typically crushed and ground to decrease the size of the ore particles to 75 microns or less to provide a larger contact surface area between the gold and the leaching solution. Depending on the ore type, the cyanide consumption varies from about 0.25 to 2 kg of cyanide per tonne of ore and the rate of gold dissolution in cyanide takes 16 to 48 hours¹¹. The cyanide consumption increases when the refractoriness of the gold ore is increased. A refractory gold ore is a gold-containing ore that is resistant to recovery by direct cyanidation. Other minerals and metals are also dissolved in the alkaline cyanide solution and they usually consume cyanide and oxygen and thus reduce the overall efficiency of gold leaching.

For example, copper minerals such as chalcocite (Cu₂S) and cuprite (Cu₂O) can form a variety of cyanide complexes such as CuCN, Cu(CN)₂⁻, Cu(CN)₃²⁻ and Cu(CN)₄³⁻ and iron sulfides like pyrrhotite (Fe₇S₈), pyrite (FeS₂) and arsenopyrite (FeAsS) form highly stable Fe(CN)₆⁴⁻ and Fe(CN)₆³⁻ complexes¹². In addition, most sulfide minerals have a detrimental effect on gold leaching since they may passivate the surface of gold and consume cyanide and oxygen. However, some other minerals such as galena (PbS) can improve gold leaching kinetics by preventing formation of a passivation layer on the gold surface¹³.

Although cyanide is still the main leaching reagent for gold recovery in the mining industry, it suffers from several drawbacks such as but not limited to high toxicity, slow leaching kinetics and low gold extraction for refractory ores. Considerable efforts have thus been made to find an alternative to cyanide.

Gold Recovery From Cyanide Solution

There are several techniques for gold recovery from cyanide leach liquors like carbon adsorption, zinc cementation and solvent extraction with carbon adsorption being by far the more common technique^{14,15}. In the carbon adsorption technique, after gold is leached into cyanide solution, activated carbon is applied for selective gold adsorption to separate AuCN₂⁻ from other metals and impurities. 0.1 to 1 kg activated carbon per tonne of ore is usually applied in 4 to 8 steps for complete adsorption of Au(CN)₂⁻ complex from cyanide solution which takes 4 to 8 hours. The loaded activated carbon is usually washed with a low concentration HCl solution to remove other impurities such as Fe, Cu, Zn, Ca, and Ag. The dicyanoaurate(I) complex is then removed from the activated carbon in an elution step by washing the loaded activated carbon with a fresh basic sodium cyanide solution at 110° C. for 36 to 72 hours^{10,16}. The desorbed Au(CN)₂⁻ complex is finally reduced to elemental gold by electrowinning or reduction.

The activated carbon method suffers from several drawbacks such as but not limited to low selectivity, very long procedures, loss of some gold product, and high temperature requirements¹⁷.

Alternatives to Cyanide

Due to the high toxicity and environmental problems of cyanide, there has been a quest to find useful alternatives. In recent years, some alternatives to cyanide have been reported to leach gold ore efficiently. Some of the useful reported leaching reagents are thiosulfate, thiocyanite, thiourea, and chloride in combination with an oxidizing agent like HNO₃, H₂O₂ and hypochlorite.

Thiosulfate Leaching

Thiosulfate is the most studied alternative to cyanide. Gold can be leached in alkaline aqueous solutions (pH=9.5-10.5) of thiosulfate in the presence of oxidizing agents like O₂ and copper(II) ions. The rate of gold dissolution becomes slower in the absence of copper (II) ions¹⁸. Ammonia is usually used to accelerate the rate of gold leaching in this media. It has an efficient role to stabilize the intermediate oxidation products of gold, decreasing the rate of thiosulfate oxidation by Cu²⁺, preventing the formation of insoluble components like sulfides on the gold surface and keeping a high concentration of Cu²⁺ by forming Cu(NH₃)₄²⁺ during the leaching process^{19,20}. Oxygen has a dual role by oxidation of Cu(NH₃)₂⁺ to Cu(NH₃)₄²⁺ or direct oxidation of the gold surface. The overall balanced equation of gold dissolution in thiosulfate media is shown in the following reaction²¹ (2):

Au+Cu(NH₃)₄²⁺+2S₂O₃²⁻→Au(S₂O₃)₂³⁻+Cu(NH₃)₂⁺+2NH₃ (2)

Compared to the cyanidation process, thiosulfate leaching has some advantages such as but not limited to fast leaching kinetics, lower toxicity and higher gold recovery in the case of some refractory gold ores^{22,23}. However, it suffers from some major drawbacks such as but not limited to complex chemistry, toxicity of ammonia, ineffectiveness of activated carbon for desorption of leached gold, and high consumption of thiosulfate.

For example, the copper(II) itself consumes thiosulfate resulting in high consumption of both thiosulfate and copper and the resulting tetrathionate (S₄O₆²⁻) decomposes to elemental sulfur and forms sulfides such as CuS which increases the gold passivation during the leaching process (reaction 3)^{24,25}.

2Cu(NH₃)₄²⁺+8S₂O₃²⁻→2Cu(S₂O₃)₃⁵⁻+8NH₃+S₄O₆²⁻ (3)

Thiourea

Thiourea is another well-studied leaching reagent which can dissolve gold in acidic media based on the following reaction (4)²⁶:

Au+2CS(NH₂)₂→Au(SC(NH₂)₂)₂⁺ (4)

Different oxidizing reagents such as but not limited to hydrogen peroxide, sodium peroxide, oxygen, ozone and ferric ion can be used in combination with thiourea to dissolve gold. Among these oxidizing reagents, ferric ion in sulfuric acid solution is a useful one (reaction 5)²⁷.

Au+2CS(NH₂)₂+Fe³⁺→Au(SC(NH₂)₂)₂⁺+Fe²⁺ (5)

However, thiourea is not stable in acidic media in the presence of ferric ion and is decomposed to sulfur and cyanamide²⁸. Addition of a reducing agent such as SO₂ decreases the thiourea consumption by preventing its oxidation²⁹. The kinetics of gold leaching in thiourea solution are much faster than the cyanidation process because of nongaseous oxidants such as but not limited to hydrogen peroxide and ferric sulfate which are used instead of oxygen which is used in the cyanidation process³⁰. However, gold recovery and reagent consumption with cyanide is more economical than thiourea³¹.

Complexation with base metals such as copper accelerates thiourea consumption and decreases gold leaching kinetics. Thermal degradation, oxidation by the ferric sulfate and air are the other reasons for high consumption of thiourea³². Thiourea's commercial application has been hindered due to its high consumption and no existence of applicable industrial techniques for the recovery of gold from its solution. Although thiourea has a lower toxicity compared to cyanide, it is suspected to be a carcinogen agent and is treated with caution³³.

Chloride Solution Containing an Oxidizing Agent

Concentrated hydrochloric acid in combination with powerful oxidizing agents is known as a strong leaching reagent for leaching precious metals, for example from scraps and secondary sources³⁴. A hot solution of concentrated HCl mixed with concentrated HNO₃ (known as aqua regia) or hydrogen peroxide can dissolve gold according to the following chemical reactions (see reactions 6 and 7) resulting in the formation of a stable AuCl₄⁻ complex³⁵.

Au+4HCl+HNO₃→HAuCl₄+2H₂O+NO (6)

2Au+3H₂O₂+8HCl→2HAuCl₄+6H₂O (7)

Apart from these oxidants, chlorine gas can also be used which forms the same gold species³⁶. Chlorine had been used to dissolve gold from ores and concentrates during the second half of the 19^{th} century until it was gradually replaced by the more economical alkaline cyanide leaching. In all cases, the dissolution rate is faster compared to cyanide, however, due to high concentration of HCl, all of these solutions are highly corrosive and toxic and in the case of gold ore treatment, their consumption is not economical³⁷.

Chloride/Hypochlorite

Chloride/hypochlorite solutions have been recognized as another alternative leaching reagent to cyanide which can dissolve gold in a wide range of pH values³⁸. Depending on the solution's pH, three different oxidizing species can be formed in hypochlorite solutions. At pH>7.5, hypochlorite ion (OCl⁻) is the dominant species while for pH values between 3.5 and 7.5, hypochlorous acid (HOCl) acts as oxidizing agent and for pH less than 3.5, nascent chlorine gas (Cl₂) is formed. Among these three species, HOCl is the most effective oxidizing agent to leach gold as the [AuCl₄]⁻ (reaction 8)³⁹.

2Au+3HOCl+3H⁺+5Cl⁻→2[AuCl₄]⁻+3H₂O (8)

In a solution containing 100 g/L NaCl, the [AuCl₄]⁻ is stable in the pH range of 0-8 and potentials greater than 0.9 V⁴⁰. The chloride-hypochlorite solution is a useful leaching reagent, for example for refractory gold ores. Because of low acidity, it does not produce a corrosion media; however the reagents consumption is still high^{41,42}. The main drawback of this leaching reagent is that the percentage of leached gold is usually less than 85%⁴³.

Gold Leaching in Organic Solvents

Polar and water miscible organic solvents have been investigated for dissolution of some transition metals like silver and copper^{44,45,46}. In some cases better leaching efficiency has been achieved in particular mixtures of water-solvent or pure solvent. There are also a few examples of gold leaching in organic solvents like DMSO, methanol, acetone, N,N-dimethylformamide and acetonitrile^{45,47,48}. For example, Yukimichi investigated the dissolution rate of gold, silver and palladium in different halogen-halide-polar organic solvent systems and in the case of gold, he proved it could be dissolved in a mixture of a halide source, a halogen such as chlorine gas, bromine, iodine, and an organic solvent like methanol or MeCN. Among investigated systems, mixtures of chlorine gas, acetonitrile and Me₃NHCl (as chloride source) dissolved gold most effectively; even faster than aqua regia⁴⁸.

### SUMMARY

The present studies disclose the use of a polar, water-miscible organic solvent in combination with leaching reagents to form extraction solutions that may, for example, simplify recovery of precious metal from substances comprising such metal, save time and energy and due to recoverability of the organic solvent, and/or produce less waste.

Accordingly, the present disclosure includes a method of leaching precious metal from a substance comprising precious metal, the method comprising contacting the substance with a mixture comprising: (a) a ligand source; (b) an optional acid catalyst; (c) an optional stabilizer; (d) an oxidizing agent; and (e) a water-miscible organic solvent, under conditions to leach the precious metal from the substance.

In an embodiment of the present disclosure, the method comprises contacting the substance with a mixture comprising: (a) a ligand source; (b) an acid catalyst; (c) a stabilizer; (d) an oxidizing agent; and (e) a water-miscible organic solvent, under conditions to leach the precious metal from the substance.

In an embodiment of the present disclosure, the conditions to leach the precious metal such as palladium platinum, rhodium and/or gold from the substance comprise contacting the substance and the mixture for a time of less than 0.1 min, or about 0.1 min to about 10 min, or about 0.1 min to about 30 min, or about 0.1 to about 40 min, or about 0.1 min to about 50 min, or about 0.1 min to 1 hour, or about 0.1 min to about 3 hours, or about 0.1 min to about 6 hours, or about 0.1 min to about 18 hours, at a temperature of about 20° C. to about 90° C., or about 20° C. to about 120° C., or about 20° C. to about 118° C.

In another embodiment, the acid catalyst in the mixture is selected from HCl, H₂SO₄, H₃PO₄, HClO₄, and HI. In another embodiment, the acid catalyst is an aqueous solution of HCl, H₂SO₄, or HI having a concentration of from about 0.01 M to about 2.5 M, or about 0.1 M to about 2 M, or about 0.2 M to about 1.5 M, or about 0.5 to about 1 M, in the water-miscible organic solvent.

In an embodiment, the oxidizing agent in the mixture is selected from H₂O₂, Cl₂, I₂, HNO₃, MnO₂, HClO₄, NaIO₃, CuCl₂, FeCl₃, and O₂ from air. In some embodiments, the oxidizing agent is H₂O₂, I₂, NaIO₃, CuCl₂, FeCl₃, O₂, and bubbled air. In other embodiments, the oxidizing agent is H₂O₂, Cl₂, HNO₃, MnO₂, CuCl₂, FeCl₃, O₂, and bubbled air. In another embodiment, the oxidizing agent is at a concentration of from about 0.01 M to about 2.5 M, or about 0.01 M to about 1 M, or about 0.01 M to about 0.5 M, or about 0.01 to about 0.1 M, or from about 0.02 M to about 0.1 M, or about 0.05 to about 0.1 M in the water-miscible organic solvent.

In an embodiment, the ligand source is a source of Cl⁻ ligand or a source of I⁻ ligand. In some embodiments, the source of I⁻ is NaI, KI, HI, NH₄I, CsI or a combination thereof. In other embodiments, the source of Cl⁻ is HCl, MgCl₂, AlCl₃ or CaCl₂, or a combination thereof. In another embodiment, the ligand source is at a concentration of from about 0.1 M to about 4 M, from about 0.1 M to about 3 M, from about 0.1 M to about 2 M, from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent.

In an embodiment, the water-miscible organic solvent in the mixture is glacial acetic acid.

In an embodiment, the stabilizer is a carboxylic acid. In some embodiments, the carboxylic acid is the solvent acetic acid. In other embodiments, the carboxylic acid is citric acid.

In an embodiment, the substance comprising the precious metal is a platinum group metal concentrate. In an embodiment, the substance comprising precious metal is a palladium, rhodium, and/or platinum-containing substance. In an embodiment, the palladium, rhodium, and/or platinum-containing substance further comprises gold, iron, copper, aluminum, cobalt, or nickel or a combination thereof, and the method selectively dissolves the palladium, rhodium, and/or platinum from the palladium, rhodium, and/or platinum-containing substance, and can also dissolve the gold. In another embodiment, the palladium, rhodium, and/or platinum-containing substance is an ore, electronic or electrical waste, or a catalytic converter.

In an embodiment, the substance comprising the precious metals is a palladium-containing substance. In an embodiment, the palladium-containing substance further comprises gold, iron, copper, cobalt, or nickel, or a combination thereof, and the method selectively dissolves the palladium, and can also dissolve the gold from the palladium-containing substance. In embodiments where the method selectively dissolves the palladium and the gold, the rate of gold dissolution is slow relative to the rate of palladium dissolution. In an embodiment, the palladium-containing substance further comprises iron, copper, cobalt, or nickel, or a combination thereof, and the method selectively dissolves the palladium from the palladium-containing substance. In another embodiment of the present disclosure, the palladium-containing substance is an ore, electronic or electrical waste, or a catalytic converter.

In an embodiment, the substance comprising precious metal is a palladium and platinum containing substance; a palladium, platinum, and rhodium containing substance; or a rhodium containing substance. In an embodiment, the palladium and platinum containing substance, the palladium, platinum, and rhodium containing substance, or the rhodium containing substance further comprises gold, iron, copper, cobalt, or nickel, or a combination thereof, and the method selectively dissolves the palladium and platinum, the palladium, platinum, and rhodium, or rhodium from the palladium and platinum containing substance, the palladium, platinum, and rhodium containing substance, or the rhodium containing substance; and can also dissolve the gold. In another embodiment of the present disclosure, the palladium and platinum containing substance, the palladium, platinum, and rhodium containing substance, or the rhodium containing substance is an ore, electronic or electrical waste, or a catalytic converter.

In another embodiment, the method further comprises: separating the water-miscible organic solvent containing the leached precious metal from insoluble impurities; treating the leached precious metal in the water-miscible organic solvent with a reducing agent under conditions to obtain the precious metal; and separating the precious metal from the water-miscible organic solvent. In an embodiment, the reducing agent is selected from H₂, NaBH₄, FeCl₂, hydrazine hydrochloride, hydroxylamine hydrochloride, ascorbic acid, formic acid, oxalic acid, metallic copper, ferrocene, Fe powder and Zn powder. In some embodiments, the reducing agent is H₂.

In another embodiment, the method further comprises: separating the water-miscible organic solvent containing the leached precious metal from insoluble impurities; treating the leached precious metal in the water-miscible organic solvent under conditions to obtain the precious metal; and separating the precious metal from the water-miscible organic solvent; wherein treating the leached precious metal in the water-miscible organic solvent under conditions to obtain the precious metal comprises electrowinning, ion exchange resins, metal-salt precipitation (not reduction) such as reacting with ammonium chloride, or a combination thereof.

In another embodiment, the method further comprises recycling the water-miscible organic solvent. In other embodiments, the method further comprises recycling the mixture comprising the ligand source; the optional acid catalyst; the optional stabilizer; the oxidizing agent; and the water-miscible organic solvent.

As herein described there is also provided:
1. A method of selectively leaching palladium from a substance comprising platinum group metals, the method comprising:
   contacting the substance with a leach mixture comprising
      an iodide ligand source,
      an iodine oxidant,
      an optional acid catalyst,
      an optional carboxylic acid stabilizer, and
      a water-miscible organic solvent such as acetic acid, glacial acetic acid, acetonitrile, ethyl acetate, tetrahydrofuran, or combinations thereof, preferably glacial acetic acid,
   under conditions to selectively leach the palladium from the substance comprising platinum group metals;
   selectively leaching the palladium from the substance; and
   forming a leach solution comprising leached palladium.
2. The method of item 1, wherein the iodide ligand source comprises NaI, KI, HI, NH₄I, CsI, or a combination thereof; or preferably NaI, KI, HI, or a combination thereof; or more preferably NaI, KI, or a combination thereof.
3. The method of item 1 or 2, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
4. The method of any one of items 1 to 3, wherein the iodine oxidant comprises I₂; and optionally, the method further comprises generating the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.
5. The method of item 4, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the solvent, preferably between about 0.01 to about 0.1 M.
6. The method of any one of items 1 to 5, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.
7. The method of any one of items 1 to 6, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
8. The method of any one of items 1 to 7, wherein the carboxylic acid stabilizer comprises acetic acid, citric acid, or a combination thereof.
9. The method of item 8, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.
10. The method of any one of items 1 to 9, wherein the water-miscible organic solvent makes up at least 50 wt % of the liquid phase of the leach mixture.
11. The method of any one of items 1 to 10, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.
12. The method of item 11, wherein the conditions to selectively leach the palladium further comprise contacting the substance with the leach mixture at a solid to liquid phase ratio of 1:10.
13. The method of item 11 or 12, wherein the conditions to selectively leach the palladium are tolerant of up to about 10 wt % water, or between about 10 wt % to less than 50 wt % water, such as 30 wt % water.
14. The method of any one of items 1 to 13, wherein the substance comprising platinum group metals further comprises oxidized platinum group metals, and the method further comprises contacting the substance with a reductant under conditions to at least partially reduce the oxidized platinum group metals; and at least partially reducing the oxidized platinum group metals.
15. The method of item 14, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
16. The method of item 14 or 15, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
17. The method of any one of items 1 to 16, wherein the platinum group metals of the substance comprising platinum group metals comprise a contaminant, the method further comprising contacting the substance with a chelating agent under conditions to at least partially remove the contaminant; and at least partially decontaminating the platinum group metals.
18. The method of item 17, wherein the chelating agent comprises citric acid, oxalic acid, or salts thereof, or a combination thereof; preferably citric acid and/or salt thereof.
19. The method of item 17 or 18, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
20. The method of any one of items 17 to 19, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
21. The method of any one of items 1 to 20, wherein the method selectively leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9%, of the palladium in the substance.
22. The method of any one of items 1 to 21, further comprising adding an oxidant and a polyatomic salt to the leach solution under conditions to precipitate the leached palladium; and precipitating the leached palladium.
23. The method of item 22, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
24. The method of item 22 or 23, wherein the polyatomic salt comprises an ammonium salt, such as ammonium chloride, ammonium sulfate, ammonium nitrate, or combinations thereof.
25. The method of any one of items 22 to 24, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
26. The method of any one of items 22 to 25, further comprising contacting the leached palladium with a reducing agent under conditions to reduce the leached palladium to palladium metal; and reducing the leached palladium to palladium metal.
27. The method of item 26, wherein contacting the leached palladium with the reducing agent comprises forming an aqueous mixture comprising the leached palladium, and adding the reducing agent to the aqueous mixture.
28. The method of item 26 or 27, wherein the reducing agent comprises H₂, metal powder, metal strips, or a combination thereof, the metal comprising Al, Cu, Fe, Zn, or a combination thereof.
29. The method of any one of items 26 to 28, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
30. The method of any one of items 26 to 29, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
31. The method of item 30, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
32. The method of item 30 or 31, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
33. The method of any one of items 22 to 32, wherein the palladium metal has a purity of about 90% to about 100%, or about 95% to about 99.9%, or about 98% to about 99.9%.
34. The method of any one of items 1 to 33, wherein the substance comprising platinum group metals is a platinum group metal ore, a platinum group metal concentrate, electronic or electrical waste, a spent catalyst, or a catalytic converter; preferably a spent catalyst or catalytic converter.
35. The method of any one of items 1 to 34, wherein the platinum group metals of the substance comprising platinum group metals comprise palladium, palladium and platinum, or palladium, platinum, and rhodium.
36. A process of selectively leaching palladium from a substance comprising platinum group metals, the process comprising:
   contacting the substance with a leach mixture comprising
      an iodide ligand source,
      an iodine oxidant,
      an optional acid catalyst,
      an optional carboxylic acid stabilizer, and
      a water-miscible organic solvent such as acetic acid, glacial acetic acid, acetonitrile, ethyl acetate, tetrahydrofuran, or combinations thereof, preferably glacial acetic acid,
   under conditions to selectively leach the palladium from the substance comprising platinum group metals;
   selectively leaching the palladium from the substance to form a leach solution comprising leached palladium and a leached substance;
   separating the leach solution from the leached substance; and
treating the leach solution comprising leached palladium under conditions to form palladium metal.
37. The process of item 36, wherein the iodide ligand source comprises NaI, KI, HI, NH₄I, CsI, or a combination thereof; or preferably NaI, KI, HI, or a combination thereof; or more preferably NaI, KI, or a combination thereof.
38. The process of item 36 or 37, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
39. The process of any one of items 36 to 38, wherein the iodine oxidant comprises I₂; and optionally, the process further comprises generating the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.
40. The process of item 39, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the glacial acetic acid solvent, preferably between about 0.01 to about 0.1 M.
41. The process of any one of items 36 to 40, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.
42. The process of any one of items 36 to 41, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
43. The process of any one of items 36 to 42, wherein the carboxylic acid stabilizer comprises acetic acid, citric acid, or a combination thereof.
44. The process of item 43, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.
45. The process of any one of items 36 to 44, wherein the water-miscible organic solvent makes up at least 50 wt % of the liquid phase of the leach mixture.
46. The process of any one of items 36 to 45, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.
47. The process of item 46, wherein the conditions to selectively leach the palladium further comprise contacting the substance with the leach mixture at a solid to liquid phase ratio of 1:10.
48. The process of item 46 or 47, wherein the conditions to selectively leach the palladium are tolerant of up to about 10 wt % water, or between about 10 wt % to less than 50 wt % water, such as 30 wt % water.
49. The process of any one of items 36 to 48, wherein the substance comprising platinum group metals further comprises oxidized platinum group metals, and the process further comprises contacting the substance with a reductant under conditions to at least partially reduce the oxidized platinum group metals; and at least partially reducing the oxidized platinum group metals.
50. The process of item 49, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
51. The process of item 49 or 50, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
52. The process of any one of items 36 to 51, wherein the platinum group metals of the substance comprising platinum group metals comprise a contaminant, the process further comprising contacting the substance with a chelating agent under conditions to at least partially remove the contaminant; and at least partially decontaminating the platinum group metals.
53. The process of item 52, wherein the chelating agent comprises citric acid, oxalic acid, or salts thereof, or a combination thereof; preferably citric acid and/or salt thereof.
54. The process of item 52 or 53, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
55. The process of any one of items 52 to 54, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
56. The process of any one of items 36 to 55, wherein the process selectively leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the substance.
57. The process of any one of items 36 to 56, wherein treating the leach solution comprising leached palladium under conditions to form palladium metal comprises adding an oxidant and a polyatomic salt to the leach solution under conditions to precipitate the leached palladium; and precipitating the leached palladium.
58. The process of item 57, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
59. The process of item 57 or 58, wherein the polyatomic salt comprises an ammonium salt, such as ammonium chloride, ammonium sulfate, ammonium nitrate, or combinations thereof.
60. The process of any one of items 57 to 59, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
61. The process of any one of items 57 to 60, wherein treating the leach solution comprising leached palladium under conditions to form palladium metal further comprises contacting the leached palladium with a reducing agent under conditions to reduce the leached palladium to palladium metal; and reducing the leached palladium to palladium metal.
62. The process of item 61, wherein contacting the leached palladium with the reducing agent comprises forming an aqueous mixture comprising the leached palladium, and adding the reducing agent to the aqueous mixture.
63. The process of item 61 or 62, wherein the reducing agent comprises H₂, metal powder, metal strips, or a combination thereof, the metal comprising Al, Cu, Fe, Zn, or a combination thereof.
64. The process of any one of items 61 to 63, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
65. The process of any one of items 61 to 64, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
66. The process of item 65, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
67. The process of item 65 or 66, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
68. The process of any one of items 57 to 67, wherein the palladium metal has a purity of about 90% to about 100%, or about 95% to about 99.9%, or about 98% to about 99.9%.
69. The process of any one of items 36 to 68, wherein the substance comprising platinum group metals is a platinum group metal ore, a platinum group metal concentrate, electronic or electrical waste, a spent catalyst, or a catalytic converter; preferably a spent catalyst or catalytic converter.
70. The process of any one of items 36 to 69, wherein the platinum group metals of the substance comprising platinum group metals comprise palladium, palladium and platinum, or palladium, platinum, and rhodium.
71. A method of simultaneously and selectively leaching at least two of palladium, platinum, and rhodium from a substance comprising platinum group metals, the method comprising:
   contacting the substance with a leach mixture comprising
      a chloride ligand source,
      an oxidizing agent,
      an acid catalyst, and
      a water-miscible organic solvent such as acetic acid, glacial acetic acid, acetonitrile, ethyl acetate, tetrahydrofuran, or combinations thereof, preferably glacial acetic acid,
   under conditions to simultaneously and selectively leach at least two of the palladium, platinum, and rhodium from the substance comprising platinum group metals;
   simultaneously and selectively leaching at least two of the palladium, platinum, and rhodium from the substance; and
   forming a leach solution comprising at least two of leached palladium, platinum, and rhodium.
72. The method of item 71, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.
73. The method of item 71 or 72, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
74. The method of any one of items 71 to 73, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.
75. The method of item 74, wherein the oxidizing agent has a concentration of from about 0.01 M to about 2.5 M in the solvent, preferably between about 0.01 to about 1 M.
76. The method of any one of items 71 to 75, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.
77. The method of any one of items 71 to 76, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
78. The method of any one of items 71 to 77, wherein the water-miscible organic solvent makes up at least 50 wt % of the liquid phase of the leach mixture.
79. The method of any one of items 71 to 78, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.
80. The method of item 79, wherein the conditions to simultaneously and selectively leach at least two of palladium, platinum, and rhodium further comprise contacting the substance with the leach mixture at a solid to liquid phase ratio of 1:10.
81. The method of item 79 or 80, wherein the conditions to simultaneously and selectively leach at least two of palladium, platinum, and rhodium are tolerant of up to about 10 wt % water, or between about 10 wt % to less than 50 wt % water, such as 30 wt % water.
82. The method of any one of items 71 to 81, wherein the substance comprising platinum group metals further comprises oxidized platinum group metals, and the method further comprises contacting the substance with a reductant under conditions to at least partially reduce the oxidized platinum group metals; and at least partially reducing the oxidized platinum group metals.
83. The method of item 82, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
84. The method of item 82 or 83, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
85. The method of any one of items 71 to 84, wherein the platinum group metals of the substance comprising platinum group metals comprise a contaminant, the method further comprising contacting the substance with a chelating agent under conditions to at least partially remove the contaminant; and at least partially decontaminating the platinum group metals.
86. The method of item 85, wherein the chelating agent comprises citric acid, oxalic acid, or salts thereof, or a combination thereof; preferably citric acid and/or salt thereof.
87. The method of item 86 or 86, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
88. The method of any one of items 85 to 87, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
89. The method of any one of items 71 to 88, wherein the method leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.
90. The method of any one of items 71 to 89, further comprising adding an oxidant and a polyatomic salt to the leach solution under conditions to precipitate the leached palladium, platinum, and/or rhodium; and precipitating the leached palladium, platinum, and/or rhodium.
91. The method of item 90, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
92. The method of item 90 or 91, wherein the polyatomic salt comprises an ammonium salt, such as ammonium chloride, ammonium sulfate, ammonium nitrate, or combinations thereof.
93. The method of any one of items 90 to 92, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
94. The method of any one of items 90 to 93, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
95. The method of item 94, wherein contacting the leached palladium, platinum, and/or rhodium with the reducing agent comprises forming an aqueous mixture comprising the leached palladium, platinum, and/or rhodium, and adding the reducing agent to the aqueous mixture.
96. The method of item 94 or 95, wherein the reducing agent comprises H₂, metal powder, metal strips, or a combination thereof, the metal comprising Al, Cu, Fe, Zn, or a combination thereof.
97. The method of any one of items 94 to 96, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
98. The method of any one of items 94 to 97, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
99. The method of item 98, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
100. The method of item 98 or 99, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
101. The method of any one of items 90 to 100, wherein at least one of the palladium, platinum, and/or rhodium metal has a purity of about 90% to about 100%, or about 95% to about 99.9%, or about 98% to about 99.9%.
102. The method of any one of items 71 to 101, wherein the substance comprising platinum group metals is a platinum group metal ore, a platinum group metal concentrate, electronic or electrical waste, a spent catalyst, or a catalytic converter; preferably a spent catalyst or catalytic converter.
103. The method of any one of items 71 to 102, wherein the platinum group metals of the substance comprising platinum group metals comprise palladium, platinum, and/or rhodium.
104. Use of a leach mixture for simultaneously and selectively leaching at least two of palladium, platinum, and rhodium from a substance comprising platinum group metals, under conditions to simultaneously and selectively leach at least two of the palladium, platinum, and rhodium from the substance comprising platinum group metals, and forming a leach solution comprising at least two of leached palladium, platinum, and rhodium, the leach mixture comprising
   a chloride ligand source,
   an oxidizing agent,
   an acid catalyst, and
   a water-miscible organic solvent such as acetic acid, glacial acetic acid, acetonitrile, ethyl acetate, tetrahydrofuran, or combinations thereof, preferably glacial acetic acid.
105. The use of item 104, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.
106. The use of item 104 or 105, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
107. The use of any one of items 104 to 105, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.
108. The use of item 107, wherein the oxidizing agent has a concentration of from about 0.01 M to about 2.5 M in the solvent, preferably between about 0.01 to about 1 M.
109. The use of any one of items 104 to 108, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.
110. The use of any one of items 104 to 109, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
111. The use of any one of items 104 to 110, wherein the water-miscible organic solvent makes up at least 50 wt % of the liquid phase of the leach mixture.
112. The use of any one of items 104 to 111, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.
113. The use of item 112, wherein the conditions to simultaneously and selectively leach at least two of palladium, platinum, and rhodium further comprise contacting the substance with the leach mixture at a solid to liquid phase ratio of 1:10.
114. The use of item 112 or 113, wherein the conditions to simultaneously and selectively leach at least two of palladium, platinum, and rhodium are tolerant of up to about 10 wt % water, or between about 10 wt % to less than 50 wt % water, such as 30 wt % water.
115. The use of any one of items 104 to 114, wherein the substance comprising platinum group metals further comprises oxidized platinum group metals, and the use further comprises use of a reductant for contacting the substance under conditions to at least partially reduce the oxidized platinum group metals; and at least partially reducing the oxidized platinum group metals.
116. The use of item 115, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
117. The use of item 115 or 116, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
118. The use of any one of items 104 to 117, wherein the platinum group metals of the substance comprising platinum group metals comprise a contaminant, the use further comprising use of a chelating agent for contacting the substance under conditions to at least partially remove the contaminant; and at least partially decontaminating the platinum group metals.
119. The use of item 118, wherein the chelating agent comprises citric acid, oxalic acid, or salts thereof, or a combination thereof; preferably citric acid and/or salt thereof.
120. The use of item 118 or 119, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
121. The use of any one of items 118 to 120, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
122. The use of any one of items 104 to 121, wherein the leach mixture leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.
123. The use of any one of items 104 to 122, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.
124. The use of item 123, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
125. The use of item 123 or 124, wherein the polyatomic salt comprises an ammonium salt, such as ammonium chloride, ammonium sulfate, ammonium nitrate, or combinations thereof.
126. The use of any one of items 123 to 125, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
127. The use of any one of items 123 to 126, further comprising use of a reducing agent for reducing the leached palladium, platinum, and/or rhodium by contacting the leached palladium, platinum, and/or rhodium with the reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
128. The use of item 127, wherein contacting the leached palladium, platinum, and/or rhodium with the reducing agent comprises forming an aqueous mixture comprising the precipitated leached palladium, platinum, and/or rhodium, and adding the reducing agent to the aqueous mixture.
129. The use of item 127, wherein the reducing agent comprises H₂, metal powder, metal strips, or a combination thereof, the metal comprising Al, Cu, Fe, Zn, or a combination thereof.
130. The use of item 127 or 128, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
131. The use of any one of items 127 to 130, wherein the palladium, platinum, and/or rhodium metal at least comprises palladium metal, the use further comprising use of a refining mixture for refining the palladium metal of the palladium, platinum, and/or rhodium metals under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
132. The use of item 131, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
133. The use of item 131 or 132, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
134. The use of any one of items 123 to 133, wherein at least one of the palladium, platinum, and/or rhodium metal has a purity of about 90% to about 100%, or about 95% to about 99.9%, or about 98% to about 99.9%.
135. The use of any one of items 104 to 134, wherein the substance comprising platinum group metals is a platinum group metal ore, a platinum group metal concentrate, electronic or electrical waste, a spent catalyst, or a catalytic converter; preferably a spent catalyst or catalytic converter.
136. The use of any one of items 104 to 135, wherein the platinum group metals of the substance comprising platinum group metals comprise palladium, platinum, and/or rhodium.
137. A process of simultaneously and selectively leaching at least two of palladium, platinum, and rhodium from a substance comprising platinum group metals, the process comprising:
   contacting the substance with a leach mixture comprising
      a chloride ligand source,
      an oxidizing agent,
      an acid catalyst, and
      a water-miscible organic solvent such as acetic acid, glacial acetic acid, acetonitrile, ethyl acetate, tetrahydrofuran, or combinations thereof, preferably glacial acetic acid,
   under conditions to simultaneously and selectively leach at least two of the palladium, platinum, and rhodium from the substance comprising platinum group metals;
   simultaneously and selectively leaching at least two of the palladium, platinum, and rhodium from the substance to form a leach solution comprising leached palladium, platinum, and/or rhodium and a leached substance;
   separating the leach solution from the leached substance; and
   treating the leach solution comprising leached palladium, platinum, and/or rhodium under conditions to form palladium, platinum, and/or rhodium metal.
138. The process of item 137, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.
139. The process of item 137 or 138, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
140. The process of any one of items 137 to 139, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.
141. The process of item 140, wherein the oxidizing agent has a concentration of from about 0.01 M to about 2.5 M in the solvent, preferably between about 0.01 to about 1 M.
142. The process of any one of items 137 to 141, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.
143. The process of any one of items 137 to 142, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
144. The process of any one of items 137 to 143, wherein the water-miscible organic solvent makes up at least 50 wt % of the liquid phase of the leach mixture.
145. The process of any one of items 137 to 144, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.
146. The process of item 145, wherein the conditions to simultaneously and selectively leach at least two of palladium, platinum, and rhodium further comprise contacting the substance with the leach mixture at a solid to liquid phase ratio of 1:10.
147. The process of item 145 or 146, wherein the conditions to simultaneously and selectively leach at least two of palladium, platinum, and rhodium are tolerant of up to about 10 wt % water, or between about 10 wt % to less than 50 wt % water, such as 30 wt % water.
148. The process of any one of items 137 to 147, wherein the substance comprising platinum group metals further comprises oxidized platinum group metals, and the process further comprises contacting the substance with a reductant under conditions to at least partially reduce the oxidized platinum group metals; and at least partially reducing the oxidized platinum group metals.
149. The process of item 148, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
150. The process of item 148 or 149, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
151. The process of any one of items 137 to 150, wherein the platinum group metals of the substance comprising platinum group metals comprise a contaminant, the process further comprising contacting the substance with a chelating agent under conditions to at least partially remove the contaminant; and at least partially decontaminating the platinum group metals.
152. The process of item 151, wherein the chelating agent comprises citric acid, oxalic acid, or salts thereof, or a combination thereof; preferably citric acid and/or salt thereof.
153. The process of item 151 or 152, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
154. The process of any one of items 151 to 153, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
154. The process of any one of items 137 to 154, wherein the process leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.
155. The process of any one of items 137 to 154, wherein treating the leach solution comprising leached palladium, platinum, and/or rhodium under conditions to form palladium, platinum, and/or rhodium metal comprises adding an oxidant and a polyatomic salt to the leach solution under conditions to precipitate the leached palladium, platinum, and/or rhodium; and precipitating the leached palladium, platinum, and/or rhodium.
156. The process of item 155, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
157. The process of item 155 or 156, wherein the polyatomic salt comprises an ammonium salt, such as ammonium chloride, ammonium sulfate, ammonium nitrate, or combinations thereof.
158. The process of any one of items 155 to 157, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
159. The process of any one of items 155 to 158, wherein treating the leach solution comprising leached palladium, platinum, and/or rhodium under conditions to form palladium, platinum, and/or rhodium metal further comprises contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
160. The process of item 159, wherein contacting the leached palladium, platinum, and/or rhodium with the reducing agent comprises forming an aqueous mixture comprising the leached palladium, platinum, and/or rhodium, and adding the reducing agent to the aqueous mixture.
161. The process of item 159 or 160, wherein the reducing agent comprises H₂, metal powder, metal strips, or a combination thereof, the metal comprising Al, Cu, Fe, Zn, or a combination thereof.
162. The process of any one of items 159 to 161, wherein the conditions to reduce the leached palladium, platinum, and/or rhodium to palladium, platinum, and/or rhodium metal comprises contacting the leached palladium, platinum, and/or rhodium with a reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
163. The process of any one of items 159 to 162, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
164. The process of item 163, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
165. The process of item 163 or 164, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
166. The process of any one of items 155 to 165, wherein at least one of the palladium, platinum, and/or rhodium metal has a purity of about 90% to about 100%, or about 95% to about 99.9%, or about 98% to about 99.9%.
167. The process of any one of items 137 to 166, wherein the substance comprising platinum group metals is a platinum group metal ore, a platinum group metal concentrate, electronic or electrical waste, a spent catalyst, or a catalytic converter; preferably a spent catalyst or catalytic converter.
168. The process of any one of items 137 to 167, wherein the platinum group metals of the substance comprising platinum group metals comprise palladium, platinum, and/or rhodium.
169. A method of selectively leaching palladium from a spent catalyst comprising palladium and platinum, the method comprising:
   contacting the spent catalyst with a leach mixture comprising
      an metal iodide ligand source,
      an iodine-based oxidizing agent,
      an optional acid catalyst, and
      acetic acid as a water-miscible organic solvent, preferably glacial acetic acid,
   under conditions to selectively leach the palladium from the spent catalyst comprising palladium and platinum;
   selectively leaching the palladium from the spent catalyst; and
   forming a leach solution comprising leached palladium.
170. The method of item 169, wherein the metal iodide ligand source NaI, KI, or a combination thereof.
171. The method of item 169 or 170, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
172. The method of any one of items 169 to 171, wherein the iodine-based oxidizing agent comprises I₂, NaIO₃, or a combination thereof.
173. The method of item 172, wherein the iodine-based oxidizing agent has a concentration of from about 0.01 M to about 0.1 M in the acetic acid solvent, preferably a concentration from about 0.01 to about 0.05 M.
174. The method of any one of items 169 to 173, wherein the acid catalyst comprises a hydrogen halide; preferably HCl.
175. The method of any one of items 169 to 174, wherein the acid catalyst has a concentration of from about 0.01 M to about 1 M in the acetic acid solvent; or preferably has a concentration of from about 0.1 M to about 0.5 M.
176. The method of any one of items 169 to 175, wherein the acetic acid as the water-miscible organic solvent makes up at least 50 wt % of the liquid phase of the leach mixture.
177. The method of any one of items 169 to 176, wherein the conditions to selectively leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.
178. The method of item 177, wherein the conditions to selectively leach the palladium further comprise contacting the spent catalyst with the leach mixture at a solid to liquid phase ratio of 1:10.
179. The method of item 177 or 178, wherein the conditions to selectively leach the palladium are tolerant of up to about 10 wt % water.
180. The method of any one of items 169 to 179, wherein the spent catalyst comprises oxidized palladium and platinum, and the method further comprises contacting the spent catalyst with a reductant under conditions to at least partially reduce the oxidized palladium and platinum; and at least partially reducing the oxidized palladium and platinum.
181. The method of item 180, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
182. The method of item 180 or 181, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
183. The method of any one of items 169 to 182, wherein the palladium and platinum of the spent catalyst comprise a contaminant, the method further comprising contacting the spent catalyst with a chelating agent under conditions to at least partially remove the contaminant; and at least partially decontaminating the palladium and platinum.
184. The method of item 183, wherein the chelating agent comprises citric acid, oxalic acid, or salts thereof, or a combination thereof; preferably citric acid and/or salt thereof.
185. The method of item 183 or 184, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
186. The method of any one of items 183 to 185, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
187. The method of any one of items 169 to 186, wherein the method selectively leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.
188. The method of any one of items 169 to 187, further comprising adding an oxidant and a polyatomic salt to the leach solution under conditions to precipitate the leached palladium; and precipitating the leached palladium.
189. The method of item 188, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
190. The method of item 188 or 189, wherein the polyatomic salt comprises an ammonium salt, such as ammonium chloride, ammonium sulfate, ammonium nitrate, or combinations thereof.
191. The method of any one of items 188 to 190, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
192. The method of any one of items 188 to 191, further comprising contacting the leached palladium with a reducing agent under conditions to reduce the leached palladium to palladium metal; and reducing the leached palladium to palladium metal.
193. The method of item 192, wherein contacting the leached palladium with the reducing agent comprises forming an aqueous mixture comprising the leached palladium, and adding the reducing agent to the aqueous mixture.
194. The method of item 192 or 193, wherein the reducing agent comprises H₂, metal powder, metal strips, or a combination thereof, the metal comprising Al, Cu, Fe, Zn, or a combination thereof.
195. The method of any one of items 192 to 194, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
196. The method of any one of items 192 to 195, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
197. The method of item 196, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
198. The method of item 196 or 197, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
199. The method of any one of items 188 to 198, wherein the palladium metal has a purity of about 90% to about 100%, or about 95% to about 99.9%, or about 98% to about 99.9%.
200. The method of any one of items 169 to 199, wherein the spent catalyst is a catalytic converter; preferably a gasoline-based or diesel-based catalytic converter in biscuit form.
201. Use of a leach mixture for selectively leaching palladium from a spent catalyst comprising palladium and platinum under conditions to selectively leach the palladium from the spent catalyst comprising palladium and platinum, and forming a leach solution comprising leached palladium, the leach mixture comprising
   an metal iodide ligand source,
   an iodine-based oxidizing agent,
   an optional acid catalyst, and
   acetic acid as a water-miscible organic solvent, preferably glacial acetic acid,
under conditions to selectively leach the palladium from the spent catalyst comprising palladium and platinum;
selectively leaching the palladium from the spent catalyst; and
forming a leach solution comprising leached palladium.
202. The use of item 201, wherein the metal iodide ligand source NaI, KI, or a combination thereof.
203. The use of item 201 or 202, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
204. The use of any one of items 201 to 203, wherein the iodine-based oxidizing agent comprises I₂, NaIO₃, or a combination thereof.
205. The use of item 204, wherein the iodine-based oxidizing agent has a concentration of from about 0.01 M to about 0.1 M in the acetic acid solvent, preferably a concentration from about 0.01 to about 0.05 M.
206. The use of any one of items 201 to 205, wherein the acid catalyst comprises a hydrogen halide; preferably HCl.
207. The use of any one of items 201 to 206, wherein the acid catalyst has a concentration of from about 0.01 M to about 1 M in the acetic acid solvent; or preferably has a concentration of from about 0.1 M to about 0.5 M.
208. The use of any one of items 201 to 207, wherein the acetic acid as the water-miscible organic solvent makes up at least 50 wt % of the liquid phase of the leach mixture.
209. The use of any one of items 201 to 208, wherein the conditions to selectively leach the palladium from the spent catalyst comprises contacting the spent catalyst with the leach mixture for a time of about 10 min to about 18 hours, at a temperature of about 20° C. to about 30° C., under ambient pressure; wherein preferably, the time is about 30 min to about 18 hours; and the temperature is about 20° C. to about 25° C.
210. The use of item 209, wherein the conditions to selectively leach the palladium further comprise contacting the spent catalyst with the leach mixture at a solid to liquid phase ratio of 1:10.
211. The use of item 209 or 210, wherein the conditions to selectively leach the palladium are tolerant of up to about 10 wt % water.
212. The use of any one of items 201 to 211, wherein the spent catalyst further comprises oxidized palladium and platinum, and the use further comprises use of a reductant for contacting the spent catalyst under conditions to at least partially reduce the oxidized palladium and platinum; and at least partially reducing the oxidized palladium and platinum.
213. The use of item 212, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
214. The use of item 212 or 213, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
215. The use of any one of items 201 to 214, wherein the palladium and platinum of the spent catalyst comprise a contaminant, the use further comprising use of a chelating agent for contacting the spent catalyst under conditions to at least partially remove the contaminant; and at least partially decontaminating the palladium and platinum.
216. The use of item 215, wherein the chelating agent comprises citric acid, oxalic acid, or salts thereof, or a combination thereof; preferably citric acid and/or salt thereof.
217. The use of item 215 or 216, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
218. The use of any one of items 215 to 217, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
219. The use of any one of items 201 to 218, wherein the leach mixture selectively leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.
220. The use of any one of items 201 to 219, further comprising use of an oxidant and a polyatomic salt for precipitating the leached palladium by adding an oxidant and a polyatomic salt to the leach solution under conditions to precipitate the leached palladium; and precipitating the leached palladium.
221. The use of item 220, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
222. The use of item 220 or 221, wherein the polyatomic salt comprises an ammonium salt, such as ammonium chloride, ammonium sulfate, ammonium nitrate, or combinations thereof.
223. The use of any one of items 220 to 222, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
224. The use of any one of items 220 to 223, further comprising use of a reducing agent for reducing the leached palladium to palladium metal by contacting the leached palladium with the reducing agent under conditions to reduce the leached palladium to palladium metal; and reducing the leached palladium to palladium metal.
225. The use of item 224, wherein contacting the leached palladium with the reducing agent comprises forming an aqueous mixture comprising the leached palladium, and adding the reducing agent to the aqueous mixture.
226. The use of item 224 or 225, wherein the reducing agent comprises H₂, metal powder, metal strips, or a combination thereof, the metal comprising Al, Cu, Fe, Zn, or a combination thereof.
227. The use of any one of items 224 to 226, wherein the conditions to reduce the leached palladium to palladium metal comprises contacting the leached palladium with a reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
228. The use of any one of items 224 to 227, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
229. The use of item 228, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
230. The use of item 228 or 229, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
231. The use of any one of items 220 to 230, wherein the palladium metal has a purity of about 90% to about 100%, or about 95% to about 99.9%, or about 98% to about 99.9%.
232. The use of any one of items 201 to 231, wherein the spent catalyst is a catalytic converter; preferably a gasoline-based or diesel-based catalytic converter in biscuit form.
233. A process of recycling palladium from a spent catalyst comprising palladium and platinum, the process comprising:
   contacting the spent catalyst with a leach mixture comprising
      an metal iodide ligand source,
      an iodine-based oxidizing agent,
      an optional acid catalyst, and
      acetic acid as a water-miscible organic solvent, preferably glacial acetic acid,
   under conditions to leach the palladium from the spent catalyst comprising palladium and platinum;
   leaching the palladium from the spent catalyst to form a leach solution comprising leached palladium and a leached spent catalyst; and
   separating the leach solution from the leached spent catalyst; and
   treating the leach solution comprising leached palladium under conditions to form palladium metal.
234. The process of cl233, wherein the metal iodide ligand source NaI, KI, or a combination thereof.
235. The process of item 233 or 234, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
236. The process of any one of items 233 to 235, wherein the iodine-based oxidizing agent comprises I₂, NaIO₃, or a combination thereof.
237. The process of item 236, wherein the iodine-based oxidizing agent has a concentration of from about 0.01 M to about 0.1 M in the acetic acid solvent, preferably a concentration from about 0.01 to about 0.05 M.
238. The process of any one of items 233 to 237, wherein the acid catalyst comprises a hydrogen halide; preferably HCl.
239. The process of any one of items 233 to 238, wherein the acid catalyst has a concentration of from about 0.01 M to about 1 M in the acetic acid solvent; or preferably has a concentration of from about 0.1 M to about 0.5 M.
240. The process of any one of items 233 to 239, wherein the acetic acid as the water-miscible organic solvent makes up at least 50 wt % of the liquid phase of the leach mixture.
241. The process of any one of items 233 to 240, wherein the conditions to leach the palladium from the spent catalyst comprises contacting the spent catalyst with the leach mixture for a time of about 10 min to about 18 hours, at a temperature of about 20° C. to about 30° C., under ambient pressure; wherein preferably, the time is about 30 min to about 18 hours; and the temperature is about 20° C. to about 25° C.
242. The process of item 241, wherein the conditions to leach the palladium further comprise contacting the spent catalyst with the leach mixture at a solid to liquid phase ratio of 1:10.
243. The process of item 241 or 242, wherein the conditions to leach the palladium are tolerant of up to about 10 wt % water.
244. The process of any one of items 233 to 243, wherein the spent catalyst further comprises oxidized palladium and platinum, and the process further comprises contacting the spent catalyst with a reductant under conditions to at least partially reduce the oxidized palladium and platinum; and at least partially reducing the oxidized palladium and platinum.
245. The process of item 244, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
246. The process of item 244 or 245, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
247. The process of any one of items 233 to 246, wherein the palladium and platinum of the spent catalyst comprise a contaminant, the process further comprising contacting the spent catalyst with a chelating agent under conditions to at least partially remove the contaminant; and at least partially decontaminating the palladium and platinum.
248. The process of item 247, wherein the chelating agent comprises citric acid, oxalic acid, or salts thereof, or a combination thereof; preferably citric acid and/or salt thereof.
249. The process of item 247 or 248, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
250. The process of any one of items 247 to 249, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
251. The process of any one of items 233 to 250, wherein the process leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.
252. The process of any one of items 233 to 251, wherein treating the leach solution comprising leached palladium under conditions to form palladium metal comprises adding an oxidant and a polyatomic salt to the leach solution under conditions to precipitate the leached palladium; and precipitating the leached palladium.
253. The process of item 252, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
254. The process of item 252 or 253, wherein the polyatomic salt comprises an ammonium salt, such as ammonium chloride, ammonium sulfate, ammonium nitrate, or combinations thereof.
255. The process of any one of items 252 to 254, wherein the conditions to precipitate the leached palladium comprise contacting the leach mixture with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
256. The process of any one of items 252 to 255, wherein treating the leach solution comprising leached palladium under conditions to form palladium metal further comprises contacting the leached palladium with a reducing agent under conditions to reduce the leached palladium to palladium metal; and reducing the leached palladium to palladium metal.
257. The process of item 256, wherein contacting the leached palladium with the reducing agent comprises forming an aqueous mixture comprising the leached palladium, and adding the reducing agent to the aqueous mixture.
258. The process of item 256 or 257, wherein the reducing agent comprises H₂, metal powder, metal strips, or a combination thereof, the metal comprising Al, Cu, Fe, Zn, or a combination thereof.
259. The process of any one of items item 256 to 258, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
260. The process of any one of items 256 to 259, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
261. The process of item 260, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
262. The process of item 260 or 261, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
263. The process of any one of items 252 to 262, wherein the palladium metal has a purity of about 90% to about 100%, or about 95% to about 99.9%, or about 98% to about 99.9%.
264. The process of any one of items 233 to 263, wherein the spent catalyst is a catalytic converter; preferably a gasoline-based or diesel-based catalytic converter in biscuit form.
265. A method of leaching about 40% or more, or about 50% or more of palladium from a spent catalyst comprising palladium in about 20 min or less, the method comprising contacting the spent catalyst with a leach mixture comprising:
   an metal iodide ligand source,
   an inorganic oxidizing agent,
   an acid catalyst,
   an optional stabilizer, and
   acetic acid as a water-miscible organic solvent, preferably glacial acetic acid,
under conditions to leach the palladium from the spent catalyst;
leaching the palladium from the spent catalyst; and
forming a leach solution comprising leached palladium.
266. A method of leaching palladium from a spent catalyst comprising palladium at a leaching rate about an order of magnitude faster than aqua regia, the method comprising contacting the spent catalyst with a leach mixture comprising:
   an metal iodide ligand source,
   an inorganic oxidizing agent,
   an acid catalyst,
   an optional stabilizer, and
   acetic acid as a water-miscible organic solvent, preferably glacial acetic acid,
under conditions to leach the palladium from the spent catalyst;
leaching the palladium from the spent catalyst; and
forming a leach solution comprising leached palladium.
267. The method of item 265 or 266, wherein the metal iodide ligand source NaI, KI, or a combination thereof.
268. The method of any one of items 265 to 267, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
269. The method of any one of items 265 to 268, wherein the inorganic oxidizing agent comprises I₂, H₂O₂, CuCl₂, O₂, bubbled air or a combination thereof.
270. The method of item 269, wherein the inorganic oxidizing agent has a concentration of from about 0.01 M to about 0.1 M in the acetic acid solvent, preferably a concentration from about 0.01 to about 0.05 M.
271. The method of any one of items 265 to 270, wherein the acid catalyst comprises a hydrogen halide; preferably HCl.
272. The method of any one of items 2651 to 271, wherein the acid catalyst has a concentration of from about 0.01 M to about 1 M in the acetic acid solvent; or preferably has a concentration of from about 0.1 M to about 0.5 M.
273. The method of any one of items 265 to 272, wherein the carboxylic acid stabilizer comprises acetic acid, citric acid, or a combination thereof; preferably citric acid.
274. The method of item 273, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
275. The method of any one of items 265 to 274, wherein the acetic acid as the water-miscible organic solvent makes up at least 50 wt % of the liquid phase of the leach mixture.
276. The method of any one of items 265 to 275, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.
277. The method of item 276, wherein the conditions to leach the palladium further comprise contacting the spent catalyst with the leach mixture at a solid to liquid phase ratio of 1:10.
278. The method of item 276 or 277, wherein the conditions to leach the palladium are tolerant of up to about 10 wt % water.
279. The method of any one of items 265 to 278, wherein the spent catalyst further comprises oxidized palladium, and the method further comprises contacting the spent catalyst with a reductant under conditions to at least partially reduce the oxidized palladium; and at least partially reducing the oxidized palladium.
280. The method of item 279, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
281. The method of item 279 or 280, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
282. The method of any one of items 265 to 281, wherein the palladium of the spent catalyst comprises a contaminant, the method further comprising contacting the spent catalyst with a chelating agent under conditions to at least partially remove the contaminant; and at least partially decontaminating the palladium.
283. The method of item 282, wherein the chelating agent comprises citric acid, oxalic acid, or salts thereof, or a combination thereof; preferably citric acid and/or salt thereof.
284. The method of item 282 or 283, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
285. The method of any one of items 282 to 284, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
286. The method of any one of items 265 to 285, wherein the method leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.
287. The method of any one of items 265 to 286, further comprising adding an oxidant and a polyatomic salt to the leach solution under conditions to precipitate the leached palladium; and precipitating the leached palladium.
288. The method of item 287, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
289. The method of item 287 or 288, wherein the polyatomic salt comprises an ammonium salt, such as ammonium chloride, ammonium sulfate, ammonium nitrate, or combinations thereof.
290. The method of any one of items 287 to 289, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
291. The method of any one of items 287 to 290, further comprising contacting the leached palladium with a reducing agent under conditions to reduce the leached palladium to palladium metal; and reducing the leached palladium to palladium metal.
292. The method of item 291, wherein contacting the leached palladium with the reducing agent comprises forming an aqueous mixture comprising the leached palladium, and adding the reducing agent to the aqueous mixture.
293. The method of item 291 or 292, wherein the reducing agent comprises H₂, metal powder, metal strips, or a combination thereof, the metal comprising Al, Cu, Fe, Zn, or a combination thereof.
294. The method of any one of items 291 to 293, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
295. The method of any one of items 291 to 294, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
296. The method of item 295, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
297. The method of item 295 or 296, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
298. The method of any one of items 287 to 297, wherein the palladium metal has a purity of about 90% to about 100%, or about 95% to about 99.9%, or about 98% to about 99.9%.
299. The method of any one of items 265 to 298, wherein the spent catalyst further comprises platinum and/or rhodium, and the method selectively leaches the palladium from the spent catalyst.
300. The method of any one of items 265 to 299, wherein the spent catalyst is a catalytic converter; preferably a gasoline-based or diesel-based catalytic converter in biscuit form.
301. Use of a leach mixture for leaching about 40% or more, or about 50% or more of palladium from a spent catalyst comprising palladium in about 20 min or less, under conditions to leach the palladium from the spent catalyst, and form a leach solution comprising leached palladium, the leach mixture comprising:
   an metal iodide ligand source,
   an inorganic oxidizing agent,
   an acid catalyst,
   an optional stabilizer, and
   acetic acid as a water-miscible organic solvent, preferably glacial acetic acid.
302. Use of a leach mixture for leaching palladium from a spent catalyst comprising palladium at a leaching rate about an order of magnitude faster than aqua regia, under conditions to leach the palladium from the spent catalyst, and form a leach solution comprising leached palladium, the leach mixture comprising:
   an metal iodide ligand source,
   an inorganic oxidizing agent,
   an acid catalyst,
   an optional stabilizer, and
   acetic acid as a water-miscible organic solvent, preferably glacial acetic acid.
303. The use of item 301 or 302, wherein the metal iodide ligand source NaI, KI, or a combination thereof.
304. The use of any one of items 301 to 303, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
305. The use of any one of items 301 to 304, wherein the inorganic oxidizing agent comprises I₂, H₂O₂, CuCl₂, O₂, bubbled air or a combination thereof.
306. The use of item 305, wherein the inorganic oxidizing agent has a concentration of from about 0.01 M to about 0.1 M in the acetic acid solvent, preferably a concentration from about 0.01 to about 0.05 M.
307. The use of any one of items 301 to 306, wherein the acid catalyst comprises a hydrogen halide; preferably HCl.
308. The use of any one of items 301 to 307, wherein the acid catalyst has a concentration of from about 0.01 M to about 1 M in the acetic acid solvent; or preferably has a concentration of from about 0.1 M to about 0.5 M.
309. The use of any one of items 301 to 308, wherein the carboxylic acid stabilizer comprises acetic acid, citric acid, or a combination thereof; preferably citric acid.
310. The use of item 309, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
311. The use of any one of items 301 to 310, wherein the acetic acid as the water-miscible organic solvent makes up at least 50 wt % of the liquid phase of the leach mixture.
312. The use of any one of items 301 to 311, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.
313. The use of item 312, wherein the conditions to leach the palladium further comprise contacting the spent catalyst with the leach mixture at a solid to liquid phase ratio of 1:10.
314. The use of item 312 or 313, wherein the conditions to leach the palladium are tolerant of up to about 10 wt % water.
315. The use of any one of items 301 to 314, wherein the spent catalyst further comprises oxidized palladium, and the use further comprises use of a reductant for contacting the spent catalyst under conditions to at least partially reduce the oxidized palladium; and at least partially reducing the oxidized palladium.
316. The use of item 315, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
317. The use of item 315 or 316, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
318. The use of any one of items 301 to 317, wherein the palladium of the spent catalyst comprises a contaminant, the use further comprising use of a chelating agent for contacting the spent catalyst under conditions to at least partially remove the contaminant; and at least partially decontaminating the palladium.
319. The use of item 318, wherein the chelating agent comprises citric acid, oxalic acid, or salts thereof, or a combination thereof; preferably citric acid and/or salt thereof.
320. The use of item 318 or 319, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
321. The use of any one of items 318 to 320, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
322. The use of any one of items 301 to 321, wherein the leach mixture leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.
323. The use of any one of items 301 to 322, further comprising use of an oxidant and a polyatomic salt for precipitating the leached palladium by adding the oxidant and polyatomic salt to the leach solution under conditions to precipitate the leached palladium; and precipitating the leached palladium.
324. The use of item 323, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
325. The use of item 323 or 324, wherein the polyatomic salt comprises an ammonium salt, such as ammonium chloride, ammonium sulfate, ammonium nitrate, or combinations thereof.
326. The use of any one of items 323 to 325, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
327. The use of any one of items 323 to 326, further comprising use of a reducing agent for reducing the leached palladium to palladium metal by contacting the leached palladium with a reducing agent under conditions to reduce the leached palladium to palladium metal; and reducing the leached palladium to palladium metal.
328. The use of item 327, wherein contacting the leached palladium with the reducing agent comprises forming an aqueous mixture comprising the leached palladium, and adding the reducing agent to the aqueous mixture.
329. The use of item 327 or 328, wherein the reducing agent comprises H₂, metal powder, metal strips, or a combination thereof, the metal comprising Al, Cu, Fe, Zn, or a combination thereof.
330. The use of any one of items 327 to 329, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
331. The use of any one of items 327 to 330, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
332. The use of item 331, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
333. The use of item 331 or 332, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
334. The use of any one of items 323 to 333, wherein the palladium metal has a purity of about 90% to about 100%, or about 95% to about 99.9%, or about 98% to about 99.9%.
335. The use of any one of items 301 to 334, wherein the spent catalyst further comprises platinum and/or rhodium, and the leach mixture selectively leaches the palladium from the spent catalyst.
336. The use of any one of items 301 to 335, wherein the spent catalyst is a catalytic converter; preferably a gasoline-based or diesel-based catalytic converter in biscuit form.
337. A process of recycling palladium from a spent catalyst comprising palladium, the process comprising:
   contacting the spent catalyst with a leach mixture comprising
      an metal iodide ligand source,
      an inorganic oxidizing agent,
      an acid catalyst,
      an optional stabilizer, and
      acetic acid as a water-miscible organic solvent, preferably glacial acetic acid,
   under conditions to leach the palladium from the spent catalyst comprising palladium;
   leaching about 40% or more, or about 50% or more of the palladium from the spent catalyst in about 20 min or less to form a leach solution comprising leached palladium and a leached spent catalyst; and
   separating the leach solution from the leached spent catalyst; and
   treating the leach solution comprising leached palladium under conditions to form palladium metal.
338. A process of recycling palladium from a spent catalyst comprising palladium, the process comprising:
   contacting the spent catalyst with a leach mixture comprising
      an metal iodide ligand source,
      an inorganic oxidizing agent,
      an acid catalyst,
      an optional stabilizer, and
      acetic acid as a water-miscible organic solvent, preferably glacial acetic acid,
   under conditions to leach the palladium from the spent catalyst comprising palladium;
   leaching the palladium from the spent catalyst at a leaching rate of about an order or magnitude faster than aqua regia to form a leach solution comprising leached palladium and a leached spent catalyst; and
   separating the leach solution from the leached spent catalyst; and
   treating the leach solution comprising leached palladium under conditions to form palladium metal.
339. The process of item 337 or 338, wherein the metal iodide ligand source NaI, KI, or a combination thereof.
340. The process of any one of items 337 to 339, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
341. The process of any one of items 337 to 340, wherein the inorganic oxidizing agent comprises I₂, H₂O₂, CuCl₂, O₂, bubbled air or a combination thereof.
342. The process of item 341, wherein the inorganic oxidizing agent has a concentration of from about 0.01 M to about 0.1 M in the acetic acid solvent, preferably a concentration from about 0.01 to about 0.05 M.
343. The process of any one of items 337 to 342, wherein the acid catalyst comprises a hydrogen halide; preferably HCl.
344. The process of any one of items 337 to 343, wherein the acid catalyst has a concentration of from about 0.01 M to about 1 M in the acetic acid solvent; or preferably has a concentration of from about 0.1 M to about 0.5 M.
345. The process of any one of items 337 to 344, wherein the carboxylic acid stabilizer comprises acetic acid, citric acid, or a combination thereof; preferably citric acid.
346. The process of item 345, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
347. The process of any one of items 337 to 346, wherein the acetic acid as the water-miscible organic solvent makes up at least 50 wt % of the liquid phase of the leach mixture.
348. The process of any one of items 337 to 347, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.
349. The process of item 348, wherein the conditions to leach the palladium further comprise contacting the spent catalyst with the leach mixture at a solid to liquid phase ratio of 1:10.
350. The process of item 348 or 349, wherein the conditions to leach the palladium are tolerant of up to about 10 wt % water.
351. The process of any one of items 337 to 350, wherein the spent catalyst further comprises oxidized palladium, and the process further comprises contacting the spent catalyst with a reductant under conditions to at least partially reduce the oxidized palladium; and at least partially reducing the oxidized palladium.
352. The process of item 351, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
353. The process of item 351 or 352, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
354. The process of any one of items 337 to 353, wherein the palladium of the spent catalyst comprises a contaminant, the process further comprising contacting the spent catalyst with a chelating agent under conditions to at least partially remove the contaminant; and at least partially decontaminating the palladium.
355. The process of item 354, wherein the chelating agent comprises citric acid, oxalic acid, or salts thereof, or a combination thereof; preferably citric acid and/or salt thereof.
356. The process of item 354 or 355, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
357. The process of any one of items 354 to 356, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
358. The process of any one of items 337 to 357, wherein the process selectively leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.
359. The process of any one of items 337 to 358, further comprising adding an oxidant and a polyatomic salt to the leach solution under conditions to precipitate the leached palladium; and precipitating the leached palladium.
360. The process of item 359, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
361. The process of item 359 or 360, wherein the polyatomic salt comprises an ammonium salt, such as ammonium chloride, ammonium sulfate, ammonium nitrate, or combinations thereof.
362. The process of any one of items 359 to 361, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
363. The process of any one of items 359 to 362, further comprising contacting the leached palladium with a reducing agent under conditions to reduce the leached palladium to palladium metal; and reducing the leached palladium to palladium metal.
364. The process of item 363, wherein contacting the leached palladium with the reducing agent comprises forming an aqueous mixture comprising the leached palladium, and adding the reducing agent to the aqueous mixture.
365. The process of item 363 or 364, wherein the reducing agent comprises H₂, metal powder, metal strips, or a combination thereof, the metal comprising Al, Cu, Fe, Zn, or a combination thereof.
366. The process of any one of items 363 to 365, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
367. The process of any one of items 363 to 366, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
368. The process of item 367, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
369. The process of item 367 or 368, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
370. The process of any one of items 359 to 369, wherein the palladium metal has a purity of about 90% to about 100%, or about 95% to about 99.9%, or about 98% to about 99.9%.
371. The process of any one of items 337 to 370, wherein the spent catalyst further comprises platinum and/or rhodium, and the process selectively leaches the palladium from the spent catalyst.
372. The process of any one of items 337 to 371, wherein the spent catalyst is a catalytic converter; preferably a gasoline-based or diesel-based catalytic converter in biscuit form.
373. A method of leaching at least 60% of surface palladium from a spent catalyst comprising palladium, the method comprising contacting the spent catalyst with a leach mixture comprising:
   an metal iodide ligand source,
   an halide-based oxidizing agent,
   an optional acid catalyst,
   an optional stabilizer, and
   acetic acid as a water-miscible organic solvent, preferably glacial acetic acid,
under conditions to leach the palladium from the spent catalyst comprising palladium and platinum;
leaching the palladium from the spent catalyst; and
forming a leach solution comprising leached palladium.
374. A method of leaching at least 60% of surface palladium from a spent catalyst comprising palladium, the method comprising contacting the spent catalyst with a leach mixture comprising:
   an metal iodide ligand source,
   an halide-based oxidizing agent,
   an optional acid catalyst,
   an optional stabilizer, and
   acetic acid as a water-miscible organic solvent, preferably glacial acetic acid,
under conditions to leach the palladium from the spent catalyst;
leaching the palladium from the spent catalyst; and
forming a leach solution comprising leached palladium;
wherein the method is milder and less toxic relative to a method of leaching having aqua regia as a leach mixture.
375. The method of item 373 or 374, wherein the metal iodide ligand source NaI, KI, or a combination thereof.
376. The method of any one of items 373 to 375, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
377. The method of any one of items 373 to 376, wherein the halide-based oxidizing agent comprises I₂, FeCl₃, or a combination thereof.
378. The method of item 377, wherein the halide-based oxidizing agent has a concentration of from about 0.01 M to about 0.1 M in the acetic acid solvent, preferably a concentration from about 0.01 to about 0.05 M.
379. The method of any one of items 373 to 378, wherein the acid catalyst comprises a hydrogen halide, such as HCl; H₂SO₄, or a combination thereof.
380. The method of any one of items 373 to 379, wherein the acid catalyst has a concentration of from about 0.01 M to about 1 M in the acetic acid solvent; or preferably has a concentration of from about 0.1 M to about 0.5 M.
381. The method of any one of items 373 to 380, wherein the stabilizer comprises acetic acid, citric acid, or a combination thereof; preferably citric acid.
382. The method of item 381, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
383. The method of any one of items 373 to 382, wherein the acetic acid as the water-miscible organic solvent makes up at least 50 wt % of the liquid phase of the leach mixture.
384. The method of any one of items 373 to 383, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.
385. The method of item 384, wherein the conditions to leach the palladium further comprise contacting the spent catalyst with the leach mixture at a solid to liquid phase ratio of 1:10.
386. The method of item 384 or 385, wherein the conditions to leach the palladium are tolerant of up to about 10 wt % water.
387. The method of any one of items 373 to 386, wherein the spent catalyst further comprises oxidized palladium, and the method further comprises contacting the spent catalyst with a reductant under conditions to at least partially reduce the oxidized palladium; and at least partially reducing the oxidized palladium.
388. The method of item 387, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
389. The method of item 387 or 388, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
390. The method of any one of items 373 to 389, wherein the palladium of the spent catalyst comprises a contaminant, the method further comprising contacting the spent catalyst with a chelating agent under conditions to at least partially remove the contaminant; and at least partially decontaminating the palladium.
391. The method of item 390, wherein the chelating agent comprises citric acid, oxalic acid, or salts thereof, or a combination thereof; preferably citric acid and/or salt thereof.
392. The method of item 390 or 391, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
393. The method of any one of items 390 to 392, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
394. The method of any one of items 373 to 393, wherein the method leaches about 60% to about 99.9%, or about 70% to about 99.9%, or about 80% to about 99.9%, or about 90% to about 99.9% of the palladium in the spent catalyst.
395. The method of any one of items 373 to 394, further comprising adding an oxidant and a polyatomic salt to the leach solution under conditions to precipitate the leached palladium; and precipitating the leached palladium.
396. The method of item 395, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
397. The method of item 394 or 396, wherein the polyatomic salt comprises an ammonium salt, such as ammonium chloride, ammonium sulfate, ammonium nitrate, or combinations thereof.
398. The method of any one of items 395 to 397, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
399. The method of any one of items 395 to 398, further comprising contacting the leached palladium with a reducing agent under conditions to reduce the leached palladium to palladium metal; and reducing the leached palladium to palladium metal.
400. The method of item 399, wherein contacting the leached palladium with the reducing agent comprises forming an aqueous mixture comprising the leached palladium, and adding the reducing agent to the aqueous mixture.
401. The method of item 399 or 400, wherein the reducing agent comprises H₂, metal powder, metal strips, or a combination thereof, the metal comprising Al, Cu, Fe, Zn, or a combination thereof.
402. The method of any one of items 399 to 401, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
403. The method of any one of items 399 to 402, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
404. The method of item 403, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
405. The method of item 403 or 404, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
406. The method of any one of items 395 to 405, wherein the palladium metal has a purity of about 90% to about 100%, or about 95% to about 99.9%, or about 98% to about 99.9%.
407. The method of any one of items 373 to 406, wherein the spent catalyst further comprises platinum and/or rhodium, and the method selectively leaches the palladium from the spent catalyst.
408. The method of any one of items 373 to 407, wherein the spent catalyst is a catalytic converter; preferably a gasoline-based or diesel-based catalytic converter in biscuit form.
409. Use of a leach mixture for leaching at least 60% of surface palladium from a spent catalyst comprising palladium, under conditions to leach the palladium from the spent catalyst, and form a leach solution comprising leached palladium, leach mixture comprising:
   an metal iodide ligand source,
   an halide-based oxidizing agent,
   an optional acid catalyst,
   an optional stabilize, and
   acetic acid as a water-miscible organic solvent, preferably glacial acetic acid.
410. Use of a leach mixture for leaching at least 60% of surface palladium from a spent catalyst comprising palladium, under conditions to leach the palladium from the spent catalyst, and form a leach solution comprising leached palladium, leach mixture comprising:
   an metal iodide ligand source,
   an halide-based oxidizing agent,
   an optional acid catalyst,
   an optional stabilize, and
   acetic acid as a water-miscible organic solvent, glacial acetic acid;
wherein use of the leach mixture is milder and less toxic relative to a use of aqua regia as a leach mixture.
411. The use of item 409 or 410, wherein the metal iodide ligand source NaI, KI, or a combination thereof.
412. The use of any one of items 409 to 411, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
413. The use of any one of items 409 to 412, wherein the halide-based oxidizing agent comprises I₂, FeCl₃, or a combination thereof.
414. The use of item 413, wherein the halide-based oxidizing agent has a concentration of from about 0.01 M to about 0.1 M in the acetic acid solvent, preferably a concentration from about 0.01 to about 0.05 M.
415. The use of any one of items 409 to 414, wherein the acid catalyst comprises a hydrogen halide, such as HCl; H₂SO₄, or a combination thereof.
416. The use of any one of items 409 to 415, wherein the acid catalyst has a concentration of from about 0.01 M to about 1 M in the acetic acid solvent; or preferably has a concentration of from about 0.1 M to about 0.5 M.
417. The use of any one of items 409 to 416, wherein the stabilizer comprises acetic acid, citric acid, or a combination thereof; preferably citric acid.
418. The use of item 417, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
419. The use of any one of items 409 to 418, wherein the acetic acid as the water-miscible organic solvent makes up at least 50 wt % of the liquid phase of the leach mixture.
420. The use of any one of items 409 to 419, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.
421. The use of item 420, wherein the conditions to leach the palladium further comprise contacting the spent catalyst with the leach mixture at a solid to liquid phase ratio of 1:10.
422. The use of item 420 or 421, wherein the conditions to leach the palladium are tolerant of up to about 10 wt % water.
423. The use of any one of items 409 to 422, wherein the spent catalyst further comprises oxidized palladium, and the use further comprises use of a reductant for contacting the spent catalyst under conditions to at least partially reduce the oxidized palladium; and at least partially reducing the oxidized palladium.
424. The use of item 423, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
425. The use of item 423 or 424, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
426. The use of any one of items 409 to 425, wherein the palladium of the spent catalyst comprises a contaminant, the use further comprising use of a chelating agent for contacting the spent catalyst under conditions to at least partially remove the contaminant; and at least partially decontaminating the palladium.
427. The use of item 426, wherein the chelating agent comprises citric acid, oxalic acid, or salts thereof, or a combination thereof; preferably citric acid and/or salt thereof.
428. The use of item 426 or 427, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
429. The use of any one of items 426 to 428, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
430. The use of any one of items 409 to 429, wherein the leach mixture leaches about 60% to about 99.9%, or about 70% to about 99.9%, or about 80% to about 99.9%, or about 90% to about 99.9% of the palladium in the spent catalyst.
431. The use of any one of items 409 to 430, further comprising use of an oxidant and a polyatomic salt for precipitating the leached palladium by adding the oxidant and polyatomic salt to the leach solution under conditions to precipitate the leached palladium; and precipitating the leached palladium.
432. The use of item 431, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
432. The use of item 431 or 432, wherein the polyatomic salt comprises an ammonium salt, such as ammonium chloride, ammonium sulfate, ammonium nitrate, or combinations thereof.
433. The use of any one of items 431 to 432, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
434. The use of any one of items 431 to 433, further comprising use of a reducing agent for reducing the leached palladium to palladium metal by contacting the leached palladium with a reducing agent under conditions to reduce the leached palladium to palladium metal; and reducing the leached palladium to palladium metal.
435. The use of item 434, wherein contacting the leached palladium with the reducing agent comprises forming an aqueous mixture comprising the leached palladium, and adding the reducing agent to the aqueous mixture.
436. The use of item 434 or 435, wherein the reducing agent comprises H₂, metal powder, metal strips, or a combination thereof, the metal comprising Al, Cu, Fe, Zn, or a combination thereof.
437. The use of any one of items 434 to 436, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
438. The use of any one of items 434 to 437, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
439. The use of item 438, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
440. The use of item 438 or 439, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
441. The use of any one of items 431 to 440, wherein the palladium metal has a purity of about 90% to about 100%, or about 95% to about 99.9%, or about 98% to about 99.9%.
443. The use of any one of items 409 to 441, wherein the spent catalyst further comprises platinum and/or rhodium, and the leach mixture selectively leaches the palladium from the spent catalyst.
444. The use of any one of items 409 to 443, wherein the spent catalyst is a catalytic converter; preferably a gasoline-based or diesel-based catalytic converter in biscuit form.
445. A process of recycling at least 60% of surface palladium from a spent catalyst comprising palladium, the process comprising:
   contacting the spent catalyst with a leach mixture comprising
      an metal iodide ligand source,
      an halide-based oxidizing agent,
      an optional acid catalyst,
      an optional stabilizer, and
      acetic acid as a water-miscible organic solvent, preferably glacial acetic acid,
   under conditions to leach the palladium from the spent catalyst;
   leaching the palladium from the spent catalyst to form a leach solution comprising leached palladium and a leached spent catalyst; and
   separating the leach solution from the leached spent catalyst; and treating the leach solution comprising leached palladium under conditions to form palladium metal.
446. A process of recycling at least 60% of surface palladium from a spent catalyst comprising palladium, the process comprising:
   contacting the spent catalyst with a leach mixture comprising
      an metal iodide ligand source,
      an halide-based oxidizing agent,
      an optional acid catalyst,
      an optional stabilizer, and
      acetic acid as a water-miscible organic solvent, preferably glacial acetic acid,
   under conditions to leach the palladium from the spent catalyst;
   leaching the palladium from the spent catalyst to form a leach solution comprising leached palladium and a leached spent catalyst; and
   separating the leach solution from the leached spent catalyst; and
   treating the leach solution comprising leached palladium under conditions to form palladium metal,
   wherein the process is milder and less toxic relative to a process having aqua regia as a leach mixture.
447. The process of item 445 or 446, wherein the metal iodide ligand source NaI, KI, or a combination thereof.
448. The process of any one of items 445 to 447, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.
449. The process of any one of items 445 to 448, wherein the halide-based oxidizing agent comprises I₂, FeCl₃, or a combination thereof.
450. The process of item 449, wherein the halide-based oxidizing agent has a concentration of from about 0.01 M to about 0.1 M in the acetic acid solvent, preferably a concentration from about 0.01 to about 0.05 M.
451. The process of any one of items 445 to 450, wherein the acid catalyst comprises a hydrogen halide, such as HCl; H₂SO₄, or a combination thereof.
452. The process of any one of items 445 to 451, wherein the acid catalyst has a concentration of from about 0.01 M to about 1 M in the acetic acid solvent; or preferably has a concentration of from about 0.1 M to about 0.5 M.
453. The process of any one of items 445 to 452, wherein the stabilizer comprises acetic acid, citric acid, or a combination thereof; preferably citric acid.
454. The process of item 453, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.
455. The process of any one of items 445 to 454, wherein the acetic acid as the water-miscible organic solvent makes up at least 50 wt % of the liquid phase of the leach mixture.
456. The process of any one of items 445 to 455, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.
457. The process of item 456, wherein the conditions to leach the palladium further comprise contacting the spent catalyst with the leach mixture at a solid to liquid phase ratio of 1:10.
458. The process of item 456 or 457, wherein the conditions to leach the palladium are tolerant of up to about 10 wt % water.
459. The process of any one of items 445 to 458, wherein the spent catalyst further comprises oxidized palladium, and the process further comprises contacting the spent catalyst with a reductant under conditions to at least partially reduce the oxidized palladium; and at least partially reducing the oxidized palladium.
460. The process of item 459, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
461. The process of item 459 or 460, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
462. The process of any one of items 445 to 461, wherein the palladium of the spent catalyst comprises a contaminant, the process further comprising contacting the spent catalyst with a chelating agent under conditions to at least partially remove the contaminant; and at least partially decontaminating the palladium.
463. The process of item 462, wherein the chelating agent comprises citric acid, oxalic acid, or salts thereof, or a combination thereof; preferably citric acid and/or salt thereof.
464. The process of item 462 or 463, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
465. The process of any one of items 462 to 464, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
466. The process of any one of items 445 to 465, wherein the process leaches about 60% to about 99.9%, or about 70% to about 99.9%, or about 80% to about 99.9%, or about 90% to about 99.9% of the palladium in the spent catalyst.
467. The process of any one of items 445 to 466, wherein treating the leach solution comprising leached palladium under conditions to form palladium metal comprises adding an oxidant and a polyatomic salt to the leach solution under conditions to precipitate the leached palladium; and precipitating the leached palladium.
468. The process of item 467, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
469. The process of item 467 or 468, wherein the polyatomic salt comprises an ammonium salt, such as ammonium chloride, ammonium sulfate, ammonium nitrate, or combinations thereof.
470. The process of any one of items 467 to 469, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
471. The process of any one of items 467 to 470, wherein treating the leach solution comprising leached palladium under conditions to form palladium metal further comprises contacting the leached palladium with a reducing agent under conditions to reduce the leached palladium to palladium metal; and reducing the leached palladium to palladium metal.
472. The process of item 471, wherein contacting the leached palladium with the reducing agent comprises forming an aqueous mixture comprising the leached palladium, and adding the reducing agent to the aqueous mixture.
473. The process of item 471 or 472, wherein the reducing agent comprises H₂, metal powder, metal strips, or a combination thereof, the metal comprising Al, Cu, Fe, Zn, or a combination thereof.
474. The process of any one of items 471 to 473, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
475. The process of any one of items 471 to 474, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
476. The process of item 475, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
477. The process of item 475 or 476, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
478. The process of any one of items 467 to 477, wherein the palladium metal has a purity of about 90% to about 100%, or about 95% to about 99.9%, or about 98% to about 99.9%.
479. The process of any one of items 445 to 478, wherein the spent catalyst further comprises platinum and/or rhodium, and the process selectively leaches the palladium from the spent catalyst.
480. The process of any one of items 445 to 479, wherein the spent catalyst is a catalytic converter; preferably a gasoline-based or diesel-based catalytic converter in biscuit form.
481. A method of simultaneously and selectively leaching at least two of palladium, platinum, and rhodium from a spent catalyst comprising aluminum oxide and at least two of palladium, platinum, and rhodium, the method comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to simultaneously and selectively leach at least two of the palladium, platinum, and rhodium from the spent catalyst;
   simultaneously and selectively leaching at least two of the palladium, platinum, and
   rhodium from the spent catalyst; and
   forming a leach solution comprising at least two of leached palladium, platinum, and rhodium.
482. The method of item 481, wherein the chloride ligand source comprises HCl, AlCl₃, CaCl₂, or a combination thereof; or more preferably AlCl₃, CaCl₂, or a combination thereof.
483. The method of item 481 or 482, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
484. The method of any one of items 481 to 483, wherein the oxidizing agent comprises FeCl₃, O₂, bubbled air, or a combination thereof.
485. The method of item 484, wherein the oxidizing agent has a concentration of from about 0.01 M to about 0.2 M in the acetic acid solvent, preferably between about 0.01 to about 0.1 M.
486. The method of any one of items 481 to 485, wherein the acid catalyst comprises a hydrogen halide, preferably HCl; and optionally, the acid catalyst is the chloride ligand source.
487. The method of any one of items 481 to 486, wherein the acid catalyst has a concentration of from about 0.01 M to about 1 M in the acetic acid solvent; or preferably has a concentration of from about 0.1 M to about 0.5 M.
488. The method of any one of items 481 to 487, wherein the acetic acid as the water-miscible organic solvent makes up at least 50 wt % of the liquid phase of the leach mixture.
489. The method of any one of items 481 to 488, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
490. The method of item 489, wherein the conditions to simultaneously and selectively leach at least two of palladium, platinum, and rhodium further comprise contacting the spent catalyst with the leach mixture at a solid to liquid phase ratio of 1:10.
491. The method of item 489 or 490, wherein the conditions to simultaneously and selectively leach at least two of palladium, platinum, and rhodium are tolerant of up to about 10 wt % water, or between about 10 wt % to less than 50 wt % water, such as 30 wt % water.
492. The method of any one of items 481 to 491, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.
493. The method of item 492, wherein the reductant comprises organic reductants, such as ascorbic acid, formic acid, oxalic acid, or salts thereof, or a combination thereof; inorganic reductants, such as NaBH₄, FeCl₂, hydrazine hydrochloride, hydroxylamine hydrochloride, or a combination thereof; or a combination thereof.
494. The method of item 492 or 493, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
495. The method of any one of items 481 to 494, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.
496. The method of item 495, wherein the chelating agent comprises citric acid, oxalic acid, or salts thereof, or a combination thereof; preferably citric acid and/or salt thereof.
497. The method of item 495 or 496, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
498. The method of any one of items 495 to 497, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
499. The method of any one of items 481 to 498, wherein the method leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.
500. The method of any one of items 481 to 499, further comprising adding an oxidant and a polyatomic salt to the leach solution under conditions to precipitate the leached palladium, platinum, and/or rhodium; and precipitating the leached palladium, platinum, and/or rhodium.
501. The method of item 500, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
502. The method of item 500 or 501, wherein the polyatomic salt comprises an ammonium salt, such as ammonium chloride, ammonium sulfate, ammonium nitrate, or combinations thereof.
503. The method of any one of items 500 to 502, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
504. The method of any one of items 500 to 503, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
505. The method of item 504, wherein contacting the leached palladium, platinum, and/or rhodium with the reducing agent comprises forming an aqueous mixture comprising the leached palladium, platinum, and/or rhodium, and adding the reducing agent to the aqueous mixture.
506. The method of item 504 or 505, wherein the reducing agent comprises H₂, metal powder, metal strips, or a combination thereof, the metal comprising Al, Cu, Fe, Zn, or a combination thereof.
507. The method of any one of items 504 to 506, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
508. The method of any one of items 504 to 507, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
509. The method of item 508, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
510. The method of item 508 or 509, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
511. The method of any one of items 500 to 510, wherein at least one of the palladium, platinum, and/or rhodium metal has a purity of about 90% to about 100%, or about 95% to about 99.9%, or about 98% to about 99.9%.
512. The method of any one of items 481 to 511, the wherein the spent catalyst is a catalytic converter; preferably a gasoline-based or diesel-based catalytic converter in biscuit or powder form.
513. Use of a leach mixture for simultaneously and selectively leaching at least two of palladium, platinum, and rhodium from a spent catalyst comprising aluminum oxide and at least two of palladium, platinum, and rhodium, under conditions to simultaneously and selectively leach at least two of the palladium, platinum, and rhodium from the spent catalyst and forming a leach solution comprising at least two of leached palladium, platinum, and rhodium, the leach mixture comprising:
   an metal chloride ligand source,
   an inorganic oxidizing agent,
   an acid catalyst, and
   acetic acid as a water-miscible organic solvent, preferably glacial acetic acid.
514. The use of item 513, wherein the chloride ligand source comprises HCl, AlCl₃, CaCl₂, or a combination thereof; or more preferably AlCl₃, CaCl₂, or a combination thereof.
515. The use of item 513 or 514, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
516. The use of any one of items 513 to 515, wherein the oxidizing agent comprises FeCl₃, O₂, bubbled air, or a combination thereof.
517. The use of item 516, wherein the oxidizing agent has a concentration of from about 0.01 M to about 0.2 M in the acetic acid solvent, preferably between about 0.01 to about 0.1 M.
518. The use of any one of items 513 to 517, wherein the acid catalyst comprises a hydrogen halide, preferably HCl; and optionally, the acid catalyst is the chloride ligand source.
519. The use of any one of items 513 to 518, wherein the acid catalyst has a concentration of from about 0.01 M to about 1 M in the acetic acid solvent; or preferably has a concentration of from about 0.1 M to about 0.5 M.
520. The use of any one of items 513 to 519, wherein the acetic acid as the water-miscible organic solvent makes up at least 50 wt % of the liquid phase of the leach mixture.
521. The use of any one of items 513 to 520, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
522. The use of item 521, wherein the conditions to simultaneously and selectively leach at least two of palladium, platinum, and rhodium further comprise contacting the spent catalyst with the leach mixture at a solid to liquid phase ratio of 1:10.
523. The use of item 521 or 522, wherein the conditions to simultaneously and selectively leach at least two of palladium, platinum, and rhodium are tolerant of up to about 10 wt % water, or between about 10 wt % to less than 50 wt % water, such as 30 wt % water.
524. The use of any one of items 513 to 523, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.
525. The use of item 524, wherein the reductant comprises organic reductants, such as ascorbic acid, formic acid, oxalic acid, or salts thereof, or a combination thereof; inorganic reductants, such as NaBH₄, FeCl₂, hydrazine hydrochloride, hydroxylamine hydrochloride, or a combination thereof; or a combination thereof.
526. The use of item 524 or 525, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
527. The use of any one of items 513 to 526, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.
528. The use of item 527, wherein the chelating agent comprises citric acid, oxalic acid, or salts thereof, or a combination thereof; preferably citric acid and/or salt thereof.
529. The use of item 527 or 528, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
530. The use of any one of items 527 to 529, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
531. The use of any one of items 513 to 530, wherein the leach mixture leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.
532. The use of any one of items 513 to 531, further comprising use of an oxidant and a polyatomic salt for precipitating the leached palladium, platinum, and/or rhodium by adding the oxidant and polyatomic salt to the leach solution under conditions to precipitate the leached palladium, platinum, and/or rhodium; and precipitating the leached palladium, platinum, and/or rhodium.
533. The use of item 532, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
534. The use of item 532 or 533, wherein the polyatomic salt comprises an ammonium salt, such as ammonium chloride, ammonium sulfate, ammonium nitrate, or combinations thereof.
535. The use of any one of items 532 to 534, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
536. The use of any one of items 532 to 535, further comprising use of a reducing agent reducing the leached palladium, platinum, and/or rhodium by contacting the leached palladium, platinum, and/or rhodium with the reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
537. The use of item 536, wherein contacting the leached palladium, platinum, and/or rhodium with the reducing agent comprises forming an aqueous mixture comprising the leached palladium, platinum, and/or rhodium, and adding the reducing agent to the aqueous mixture.
538. The use of item 536 or 537, wherein the reducing agent comprises H₂, metal powder, metal strips, or a combination thereof, the metal comprising Al, Cu, Fe, Zn, or a combination thereof.
539. The use of any one of items 536 to 538, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
540. The use of any one of items 536 to 539, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
541. The use of item 540, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
542. The use of item 540 or 541, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
543. The use of any one of items 532 to 542, wherein at least one of the palladium, platinum, and/or rhodium metal has a purity of about 90% to about 100%, or about 95% to about 99.9%, or about 98% to about 99.9%.
544. The use of any one of items 513 to 543, the wherein the spent catalyst is a catalytic converter; preferably a gasoline-based or diesel-based catalytic converter in biscuit or powder form.
545. A process of recycling at least two of palladium, platinum, and rhodium from a spent catalyst comprising aluminum oxide and at least two of palladium, platinum, and rhodium, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to simultaneously and selectively leach at least two of the palladium, platinum, and rhodium from the spent catalyst;
   simultaneously and selectively leaching at least two of the palladium, platinum, and rhodium from the spent catalyst to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal
546. The process of item 545, wherein the chloride ligand source comprises HCl, AlCl₃, CaCl₂, or a combination thereof; or more preferably AlCl₃, CaCl₂, or a combination thereof.
547. The process of item 545 or 546, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
548. The process of any one of items 545 to 547, wherein the oxidizing agent comprises FeCl₃, O₂, bubbled air, or a combination thereof.
549. The process of item 548, wherein the oxidizing agent has a concentration of from about 0.01 M to about 0.2 M in the acetic acid solvent, preferably between about 0.01 to about 0.1 M.
550. The process of any one of items 545 to 549, wherein the acid catalyst comprises a hydrogen halide, preferably HCl; and optionally, the acid catalyst is the chloride ligand source.
551. The process of any one of items 545 to 550, wherein the acid catalyst has a concentration of from about 0.01 M to about 1 M in the acetic acid solvent; or preferably has a concentration of from about 0.1 M to about 0.5 M.
552. The process of any one of items 545 to 551, wherein the acetic acid as the water-miscible organic solvent makes up at least 50 wt % of the liquid phase of the leach mixture.
553. The process of any one of items 545 to 552, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
554. The process of item 553, wherein the conditions to simultaneously and selectively leach at least two of palladium, platinum, and rhodium further comprise contacting the spent catalyst with the leach mixture at a solid to liquid phase ratio of 1:10.
555. The process of item 553 or 554, wherein the conditions to simultaneously and selectively leach at least two of palladium, platinum, and rhodium are tolerant of up to about 10 wt % water, or between about 10 wt % to less than 50 wt % water, such as 30 wt % water.
556. The process of any one of items 545 to 555, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.
557. The process of item 556, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
558. The process of item 556 or 557, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
559. The process of any one of items 545 to 558, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.
560. The process of item 559, wherein the chelating agent comprises citric acid, oxalic acid, or salts thereof, or a combination thereof; preferably citric acid and/or salt thereof.
561. The process of item 559 or 560, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
562. The process of any one of items 559 to 561, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
563. The process of any one of items 545 to 562, wherein the process leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.
564. The process of any one of items 545 to 563, where treating the leach solution comprising leached palladium, platinum, and/or rhodium under conditions to form palladium, platinum, and/or rhodium metal comprises adding an oxidant and a polyatomic salt to the leach solution under conditions to precipitate the leached palladium, platinum, and/or rhodium; and precipitating the leached palladium, platinum, and/or rhodium.
565. The process of item 564, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
567. The process of item 564 or 565, wherein the polyatomic salt comprises an ammonium salt, such as ammonium chloride, ammonium sulfate, ammonium nitrate, or combinations thereof.
568. The process of any one of items 564 to 567, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
569. The process of any one of items 564 to 568, wherein treating the leach solution comprising leached palladium, platinum, and/or rhodium under conditions to form palladium, platinum, and/or rhodium metal further comprises contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
570. The process of item 569, wherein contacting the leached palladium, platinum, and/or rhodium with the reducing agent comprises forming an aqueous mixture comprising the leached palladium, platinum, and/or rhodium, and adding the reducing agent to the aqueous mixture.
571. The process of item 569 or 570, wherein the reducing agent comprises H₂, metal powder, metal strips, or a combination thereof, the metal comprising Al, Cu, Fe, Zn, or a combination thereof.
572. The process of any one of items 569 to 571, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
573. The process of any one of items 569 to 572, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
574. The process of item 573, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
575. The process of item 573 or 574, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
576. The process of any one of items 564 to 575, wherein at least one of the palladium, platinum, and/or rhodium metal has a purity of about 90% to about 100%, or about 95% to about 99.9%, or about 98% to about 99.9%.
577. The process of any one of items 545 to 576, the wherein the spent catalyst is a catalytic converter; preferably a gasoline-based or diesel-based catalytic converter in biscuit or powder form.
578. A method of leaching about 40% or more, or about 50% or more of at least two of palladium, platinum, and rhodium from a spent catalyst in about 30 min or less, the method comprising: contacting the spent catalyst with a leach mixture comprising
   an metal chloride ligand source,
   an inorganic oxidizing agent,
   an acid catalyst, and
   acetic acid as a water-miscible organic solvent, preferably glacial acetic acid,
under conditions to leach at least two of the palladium, platinum, and rhodium from the spent catalyst;
leaching of at least two of the palladium, platinum, and rhodium from the spent catalyst; and
forming a leach solution comprising at least two of leached palladium, platinum, and rhodium.
579. A method of leaching at least two of palladium, platinum, and rhodium from a spent catalyst at a leaching rate at least 1 time, or at least 5 times, or at least 15 times, or at least 20 times faster than aqua regia, the method comprising:
   contacting the spent catalyst with a leach mixture comprising
      an metal chloride ligand source,
      an inorganic oxidizing agent,
      an acid catalyst, and
      acid as a water-miscible organic solvent, preferably glacial acetic acid,
   under conditions to leach at least two of the palladium, platinum, and rhodium from the spent catalyst;
   leaching at least two of the palladium, platinum, and rhodium from the spent catalyst; and
   forming a leach solution comprising at least two of leached palladium, platinum, and rhodium.
580. The method of item 578 or 579, wherein the chloride ligand source comprises HCl, CaCl₂, or a combination thereof; or more preferably CaCl₂.
581. The method of any one of items 578 to 580, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
582. The method of any one of items 578 to 581, wherein the oxidizing agent comprises FeCl₃, CuCl₂, HNO₃, MnO₂, H₂O₂, or a combination thereof.
583. The method of item 582, wherein the oxidizing agent has a concentration of from about 0.01 M to about 0.2 M in the acetic acid solvent, preferably between about 0.01 to about 0.1 M.
584. The method of any one of items 578 to 583, wherein the acid catalyst comprises a hydrogen halide, preferably HCl.
585. The method of any one of items 578 to 584, wherein the acid catalyst has a concentration of from about 0.01 M to about 1 M in the acetic acid solvent; or preferably has a concentration of from about 0.1 M to about 0.2 M.
586. The method of any one of items 578 to 585, wherein the acetic acid as the water-miscible organic solvent makes up at least 50 wt % of the liquid phase of the leach mixture.
587. The method of any one of items 578 to 586, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.
588. The method of item 587, wherein the conditions to leach at least two of palladium, platinum, and rhodium further comprise contacting the spent catalyst with the leach mixture at a solid to liquid phase ratio of 1:10.
589. The method of item 587 or 588, wherein the conditions to leach at least two of palladium, platinum, and rhodium are tolerant of up to about 10 wt % water, or between about 10 wt % to less than 50 wt % water, such as 30 wt % water.
590. The method of any one of items 578 to 589, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.
591. The method of item 590, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
592. The method of item 590 or 591, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
593. The method of any one of items 578 to 592, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.
594. The method of item 593, wherein the chelating agent comprises citric acid, oxalic acid, or salts thereof, or a combination thereof; preferably citric acid and/or salt thereof.
595. The method of item 593 or 594, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
596. The method of any one of items 593 to 595, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
597. The method of any one of items 578 to 595, wherein the method leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.
598. The method of any one of items 578 to 596, further comprising adding an oxidant and a polyatomic salt to the leach solution under conditions to precipitate the leached palladium, platinum, and/or rhodium; and precipitating the leached palladium, platinum, and/or rhodium.
599. The method of item 597, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
600. The method of item 597 or 598, wherein the polyatomic salt comprises an ammonium salt, such as ammonium chloride, ammonium sulfate, ammonium nitrate, or combinations thereof.
601. The method of any one of items 597 to 599, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
602. The method of any one of items 597 to 600, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
603. The method of item 601, wherein contacting the leached palladium, platinum, and/or rhodium with the reducing agent comprises forming an aqueous mixture comprising the leached palladium, platinum, and/or rhodium, and adding the reducing agent to the aqueous mixture.
604. The method of item 601 or 602, wherein the reducing agent comprises H₂, metal powder, metal strips, or a combination thereof, the metal comprising Al, Cu, Fe, Zn, or a combination thereof.
605. The method of any one of items 601 to 603, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
606. The method of any one of items 601 to 604, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
607. The method of item 605, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
608. The method of item 605 or 606, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
609. The method of any one of items 597 to 607, wherein at least one of the palladium, platinum, and/or rhodium metal has a purity of about 90% to about 100%, or about 95% to about 99.9%, or about 98% to about 99.9%.
610. The method of any one of items 578 to 609, wherein the spent catalyst further comprises aluminium oxide, and the method selectively leaches the at least two of palladium, platinum, and rhodium from the spent catalyst.
611. The method of any one of items 578 to 610, the wherein the spent catalyst is a catalytic converter; preferably a gasoline-based or diesel-based catalytic converter in biscuit or powder form.
612. Use of a leach mixture for leaching about 40% or more, or about 50% or more of at least two of palladium, platinum, and rhodium from a spent catalyst in about 30 min or less, under conditions to leach at least two of the palladium, platinum, and rhodium from the spent catalyst and form a leach solution comprising at least two of leached palladium, platinum, and rhodium, the leach mixture comprising
   an metal chloride ligand source,
   an inorganic oxidizing agent,
   an acid catalyst, and
   acetic acid as a water-miscible organic solvent, preferably glacial acetic acid.
613. Use of a leach mixture for leaching at least two of palladium, platinum, and rhodium from a spent catalyst at a leaching rate at least 1 time, or at least 5 times, or at least 15 times, or at least 20 times faster than aqua regia, under conditions to leach at least two of the palladium, platinum, and rhodium from the spent catalyst and form a leach solution comprising at least two of leached palladium, platinum, and rhodium, the leach mixture comprising
   an metal chloride ligand source,
   an inorganic oxidizing agent,
   an acid catalyst, and
   acid as a water-miscible organic solvent, preferably glacial acetic acid.
614. The use of item 612 or 613, wherein the chloride ligand source comprises HCl, CaCl₂, or a combination thereof; or more preferably CaCl₂.
615. The use of any one of items 612 to 614, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
616. The use of any one of items 612 to 615, wherein the oxidizing agent comprises FeCl₃, CuCl₂, HNO₃, MnO₂, H₂O₂, or a combination thereof.
617. The use of item 616, wherein the oxidizing agent has a concentration of from about 0.01 M to about 0.2 M in the acetic acid solvent, preferably between about 0.01 to about 0.1 M.
618. The use of any one of items 612 to 617, wherein the acid catalyst comprises a hydrogen halide, preferably HCl.
619. The use of any one of items 612 to 618, wherein the acid catalyst has a concentration of from about 0.01 M to about 1 M in the acetic acid solvent; or preferably has a concentration of from about 0.1 M to about 0.2 M.
620. The use of any one of items 612 to 619, wherein the acetic acid as the water-miscible organic solvent makes up at least 50 wt % of the liquid phase of the leach mixture.
621. The use of any one of items 612 to 620, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.
622. The use of item 621, wherein the conditions to leach at least two of palladium, platinum, and rhodium further comprise contacting the spent catalyst with the leach mixture at a solid to liquid phase ratio of 1:10.
623. The use of item 621 or 622, wherein the conditions to leach at least two of palladium, platinum, and rhodium are tolerant of up to about 10 wt % water, or between about 10 wt % to less than 50 wt % water, such as 30 wt % water.
624. The use of any one of items 612 to 623, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.
625. The use of item 624, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
626. The use of item 624 or 625, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
627. The use of any one of items 612 to 626, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.
628. The use of item 627, wherein the chelating agent comprises citric acid, oxalic acid, or salts thereof, or a combination thereof; preferably citric acid and/or salt thereof.
629. The use of item 627 or 628, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
630. The use of any one of items 627 to 629, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
631. The use of any one of items 612 to 630, wherein the leach mixture leaches about 40% to about 99.9%, or about 50% to about 99.9%, or about 60% to about 99.9%, or about 70% to about 99.9%, or about 80% to about 99.9%, or about 90% to about 99.9%, of at least one of the palladium, platinum, and rhodium in the spent catalyst, preferably at least two of the palladium, platinum, and rhodium.
632. The use of any one of items 612 to 631, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.
633. The use of item 632, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
634. The use of item 632 or 633, wherein the polyatomic salt comprises an ammonium salt, such as ammonium chloride, ammonium sulfate, ammonium nitrate, or combinations thereof.
635. The use of any one of items 632 to 634, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
636. The use of any one of items 632 to 635, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
637. The use of item 636, wherein contacting the leached palladium, platinum, and/or rhodium with the reducing agent comprises forming an aqueous mixture comprising the leached palladium, platinum, and/or rhodium, and adding the reducing agent to the aqueous mixture.
638. The use of item 636 or 637, wherein the reducing agent comprises H₂, metal powder, metal strips, or a combination thereof, the metal comprising Al, Cu, Fe, Zn, or a combination thereof.
639. The use of any one of items 636 to 638, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
640. The use of any one of items 636 to 639, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
641. The use of item 640, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
642. The use of item 640 or 641, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
643. The use of any one of items 632 to 642, wherein at least one of the palladium, platinum, and/or rhodium metal has a purity of about 90% to about 100%, or about 95% to about 99.9%, or about 98% to about 99.9%.
644. The use of any one of items 612 to 643, wherein the spent catalyst further comprises aluminium oxide, and the leach mixture selectively leaches the at least two of palladium, platinum, and rhodium from the spent catalyst.
645. The use of any one of items 612 to 644, the wherein the spent catalyst is a catalytic converter; preferably a gasoline-based or diesel-based catalytic converter in biscuit or powder form.
646. A process of recycling at least two of palladium, platinum, and rhodium from a spent catalyst, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least two of the palladium, platinum, and rhodium from the spent catalyst;
   leaching about 40% or more, or about 50% or more of at least two of the palladium, platinum, and rhodium from the spent catalyst in about 30 min or less to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal.
647. A process of recycling at least two of palladium, platinum, and rhodium from a spent catalyst, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least two of the palladium, platinum, and rhodium from the spent catalyst;
   leaching at least two of the palladium, platinum, and rhodium from the spent catalyst at a leaching rate at least 1 time, or at least 5 times, or at least 15 times, or at least 20 times faster than aqua regia to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal.
648. The process of item 646 or 647, wherein the chloride ligand source comprises HCl, CaCl₂, or a combination thereof; or more preferably CaCl₂.
649. The process of any one of items 646 to 648, wherein the chloride li651gand source has a concentration of about 0.1 M to about 0.5 M, or about 0.1 to about 0.4 M, or from about 0.1 M to about 0.3 M, or about 0.1 to about 0.2 M, in the acetic acid solvent.
650. The process of any one of items 646 to 649, wherein the oxidizing agent comprises FeCl₃, CuCl₂, HNO₃, MnO₂, H₂O₂, or a combination thereof.
651. The process of item 650, wherein the oxidizing agent has a concentration of from about 0.01 M to about 0.2 M in the acetic acid solvent, preferably between about 0.01 to about 0.1 M.
652. The process of any one of items 646 to 6, wherein the acid catalyst comprises a hydrogen halide, preferably HCl.
653. The process of any one of items 646 to 652, wherein the acid catalyst has a concentration of from about 0.01 M to about 1 M in the acetic acid solvent; or preferably has a concentration of from about 0.1 M to about 0.2 M.
654. The process of any one of items 646 to 653, wherein the acetic acid as the water-miscible organic solvent makes up at least 50 wt % of the liquid phase of the leach mixture.
655. The process of any one of items 646 to 654, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.
656. The process of item 655, wherein the conditions to leach at least two of palladium, platinum, and rhodium further comprise contacting the spent catalyst with the leach mixture at a solid to liquid phase ratio of 1:10.
657. The process of item 655 or 656, wherein the conditions to leach at least two of palladium, platinum, and rhodium are tolerant of up to about 10 wt % water, or between about 10 wt % to less than 50 wt % water, such as 30 wt % water.
658. The process of any one of items 646 to 657, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.
659. The process of item 658, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
660. The process of item 658 or 659, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; 663 wherein preferably, the time is about 2 to 4 hours; and the temperature is about 70° C. to about 90° C.
661. The process of any one of items 646 to 660, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.
662. The process of item 661, wherein the chelating agent comprises citric acid, oxalic acid, or salts thereof, or a combination thereof; preferably citric acid and/or salt thereof.
663. The process of item 661 or 662, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
664. The process of any one of items 661 to 663, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
665. The process of any one of items 646 to 664, wherein the process leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.
666. The process of any one of items 646 to 665, further comprising adding an oxidant and a polyatomic salt to the leach solution under conditions to precipitate the leached palladium, platinum, and/or rhodium; and precipitating the leached palladium, platinum, and/or rhodium.
667. The process of item 666, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
668. The process of item 666 or 667, wherein the polyatomic salt comprises an ammonium salt, such as ammonium chloride, ammonium sulfate, ammonium nitrate, or combinations thereof.
669. The process of any one of items 666 to 668, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
670. The process of any one of items 666 to 669, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
671. The process of item 670, wherein contacting the leached palladium, platinum, and/or rhodium with the reducing agent comprises forming an aqueous mixture comprising the leached palladium, platinum, and/or rhodium, and adding the reducing agent to the aqueous mixture.
672. The process of item 670 or 671, wherein the reducing agent comprises H₂, metal powder, metal strips, or a combination thereof, the metal comprising Al, Cu, Fe, Zn, or a combination thereof.
673. The process of any one of items 670 to 672, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
674. The process of any one of items 670 to 673, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
675. The process of item 674, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
676. The process of item 674 or 675, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
677. The process of any one of items 666 to 676, wherein at least one of the palladium, platinum, and/or rhodium metal has a purity of about 90% to about 100%, or about 95% to about 99.9%, or about 98% to about 99.9%.
678. The process of any one of items 646 to 677, wherein the spent catalyst further comprises aluminium oxide, and the process selectively leaches the at least two of palladium, platinum, and rhodium from the spent catalyst.
679. The process of any one of items 646 to 678, the wherein the spent catalyst is a catalytic converter; preferably a gasoline-based or diesel-based catalytic converter in biscuit or powder form.
680. A method of leaching at least 40% of at least one of palladium, platinum, and rhodium from a spent catalyst, the method comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least one of the palladium, platinum, and rhodium from the spent catalyst;
   leaching at least one of the palladium, platinum, and rhodium from the spent catalyst; and
   forming a leach solution comprising at least one of leached palladium, platinum, and rhodium.
681. A method of leaching at least 40% of at least one of palladium, platinum, and rhodium from a spent catalyst, the method comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least one of the palladium, platinum, and rhodium from the spent catalyst;
   leaching at least one of the palladium, platinum, and rhodium from the spent catalyst; and
   forming a leach solution comprising at least one of leached palladium, platinum, and rhodium;
   wherein the method is milder and less toxic relative to a method of leaching having aqua regia as a leach mixture.
682. The method of item 680 or 681, wherein the chloride ligand source comprises HCl, AlCl₃, CaCl₂, or a combination thereof.
683. The method of any one of items 680 to 682, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
684. The method of any one of items 680 to 683, wherein the oxidizing agent comprises CuCl₂, H₂O₂, or a combination thereof.
685. The method of item 684, wherein the oxidizing agent has a concentration of from about 0.01 M to about 0.2 M in the acetic acid solvent, preferably between about 0.01 to about 0.1 M.
686. The method of any one of items 680 to 685, wherein the acid catalyst comprises a hydrogen halide, preferably HCl; and optionally, the acid catalyst is the chloride ligand source.
687. The method of any one of items 680 to 686, wherein the acid catalyst has a concentration of from about 0.01 M to about 1 M in the acetic acid solvent; or preferably has a concentration of from about 0.1 M to about 0.5 M.
688. The method of any one of items 680 to 687, wherein the acetic acid as the water-miscible organic solvent makes up at least 50 wt % of the liquid phase of the leach mixture.
689. The method of any one of items 680 to 688, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.
690. The method of item 689, wherein the conditions to leach at least one of palladium, platinum, and rhodium further comprise contacting the spent catalyst with the leach mixture at a solid to liquid phase ratio of 1:10.
691. The method of item 689 or 690, wherein the conditions to leach at least one of palladium, platinum, and rhodium are tolerant of up to about 10 wt % water, or between about 10 wt % to less than 50 wt % water, such as 30 wt % water.
692. The method of any one of items 680 to 691, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.
693. The method of item 692, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
694. The method of item 692 or 693, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
695. The method of any one of items 680 to 694, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.
696. The method of item 695, wherein the chelating agent comprises citric acid, oxalic acid, or salts thereof, or a combination thereof; preferably citric acid and/or salt thereof.
697. The method of item 695 or 696, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
698. The method of any one of items 695 to 697, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
699. The method of any one of items 680 to 698, wherein the method leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.
700. The method of any one of items 680 to 699, further comprising adding an oxidant and a polyatomic salt to the leach solution under conditions to precipitate the leached palladium, platinum, and/or rhodium; and precipitating the leached palladium, platinum, and/or rhodium.
701. The method of item 700, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
702. The method of item 700 or 701, wherein the polyatomic salt comprises an ammonium salt, such as ammonium chloride, ammonium sulfate, ammonium nitrate, or combinations thereof.
703. The method of any one of items 700 to 703, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
704. The method of any one of items 700 to 703, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
705. The method of item 704, wherein contacting the leached palladium, platinum, and/or rhodium with the reducing agent comprises forming an aqueous mixture comprising the leached palladium, platinum, and/or rhodium, and adding the reducing agent to the aqueous mixture.
706. The method of item 704 or 705, wherein the reducing agent comprises H₂, metal powder, metal strips, or a combination thereof, the metal comprising Al, Cu, Fe, Zn, or a combination thereof.
707. The method of any one of items 704 to 706, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
708. The method of any one of items 704 to 707, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
709. The method of item 708, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
710. The method of item 708 or 709, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
711. The method of any one of items 700 to 710, wherein at least one of the palladium, platinum, and/or rhodium metal has a purity of about 90% to about 100%, or about 95% to about 99.9%, or about 98% to about 99.9%.
712. The method of any one of items 680 to 711, wherein the spent catalyst further comprises aluminium oxide, and the method selectively leaches the at least two of palladium, platinum, and rhodium from the spent catalyst.
713. The method of any one of items 1680 to 712, the wherein the spent catalyst is a catalytic converter; preferably a gasoline-based or diesel-based catalytic converter in biscuit or powder form.
714. Use of a leach mixture for leaching at least 40% of at least one of palladium, platinum, and rhodium from a spent catalyst, under conditions to leach at least one of the palladium, platinum, and rhodium from the spent catalyst and form a leach solution comprising at least one of leached palladium, platinum, and rhodium, the leach mixture comprising
   an metal chloride ligand source,
   an inorganic oxidizing agent,
   an acid catalyst, and
   acetic acid as a water-miscible organic solvent, preferably glacial acetic acid.
715. Use of a leach mixture for leaching at least 40% of at least one of palladium, platinum, and rhodium from a spent catalyst, under conditions to leach at least one of the palladium, platinum, and rhodium from the spent catalyst and form a leach solution comprising at least one of leached palladium, platinum, and rhodium, the leach mixture comprising
   an metal chloride ligand source,
   an inorganic oxidizing agent,
   an acid catalyst, and
acetic acid as a water-miscible organic solvent, preferably glacial acetic acid;
wherein use of the leach mixture is milder and less toxic relative to use of aqua regia as a leach mixture.
716. The use of item 714 or 715, wherein the chloride ligand source comprises HCl, AlCl₃, CaCl₂, or a combination thereof.
717. The use of any one of items 714 to 716, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
718. The use of any one of items 714 to 717, wherein the oxidizing agent comprises CuCl₂, H₂O₂, or a combination thereof.
719. The use of item 718, wherein the oxidizing agent has a concentration of from about 0.01 M to about 0.2 M in the acetic acid solvent, preferably between about 0.01 to about 0.1 M.
720. The use of any one of items 714 to 719, wherein the acid catalyst comprises a hydrogen halide, preferably HCl; and optionally, the acid catalyst is the chloride ligand source.
721. The use of any one of items 714 to 720, wherein the acid catalyst has a concentration of from about 0.01 M to about 1 M in the acetic acid solvent; or preferably has a concentration of from about 0.1 M to about 0.5 M.
722. The use of any one of items 714 to 721, wherein the acetic acid as the water-miscible organic solvent makes up at least 50 wt % of the liquid phase of the leach mixture.
723. The use of any one of items 714 to 722, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.
724. The use of item 723, wherein the conditions to leach at least one of palladium, platinum, and rhodium further comprise contacting the spent catalyst with the leach mixture at a solid to liquid phase ratio of 1:10.
725. The use of item 723 or 724, wherein the conditions to leach at least one of palladium, platinum, and rhodium are tolerant of up to about 10 wt % water, or between about 10 wt % to less than 50 wt % water, such as 30 wt % water.
726. The use of any one of items 714 to 725, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.
727. The use of item 726, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
728. The use of item 726 or 727, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
729. The use of any one of items 714 to 728, wherein palladium, platinum, and/or rhodium of the spent catalyst comprise a contaminant, the use further comprising use of a chelating agent for contacting the spent catalyst with a chelating agent under conditions to at least partially remove the contaminant; and at least partially decontaminating the palladium, platinum, and/or rhodium.
730. The use of item 729, wherein the chelating agent comprises citric acid, oxalic acid, or salts thereof, or a combination thereof; preferably citric acid and/or salt thereof.
731. The use of item 729 or 1730, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
732. The use of any one of items 729 to 731, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
733. The use of any one of items 714 to 732, wherein the leach mixture leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.
734. The use of any one of items 714 to 733, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.
735. The use of item 734, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
736. The use of item 734 or 735, wherein the polyatomic salt comprises an ammonium salt, such as ammonium chloride, ammonium sulfate, ammonium nitrate, or combinations thereof.
737. The use of any one of items 734 to 736, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
738. The use of any one of items 734 to 737, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
739. The use of item 738, wherein contacting the leached palladium, platinum, and/or rhodium with the reducing agent comprises forming an aqueous mixture comprising the leached palladium, platinum, and/or rhodium, and adding the reducing agent to the aqueous mixture.
740. The use of item 738 or 739, wherein the reducing agent comprises H₂, metal powder, metal strips, or a combination thereof, the metal comprising Al, Cu, Fe, Zn, or a combination thereof.
741. The use of any one of items 738 to 40, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
742. The use of any one of items 738 to 741, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
743. The use of item 742, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
744. The use of item 742 or 743, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
745. The use of any one of items 734 to 744, wherein at least one of the palladium, platinum, and/or rhodium metal has a purity of about 90% to about 100%, or about 95% to about 99.9%, or about 98% to about 99.9%.
746. The use of any one of items 714 to 745, wherein the spent catalyst further comprises aluminium oxide, and the leach mixture selectively leaches the at least two of palladium, platinum, and rhodium from the spent catalyst.
747. The use of any one of items 714 to 746, the wherein the spent catalyst is a catalytic converter; preferably a gasoline-based or diesel-based catalytic converter in biscuit or powder form.
748. A process of recycling at least one of palladium, platinum, and rhodium from a spent catalyst, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least one of the palladium, platinum, and rhodium from the spent catalyst;
   leaching at least 40% of at least one of the palladium, platinum, and rhodium from the spent catalyst to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal.
749. A process of recycling at least one of palladium, platinum, and rhodium from a spent catalyst, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least one of the palladium, platinum, and rhodium from the spent catalyst;
   leaching at least 40% of at least one of the palladium, platinum, and rhodium from the spent catalyst to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal,
   wherein the process is milder and less toxic relative to a process having aqua regia as a leach mixture.
750. The process of item 748 or 749, wherein the chloride ligand source comprises HCl, AlCl₃, CaCl₂, or a combination thereof.
751. The process of any one of items 748 to 750, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.
752. The process of any one of items 748 to 751, wherein the oxidizing agent comprises CuCl₂, H₂O₂, or a combination thereof.
753. The process of item 752, wherein the oxidizing agent has a concentration of from about 0.01 M to about 0.2 M in the acetic acid solvent, preferably between about 0.01 to about 0.1 M.
754. The process of any one of items 748 to 753, wherein the acid catalyst comprises a hydrogen halide, preferably HCl; and optionally, the acid catalyst is the chloride ligand source.
756. The process of any one of items 748 to 754, wherein the acid catalyst has a concentration of from about 0.01 M to about 1 M in the acetic acid solvent; or preferably has a concentration of from about 0.1 M to about 0.5 M.
757. The process of any one of items 748 to 756, wherein the acetic acid as the water-miscible organic solvent makes up at least 50 wt % of the liquid phase of the leach mixture.
758. The process of any one of items 748 to 757, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.
759. The process of item 758, wherein the conditions to leach at least one of palladium, platinum, and rhodium further comprise contacting the spent catalyst with the leach mixture at a solid to liquid phase ratio of 1:10.
760. The process of item 758 or 759, wherein the conditions to leach at least one of palladium, platinum, and rhodium are tolerant of up to about 10 wt % water, or between about 10 wt % to less than 50 wt % water, such as 30 wt % water.
761. The process of any one of items 748 to 760, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.
762. The process of item 761, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
763. The process of item 761 or 762, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
764. The process of any one of items 748 to 763, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.
765. The process of item 764, wherein the chelating agent comprises citric acid, oxalic acid, or salts thereof, or a combination thereof; preferably citric acid and/or salt thereof.
767. The process of item 764 or 765, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
768. The process of any one of items 764 to 767, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
769. The process of any one of items 748 to 768, wherein the process leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.
770. The process of any one of items 748 to 769, further comprising adding an oxidant and a polyatomic salt to the leach solution under conditions to precipitate the leached palladium, platinum, and/or rhodium; and precipitating the leached palladium, platinum, and/or rhodium.
771. The process of item 770, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
772. The process of item 770 or 771, wherein the polyatomic salt comprises an ammonium salt, such as ammonium chloride, ammonium sulfate, ammonium nitrate, or combinations thereof.
773. The process of any one of items 771 to 772, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
774. The process of any one of items 770 to 773, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
775. The process of item 774, wherein contacting the leached palladium, platinum, and/or rhodium with the reducing agent comprises forming an aqueous mixture comprising the leached palladium, platinum, and/or rhodium, and adding the reducing agent to the aqueous mixture.
776. The process of item 774 or 775, wherein the reducing agent comprises H₂, metal powder, metal strips, or a combination thereof, the metal comprising Al, Cu, Fe, Zn, or a combination thereof.
777. The process of any one of items 774 to 776, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
778. The process of any one of items 774 to 777, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
779. The process of item 778, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
780. The process of item 778 or 779, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
781. The process of any one of items 770 to 780, wherein at least one of the palladium, platinum, and/or rhodium metal has a purity of about 90% to about 100%, or about 95% to about 99.9%, or about 98% to about 99.9%.
782. The process of any one of items 748 to 781, wherein the spent catalyst further comprises aluminium oxide, and the process selectively leaches the at least two of palladium, platinum, and rhodium from the spent catalyst.
783. The process of any one of items 748 to 782, the wherein the spent catalyst is a catalytic converter; preferably a gasoline-based or diesel-based catalytic converter in biscuit or powder form.
784. A method of leaching at least 80% of at least two of palladium, platinum, and rhodium from a spent catalyst, the method comprising:
   contacting the spent catalyst with a leach mixture comprising
      an metal chloride ligand source,
      at least one inorganic oxidizing agent,
      an acid catalyst, and
      acetic acid as a water-miscible organic solvent, preferably glacial acetic acid,
   under conditions to leach at least two of the palladium, platinum, and rhodium from the spent catalyst;
   leaching at least two of the palladium, platinum, and rhodium from the spent catalyst; and
   forming a leach solution comprising at least two of the leached palladium, platinum, and rhodium.
785. The method of item 784, wherein the chloride ligand source comprises HCl, CaCl₂, or a combination thereof; or more preferably HCl.
786. The method of item 784 or 785, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.
787. The method of any one of items 784 to 786, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.
788. The method of item 787, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.
789. The method of any one of items 784 to 788, wherein the acid catalyst comprises a hydrogen halide, preferably HCl; and optionally, the acid catalyst is the chloride ligand source.
790. The method of any one of items 784 to 789, wherein the acid catalyst has a concentration of from about 0.01 M to about 2 M in the acetic acid solvent; or preferably has a concentration of from about 0.1 M to about 1 M, or 0.5 M to about 1 M.
791. The method of any one of items 784 to 790, wherein the acetic acid as the water-miscible organic solvent makes up at least 50 wt % of the liquid phase of the leach mixture.
792. The method of any one of items 784 to 791, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
793. The method of item 792, wherein the conditions to leach at least two of palladium, platinum, and rhodium further comprise contacting the spent catalyst with the leach mixture at a solid to liquid phase ratio of 1:10.
794. The method of item 792 or 793, wherein the conditions to leach at least two of palladium, platinum, and rhodium are tolerant of up to about 10 wt % water, or between about 10 wt % to less than 50 wt % water, such as 30 wt % water.
795. The method of any one of items 784 to 794, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.
796. The method of item 795, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
797. The method of item 795 or 796, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
798. The method of any one of items 784 to 797, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.
799. The method of item 798, wherein the chelating agent comprises citric acid, oxalic acid, or salts thereof, or a combination thereof; preferably citric acid and/or salt thereof.
800. The method of item 798 or 799, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
801. The method of any one of items 798 to 800, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
802. The method of any one of items 784 to 801, wherein the method leaches about 80% to about 99.9%, or about 85% to about 99.9%, or about 90% to about 99.9%, or about 95% to about 99.9% of at least two of the palladium, platinum, and rhodium in the spent catalyst.
803. The method of any one of items 784 to 802, further comprising adding an oxidant and a polyatomic salt to the leach solution under conditions to precipitate the leached palladium, platinum, and/or rhodium; and precipitating the leached palladium, platinum, and/or rhodium.
804. The method of item 803, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
805. The method of item 803 or 804, wherein the polyatomic salt comprises an ammonium salt, such as ammonium chloride, ammonium sulfate, ammonium nitrate, or combinations thereof.
806. The method of any one of items 803 to 805, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
807. The method of any one of items 803 to 806, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
808. The method of item 807, wherein contacting the leached palladium, platinum, and/or rhodium with the reducing agent comprises forming an aqueous mixture comprising the leached palladium, platinum, and/or rhodium, and adding the reducing agent to the aqueous mixture.
809. The method of item 807 or 808, wherein the reducing agent comprises H₂, metal powder, metal strips, or a combination thereof, the metal comprising Al, Cu, Fe, Zn, or a combination thereof.
810. The method of any one of items 807 to 809, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
811. The method of any one of items 807 to 810, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
812. The method of item 811, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
813. The method of item 811 or 812, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
814. The method of any one of items 803 to 813, wherein at least one of the palladium, platinum, and/or rhodium metal has a purity of about 90% to about 100%, or about 95% to about 99.9%, or about 98% to about 99.9%.
815. The method of any one of items 784 to 814, wherein the spent catalyst further comprises aluminium oxide, and the method selectively leaches the at least two of palladium, platinum, and rhodium from the spent catalyst.
816. The method of any one of items 1 to 815, the wherein the spent catalyst is a catalytic converter; preferably a gasoline-based or diesel-based catalytic converter in biscuit or powder form.
817. Use of a leach mixture for leaching at least 80% of at least two of palladium, platinum, and rhodium from a spent catalyst, under conditions to leach at least two of the palladium, platinum, and rhodium from the spent catalyst and form a leach solution comprising at least two of leached palladium, platinum, and rhodium, the leach mixture comprising
   an metal chloride ligand source,
   at least one inorganic oxidizing agent,
   an acid catalyst, and
   acetic acid as a water-miscible organic solvent, preferably glacial acetic acid.
818. The use of item 817, wherein the chloride ligand source comprises HCl, CaCl₂, or a combination thereof; or more preferably HCl.
819. The use of item 817 or 818, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.
820. The use of any one of items 817 to 819, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.
821. The use of item 820, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.
822. The use of any one of items 817 to 821, wherein the acid catalyst comprises a hydrogen halide, preferably HCl; and optionally, the acid catalyst is the chloride ligand source.
823. The use of any one of items 817 to 822, wherein the acid catalyst has a concentration of from about 0.01 M to about 2 M in the acetic acid solvent; or preferably has a concentration of from about 0.1 M to about 1 M, or 0.5 M to about 1 M.
824. The use of any one of items 817 to 823, wherein the acetic acid as the water-miscible organic solvent makes up at least 50 wt % of the liquid phase of the leach mixture.
825. The use of any one of items 817 to 824, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
826. The use of item 825, wherein the conditions to leach at least two of palladium, platinum, and rhodium further comprise contacting the spent catalyst with the leach mixture at a solid to liquid phase ratio of 1:10.
827. The use of item 825 or 826, wherein the conditions to leach at least two of palladium, platinum, and rhodium are tolerant of up to about 10 wt % water, or between about 10 wt % to less than 50 wt % water, such as 30 wt % water.
828. The use of any one of items 817 to 827, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.
829. The use of item 828, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
830. The use of item 828 or 829, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
831. The use of any one of items 817 to 830, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.
832. The use of item 831, wherein the chelating agent comprises citric acid, oxalic acid, or salts thereof, or a combination thereof; preferably citric acid and/or salt thereof.
833. The use of item 831 or 832, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
834. The use of any one of items 831 to 833, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
835. The use of any one of items 817 to 834, wherein about 80% to about 99.9%, or about 85% to about 99.9%, or about 90% to about 99.9%, or about 95% to about 99.9% of at least two of the palladium, platinum, and rhodium in the spent catalyst.
836. The use of any one of items 817 to 835, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.
837. The use of item 836, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
838. The use of item 836 or 837, wherein the polyatomic salt comprises an ammonium salt, such as ammonium chloride, ammonium sulfate, ammonium nitrate, or combinations thereof.
839. The use of any one of items 836 to 838, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
840. The use of any one of items 836 to 839, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
841. The use of item 840, wherein contacting the leached palladium, platinum, and/or rhodium with the reducing agent comprises forming an aqueous mixture comprising the leached palladium, platinum, and/or rhodium, and adding the reducing agent to the aqueous mixture.
842. The use of item 840, wherein the reducing agent comprises H₂, metal powder, metal strips, or a combination thereof, the metal comprising Al, Cu, Fe, Zn, or a combination thereof.
843. The use of any one of item 840 to 842, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
844. The use of any one of items 840 to 843, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
845. The use of item 844, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
846. The use of item 844 or 845, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
847. The use of any one of items 836 to 846, wherein at least one of the palladium, platinum, and/or rhodium metal has a purity of about 90% to about 100%, or about 95% to about 99.9%, or about 98% to about 99.9%.
848. The use of any one of items 817 to 847, wherein the spent catalyst further comprises aluminium oxide, and the leach mixture selectively leaches the at least two of palladium, platinum, and rhodium from the spent catalyst.
849. The use of any one of items 817 to 848, the wherein the spent catalyst is a catalytic converter; preferably a gasoline-based or diesel-based catalytic converter in biscuit or powder form.
850. A process of recycling at least two of palladium, platinum, and rhodium from a spent catalyst, the process comprising:
   contacting the spent catalyst with a leach mixture comprising
      an metal chloride ligand source,
      an inorganic oxidizing agent,
      an acid catalyst, and
      acetic acid as a water-miscible organic solvent, preferably glacial acetic acid,
   under conditions to leach at least two of the palladium, platinum, and rhodium from the spent catalyst;
   leaching at least 80% of at least two of the palladium, platinum, and rhodium from the spent catalyst to form a leach solution comprising leached palladium, platinum, and/or rhodium and a leached spent catalyst;
   separating the leach solution from the leached spent catalyst; and
   treating the leach solution comprising leached palladium, platinum, and/or rhodium under conditions to form palladium, platinum, and/or rhodium metal.
851. The process of item 850, wherein the chloride ligand source comprises HCl, CaCl₂, or a combination thereof; or more preferably HCl.
852. The process of item 850 or 851, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.
853. The process of any one of items 850 to 852, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.
854. The process of item 853, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.
855. The process of any one of items 850 to 854, wherein the acid catalyst comprises a hydrogen halide, preferably HCl; and optionally, the acid catalyst is the chloride ligand source.
856. The process of any one of items 850 to 855, wherein the acid catalyst has a concentration of from about 0.01 M to about 2 M in the acetic acid solvent; or preferably has a concentration of from about 0.1 M to about 1 M, or 0.5 M to about 1 M.
857. The process of any one of items 850 to 856, wherein the acetic acid as the water-miscible organic solvent makes up at least 50 wt % of the liquid phase of the leach mixture.
858. The process of any one of items 850 to 857, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.
859. The process of item 858, wherein the conditions to leach at least two of palladium, platinum, and rhodium further comprise contacting the spent catalyst with the leach mixture at a solid to liquid phase ratio of 1:10.
860. The process of item 858 or 859, wherein the conditions to leach at least two of palladium, platinum, and rhodium are tolerant of up to about 10 wt % water, or between about 10 wt % to less than 50 wt % water, such as 30 wt % water.
861. The process of any one of items 850 to 860, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.
862. The process of item 861, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
863. The process of item 861 or 862, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
864. The process of any one of items 850 to 863, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.
865. The process of item 864, wherein the chelating agent comprises citric acid, oxalic acid, or salts thereof, or a combination thereof; preferably citric acid and/or salt thereof.
866. The process of item 864 or 865, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
867. The process of any one of items 864 to 866, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
868. The process of any one of items 850 to 867, wherein the process leaches about 80% to about 99.9%, or about 85% to about 99.9%, or about 90% to about 99.9%, or about 95% to about 99.9% of at least two of the palladium, platinum, and rhodium in the spent catalyst.
869. The process of any one of items 850 to 868, further comprising adding an oxidant and a polyatomic salt to the leach solution under conditions to precipitate the leached palladium, platinum, and/or rhodium; and precipitating the leached palladium, platinum, and/or rhodium.
870. The process of item 869, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
871. The process of item 869 or 870, wherein the polyatomic salt comprises an ammonium salt, such as ammonium chloride, ammonium sulfate, ammonium nitrate, or combinations thereof.
872. The process of any one of items 869 to 871, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
873. The process of any one of items 869 to 872, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.
874. The process of item 873, wherein contacting the leached palladium, platinum, and/or rhodium with the reducing agent comprises forming an aqueous mixture comprising the leached palladium, platinum, and/or rhodium, and adding the reducing agent to the aqueous mixture.
875. The process of item 873 or 874, wherein the reducing agent comprises H₂, metal powder, metal strips, or a combination thereof, the metal comprising Al, Cu, Fe, Zn, or a combination thereof.
876. The process of any one of items 874 to 875, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
877. The process of any one of items 874 to 876, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
878. The process of item 977, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
879. The process of item 877 or 878, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
880. The process of any one of items 869 to 879, wherein at least one of the palladium, platinum, and/or rhodium metal has a purity of about 90% to about 100%, or about 95% to about 99.9%, or about 98% to about 99.9%.
881. The process of any one of items 850 to 880, wherein the spent catalyst further comprises aluminium oxide, and the process selectively leaches the at least two of palladium, platinum, and rhodium from the spent catalyst.
882. The process of any one of items 850 to 881, the wherein the spent catalyst is a catalytic converter; preferably a gasoline-based or diesel-based catalytic converter in biscuit or powder form.
883. Use of a leach mixture for selectively leaching palladium from a substance comprising platinum group metals under conditions to selectively leach the palladium from the substance comprising platinum group metals, and forming a leach solution comprising leached palladium, the leach mixture comprising
   an iodide ligand source,
   an iodine oxidant,
   an optional acid catalyst,
   an optional carboxylic acid stabilizer, and
   a water-miscible organic solvent such as acetic acid, glacial acetic acid, acetonitrile, ethyl acetate, tetrahydrofuran, or combinations thereof, preferably glacial acetic acid.
884. The use of item 883, wherein the iodide ligand source comprises NaI, KI, HI, NH₄I, CsI, or a combination thereof; or preferably NaI, KI, HI, or a combination thereof; or more preferably NaI, KI, or a combination thereof.
885. The use of item 883 or 884, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.
886. The use of any one of items 883 to 885, wherein the iodine oxidant comprises I₂; and optionally, the use further comprises using the leach mixture to generate the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.
887. The use of item 886, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the solvent, preferably between about 0.01 to about 0.1 M.
888. The use of any one of items 883 to 887, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.
889. The use of any one of items 883 to 889, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.
890. The use of any one of items 883 to 889, wherein the carboxylic acid stabilizer comprises acetic acid, citric acid, or a combination thereof.
891. The use of item 890, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.
892. The use of any one of items 883 to 891, wherein the water-miscible organic solvent makes up at least 50 wt % of the liquid phase of the leach mixture.
893. The use of any one of items 883 to 892, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.
894. The use of item 893, wherein the conditions to selectively leach the palladium further comprise contacting the substance with the leach mixture at a solid to liquid phase ratio of 1:10.
895. The use of item 893 or 894, wherein the conditions to selectively leach the palladium are tolerant of up to about 10 wt % water, or between about 10 wt % to less than 50 wt % water, such as 30 wt % water.
896. The use of any one of items 883 to 895, wherein the substance comprising platinum group metals further comprises oxidized platinum group metals, and the use further comprises use of a reductant for contacting the substance under conditions to at least partially reduce the oxidized platinum group metals, and at least partially reducing the oxidized platinum group metals.
897. The use of item 896, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.
898. The use of item 896 or 897, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.
899. The use of any one of items 883 to 898, wherein the platinum group metals of the substance comprising platinum group metals comprise a contaminant, the use further comprising use of a chelating agent for contacting the substance under conditions to at least partially remove the contaminant; and at least partially decontaminating the platinum group metals.
900. The use of item 899, wherein the chelating agent comprises citric acid, oxalic acid, or salts thereof, or a combination thereof; preferably citric acid and/or salt thereof.
901. The use of item 899 or 900, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.
902. The use of any one of items 899 to 901, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.
903. The use of any one of items 883 to 902, wherein the leach mixture selectively leaches leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9%, of the palladium in the substance.
904. The use of any one of items 883 to 903, further comprising use of an oxidant and a polyatomic salt for precipitating the leached palladium by adding the oxidant and the polyatomic salt to the leach solution under conditions to precipitate the leached palladium; and precipitating the leached palladium.
905. The use of item 904, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.
906. The use of item 904 or 905, wherein the polyatomic salt comprises an ammonium salt, such as ammonium chloride, ammonium sulfate, ammonium nitrate, or combinations thereof.
907. The use of any one of items 904 to 906, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.
908. The use of any one of items 904 to 907, further comprising use of a reducing agent for reducing the leached palladium to palladium metal by contacting the leached palladium with the reducing agent under conditions to reduce the leached palladium to palladium metal; and reducing the leached palladium to palladium metal.
909. The use of item 908, wherein contacting the leached palladium with the reducing agent comprises forming an aqueous mixture comprising the leached palladium, and adding the reducing agent to the aqueous mixture.
910. The use of item 908 or 909, wherein the reducing agent comprises H₂, metal powder, metal strips, or a combination thereof, the metal comprising Al, Cu, Fe, Zn, or a combination thereof.
911. The use of any one of items 908 to 910, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.
912. The use of any one of items 908 to 911, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.
913. The use of item 912, wherein
   (i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
   (ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
   (iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
   (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.
914. The use of item 912 or 913, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.
915. The use of any one of items 904 to 914, wherein the palladium metal has a purity of about 90% to about 100%, or about 95% to about 99.9%, or about 98% to about 99.9%.
916. The use of any one of items 883 to 915, wherein the substance comprising platinum group metals is a platinum group metal ore, a platinum group metal concentrate, electronic or electrical waste, a spent catalyst, or a catalytic converter; preferably a spent catalyst or catalytic converter.
917. The use of any one of items 883 to 916, wherein the platinum group metals of the substance comprising platinum group metals comprise palladium, palladium and platinum, or palladium, platinum, and rhodium.

### BRIEF DESCRIPTION OF THE DRAWINGS

The present disclosure will now be described in greater detail with reference to the drawings in which:

FIG. 1 shows a schematic representation of a process of gold recovery using cyanide leaching according to the prior art.

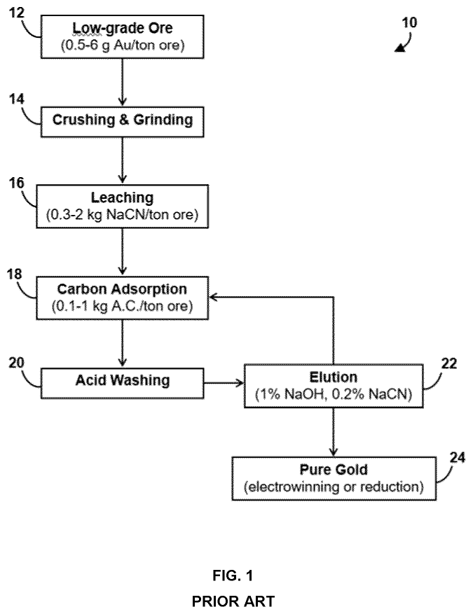

### DETAILED DESCRIPTION

### I. Definitions

Unless otherwise indicated, the definitions and embodiments described in this and other sections are intended to be applicable to all embodiments and aspects of the present disclosure herein described for which they are suitable as would be understood by a person skilled in the art.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The term “and/or” as used herein means that the listed items are present, or used, individually or in any combination (e.g., A, B, . . . X, and/or Y” refers to “A, B, . . . X, and Y”; or “one of A, B, . . . X, or Y”; or any combination of A, B, . . . X, Y). In effect, this term means that “at least one of” or “one or more” of the listed items is used or present.

As used in this disclosure, the singular forms “a”, “an” and “the” include plural references unless the content clearly dictates otherwise. For example, an embodiment including “a compound” should be understood to present certain aspects with one compound or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

The term “suitable” as used herein means that the selection of specific reagents or conditions will depend on the reaction being performed and the desired results, but none-the-less, can generally be made by a person skilled in the art once all relevant information is known.

The term “immiscible” as used herein when referring to two liquid phases means that the two liquid phases cannot be mixed to form a solution having a single phase under the conditions used, such as the relative proportions of the two liquid phases and/or the temperature, etc. Two immiscible liquid phases will, for example separate into two liquid phases after mixing. Each of these two liquid phases may, for example contain small amounts of the other liquid phase. Accordingly, a “water-immiscible” liquid such as a “water-immiscible organic solvent” is a liquid that cannot be mixed with water to form a solution having a single phase under the conditions used but that may, for example contain small amounts of water after being mixed with water.

The term “partially miscible” as used herein when referring to two liquid phases means that the two liquid phases will, for example, separate into two liquid phases after mixing, each liquid phase containing a portion of the other liquid phase in a dissolved state. Accordingly, a “partially water-miscible organic solvent” is a liquid that, after mixing with water, will separate into two liquid phases after mixing, one phase being water containing a portion, for example, about 10% (v/v) of the partially water-miscible organic liquid in a dissolved state, and the other phase being the partially water-miscible organic liquid containing a portion, for example, about 10% (v/v) of water in a dissolved state.

The term “miscible” as used herein when referring to two liquid phases means that the two liquid phases can, for example be mixed in all proportions to form a homogeneous solution. Two miscible liquid phases will not, for example separate into two liquid phases after mixing. Accordingly, a “water-miscible” liquid such as a “water-miscible organic solvent” is a liquid that can be mixed with water to form a homogeneous solution.

The term “precious metal” or “precious metals” as used herein refers to gold and/or platinum group metals, such as platinum (Pt), palladium (Pd), rhodium (Rh), ruthenium (Ru), iridium (Ir) and osmium (Os). In some embodiments, “precious metal” refers to gold, palladium, and/or platinum. In other embodiments, “precious metal” refers to palladium and/or platinum. In yet other embodiments, “precious metal” refers to palladium, rhodium, and/or platinum.

The term “base metal” or “base metals” refers to any nonferrous metals that are neither precious metals nor noble metals; for example: copper, lead, nickel, tin, aluminum, and zinc. The term “ferrous metal” or “ferrous metals” refers to metals and alloys comprising iron; for example: steel, alloy steel, carbon steel, cast iron, and wrought iron.

The term “ambient pressure” refers to the pressure of the surrounding medium, such as a gas or liquid, in contact with an object(s). The term “ambient temperature” refers to the temperature of the air (or other medium and surroundings) in any particular place, as measured by a thermometer. As used herein, “room temperature” generally refers to a temperature in a range of about 20° C. to about 25° C.; or may be used interchangeably with “ambient temperature”.

### II. Leaching Methods, Use, Processes and Leaching Components of the Disclosure

The present studies disclose the use of a polar, water-miscible organic solvent in combination with leaching reagents, for example, acidified iodide or chloride solutions containing an oxidizing agent. Using a leach mixture of a ligand source; an optional acid catalyst; an optional stabilizer; an oxidizing agent; and a water-miscible organic solvent to form an extraction solution achieved leaching of precious metal such as palladium, rhodium, and/or platinum from a substance comprising such metals. In some embodiments, this extraction solution simplifies the recovery process, saves time and energy, and/or produces less waste due to good selectivity for the precious metal and/or recoverability of the organic solvent.

Accordingly, the present disclosure includes a method of leaching precious metal from a substance comprising precious metal, the method comprising contacting the substance with a leach mixture comprising: (a) a ligand source; (b) an optional acid catalyst; (c) an optional stabilizer; (d) an oxidizing agent; and (e) a water-miscible organic solvent, under conditions to leach the precious metal from the substance.

In an embodiment of the present disclosure, the method comprises contacting the substance with a leach mixture comprising: (a) a ligand source; (b) an acid catalyst; (c) a stabilizer; (d) an oxidizing agent; and (e) a water-miscible organic solvent, under conditions to leach the precious metal from the substance.

In an embodiment, the method further comprises: separating the water-miscible organic solvent containing the leached precious metal from insoluble impurities; treating the leached precious metal in the water-miscible organic solvent with a reducing agent under conditions to obtain palladium, rhodium, and/or platinum; and separating the precious metal from the water-miscible organic solvent.

The water-miscible organic solvent containing the leached precious metal and the insoluble impurities are separated by any suitable means, the selection of which can be made by a person skilled in the art. The precious metal and the water-miscible organic solvent are separated by any suitable means, the selection of which can be made by a person skilled in the art.

The reducing agent can be any suitable reducing agent. In an embodiment of the present disclosure, the reducing agent is selected from H₂, NaBH₄, FeCl₂, hydrazine hydrochloride, hydroxylamine hydrochloride, ascorbic acid, formic acid, oxalic acid, metallic copper, ferrocene, Fe powder and Zn powder. In some embodiments, the reducing agent is H₂.

In another embodiment, the method further comprises: separating the water-miscible organic solvent containing the leached precious metal from insoluble impurities; treating the leached precious metal in the water-miscible organic solvent under conditions to obtain the precious metal; and separating the precious metal from the water-miscible organic solvent; wherein treating the leached precious metal in the water-miscible organic solvent under conditions to obtain palladium, rhodium, and/or platinum comprises electrowinning, ion exchange resins, metal-salt precipitation (not reduction) such as reacting with ammonium chloride, or a combination thereof.

In another embodiment, the method further comprises recycling the water-miscible organic solvent. In another embodiment, the method further comprises recycling the mixture comprising the ligand source; the optional acid catalyst; the optional stabilizer; the oxidizing agent; and the water-miscible organic solvent.

In an embodiment, the conditions to leach the precious metal such as palladium, rhodium, and/or platinum from the substance comprising precious metal comprise contacting the substance and the mixture for a time of less than 0.1 min, or about 0.1 min to about 10 min, or about 0.1 min to about 30 min, or about 0.1 to about 40 min, or about 0.1 min to about 50 min, or about 0.1 min to 1 hour, or about 0.1 min to about 3 hours, or about 0.1 min to about 6 hours, or about 0.1 min to about 12 hours, or about 0.1 min to about 18 hours, at a temperature of about 20° C. to about 120° C., about 20° C. to about 118° C., about 20° C. to about 90° C., about 20° C. to about 60° C., about 20° C. to about 40° C., or about 20° C. to about 25° C.; or at any time, or any range of time between about 0.1 min and about 18 hours, at any temperature, or any range of temperatures between about 20° C. and about 90° C.

In an embodiment, the conditions to leach the precious metal form the substance (the leaching conditions) are tolerant of up to about 10 wt % water. In another embodiment, the leaching conditions are tolerant of more than 10 wt %, for example 30 wt % water. In other embodiments, the presence of water (e.g., >10 wt %, or >30 wt %) may decrease leaching efficiency. In some embodiments, the leaching conditions comprise ambient pressures. In other embodiments, the leaching conditions comprise stirring the mixture. In further embodiments, the leaching conditions comprise adding together the ligand source, the optional acid catalyst, the optional stabilizer, the oxidizing agent, or the water-miscible organic solvent in any order prior to contacting the substance comprising the precious metal.

In another embodiment, the leaching conditions do not comprise stirring the mixture. In some embodiments, the leaching conditions do not comprise purifying any one or combination of the ligand source, the optional acid catalyst, the optional stabilizer, the oxidizing agent, or the water-miscible organic solvent. In some embodiments, the leaching conditions do not comprise degassing any one or combination of the ligand source, the optional acid catalyst, the optional stabilizer, the oxidizing agent, or the water-miscible organic solvent.

The acid catalyst in the mixture can be any suitably strong acid; for example, an acid having a pKa of <3; i.e. the acid in the mixture can be any suitable proton donor. In an embodiment, the acid catalyst is a strong acid having a pKa of <3, or <2.5, or <2, or <1, or <0. In an embodiment, the acid catalyst comprises, consists essentially of, or consists of a hydrogen halide (e.g., HCl, HBr, or HI), sulfuric acid, phosphoric acid, perchloric acid, or combinations thereof. In an embodiment, the acid catalyst comprises, consists essentially of, or consists of HCl, H₂SO₄, HI, or a combination thereof. In an embodiment, the acid catalyst comprises, consists essentially of, or consists of HCl, H₂SO₄, or a combination thereof. In an embodiment, the acid catalyst comprises, consists essentially of, or consists of HCl, HI, or a combination thereof. In an embodiment, the acid catalyst is selected from HCl, H₂SO₄, HI, or a combination thereof. In an embodiment, the acid catalyst is selected from HCl, H₂SO₄, and HI. In another embodiment, the acid catalyst is HCl. In another embodiment, the acid catalyst is H₂SO₄. In another embodiment, the acid catalyst is HI.

The concentration of the acid catalyst in the water-miscible organic solvent can be any suitable concentration. In an embodiment, the acid catalyst has a concentration of from about 0.01 M to about 4 M in the water-miscible organic solvent, such as glacial acetic acid; or has any concentration between about 0.01 M and about 4 M in the water-miscible organic solvent, such as glacial acetic acid. In an embodiment, the acid catalyst comprises, consists essentially of, or consists of a concentrated aqueous solution of HCl, H₂SO₄, HI, or a combination thereof having a concentration of from about 0.01 M to about 4 M in the water-miscible organic solvent, such as glacial acetic acid; or having any concentration between about 0.01 M and about 4 M in the water-miscible organic solvent, such as glacial acetic acid. In an embodiment, the acid catalyst comprises, consists essentially of, or consists of a concentrated aqueous solution, or an aqueous solution of HCl, H₂SO₄, HI, or a combination thereof having any concentration between about 0.01 M and about 4 M in the water-miscible organic solvent, such as glacial acetic acid. In another embodiment, the acid catalyst comprises, consists essentially of, or consists of a concentrated aqueous solution of HCl, H₂SO₄, HI, or a combination thereof having a concentration of from about 0.1 M to about 2 M in the water-miscible organic solvent, such as glacial acetic acid. It is an embodiment that the acid catalyst is a concentrated aqueous solution of HCl having a concentration of from about 0.1 M to about 2 M, about 0.1 M to about 1 M, about 0.1 M to about 0.5 M or about 0.1 M to about 0.2 M, in the water-miscible organic solvent, such as glacial acetic acid. In another embodiment, the acid catalyst is a concentrated aqueous solution of HCl having a concentration of about 0.2 M in the water-miscible organic solvent, such as glacial acetic acid. In another embodiment, the acid catalyst is a concentrated aqueous solution of HCl having a concentration of about 0.1 M in the water-miscible organic solvent, such as glacial acetic acid. In another embodiment, the acid catalyst is a concentrated aqueous solution of HCl having a concentration of 0.5 M in the water-miscible organic solvent, such as glacial acetic acid. It is an embodiment that the acid catalyst is a concentrated aqueous solution of H₂SO₄ having a concentration of from about 0.1 M to about 2 M, about 0.1 M to about 1 M, about 0.1 M to about 0.5 M or about 0.1 M to about 0.2 M, in the water-miscible organic solvent, such as glacial acetic acid. In another embodiment, the acid catalyst is a concentrated aqueous solution of HCl having a concentration of about 0.1 M in the water-miscible organic solvent, such as glacial acetic acid.

The oxidizing agent in the mixture can be any suitable oxidizing agent, wherein the oxidizing agent is also referred to herein as an oxidant. In an embodiment, the oxidizing agent comprises, consists essentially of, or consists of nitric acid (HNO₃), hydrogen peroxide (H₂O₂), O₂, bubbled air, I₂, NaClO₂, NaClO₃, NaClO, K₂Cr₂O₇, KMnO₄, Ca(ClO)₂, Cl₂, CuCl₂, FeCl₃, CaO₂, sodium iodate, potassium iodate, manganese dioxide, perchloric acid, or combinations thereof. In an embodiment, the oxidizing agent comprises, consists essentially of, or consists of nitric acid (HNO₃), O₂, bubbled air, I₂, NaClO₂, NaClO₃, NaClO, K₂Cr₂O₇, KMnO₄, Ca(ClO)₂, Cl₂, CuCl₂, FeCl₃, sodium iodate, potassium iodate, manganese dioxide, perchloric acid, or combinations thereof. In an embodiment, the oxidizing agent in the mixture is selected from H₂O₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof. In an embodiment, the oxidizing agent in the mixture is selected from Cl₂, I₂, HNO₃, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof. In an embodiment, the oxidizing agent in the mixture is selected from H₂O₂, Cl₂, I₂, HNO₃, CaO₂, MnO₂, CaO₂ and MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof. In another embodiment, the oxidizing agent comprises, consists essentially of, or consists of H₂O₂, I₂, NaIO₃, HClO₄, FeCl₃, O₂, CuCl₂, MnO₂, K₂Cr₂O₇, KMnO₄, bubbled air, or a combination thereof. In another embodiment, the oxidizing agent comprises, consists essentially of, or consists of I₂, NaIO₃, HClO₄, FeCl₃, O₂, CuCl₂, MnO₂, K₂Cr₂O₇, KMnO₄, bubbled air, or a combination thereof. In another embodiment, the oxidizing agent comprises, consists essentially of, or consists of H₂O₂, I₂, NaIO₃, CuCl₂, FeCl₃, O₂ from air, or a combination thereof. In another embodiment, the oxidizing agent comprises, consists essentially of, or consists of I₂, NaIO₃, CuCl₂, FeCl₃, O₂ from air, or a combination thereof. In another embodiment, the oxidizing agent comprises, consists essentially of, or consists of H₂O₂, NaClO₂, NaClO₃, NaClO, K₂Cr₂O₇, KMnO₄, Ca(ClO)₂, Cl₂, or HNO₃, or a combination thereof. In another embodiment, the oxidizing agent comprises, consists essentially of, or consists of NaClO₂, NaClO₃, NaClO, K₂Cr₂O₇, KMnO₄, Ca(ClO)₂, Cl₂, or HNO₃, or a combination thereof. In another embodiment, the oxidizing agent comprises, consists essentially of, or consists of H₂O₂, Cl₂, HNO₃, CaO₂, MnO₂, CaO₂ and MnO₂, CuCl₂, FeCl₃, O₂ from air, or a combination thereof. In another embodiment, the oxidizing agent comprises, consists essentially of, or consists of Cl₂, HNO₃, MnO₂, CuCl₂, FeCl₃, O₂ from air, or a combination thereof.

The concentration of the oxidizing agent can be any suitable concentration, in the water-miscible organic solvent. In an embodiment, the oxidizing agent has a concentration of from about 0.01 M to about 2.5 M in the water-miscible organic solvent, such as glacial acetic acid; or has any concentration between about 0.01 M and about 2.5 M in the water-miscible organic solvent, such as glacial acetic acid. In an embodiment, the oxidizing agent comprises, consists essentially of, or consists of H₂O₂, Cl₂, I₂, HNO₃, CaO₂, MnO₂, CaO₂ and MnO₂, NaIO₃, CuCl₂, FeCl₃, O₂ from air, or a combination thereof having a concentration of from about 0.01 M to about 2.5 M, or about 0.01 M to about 1 M, or about 0.01 M to about 0.5 M, or about 0.01 to about 0.1 M, or from about 0.02 M to about 0.1 M, or from about 0.03 M to about 0.1 M, or about 0.05 to about 0.1 M in the water-miscible organic solvent, such as glacial acetic acid; or having any concentration between about 0.01 M and about 2.5 M in the water-miscible organic solvent, such as glacial acetic acid. In some embodiments, when the oxidizing agent is I₂, the concentration of the oxidizing agent I₂ may be maintained below 0.1 M, as concentrations of 0.1 M or higher may inhibit the efficiency of the leaching reaction.

The ligand source in the mixture can be any source of Cl⁻ ligand or any source of I⁻ ligand. In an embodiment, the source of I⁻ ligand comprises, consists essentially of, or consists of NaI, KI, HI, NH₄I, CsI, or a combination thereof. In another embodiment, the source of I⁻ ligand comprises, consists essentially of, or consists of NaI, KI, HI, or a combination thereof. In another embodiment, the source of I⁻ ligand comprises, consists essentially of, or consists of NaI, KI, or a combination thereof. In another embodiment, the source of I⁻ ligand is NaI In another embodiment, the source of I⁻ ligand is KI. In an embodiment, the source of Cl⁻ ligand comprises, consists essentially of, or consists of HCl, MgCl₂, AlCl₃, CaCl₂, or a combination thereof. In an embodiment, the source of Cl⁻ ligand comprises, consists essentially of, or consists of HCl, AlCl₃, CaCl₂, or a combination thereof. In an embodiment, the source of Cl⁻ ligand is HCl, CaCl₂, or a combination thereof. In an embodiment, the source of Cl⁻ ligand is HCl, AlCl₃ or a combination thereof. In an embodiment, the source of CI ligand comprises, consists essentially of, or consists of AlCl₃, CaCl₂, or a combination thereof. In an embodiment, the source of Cl⁻ ligand is HCl. In an embodiment, the source of Cl⁻ ligand is AlCl₃. In an embodiment, the source of Cl⁻ ligand is CaCl₂.

The concentration of the ligand source can be any suitable concentration, in the water-miscible organic solvent. In an embodiment, the ligand source is at a concentration of from about 0.1 M to about 4 M, from about 0.1 M to about 3 M, from about 0.1 M to about 2 M, from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent, such as glacial acetic acid; or is at any concentration between about 0.1 M and about 4 M in the water-miscible organic solvent, such as glacial acetic acid. In an embodiment, the source of I⁻ ligand has a concentration of from about 0.1 M to about 4 M, from about 0.1 M to about 3 M, from about 0.1 M to about 2 M, from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent, such as glacial acetic acid; or is at any concentration between about 0.1 M and about 4 M in the water-miscible organic solvent, such as glacial acetic acid. In another embodiment, the source of I⁻ ligand comprises, consists essentially of, or consists of NaI, KI, HI, or a combination thereof having a concentration of from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent, such as glacial acetic acid; or is at any concentration between about 0.1 M and about 1 M in the water-miscible organic solvent, such as glacial acetic acid. In an embodiment, the source of CI-ligand has a concentration of from about 0.1 M to about 4 M, from about 0.1 M to about 3 M, from about 0.1 M to about 2 M, from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent, such as glacial acetic acid; or is at any concentration between about 0.1 M and about 4 M in the water-miscible organic solvent, such as glacial acetic acid. In another embodiment, the source of Cl⁻ ligand comprises, consists essentially of, or consists of HCl, AlCl₃, CaCl₂, or a combination thereof having a concentration of from about 0.1 M to about 1 M, from about 0.1 M to about 0.5 M, or about 0.1 to about 0.4 M, or from about 0.1 M to about 0.3 M, or about 0.1 to about 0.2 M in the water-miscible organic solvent, such as glacial acetic acid; or is at any concentration between about 0.1 M and about 1 M in the water-miscible organic solvent, such as glacial acetic acid.

The stabilizer can be any suitable carboxylic acid. In an embodiment, the stabilizer comprises, consists essentially of, or consists of acetic acid, citric acid, or a combination thereof. In another embodiment, the stabilizer is citric acid. In another embodiment, the stabilizer is acetic acid. The concentration of the stabilizer can be any suitable concentration, in the water-miscible organic solvent. In an embodiment, the stabilizer is at a concentration of from about 0.1 M to about 2.5 M, from about 0.1 M to about 1.5 M, from about 0.1 M to about 1 M, from about 0.2 M to about 0.8 M, or about 0.3 to about 0.7 M, or from about 0.4 M to about 0.6 M in the water-miscible organic solvent, such as glacial acetic acid; or is at any concentration between about 0.1 M and about 2.5 M in the water-miscible organic solvent, such as glacial acetic acid. In some embodiments, the solvent glacial acetic acid may act as a stabilizer. In other embodiments, when a stabilizer is used in the leaching mixture, it is a component added in addition to the solvent, such as glacial acetic acid.

The water-miscible organic solvent can be any suitable water-miscible organic solvent, including organic acids such as acetic acid. In an embodiment the solvent comprises, consists essentially of, or consists of ethyl acetate, acetic acid, acetonitrile, tetrahydrofuran, or combinations thereof; or the solvent is any subset of the group comprising, consisting essentially of, or consisting of ethyl acetate, acetic acid, acetonitrile, tetrahydrofuran, or combinations thereof. In an embodiment, the water-miscible organic solvent comprises, consists essentially of, or consists of acetic acid. In an embodiment, the water-miscible organic solvent comprises, consists essentially of, or consists of glacial acetic acid. As used herein, a “solvent” refers to a liquid that makes up at least 50 wt % of the liquid phase of the herein described leach mixture. As such, in embodiments where the leach mixture comprises, or contains up to, or greater than 10 wt % water, for example between 1 wt % to 30 wt % water, the solvent of the leach mixture remains the water-miscible organic solvent, as the water is not present in amounts greater than 50 wt %.

In an embodiment, the mixture further comprises a metal halide, an ammonium halide or a tetraalkylammonium halide, or a combination thereof. In an embodiment, mixture comprises a metal halide and the metal halide is an alkali metal halide, an alkaline earth metal halide or an aluminum halide, or a combination thereof. In an embodiment, the metal halide is sodium halide, potassium halide, lithium halide, calcium halide, magnesium halide or aluminum halide, or a combination thereof. In an embodiment, the tetraalkylammonium halide is a tetra(C₁₋₄alkyl)ammonium halide, such as tetramethylammonium chloride. In an embodiment, the ammonium halide is ammonium bromide or ammonium chloride, or a combination thereof. In another embodiment of the present disclosure, the mixture further comprises a reagent selected from NaCl, KCl, AlCl₃, NaBr, KBr, NaI, KI, CaCl₂, MgCl₂, NH₄Br, NH₄Cl and N(CH₃)₄Cl, or a combination thereof. In a further embodiment, the mixture further comprises the metal halide and the metal halide is CaCl₂, It is an embodiment that the CaCl₂ in the mixture has a concentration of about 0.05M to about 1.5M, about 0.3M to about 0.8M or about 0.6M.

The substance comprising precious metal can be any suitable substance comprising precious metal, such as palladium, platinum, and/or rhodium. In an embodiment, the substance comprising precious metal is selected from an anode slime, a platinum group metal (PGM)-containing substance such as a PGM concentrate, spent catalyst, electronic scrap, and jewelry scrap.

In some embodiments, the substance comprising precious metal is a platinum group metal concentrate. In an embodiment, the substance comprising precious metal is a palladium, rhodium, and/or platinum-containing substance. In an embodiment, the palladium, rhodium, and/or platinum-containing substance further comprises metal oxides iron, copper, aluminum, cobalt, or nickel or a combination thereof, and the method selectively dissolves the palladium, rhodium, and/or platinum from the palladium, rhodium, and/or platinum-containing substance. In another embodiment, the palladium, rhodium and/or platinum-containing substance is an ore, electronic or electrical waste, spent catalyst, or a catalytic converter.

In other embodiments, the substance comprising precious metal is a palladium-containing substance. In an embodiment, the palladium-containing substance further comprises gold, iron, aluminum, copper, cobalt, or nickel, or a combination thereof, and the method selectively dissolves the palladium and gold from the palladium-containing substance. In embodiments where the method selectively dissolves the palladium and the gold, the rate of gold dissolution is slow relative to the rate of palladium dissolution. In an embodiment, the palladium-containing substance further comprises iron, copper, cobalt, or nickel, or a combination thereof, and the method selectively dissolves the palladium from the palladium-containing substance. In another embodiment of the present disclosure, the palladium-containing substance is an ore, electronic or electrical waste, or a catalytic converter.

In further embodiments, the substance comprising precious metal is a palladium and platinum containing substance, a palladium, platinum, and rhodium containing substance, or a rhodium containing substance. In an embodiment, the palladium and platinum containing substance, the palladium, platinum, and rhodium containing substance, or the rhodium containing substance further comprises gold, iron, aluminum, copper, cobalt, or nickel, or a combination thereof, and the method selectively dissolves the palladium and platinum, the palladium, platinum, and rhodium, or the rhodium from the palladium and platinum containing substance, the palladium, platinum, and rhodium containing substance, or the rhodium containing substance; and can also dissolve the gold. In another embodiment of the present disclosure, the palladium and platinum containing substance, the palladium, platinum, and rhodium containing substance, or the rhodium containing substance is an ore, electronic or electrical waste, or a catalytic converter.

As described above, the present disclosure includes a method of leaching precious metal from a substance comprising precious metal, the method comprising contacting the substance with a mixture comprising: a ligand source; an optional acid catalyst; an optional stabilizer; an oxidizing agent; and a water-miscible organic solvent, under conditions to leach the precious metal from the substance. In an embodiment of the present disclosure, the method comprises contacting the substance with a mixture comprising: a ligand source; an acid catalyst; a stabilizer; an oxidizing agent; and a water-miscible organic solvent, under conditions to leach the precious metal from the substance.

In an embodiment of the present disclosure, the ligand of the ligand source may interact with the leached precious metal, such as palladium, rhodium, and/or platinum, that is dissolved in the water-miscible organic solvent to form a metal-ligand complex. Without wishing to be bound by theory, formation of the metal-ligand complex may stabilize the dissolved metal in solution, which may facilitate leaching the metal into solution and isolating the metal from solution. In an embodiment, the ligand is I⁻ or Cl⁻, and the metal is palladium, rhodium, and/or platinum. In some embodiments, the ligand is I⁻ and the metal is palladium. In other embodiments, the ligand is Cl⁻ and the metal is palladium, rhodium, and/or platinum.

In another embodiment of the present disclosure, the ligand source and the oxidizing agent together may generate an oxidant that leaches the precious metal from the substance comprising precious metal. In another embodiment, the oxidant generated is I₂ or Cl₂. In some embodiments, the oxidant I₂ is formed when the ligand source is a source of I⁻ ligand and the oxidizing agent is H₂O₂, I₂, NaIO₃, HClO₄, FeCl₃, O₂, CuCl₂, MnO₂, K₂Cr₂O₇, KMnO₄, or bubbled air. In other embodiments, the oxidant Cl₂ is formed when the ligand source is a source of Cl⁻ ligand and the oxidizing agent is H₂O₂, NaClO₂, NaClO₃, NaClO, K₂Cr₂O₇, KMnO₄, Ca(ClO)₂ Cl₂, or HNO₃. In another embodiment of the method described herein, the oxidizing agent is the oxidant that may, at least in part, leach the precious metal from the substance comprising precious metal.

In an embodiment of the present disclosure, the acid catalyst, without wishing to be bound by theory, increases the rate at which the precious metal is leached into the water-miscible organic solvent. Further, in some embodiments where the water-miscible organic solvent comprises, consists essentially of, or consists of acetic acid, or glacial acetic acid, the acetic acid does not act as the acid catalyst of the leach mixture, as the pKₐ of acetic acid or glacial acetic acid is not less than 3—instead, it is between about 4 and 5. Thus, in some embodiments where the water-miscible organic solvent comprises, consists essentially of, or consists of acetic acid, or glacial acetic acid, the acetic acid does not act as the acid catalyst, as it is not a strong enough acid.

In an embodiment of the present disclosure, the stabilizer may interact with the metal-ligand complex and, without wishing to be bound by theory, stabilize the complex. In some embodiments, said stabilizing of the metal-ligand complex may facilitate increasing the rate at which the precious metal is leached into the water-miscible organic solvent. In some embodiments, the water-miscible organic solvent also acts as a stabilizer, such as when the solvent is glacial acetic acid. Further, in some embodiments where the stabilizer comprises, consists essentially of, or consists of acetic acid, citric acid, or a combination thereof, nether the acetic acid or citric acid act as the acid catalyst of the leach mixture—as the pKₐ of acetic acid or is not less than 3—instead, it is between about 4 and 5; and as the pKₐs of citric acid are between about 3 and 7. Thus, in some embodiments where the stabilizer comprises, consists essentially of, or consists of acetic acid, citric acid, or a combination thereof, neither the acetic acid or citric acid act as the acid catalyst, as they are not strong enough acids.

In an embodiment of the present disclosure, the acid catalyst may have oxidizing properties, such that it may be able to act as an oxidizing agent; or the oxidizing agent may have acidic properties, such that it may be able to act as an acid catalyst. In such embodiments, the acid catalyst and oxidizing agent may be one in the same, and either a separate ligand source may be added, or the acid catalyst or oxidizing agent may act as the ligand source.

### III. Leaching Platinum Group Metals with the Leaching Method, Use, Process of the Disclosure

In an embodiment of the method described herein, when the substance to be leached comprises a mixture of precious metals, base metals, or ferrous metals (e.g., gold, palladium, rhodium, platinum, iron, copper, aluminum, cobalt, nickel, aluminum, zinc, etc.), the method exhibits selectivity for one or more precious metals over the other metals in the substance. In an embodiment, the method exhibits selectivity for leaching palladium over platinum from a catalytic converter.

In another embodiment of the method described herein, when leaching precious metal from a substance comprising precious metal, the method exhibits a fast rate of leaching. In some embodiments, the rate of leaching is faster than the leaching rate exhibited by incumbent leaching processes, such as with aqua regia, or concentrated HCl/Cl₂ or H₂O₂. In other embodiments, the rate of leaching 50% of a precious metal from a substance comprising precious metal is about an order of magnitude faster than leaching with aqua regia.

In another embodiment of the method described herein, when leaching precious metal from a substance comprising precious metal, the method provides an extraction yield of precious metal that is comparable to that typically provided by incumbent leaching processes, such as with aqua regia or concentrated HCl/Cl₂ or H₂O₂, but under much milder leaching conditions. (e.g., ambient temperatures and/or pressures, low reagent concentrations, use of less toxic or less complex chemistry, as described above).

As described above, there are very few viable hydrometallurgical methods for extracting precious metals, such as platinum group metals (PGM), on an industrial scale. Generally for PGM extraction, incumbent industrial processes involve smelting—but such processes can have a high environmental impact due to their outputs of NOx, CO₂, known carcinogens, etc. On account of this, very few, if any new smelters are being approved for construction. In an embodiment of the present disclosure, there is provided a method for leaching precious metal, such as PGM, from a substance comprising precious metal, wherein the method provides a more environmentally-friendly extraction method relative to incumbent technologies (e.g., see Background). In an embodiment, the method being a more environmentally-friendly extraction method comprises having reduced environmental and safety restrictions due to the fact that it uses milder conditions relative to the incumbent technologies (e.g., see Background). In an embodiment, the milder conditions comprise using safer, less toxic and/or less complex chemistry. In another embodiment, the milder conditions comprise using a lower concentration of chemical reagents, thereby reducing the amount of reagents being consumed when carrying out the method. In another embodiment, the milder conditions comprise a reduced water consumption when carrying out the method, thereby allowing the method to be carried out in areas with water-use restrictions. In other embodiments of the method as described herein, the milder conditions contribute to a reduction in the operational and capital expenditures associated with carrying out the method.

IIIA. Methods, Use, Processes of Leaching Palladium

The present disclosure includes a method of leaching palladium from a substance comprising palladium, the method comprising contacting the substance with a leach mixture comprising: a ligand source; an optional acid catalyst; an optional stabilizer; an oxidizing agent; and a water-miscible organic solvent, under conditions to leach the palladium from the substance. In an embodiment of the present disclosure, the method comprises contacting the substance with a leach mixture comprising: a ligand source; an acid catalyst; a stabilizer; an oxidizing agent; and a water-miscible organic solvent, under conditions to leach the palladium from the substance.

In an embodiment where the substance is a catalytic converter, the catalytic converter is intact and the palladium being leached is palladium on the surface of the catalytic converter. In another embodiment where the substance is a catalytic converter, the catalytic converter is ground up and powderized, and the palladium being leached is palladium on the surface of, and from within the catalytic converter.

In an embodiment of the method of leaching palladium, the method provides a more environmentally-friendly extraction method relative to incumbent technologies (e.g., see Background). In an embodiment, the method being a more environmentally-friendly extraction method comprises having reduced environmental and safety restrictions due to the fact that it uses milder conditions relative to the incumbent technologies (e.g., see Background). In another embodiment, the milder conditions comprise using a lower concentration of chemical reagents, thereby reducing the amount of reagents being consumed when carrying out the method. In another embodiment, the milder conditions comprise a reduced water consumption when carrying out the method, thereby allowing the method to be carried out in areas with water-use restrictions. In other embodiments of the method as described herein, the milder conditions contribute to a reduction in the operational and capital expenditures associated with carrying out the method. In some embodiments of the method of leaching palladium, the operational and capital expenditures are reduced because the oxidizing agent I₂ can be generated in-situ, instead of adding I₂ directly, as I₂ can be relatively expensive (e.g., generally 5-40 times more expensive than common oxidants such as H₂O₂, MnO₂, etc.).

In an embodiment, the method of leaching palladium being a more environmentally-friendly extraction method comprises having reduced environmental and safety restrictions due to the fact that it uses safer, less toxic and/or less complex chemistry relative to the incumbent technologies (e.g., see Background). In an embodiment, using safer, less toxic and/or less complex chemistry comprises conducting the method at ambient temperatures and pressures. In another embodiment, using safer, less toxic and/or less complex chemistry allows for the method's mixture to be reused multiple times for the leaching of palladium, thereby reducing the amount of waste produced overall by the method. In another embodiment, using safer, less toxic and/or less complex chemistry renders the waste produced less environmentally harmful, and thus easier to process and dispose of. In another embodiment, using safer, less toxic and/or less complex chemistry allows for the method to be more easily implemented industrially, as cheaper, less specialized equipment can be used, such as equipment made from stainless steel. This is in contrast to industrial processes that use aqua regia, or concentrated HCl/Cl₂ or H₂O₂, which is very corrosive, and therefore requires use of special equipment made from glass and plastic. In other embodiments using safer, less toxic and/or less complex chemistry contributes to a reduction in the operational and capital expenditures associated with carrying out the method.

In another embodiment of the method of leaching palladium, the method provides conditions for leaching palladium from the substance that comprises palladium that are tolerant of up to about 10 wt % water. In another embodiment, the method provides for no pre-processing of the substance that comprises palladium. In an embodiment where the substance is a catalytic converter, the method provides for contacting the catalytic converter with the mixture without first having to grind and powderize the catalytic converter. Avoiding having to grind and powderize the converter prevents the generation of potentially harmful dust, which would otherwise require following stricter environmental and health safety protocols to contain, such as using air purification systems (e.g., HighVacs). In other embodiments, the method provides for contacting the catalytic converter with the mixture following first grinding and powderizing the converter.

In another embodiment of the method of leaching palladium, the method exhibits a fast rate of palladium leaching. In some embodiments, the rate of leaching is faster than the leaching rate exhibited by incumbent leaching processes, such as with aqua regia, or concentrated HCl/Cl₂ or H₂O₂. In other embodiments, the rate of leaching 50% of palladium from the substance comprising palladium is about an order of magnitude faster than leaching with aqua regia.

In an embodiment of the method of leaching palladium, when the substance to be leached comprises palladium and further comprises a mixture of precious metals, base metals, or ferrous metals (e.g., gold, platinum, iron, copper, cobalt, nickel, aluminum, zinc, etc.), the method exhibits selectivity for palladium over the other metals in the substance. In an embodiment, the method exhibits selectivity for leaching palladium over platinum from a catalytic converter. In embodiments where the method provided such selectivity, further palladium refining steps, such as solvent extraction or precipitation steps, may not be required.

In an embodiment, the method selectively leaches about 50% to about 100%, or about 60% to about 99.9%, or about 70% to about 99.9%, or about 80% to about 99.9%, or about 90% to about 99.9% of the palladium in the substance.

Previously described was a method of leaching gold, palladium and/or platinum from a substance comprising gold, palladium and/or platinum, the method comprising contacting the substance with a mixture comprising: (a) an acid, such as HCl; (b) an oxidizing agent, such as H₂O₂, Ca(ClO)₂; and (c) a water-miscible or partially water-miscible organic solvent, such as acetic acid, ethyl acetate, acetonitrile, tetrahydrofuran, under conditions to leach the gold, palladium and/or platinum from the substance. In some examples, the mixture used in the method further comprised a metal halide, such as CaCl₂.

It was demonstrated that the method leached gold in short leaching times (for example, 15 min or less) using mixtures comprising HCl as the acid; H₂O₂ or Ca(ClO)₂ as the oxidizing agent; and acetic acid, ethyl acetate, or acetonitrile as the solvent. It was demonstrated that the method provided a gold dissolution rate of 6020 gm⁻² h⁻¹ at room temperature, representing the fastest recorded rate known for gold dissolution in either organic or aqueous systems at the time, and a gold dissolution rate of 9000 gm⁻² h⁻¹ at 60° C., using mixtures comprising HCl as the acid; H₂O₂ as the oxidizing agent; CaCl₂ as the metal halide; and acetic acid as the solvent. It was demonstrated that the method provided a gold dissolution rate of 5.1 gm⁻² h⁻¹ when water was used as the solvent; and it was described that water may decrease the leaching efficiency of the method when leaching gold from a gold-containing substance. It was also demonstrated that the method selectively leached gold over base metals such as iron, nickel, cobalt and copper using mixtures comprising HCl as the acid, H₂O₂ as the oxidant, CaCl₂ as the metal halide, and acetic acid or acetonitrile as the solvent.

Further, It was demonstrated that the method dissolved palladium powder (200 mesh) in, for example, 15 min at room temperature using mixtures comprising HCl as the acid, H₂O₂ as the oxidant, and acetic acid, acetonitrile, or ethyl acetate as the solvent.

As described herein, it was found that a leach mixture comprising an iodide ligand source, an iodine oxidant, an optional acid catalyst, an optional carboxylic acid stabilizer, and a water-miscible organic solvent provides selective leaching of palladium from a substance comprising platinum group metals. The leach mixture may be applied to methods, uses, and/or processes for selectively leaching palladium from a substance comprising platinum group metals.

In some embodiments, the water-miscible organic solvent of the leach mixture comprises acetic acid, glacial acetic acid, acetonitrile, ethyl acetate, tetrahydrofuran, or combinations thereof. In some embodiments, the water-miscible organic solvent is acetic acid. In some embodiments, the water-miscible organic solvent is glacial acetic acid. In some embodiments, the water-miscible organic solvent makes up at least 50 wt % of the liquid phase of the leach mixture.

In some embodiments, the iodide ligand source of the leach mixture comprises NaI, KI, HI, NH₄I, CsI, or a combination thereof. In some embodiments, the iodide ligand source comprises NaI, KI, HI, or a combination thereof. In some embodiments, the iodide ligand source is NaI, KI, or a combination thereof. In some embodiments, the iodide ligand source has a concentration of from about 0.1 M to about 4 M in the water-miscible organic solvent. In some embodiments, the iodide ligand source has a concentration of about 0.1 M to about 1 M, or about 0.1 M to about 0.5 M, or about 0.1 to about 0.4 M, or from about 0.1 M to about 0.3 M, or about 0.1 to about 0.2 M in the water-miscible organic solvent.

In some embodiments, the iodine oxidant of the leach mixture comprises I₂. In some embodiments, the iodine oxidant is generated in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof. In some embodiments, the oxidizing agent comprising H₂O₂, NaIO₃, FeCl₃, CuCl₂, O₂, bubbled air, or a combination thereof. In some embodiments, the iodine oxidant has a concentration of from about 0.01 M to about 2.5 M in the water-miscible organic solvent. In some embodiments, the iodine oxidant has a concentration from about 0.01 to about 0.1 M. In some embodiments, the oxidizing agent has a concentration of from about 0.01 M to about 2.5 M, or about 0.01 M to about 0.1 M in the in the water-miscible organic solvent.

In some embodiments, when present in the leach mixture, the acid catalyst comprises a hydrogen halide, sulfuric acid, phosphoric acid, perchloric acid, or a combination thereof. In some embodiments, the acid catalyst comprises HCl, H₂SO₄, HI, or a combination thereof. In some embodiments, the acid catalyst is HCl, H₂SO₄, or a combination thereof. In some embodiments, the acid catalyst has a concentration of from about 0.01 M to about 4 M in the in the water-miscible organic solvent. In some embodiments, the acid catalyst has a concentration of from about 0.1 M to about 2 M, or from about 0.1 M to about 1 M, or from about 0.1 M to about 0.5 M, or from about 0.1 M to about 0.2 M in the water-miscible organic solvent.

In some embodiments, when present in the leach mixture, the carboxylic acid stabilizer comprises acetic acid, citric acid, or a combination thereof. In some embodiments, the stabilizer is citric acid. In some embodiments, the carboxylic acid stabilizer has a concentration of from about 0.1 M to about 2.5 M in the in the water-miscible organic solvent. In some embodiments, the carboxylic acid stabilizer has a concentration from about 0.1 M to about 1 M, or about 0.2 M to about 0.8 M, or about 0.3 to about 0.7 M, or about 0.4 M to about 0.6 M in the water-miscible organic solvent.

The conditions in which the leach mixture may be applied to methods, uses, and/or processes for selectively leaching palladium from a substance comprising platinum group metals comprises contacting the substance with the leach mixture for a time of about 0.1 min to about 18 hours, at a temperature of about 20° C. to about 120° C., under ambient pressure. In some embodiments, the conditions comprise a time of about 1 min to about 18 hours; and a temperature of about 20° C. to about 90° C. In some embodiments, the conditions comprise contacting the substance with the leach mixture at a solid to liquid phase ratio of 1:10. In some embodiments, the conditions in which the leach mixture may be applied to methods, uses, and/or processes for selectively leaching palladium from a substance comprising platinum group metals are tolerant of up to about 10 wt % water, or between about 10 wt % to less than 50 wt % water, such as 30 wt % water.

In some embodiments, when the leach mixture is applied to methods, uses, and/or processes for selectively leaching palladium from a substance comprising platinum group metals, about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9%, of the palladium in the substance is leached.

In some embodiments, the substance comprising platinum group metals to which the leach mixture may be applied comprises a platinum group metal ore, a platinum group metal concentrate, electronic or electrical waste, a spent catalyst, a catalytic converter, or a combination thereof. In some embodiments, the substance comprises a spent catalyst or a catalytic converter. In some embodiments, the platinum group metals of the substance comprising platinum group metals comprise palladium, palladium and platinum, or palladium, platinum, and rhodium.

As described herein, it was found that a leach mixture comprising an metal iodide ligand source, an iodine-based oxidizing agent, an optional acid catalyst, and acetic acid as a water-miscible organic solvent provides selective leaching palladium from a spent catalyst comprising palladium and platinum. The leach mixture may be applied to methods, uses, and/or processes for selectively leaching palladium from a spent catalyst comprising palladium and platinum.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal iodide ligand source of the leach mixture comprises NaI, KI, or a combination thereof. In some embodiments, the metal iodide source is NaI or KI. In some embodiments, the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

In some embodiments, the iodine-based oxidizing agent of the leach mixture comprises I₂, NaIO₃, or a combination thereof. In some embodiments, the iodine-based oxidizing agent is I₂ or NaIO₃. In some embodiments, the iodine-based oxidizing agent has a concentration of from about 0.01 M to about 0.1 M in the acetic acid solvent. In some embodiments, the iodine-based oxidizing agent has a concentration from about 0.01 to about 0.05 M in the acetic acid solvent.

In some embodiments, when present in the leach mixture, the acid catalyst comprises a hydrogen halide. In some embodiments, the acid catalyst is HCl. In some embodiments, the acid catalyst has a concentration of from about 0.01 M to about 1 M in the acetic acid solvent. In some embodiments, the acid catalyst has a concentration of from about 0.1 M to about 0.5 M.

The conditions in which the leach mixture may be applied to selectively leach the palladium from the spent catalyst comprises contacting the spent catalyst with the leach mixture for a time of about 0.1 min to about 18 hours, at a temperature of about 20° C. to about 30° C., under ambient pressure. In some embodiments, the conditions comprise a time of about 30 min to about 18 hours; and the temperature of about 20° C. to about 25° C. In some embodiments, the conditions to selectively leach the palladium further comprise contacting the substance with the leach mixture at a solid to liquid phase ratio of 1:10. In some embodiments, the conditions in which the leach mixture may be applied to methods, uses, and/or processes for selectively leaching palladium from the spent catalyst are tolerant of up to about 10 wt % water.

In some embodiments, when the leach mixture is applied to methods, uses, and/or processes for selectively leaching palladium from a spent catalyst comprising palladium and platinum, about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst is leached.

In some embodiments, the spent catalyst is a catalytic converter. In some embodiments, the spent catalyst is a gasoline-based or diesel-based catalytic converter in biscuit form, or a combination thereof.

As described herein, it was found that a leach mixture comprising an metal iodide ligand source, an inorganic oxidizing agent, an acid catalyst, an optional stabilizer, and acetic acid as a water-miscible organic solvent leaches about 40% or more, or about 50% or more of palladium from a spent catalyst comprising palladium in about 20 min or less. As described herein, it was found that the leach mixture leaches palladium from a spent catalyst comprising palladium at a leaching rate about an order of magnitude faster than aqua regia. The leach mixture may be applied to methods, uses, and/or processes for leaching about 40% or more, or about 50% or more of palladium from a spent catalyst comprising palladium in about 20 min or less; or leaching palladium from a spent catalyst comprising palladium at a leaching rate about an order of magnitude faster than aqua regia.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal iodide ligand source NaI, KI, or a combination thereof. In some embodiments, the metal iodide ligand source is NaI or KI. In some embodiments, the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

In some embodiments, the inorganic oxidizing agent of the leach mixture comprises I₂, H₂O₂, CuCl₂, O₂, bubbled air or a combination thereof. In some embodiments, the inorganic oxidizing agent has a concentration of from about 0.01 M to about 0.1 M in the acetic acid solvent. In some embodiments, the inorganic oxidizing agent has a concentration from about 0.01 M to about 0.05 M.

In some embodiments, the acid catalyst of the leach mixture comprises a hydrogen halide. In some embodiments, the acid catalyst is HCl. In some embodiments, the acid catalyst has a concentration of from about 0.01 M to about 1 M in the acetic acid solvent. In some embodiments, the acid catalyst has a concentration of from about 0.1 M to about 0.5 M.

In some embodiments, when present in the leach mixture, the stabilizer comprises acetic acid, citric acid, or a combination thereof. In some embodiments, the stabilizer comprises citric acid. In some embodiments, the stabilizer has a concentration of from about 0.1 M to about 1 M in the acetic acid solvent. In some embodiments, the stabilizer has a concentration from about 0.1 M to about 0.8 M, or about 0.3 to about 0.7 M, or about 0.4 M to about 0.6 M in the acetic acid solvent.

The conditions in which the leach mixture may be applied to methods, uses, and/or processes for leaching about 40% or more, or about 50% or more of palladium from a spent catalyst comprising palladium in about 20 min or less; or for leaching palladium at a leaching rate about an order of magnitude faster than aqua regia comprises contacting the spent catalyst with the leach mixture for a time of about 0.1 min to about 20 min, at a temperature of about 20° C. to about 30° C., under ambient pressure. In some embodiments, the conditions comprises a time of about 1 min to about 15 min, or about 1 min to about 10 min, or about 1 min to about 8 min, or about 1 min to about 5 min; and a temperature is about 20° C. to about 25° C. In some embodiments, the conditions to leach the palladium further comprise contacting the spent catalyst with the leach mixture at a solid to liquid phase ratio of 1:10. In some embodiments, the conditions in which the leach mixture may be applied to methods, uses, and/or processes for leaching about 40% or more, or about 50% or more of palladium from a spent catalyst comprising palladium in about 20 min or less; or for leaching palladium at a leaching rate about an order of magnitude faster than aqua regia are tolerant of up to about 10 wt % water.

In some embodiments, when the leach mixture is applied to methods, uses, and/or processes for leaching about 40% or more, or about 50% or more of palladium from a spent catalyst comprising palladium in about 20 min or less; or for leaching palladium at a leaching rate about an order of magnitude faster than aqua regia, about 40% to about 100%, or about 50% to about 99.9%, or about 60% to about 99.9%, or about 70% to about 99.9%, or about 80% to about 99.9%, or about 90% to about 99.9% of the palladium in the spent catalyst is leached.

In some embodiments, the leach mixture is applied to the spent catalyst wherein the spent catalyst further comprises platinum and/or rhodium, and the palladium is selectively leached from the spent catalyst. In some embodiments, the spent catalyst is a catalytic converter. In some embodiments, the spent catalyst is a gasoline-based or diesel-based catalytic converter in biscuit form, or a combination thereof.

As described herein, it was found that a leach mixture comprising an metal iodide ligand source, an halide-based oxidizing agent, an optional acid catalyst, an optional stabilizer, and acetic acid as a water-miscible organic solvent leaches at least 60% of surface palladium from a spent catalyst comprising palladium. As described herein, it was found that the leach mixture leaches at least 60% of surface palladium from a spent catalyst comprising palladium under conditions that are milder and less toxic relative to aqua regia as a leach mixture. The leach mixture may be applied to methods, uses, and/or processes for leaching at least 60% of surface palladium from a spent catalyst comprising palladium, or leaching at least 60% of surface palladium from a spent catalyst comprising palladium under conditions that are milder and less toxic relative to aqua regia as a leach mixture.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal iodide ligand source NaI, KI, or a combination thereof. In some embodiments, the metal iodide ligand source is NaI or KI. In some embodiments, the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

In some embodiments, the halide-based oxidizing agent comprises I₂, FeCl₃, or a combination thereof. In some embodiments, the halide-based oxidizing agent has a concentration of from about 0.01 M to about 0.1 M in the acetic acid solvent. In some embodiments, the halide-based oxidizing agent has a concentration from about 0.01 M to about 0.05 M in the acetic acid solvent.

In some embodiments, when present in the leach mixture, the acid catalyst comprises a hydrogen halide, such as HCl; H₂SO₄, or a combination thereof. In some embodiments, the acid catalyst comprises HCl, H₂SO₄, or a combination thereof. In some embodiments, the acid catalyst has a concentration of from about 0.01 M to about 1 M in the acetic acid solvent. In some embodiments, the acid catalyst has a concentration of from about 0.1 M to about 0.5 M in the acetic acid solvent.

In some embodiments, when present in the leach mixture, the stabilizer comprises acetic acid, citric acid, or a combination thereof. In some embodiments, the stabilizer comprises citric acid. In some embodiments, the stabilizer has a concentration of from about 0.1 M to about 1 M in the acetic acid solvent. In some embodiments, the stabilizer has a concentration from about 0.1 M to about 0.8 M, or about 0.3 to about 0.7 M, or about 0.4 M to about 0.6 M in the acetic acid solvent.

The conditions in which the leach mixture may be applied to methods, uses, and/or processes for leaching at least 60% of surface palladium from a spent catalyst comprising palladium, or for leaching at least 60% of surface palladium from a spent catalyst comprising palladium under conditions that are milder and less toxic relative to aqua regia as a leach mixture, comprises contacting the spent catalyst with the leach mixture for a time of about 0.1 min to about 18 hours, at a temperature of about 20° C. to about 30° C., under ambient pressure. In some embodiments, the conditions comprise a time of about 30 min to about 18 hours; and a temperature of about 20° C. to about 25° C. In some embodiments, the conditions to leach the palladium further comprise contacting the spent catalyst with the leach mixture at a solid to liquid phase ratio of 1:10. In some embodiments, the conditions in which the leach mixture may be applied to methods, uses, and/or processes for leaching at least 60% of surface palladium from a spent catalyst comprising palladium, or for leaching at least 60% of surface palladium from a spent catalyst comprising palladium under conditions that are milder and less toxic relative to aqua regia as a leach mixture, are tolerant of up to about 10 wt % water.

In some embodiments, when the leach mixture is applied to methods, use, and/or process for leaching at least 60% of surface palladium from a spent catalyst comprising palladium, or for leaching at least 60% of surface palladium from a spent catalyst comprising palladium under conditions that are milder and less toxic relative to aqua regia as a leach mixture, about 60% to about 99.9%, or about 70% to about 99.9%, or about 80% to about 99.9%, or about 90% to about 99.9% of the palladium in the spent catalyst is leached.

In some embodiments, the leach mixture is applied to the spent catalyst wherein the spent catalyst further comprises platinum and/or rhodium, and the palladium is selectively leached from the spent catalyst. In some embodiments, the spent catalyst is a catalytic converter. In some embodiments, the spent catalyst is a gasoline-based or diesel-based catalytic converter in biscuit form, or a combination thereof.

In some embodiments, the herein described leach mixtures of the herein described methods, uses, and/or processes are tolerant of up to about 10 wt % water. In contrast, for the previously described was a method of leaching gold, palladium and/or platinum from a substance comprising gold, palladium and/or platinum, it was demonstrated that the method provided a gold dissolution rate of 5.1 gm⁻² h⁻¹ when water was used as the solvent; and it was described that water may decrease the leaching efficiency of the method when leaching gold from a gold-containing substance.

In some embodiments, the herein described leach mixtures of the herein described methods, uses, and/or processes provide fast, and/or selective recovery of palladium from a substance comprising palladium (e.g., spent catalyst, catalytic converter). In some embodiments, the herein described leach mixtures of the herein described methods, uses, and/or processes may also leach gold from the substance, should the substance comprise gold; however, the rate of gold leaching is less than the rate of palladium leaching.

In some embodiments, the herein described leach mixtures of the herein described methods, uses, and/or processes for leaching palladium may also be used as refining mixtures, for refining palladium from a mixture of other metals such as platinum, rhodium, etc.

IIIB. Methods, Use, Processes of Leaching Palladium, Platinum, and/or Rhodium

The present disclosure includes a method of leaching palladium and platinum; palladium, platinum, and rhodium; or rhodium from a palladium and platinum containing substance; a palladium, platinum, and rhodium containing substance; or a rhodium containing substance, the method comprising contacting the substance with a mixture comprising: a ligand source; an optional acid catalyst; an optional stabilizer; an oxidizing agent; and a water-miscible organic solvent, under conditions to leach the palladium and platinum; the palladium, platinum, and rhodium; or the rhodium from the substance. In an embodiment of the present disclosure, the method comprises contacting the substance with a mixture comprising: a ligand source; an acid catalyst; a stabilizer; an oxidizing agent; and a water-miscible organic solvent, under conditions to leach the palladium and platinum; the palladium, platinum, and rhodium; or the rhodium from the substance.

In an embodiment where the substance is a catalytic converter, the catalytic converter is intact and the palladium and platinum; the palladium, platinum, and rhodium; or the rhodium being leached is on the surface of the catalytic converter. In another embodiment where the substance is a catalytic converter, the catalytic converter is ground up and powderized, and the palladium and platinum; the palladium, platinum, and rhodium; or the rhodium being leached is on the surface of, and from within the catalytic converter.

In an embodiment of the method of leaching palladium and platinum; palladium, platinum, and rhodium; or rhodium, the method provides a more environmentally-friendly extraction method relative to incumbent technologies (e.g., see Background). In an embodiment, the method being a more environmentally-friendly extraction method comprises having reduced environmental and safety restrictions due to the fact that it uses milder conditions relative to the incumbent technologies (e.g., see Background). In another embodiment, the milder conditions comprise using a lower concentration of chemical reagents, thereby reducing the amount of reagents being consumed when carrying out the method. In another embodiment, the milder conditions comprise a reduced water consumption when carrying out the method, thereby allowing the method to be carried out in areas with water-use restrictions. In other embodiments of the method as described herein, the milder conditions contribute to a reduction in the operational and capital expenditures associated with carrying out the method.

In an embodiment, the method being a more environmentally-friendly extraction method comprises having reduced environmental and safety restrictions due to the fact that it uses safer, less toxic and/or less complex chemistry relative to the incumbent technologies (e.g., see Background). In an embodiment, using safer, less toxic and/or less complex chemistry comprises conducting the method at ambient pressures. In another embodiment, using safer, less toxic and/or less complex chemistry allows for the method's mixture to be reused multiple times for the leaching of palladium and platinum; palladium, platinum, and rhodium; or rhodium, thereby reducing the amount of waste produced overall by the method. In another embodiment, using safer, less toxic and/or less complex chemistry renders the waste produced less environmentally harmful, and thus easier to process and dispose of. In another embodiment, using safer, less toxic and/or less complex chemistry allows for the method to be more easily implemented industrially, as cheaper, less specialized equipment can be used, such as equipment made from stainless steel. This is in contrast to industrial processes that use aqua regia, which is very corrosive, and therefore requires use of special equipment made from glass and plastic.

In another embodiment of the method of leaching palladium and platinum; palladium, platinum, and rhodium; or rhodium, the method provides conditions for leaching palladium and platinum; palladium, platinum, and rhodium; or rhodium from the palladium and platinum containing substance; the palladium, platinum, and rhodium containing substance; or the rhodium containing substance that are tolerant of greater than 10 wt % water, e.g., 30%. In another embodiment, the method provides for no pre-processing of the substance that comprises palladium and platinum; palladium, platinum, and rhodium; or rhodium. In an embodiment where the substance is a catalytic converter, the method provides for contacting the catalytic converter with the mixture without first having to grind and powderize the catalytic converter. Avoiding having to grind and powderize the converter prevents the generation of potentially harmful dust, which would otherwise require following stricter environmental and health safety protocols to contain, such as using air purification systems (e.g., HighVacs). In other embodiments, the method provides for contacting the catalytic converter with the mixture following first grinding and powderizing the converter.

In another embodiment of the method of leaching palladium and platinum; palladium, platinum, and rhodium; or rhodium, the method exhibits a fast rate of palladium and platinum; palladium, platinum, and rhodium; or rhodium leaching. In some embodiments, the rate of leaching is faster than the leaching rate exhibited by incumbent leaching processes, such as with aqua regia, or concentrated HCl/Cl₂ or H₂O₂. In other embodiments, the rate of leaching approximately 50% of palladium and platinum; palladium, platinum, and rhodium; or rhodium from the substance comprising palladium and platinum; palladium, platinum, and rhodium; or rhodium is about 1 times faster to about 22 times faster, or about 3 times faster to about 15 times faster, or about 3 times faster to about 7 times faster, or about 3 times faster to about 6 times faster, than leaching with aqua regia.

In an embodiment of the method of leaching palladium and platinum; palladium, platinum, and rhodium; or rhodium, when the substance to be leached comprises palladium and platinum; palladium, platinum, and rhodium; or rhodium and further comprises a mixture of precious metals, base metals, or ferrous metals (e.g., gold, iron, copper, cobalt, nickel, aluminum, zinc, etc.), the method exhibits selectivity for palladium and platinum; palladium, platinum, and rhodium; or rhodium over the other metals in the substance. In an embodiment, the method exhibits selectivity for leaching palladium and platinum; palladium, platinum, and rhodium; or rhodium from a catalytic converter. In embodiments where the method provides such selectivity, further palladium and platinum; palladium, platinum, and rhodium; or rhodium refining steps, such as solvent extraction or precipitation steps, may not be required.

Previously described was a method of leaching gold, palladium and/or platinum from a substance comprising gold, palladium and/or platinum, the method comprising contacting the substance with a mixture comprising: (a) an acid, such as HCl; (b) an oxidizing agent, such as H₂O₂, Ca(ClO)₂; and (c) a water-miscible or partially water-miscible organic solvent, such as acetic acid, ethyl acetate, acetonitrile, tetrahydrofuran, under conditions to leach the gold, palladium and/or platinum from the substance. In some examples, the mixture used in the method further comprised a metal halide, such as CaCl₂.

It was demonstrated that the method leached gold in short leaching times (for example, 15 min or less) using mixtures comprising HCl as the acid; H₂O₂ or Ca(ClO)₂ as the oxidizing agent; and acetic acid, ethyl acetate, or acetonitrile as the solvent. It was demonstrated that the method provided a gold dissolution rate of 6020 gm⁻² h⁻¹ at room temperature, representing the fastest recorded rate known for gold dissolution in either organic or aqueous systems at the time, and a gold dissolution rate of 9000 gm⁻² h⁻¹ at 60° C., using mixtures comprising HCl as the acid; H₂O₂ as the oxidizing agent; CaCl₂ as the metal halide; and acetic acid as the solvent. It was demonstrated that the method provided a gold dissolution rate of 5.1 gm⁻² h⁻¹ when water was used as the solvent; and it was described that water may decrease the leaching efficiency of the method when leaching gold from a gold-containing substance. It was also demonstrated that the method selectively leached gold over base metals such as iron, nickel, cobalt and copper using mixtures comprising HCl as the acid, H₂O₂ as the oxidant, CaCl₂ as the metal halide, and acetic acid or acetonitrile as the solvent.

Further, It was demonstrated that the method dissolved platinum powder (200 mesh) in, for example, 90 min at room temperature using mixtures comprising HCl as the acid, H₂O₂ as the oxidant, and acetic acid, acetonitrile, or ethyl acetate as the solvent.

As described herein, it was found that a leach mixture comprising a chloride ligand source, an oxidizing agent, an acid catalyst, and a water-miscible organic solvent provides simultaneous and selective leaching of at least two of palladium, platinum, and rhodium from a substance comprising platinum group metals. The leach mixture may be applied to methods, uses, and/or processes for simultaneously and selectively leaching at least two of palladium, platinum, and rhodium from a substance comprising platinum group metals.

In some embodiments, the water-miscible organic solvent of the leach mixture comprises acetic acid, glacial acetic acid, acetonitrile, ethyl acetate, tetrahydrofuran, or combinations thereof. In some embodiments, the water-miscible organic solvent is acetic acid. In some embodiments, the water-miscible organic solvent is glacial acetic acid. In some embodiments, the water-miscible organic solvent makes up at least 50 wt % of the liquid phase of the leach mixture.

In some embodiments, the chloride ligand source of the leach mixture comprises HCl, MgCl₂, AlCl₃, CaCl₂, or a combination thereof. In some embodiments, the chloride ligand source comprises HCl, AlCl₃, CaCl₂, or a combination thereof. In some embodiments, the chloride ligand source comprises HCl, CaCl₂, or a combination thereof. In some embodiments, the chloride ligand source has a concentration of from about 0.1 M to about 4 M in the solvent. In some embodiments, the chloride ligand source has a concentration of about 0.1 M to about 1 M, or about 0.1 M to about 0.5 M, or about 0.1 to about 0.4 M, or from about 0.1 M to about 0.3 M, or about 0.1 to about 0.2 M in the solvent.

In some embodiments, the oxidizing agent of the leach mixture comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof. In some embodiments, the oxidizing agent comprises H₂O₂, Cl₂, HNO₃, CaO₂, MnO₂, CaO₂ and MnO₂, CuCl₂, FeCl₃, O₂, bubbled air, or a combination thereof. In some embodiments, the oxidizing agent comprises H₂O₂, Cl₂, CaO₂, MnO₂, CaO₂ and MnO₂, CuCl₂, FeCl₃, or a combination thereof. In some embodiments, the oxidizing agent has a concentration of from about 0.01 M to about 2.5 M in the solvent. In some embodiments, the oxidizing agent has a concentration of about 0.01 M to about 1 M in the solvent.

In some embodiments, the acid catalyst of the leach mixture comprises a hydrogen halide, sulfuric acid, phosphoric acid, or a combination thereof. In some embodiments, the acid catalyst comprises HCl, H₂SO₄, or a combination thereof. In some embodiment, the acid catalyst comprises preferably HCl. In some embodiments, the acid catalyst is also the chloride ligand source of the leach mixture. In some embodiments, the acid catalyst has a concentration of from about 0.01 M to about 4 M in the solvent. In some embodiments, the acid catalyst has a concentration of from about 0.1 M to about 2 M, or from about 0.1 M to about 1 M, or from about 0.1 M to about 0.5 M, or from about 0.1 M to about 0.2 M in the solvent.

The conditions in which the leach mixture may be applied to methods, uses, and/or processes for simultaneously and selectively leaching at least two of palladium, platinum, and rhodium from a substance comprising platinum group metals comprises contacting the substance with the leach mixture for a time of about 0.1 min to about 18 hours, at a temperature of about 20° C. to about 120° C., under ambient pressure. In some embodiments, the conditions comprise a time of about 1 min to about 5 hours; and a temperature of about 60° C. to about 90° C. In some embodiments, the conditions to simultaneously and selectively leach at least two of palladium, platinum, and rhodium further comprise contacting the substance with the leach mixture at a solid to liquid phase ratio of 1:10. In some embodiments, the conditions in which the leach mixture may be applied to methods, uses, and/or processes for simultaneously and selectively leaching at least two of palladium, platinum, and rhodium are tolerant of up to about 10 wt % water, or between about 10 wt % to less than 50 wt % water, such as 30 wt % water.

In some embodiments, when the leach mixture is applied to methods, uses, and/or processes for simultaneously and selectively leaching at least two of palladium, platinum, and rhodium from a substance comprising platinum group metals about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium, is leached.

In some embodiments, the substance comprising platinum group metals to which the leach mixture may be applied comprises a platinum group metal ore, a platinum group metal concentrate, electronic or electrical waste, a spent catalyst, or a catalytic converter; preferably a spent catalyst or catalytic converter. In some embodiments, the substance comprises a spent catalyst or a catalytic converter. In some embodiments, the spent catalyst comprises a spent nitric acid catalyst, which may comprise a relatively higher concentration of platinum group metals, such as Pd, Pt, and Rh; Fe₂O₃; and relatively lower concentration of base metals, such as Ni, Cu etc. In some embodiments, the platinum group metals of the substance comprising platinum group metals comprise palladium, palladium and platinum, or palladium, platinum, and rhodium.

As described herein, it was found that a leach mixture comprising an metal chloride ligand source, an inorganic oxidizing agent, an acid catalyst, and acetic acid as a water-miscible organic solvent provides simultaneous and selective leaching of at least two of palladium, platinum, and rhodium from a spent catalyst comprising aluminum oxide and at least two of palladium, platinum, and rhodium. The leach mixture may be applied to methods, uses, and/or processes for simultaneously and selectively leaching at least two of palladium, platinum, and rhodium from a spent catalyst comprising aluminum oxide and at least two of palladium, platinum, and rhodium.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal chloride ligand source of the leach mixture comprises HCl, AlCl₃, CaCl₂, or a combination thereof. In some embodiments, the metal chloride ligand source comprises AlCl₃, CaCl₂, or a combination thereof. In some embodiments, the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

In some embodiments, the inorganic oxidizing agent of the leach mixture comprises FeCl₃, O₂, bubbled air, or a combination thereof. In some embodiments, the oxidizing agent has a concentration of from about 0.01 M to about 0.2 M in the acetic acid solvent. In some embodiments, the oxidizing agent has a concentration of about 0.01 to about 0.1 M in the acetic acid solvent.

In some embodiments, the acid catalyst comprises a hydrogen halide. In some embodiments, the acid catalyst is HCl. In some embodiments, the acid catalyst is also the chloride ligand source of the leach mixture. In some embodiments, the acid catalyst has a concentration of from about 0.01 M to about 1 M in the acetic acid solvent. In some embodiments, the acid catalyst has a concentration of about 0.1 M to about 0.5 M in the acetic acid solvent.

The conditions in which the leach mixture may be applied to methods, uses, and/or processes for simultaneously and selectively leaching at least two of palladium, platinum, and rhodium from a spent catalyst comprising aluminum oxide and at least two of palladium, platinum, and rhodium comprises contacting the substance with the leach mixture for a time of about 0.1 min to about 4 hours, at a temperature of about 20° C. to about 120° C., under ambient pressure. In some embodiments, the conditions comprise a time of about 30 min to about 2 hours; and a temperature pf about 60° C. to about 90° C. In some embodiments, the conditions to simultaneously and selectively leach at least two of palladium, platinum, and rhodium further comprise contacting the substance with the leach mixture at a solid to liquid phase ratio of 1:10. In some embodiments, the conditions in which the leach mixture may be applied to methods, uses, and/or processes for simultaneously and selectively leaching at least two of palladium, platinum, and rhodium from a spent catalyst comprising aluminum oxide and at least two of palladium, platinum, and rhodium are tolerant of up to about 10 wt % water, or between about 10 wt % to less than 50 wt % water, such as 30 wt % water.

In some embodiments, when the leach mixture is applied to methods, uses, and/or processes for simultaneously and selectively leaching at least two of palladium, platinum, and rhodium from a spent catalyst comprising aluminum oxide and at least two of palladium, platinum, and rhodium about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium, is leached.

In some embodiments, the spent catalyst to which the leach mixture is applied is a catalytic converter. In some embodiments, the catalytic converter is a gasoline-based or diesel-based catalytic converter in biscuit or powder form, or a combination thereof.

As described herein, it was found that a leach mixture comprising an metal chloride ligand source, an inorganic oxidizing agent, an acid catalyst, and acetic acid as a water-miscible organic solvent leaches about 40% or more, or about 50% or more of at least two of palladium, platinum, and rhodium from a spent catalyst in about 30 min or less. As described herein, it was found that the leach mixture leaches at least two of palladium, platinum, and rhodium from a spent catalyst at a leaching rate at least 1 time, or at least 5 times, or at least 15 times, or at least 20 times faster than aqua regia. The leach mixture may be applied to methods, uses, and/or processes for leaching about 40% or more, or about 50% or more of at least two of palladium, platinum, and rhodium from a spent catalyst in about 30 min or less, or for leaching at least two of palladium, platinum, and rhodium from a spent catalyst at a leaching rate at least 1 time, or at least 5 times, or at least 15 times, or at least 20 times faster than aqua regia.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal chloride ligand source of the leach mixture comprises HCl, CaCl₂, or a combination thereof. In some embodiments, the metal chloride ligand source is CaCl₂. In some embodiments, the metal chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

In some embodiments, the inorganic oxidizing agent of the leach mixture comprises FeCl₃, CuCl₂, HNO₃, MnO₂, H₂O₂, or a combination thereof. In some embodiments, the oxidizing agent has a concentration of from about 0.01 M to about 0.2 M in the acetic acid solvent. In some embodiments, the oxidizing agent has a concentration of about 0.01 to about 0.1 M in the acetic acid solvent.

In some embodiments, the acid catalyst of the leach mixture comprises a hydrogen halide. In some embodiments, the acid catalyst is HCl. In some embodiments, the acid catalyst has a concentration of from about 0.01 M to about 1 M in the acetic acid solvent. In some embodiments, the acid catalyst has a concentration of about 0.1 M to about 0.2 M in the acetic acid solvent.

The conditions in which the leach mixture may be applied to methods, uses, and/or processes for leaching about 40% or more, or about 50% or more of at least two of palladium, platinum, and rhodium from a spent catalyst in about 30 min or less, or for leaching at least two of palladium, platinum, and rhodium from a spent catalyst at a leaching rate at least 1 time, or at least 5 times, or at least 15 times, or at least 20 times faster than aqua regia, comprises contacting the spent catalyst with the leach mixture for a time of about 0.1 min to about 25 min, at a temperature of about 20° C. to about 120° C., under ambient pressure. In some embodiments, the conditions comprise a time of about 1 min to about 20 min, or about 1 min to about 15 min, about 1 min to about 10 min, about 1 min to about 5 min; and a temperature of about 80° C. to about 90° C. In some embodiments, the conditions to leach at least two of palladium, platinum, and rhodium further comprise contacting the substance with the leach mixture at a solid to liquid phase ratio of 1:10. In some embodiments, the conditions in which the leach mixture may be applied to methods, uses, and/or processes for leaching about 40% or more, or about 50% or more of at least two of palladium, platinum, and rhodium from a spent catalyst in about 30 min or less, or for leaching at least two of palladium, platinum, and rhodium from a spent catalyst at a leaching rate at least 1 time, or at least 5 times, or at least 15 times, or at least 20 times faster than aqua regia, are tolerant of up to about 10 wt % water, or between about 10 wt % to less than 50 wt % water, such as 30 wt % water.

In some embodiments, when the leach mixture may be applied to methods, uses, and/or processes for leaching about 40% or more, or about 50% or more of at least two of palladium, platinum, and rhodium from a spent catalyst in about 30 min or less, or for leaching at least two of palladium, platinum, and rhodium from a spent catalyst at a leaching rate at least 1 time, or at least 5 times, or at least 15 times, or at least 20 times faster than aqua regia, about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium, is leached.

In some embodiments, the leach mixture is applied to the spent catalyst wherein the spent catalyst further comprises aluminium oxide, and at least two of palladium, platinum, and rhodium are selectively leached from the spent catalyst.

In some embodiments, the spent catalyst to which the leach mixture is applied is a catalytic converter. In some embodiments, the catalytic converter is a gasoline-based or diesel-based catalytic converter in biscuit or powder form, or a combination thereof.

As described herein, it was found that a leach mixture comprising an metal chloride ligand source, an inorganic oxidizing agent, an acid catalyst, and acetic acid as a water-miscible organic solvent leaches at least 40% of at least one of palladium, platinum, and rhodium from a spent catalyst. As described herein, it was found that the leach mixture leaches at least 40% of at least one of palladium, platinum, and rhodium from a spent catalyst under conditions that are milder and less toxic relative to aqua regia as a leach mixture. The leach mixture may be applied to methods, uses, and/or processes for leaching at least 40% of at least one of palladium, platinum, and rhodium from a spent catalyst, or leaching at least 40% of at least one of palladium, platinum, and rhodium from a spent catalyst under conditions that are milder and less toxic relative to aqua regia as a leach mixture.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal chloride ligand source of the leach mixture comprises HCl, AlCl₃, CaCl₂, or a combination thereof. In some embodiments, the metal chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

In some embodiments, the inorganic oxidizing agent of the leach mixture comprises CuCl₂, H₂O₂, or a combination thereof. In some embodiments, the oxidizing agent has a concentration of from about 0.01 M to about 0.2 M in the acetic acid solvent. In some embodiments, the oxidizing agent has a concentration of about 0.01 to about 0.1 M in the acetic acid solvent.

In some embodiments, the acid catalyst of the leach mixture comprises a hydrogen halide. In some embodiments, the acid catalyst is HCl. In some embodiments, the acid catalyst is also the chloride ligand source of the leach mixture. In some embodiments, the acid catalyst has a concentration of from about 0.01 M to about 1 M in the acetic acid solvent. In some embodiments, the acid catalyst has a concentration of about 0.1 M to about 0.5 M in the acetic acid solvent.

The conditions in which the leach mixture may be applied to methods, uses, and/or processes for leaching at least 40% of at least one of palladium, platinum, and rhodium from a spent catalyst, or leaching at least 40% of at least one of palladium, platinum, and rhodium from a spent catalyst under conditions that are milder and less toxic relative to aqua regia as a leach mixture, comprises contacting the substance with the leach mixture for a time of about 0.1 min to about 4 hours, at a temperature of about 20° C. to about 90° C., under ambient pressure. In some embodiments, the conditions comprise a time of about 30 min to about 3 hours; and a temperature of about 20° C. to about 60° C. In some embodiments, the conditions to leach at least one of palladium, platinum, and rhodium further comprise contacting the substance with the leach mixture at a solid to liquid phase ratio of 1:10. In some embodiments, the conditions in which the leach mixture may be applied to methods, uses, and/or processes for leaching at least 40% of at least one of palladium, platinum, and rhodium from a spent catalyst, or leaching at least 40% of at least one of palladium, platinum, and rhodium from a spent catalyst under conditions that are milder and less toxic relative to aqua regia as a leach mixture, are tolerant of up to about 10 wt % water, or between about 10 wt % to less than 50 wt % water, such as 30 wt % water.

In some embodiments, when the leach mixture may be applied to methods, uses, and/or processes for leaching at least 40% of at least one of palladium, platinum, and rhodium from a spent catalyst, or leaching at least 40% of at least one of palladium, platinum, and rhodium from a spent catalyst under conditions that are milder and less toxic relative to aqua regia as a leach mixture, about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium, is leached.

In some embodiments, the leach mixture is applied to the spent catalyst wherein the spent catalyst further comprises aluminium oxide, and at least two of palladium, platinum, and rhodium are selectively leached from the spent catalyst.

In some embodiments, the spent catalyst to which the leach mixture is applied is a catalytic converter. In some embodiments, the catalytic converter is a gasoline-based or diesel-based catalytic converter in biscuit or powder form, or a combination thereof.

As described herein, it was found that a leach mixture comprising an metal chloride ligand source, at least one inorganic oxidizing agent, an acid catalyst, and acetic acid as a water-miscible organic solvent leaches at least 80% of at least two of palladium, platinum, and rhodium from a spent catalyst. The leach mixture may be applied to methods, uses, and/or processes for leaching at least 80% of at least two of palladium, platinum, and rhodium from a spent catalyst.

In some embodiments, the water-miscible organic solvent of the leach mixture comprises acetic acid, glacial acetic acid, or combinations thereof. In some embodiments, the water-miscible organic solvent is glacial acetic acid. In some embodiments, the water-miscible organic solvent makes up at least 50 wt % of the liquid phase of the leach mixture.

In some embodiments, the metal chloride ligand source of the leach mixture comprises HCl, CaCl₂, or a combination thereof. In some embodiments, the metal chloride ligand source is HCl. In some embodiments, the metal chloride ligand source has a concentration of about 0.01 M to about 4 M, or about 0.1 to about 2 M, or from about 0.1 M to about 1 M, or about 0.1 M to about 0.5 M, in the acetic acid solvent.

In some embodiments, the at least one inorganic oxidizing agent of the leach mixture comprises HNO₃, MnO₂, H₂O₂, CaO₂, MnO₂ and CaO₂, or a combination thereof. In some embodiments, the at least one inorganic oxidizing agent comprises MnO₂, CaO₂, MnO₂ and CaO₂, or a combination thereof. In some embodiments, the at least one inorganic oxidizing agent has a concentration of from about 0.01 M to about 1 M in the acetic acid solvent. In some embodiments, the at least one inorganic oxidizing agent has a concentration of about 0.01 M to about 0.5 M, or about 0.03 M to about 0.5 M, or about 0.1 M to about 0.5 M in the acetic acid solvent.

In some embodiments, the acid catalyst of the leach mixture comprises a hydrogen halide. In some embodiments, the acid catalyst is HCl. In some embodiments, the acid catalyst is also the chloride ligand source of the leach mixture. In some embodiments, the acid catalyst has a concentration of from about 0.01 M to about 2 M in the acetic acid solvent. In some embodiments, the acid catalyst has a concentration of about 0.1 M to about 1 M, or 0.5 M to about 1 M in the acetic acid solvent.

The conditions in which the leach mixture may be applied to methods, uses, and/or processes for leaching at least 80% of at least two of palladium, platinum, and rhodium from a spent catalyst comprises contacting the substance with the leach mixture for a time of about 0.1 min to about 4 hours, at a temperature of about 20° C. to about 120° C., under ambient pressure. In some embodiments, the conditions comprise a time of about 30 min to about 2 hours; and a temperature of about 60° C. to about 90° C. In some embodiments, the conditions to leach at least two of palladium, platinum, and rhodium further comprise contacting the substance with the leach mixture at a solid to liquid phase ratio of 1:10. In some embodiments, the conditions in which the leach mixture may be applied to methods, uses, and/or processes for leaching at least 80% of at least two of palladium, platinum, and rhodium from a spent catalyst are tolerant of up to about 10 wt % water, or between about 10 wt % to less than 50 wt % water, such as 30 wt % water.

In some embodiments, when the leach mixture may be applied to methods, uses, and/or processes for leaching at least 80% of at least two of palladium, platinum, and rhodium from a spent catalyst, about 80% to about 99.9%, or about 85% to about 99.9%, or about 90% to about 99.9%, or about 95% to about 99.9% of at least two of the palladium, platinum, and rhodium in the spent catalyst is leached.

In some embodiments, the leach mixture is applied to the spent catalyst wherein the spent catalyst further comprises aluminium oxide, and at least two of palladium, platinum, and rhodium are selectively leached from the spent catalyst.

In some embodiments, the spent catalyst to which the leach mixture is applied is a catalytic converter. In some embodiments, the catalytic converter is a gasoline-based or diesel-based catalytic converter in biscuit or powder form, or a combination thereof.

In some embodiments, when applying the herein described leach mixtures to herein described methods, uses, and/or processes leaches about 95% to about 99.9% of at least one of palladium, platinum, and rhodium from a substance (e.g., spent catalyst, catalytic converter), said leach mixture and associated methods, uses, and/or processes may compete with smelters and smelting processes that are dominant in the platinum group metal refining market. For example, the difference between a 90% extraction yield and a 96% extraction yield for palladium and/or platinum can result in extracting 23 g more palladium and/or 54 g more platinum per ton of substance (e.g., spent catalyst, catalytic converter). This can translate to about $4600 in extra platinum group metals being extracted per tonne of substance. For other substances, such as high-grade catalysts, about $10,000 in extra platinum group metals could be extracted. In some embodiments, due in part to the high value of platinum group metals, extraction yields of 95% or more for platinum group metals can increase the economic viability, and/or increase scale-up capacities of herein described methods, uses, and/or processes that involve the herein described leach mixtures

In some embodiments, the herein described leach mixtures of the herein described methods, uses, and/or processes do not generate the oxidant Cl₂ in-situ; for example, when the oxidizing agent of the leach mixture is CaO₂ and MnO₂, FeCl₃, CuCl₂, MnO₂, O₂, bubbled air, or a combination thereof. In some embodiments, not generating the oxidant Cl₂ in-situ can allow the herein described methods, uses, and/or processes to be operated at higher temperatures that may otherwise degas the oxidant Cl₂ from the mixture. In some embodiments, not generating the oxidant Cl₂ in-situ, and therefore using less corrosive chemistry can increase the scalability of the herein described methods, uses, and/or processes, as said herein described methods, uses, and/or processes may be more easily implemented industrially, as cheaper, less specialized equipment can be used, such as equipment made from stainless steel.

In some embodiments, when a substance (e.g., spent catalyst, catalytic converter) comprises aluminium oxide and platinum group metals, the herein described leach mixtures of the herein described methods, uses, and/or processes can selectively leach at least one, or at least two of palladium, platinum, and rhodium from the substance, to the exclusion of the aluminium oxide. In some embodiments, when a substance (e.g., spent catalyst, catalytic converter) comprises aluminium oxide and platinum group metals, the herein described leach mixtures of the herein described methods, uses, and/or processes can selectively leach at least one, or at least two of palladium, platinum, and rhodium, extracting less than 3%, less than 2% of the aluminium oxide. In comparison, leach mixtures that use water, or aqueous solutions as a solvent may extract upwards of 10% or more of the aluminium oxide, which can impact the reusability of the leach mixture and/or downstream waste treatment.

In some embodiments, the herein described leach mixtures of the herein described methods, uses, and/or processes are tolerant of up to about 10 wt % water, or between about 10 wt % to less than 50 wt % water, such as 30 wt % water. In contrast, for the previously described method of leaching gold, palladium and/or platinum from a substance comprising gold, palladium and/or platinum, it was demonstrated that the method provided a gold dissolution rate of 5.1 gm⁻² h⁻¹ when water was used as the solvent; and it was described that water may decrease the leaching efficiency of the method when leaching gold from a gold-containing substance.

### IV. Pre-Treatment Methods of the Disclosure

In an embodiment of the present disclosure, there is provided a pre-treatment method that may be used to pre-treat a substance comprising platinum group metals prior to the substance being treated by the herein described methods, uses, and processes and the leach mixtures thereof. In some embodiments, the pre-treatment method comprises reducing the platinum group metals or decontaminating the platinum group metals comprised by the substance. In some embodiments, the pre-treatment method improves (e.g., increases) the leaching efficiency of the herein described methods, uses, and processes relative to when the pre-treatment method is not used.

A. Reducing Pre-Treatment

In an embodiment, where the substance comprising platinum group metals further comprises oxidized platinum group metals, the pre-treatment method comprises contacting the substance with a reductant under conditions to at least partially reduce the oxidized platinum group metals; and at least partially reducing the oxidized platinum group metals. In some embodiments, a substance comprising platinum group metals (such as a catalytic converter) may be exposed to oxygen or air at high temperatures, which may oxidize at least some of the platinum group metals. Once oxidized, platinum group metals can become resistant to reduction and/or recovery. As such, the herein described reducing pre-treatment—by reducing at least some of the oxidized platinum group metals—can improve (e.g., increase) the leaching efficiency of the herein described methods, uses, and processes relative to when the pre-treatment method is not used.

The reductant can be any suitable reducing agent that can reduce platinum group metals, such as palladium, platinum, or rhodium. In an embodiment, the reductant comprises, consists essentially of, or consists of an organic reductant, an inorganic reductant, or a combination thereof.

In some embodiments, the organic reductant comprises, consists essentially of, or consists of ascorbic acid and/or salts thereof, formic acid and/or salts thereof, oxalic acid and/or salts thereof, or a combination thereof; or the organic reductant is any subset of the group comprising, consisting essentially of, or consisting of ascorbic acid and/or salts thereof, formic acid and/or salts thereof, oxalic acid and/or salts thereof, or a combination thereof. In some embodiments, the organic reductant comprises, consists essentially of, or consists of ascorbic acid and/or salts thereof, oxalic acid and/or salts thereof, or a combination thereof. In some embodiments, the organic reductant comprises, consists essentially of, or consists of ascorbic acid and/or salts thereof, formic acid and/or salts thereof, or a combination thereof. In some embodiments, the organic reductant comprises, consists essentially of, or consists of formic acid and/or salts thereof, oxalic acid and/or salts thereof, or a combination thereof. In some embodiments, the organic reductant comprises, consists essentially of, or consists of formic acid and/or salts thereof. In some embodiments, the organic reductant comprises, consists essentially of, or consists of formic acid.

In some embodiments, the inorganic reductant comprises, consists essentially of, or consists of H₂, NaBH₄, FeCl₂, hydrazine hydrochloride, hydroxylamine hydrochloride, or a combination thereof; or the inorganic reductant is any subset of the group comprising, consisting essentially of, or consisting of H₂, NaBH₄, FeCl₂, hydrazine hydrochloride, hydroxylamine hydrochloride, or a combination thereof. In some embodiments, the inorganic reductant comprises, consists essentially of, or consists of H₂, NaBH₄, FeCl₂, hydrazine hydrochloride, hydroxylamine hydrochloride, or a combination thereof. In some embodiments, reductant comprises, consists essentially of, or consists of H₂, NaBH₄, FeCl₂, hydroxylamine hydrochloride, or a combination thereof. In some embodiments, the inorganic reductant comprises, consists essentially of, or consists of H₂, NaBH₄, FeCl₂, or a combination thereof. In some embodiments, the inorganic reductant comprises, consists essentially of, or consists of H₂.

The concentration and/or amount of reductant used can be selected by a person skilled in the art based at least in part on the substance and/or platinum group metal(s), the amount of substance or metal to be pre-treated, and/or the reductant being used. In some embodiments, the reductant is in solution, for example an aqueous solution, and the concentration of the reductant in solution is at least 10%, or at least 20%. In some embodiments, the reductant is used neat, and is contacted with the substance at a stoichiometric amount, or a greater than stoichiometric amount.

The conditions to at least partially reduce the oxidized platinum group metals can be selected by a person skilled in the art based at least in part on the substance and/or platinum group metal(s) to be pre-treated, and the reductant being used. In some embodiments, the conditions comprise contacting the substance with the reductant for any amount of time, at any temperature suitable to at least partially reduce the oxidized platinum group metals. In some embodiments, the conditions comprise contacting the substance with the reductant for a time of about 0.1 min to about 24 hours, or about 10 min to about 24 hours, or about 30 min to about 24 hours, or about 1 hour to about 24 hours, or about 1 hour to about 12 hours, or about 1 hour to about 6 hours, or about 1 hour to about 4 hours, or about 2 hour to about 4 hours; or at any time, or any range of time between about 0.1 min and about 24 hours. In some embodiments, the conditions comprise contacting the substance with the reductant at a temperature of about 20° C. to about 1000° C., about 20° C. to about 800° C., about 20° C. to about 500° C., about 20° C. to about 250° C., about 20° C. to about 100° C., or about 20° C. to about 90° C., 40° C. to about 90° C.; 60° C. to about 90° C., 70° C. to about 90° C.; or at any temperature, or any range of temperatures between about 20° C. and about 1000° C.

In some embodiments, the conditions comprise contacting the substance with the reductant under ambient pressure; or under pressures of less than 1 atm; or about 1 atm to about 100 atm, or at any pressure between less than 1 atm and about 100 atm.

In some embodiments, the substance further comprising the oxidized platinum group metals is a platinum group metal ore, a platinum group metal concentrate, electronic or electrical waste, a spent catalyst, or a catalytic converter. In some embodiments, the substance is a spent catalyst, or a catalytic converter. In some embodiments, the substance is ground and/or powderized prior to pre-treatment.

A. Decontaminating Pre-Treatment

In an embodiment, where the substance comprising platinum group metals further comprises a contaminant on or in the platinum group metals, the pre-treatment method comprises contacting the substance with a chelating agent under conditions to at least partially remove the contaminant; and at least partially decontaminating the platinum group metals. In some embodiments, a substance comprising platinum group metals (such as a catalytic converter) may be exposed to harsher conditions (e.g., such as those in a combustion engine), which may contaminate at least some of the platinum group metals. Once contaminated, platinum group metals can become resistant to reduction and/or recovery. As such, the herein described decontaminatinq pre-treatment—by removing at least some of a contaminant from at least some of the contaminated platinum group metals—can improve (e.g., increase) the leaching efficiency of the herein described methods, uses, and processes relative to when the pre-treatment method is not used.

The chelating agent can be any suitable chelating agent that can remove contaminants from platinum group metals, such as palladium, platinum, or rhodium. In an embodiment, the chelating agent comprises, consists essentially of, or consists citric acid and/or salts thereof, oxalic acid and/or salts thereof, or a combination thereof. In some embodiments, the chelating agent comprises, consists essentially of, or consists of oxalic acid and/or salts thereof. In some embodiments, the chelating agent comprises, consists essentially of, or consists of citric acid and/or salts thereof. In some embodiments, the chelating agent comprises, consists essentially of, or consists of citric acid.

The concentration and/or amount of chelating agent used can be selected by a person skilled in the art based at least in part on the substance and/or platinum group metal(s), the amount of substance or metal to be pre-treated, and/or the chelating agent being used. In some embodiments, the chelating agent is in solution, for example an aqueous solution, and the concentration of the reductant in solution is at least 0.1M, or at least 0.5M, or at least 1M. In some embodiments, the chelating agent may be used neat, and is contacted with the substance at a stoichiometric amount, or a greater than stoichiometric amount.

The conditions to at least partially decontaminate the platinum group metals can be selected by a person skilled in the art based at least in part on the substance and/or platinum group metal(s) to be pre-treated, and the chelating agent being used. In some embodiments, the conditions comprise contacting the substance with the chelating agent for any amount of time, at any temperature suitable to at least partially remove the contaminant. In some embodiments, the conditions comprise contacting the substance with the chelating agent for a time of about 0.1 min to about 24 hours, or about 10 min to about 24 hours, or about 30 min to about 24 hours, or about 1 hour to about 24 hours, or about 1 hour to about 12 hours, or about 1 hour to about 8 hours, or about 6 hour to about 8 hours, or about 2 hour to about 6 hours; or at any time, or any range of time between about 0.1 min and about 24 hours. In some embodiments, the conditions comprise contacting the substance with the chelating at a temperature of about 20° C. to about 100° C., or about 20° C. to about 90° C., or about 40° C. to about 90° C.; or 60° C. to about 90° C., or 70° C. to about 90° C.; or at any temperature, or any range of temperatures between about 20° C. and about 100° C.

In some embodiments, the conditions comprise contacting the substance with the chelating agent under ambient pressure; or under pressures of less than 1 atm; or about 1 atm to about 100 atm, or at any pressure between less than 1 atm and about 100 atm.

In some embodiments, the contaminant comprises carbon deposits; hydrocarbons; sulfur-based compounds; phosphorous-based compounds; silicon-based compound; metals such as Pb, Ca, Zn, Fe, Cu, Ni; or a combination thereof. In some embodiments, the substance further comprising the contaminant is a platinum group metal ore, a platinum group metal concentrate, electronic or electrical waste, a spent catalyst, or a catalytic converter. In some embodiments, the substance is a spent catalyst, or a catalytic converter. In some embodiments, the substance is ground and/or powderized prior to pre-treatment.

### V. Post-Treatment Methods of the Disclosure

In an embodiment of the present disclosure, there is provided a post-treatment method that may be used to recover platinum group metals leached from a substance comprising platinum group metals following treatment with the herein described methods, uses, and processes and leach mixtures thereof. In some embodiments, the post-treatment method comprises adding an oxidant and a polyatomic salt to a leach solution comprising leached platinum group metals under conditions to precipitate the leached platinum group metals; and precipitating the leached platinum group metals. In some embodiments, the leached platinum group metals precipitate in the form of a metal-ligand complex.

The post-treatment step further comprises contacting the leached platinum group metals with a reducing agent under conditions to reduce the leached platinum group metals to metal; and reducing the leached platinum group metals. In some embodiments, the precipitated platinum group metal-ligand complex is reduced to platinum group metal. In some embodiments, contacting with the reducing agent comprises forming an aqueous mixture comprising the leached platinum group metals, and adding the reducing agent to the aqueous mixture. In some embodiments, the post-treatment provides for the simultaneous recovery of palladium, platinum, and/or rhodium. In some embodiments, the post-treatment method provides for the recovery of platinum group metals having a purity of at least 90%, or at least 95%, or at least 99.9%.

The oxidant can be any suitable oxidant that can oxidize platinum group metals; for example, an oxidant that can oxidize the platinum group metals such as palladium, platinum, or rhodium from a lower to a higher oxidation state. In an embodiment, the oxidant comprises, consists essentially of, or consists of H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof. In some embodiments, the oxidant comprises, consists essentially of, or consists of H₂O₂, CaO₂, NaClO₂, NaClO₃, NaClO, or combinations thereof. In some embodiments, the oxidant comprises, consists essentially of, or consists of H₂O₂, CaO₂, or combinations thereof. In some embodiments, the oxidant comprises, consists essentially of, or consists of H₂O₂.

The concentration and/or amount of oxidant used can be selected by a person skilled in the art based at least in part on the platinum group metal(s), the amount of metal to be post-treated, and/or the oxidant being used. In some embodiments, the reducing agent is in solution, for example an aqueous solution, and the concentration of the reducing agent in solution is at least 10%, or at least 20%, or at least 30%. In some embodiments, the oxidant is used neat, and is contacted with the metals at a stoichiometric amount, or a greater than stoichiometric amount. In some embodiments, the concentration and/or amount of the oxidant is selected to reduce the amount of water introduced into the post-treatment method, where higher concentrations of water may inhibit the simultaneous precipitation of the platinum group metals, and thus the simultaneous recovery of the platinum group metals.

The polyatomic salt can be any suitable polyatomic salt that can counter-ion exchange with complexes of platinum group metals, such as complexes of palladium, platinum, or rhodium. In an embodiment, the polyatomic salt comprises, consists essentially of, or consists of an ammonium salt. In some embodiments, the ammonium salt comprises, consists essentially of, or consists of ammonium chloride, ammonium sulfate, ammonium nitrate, or combinations thereof. In some embodiments, the ammonium salt comprises, consists essentially of, or consists of ammonium chloride, ammonium nitrate, or combinations thereof. In some embodiments, the ammonium salt comprises, consists essentially of, or consists of ammonium chloride, or combinations thereof. In some embodiments, the ammonium salt comprises, consists essentially of, or consists of ammonium chloride.

The concentration and/or amount of polyatomic salt used can be selected by a person skilled in the art based at least in part on the platinum group metal(s), the amount of metal to be post-treated, and/or the polyatomic salt being used. In some embodiments, the reducing agent is in solution, for example an aqueous solution, and the concentration of the reducing agent in solution is at least 0.1 M, or at least 1M, or at least 5M, or at least 10M. In some embodiments, the polyatomic salt is used neat, and is contacted with the metals at a stoichiometric amount, or a greater than stoichiometric amount. In some embodiments, the concentration and/or amount of the polyatomic salt is selected to reduce the amount of water introduced into the post-treatment method, where higher concentrations of water may inhibit the simultaneous precipitation of the platinum group metals, and thus the simultaneous recovery of the platinum group metals.

The conditions to precipitate the leached platinum group metals can be selected by a person skilled in the art based at least in part on the platinum group metal(s) to be post-treated, and the oxidant and/or polyatomic salt being used. In some embodiments, the conditions comprise contacting the substance with the oxidant and polyatomic salt for any amount of time, at any temperature suitable to precipitate the leached platinum group metals. In some embodiments, the conditions comprise contacting the substance with the oxidant and polyatomic salt for a time of about 0.1 min to about 24 hours, or about 0.1 min to about 12 hours, or about 0.1 min to about 6 hours, or about 0.1 min to about 3, or about 0.1 min to about 2 hours, or about 0.1 min to about 1 hour, or about 0.1 min to about 30 min, or about 0.1 min to 15 min, or about 0.1 min to about 10 min; or about 0.1 min to about 5 min; or at any time, or any range of time between about 0.1 min and about 24 hours. In some embodiments, the conditions comprise contacting the substance with the oxidant and polyatomic salt at a temperature of about 20° C. to about 100° C., or about 20° C. to about 80° C., or about 20° C. to about 60° C.; or 20° C. to about 40° C., or 20° C. to about 30° C., or 20° C. to about 25° C.; or at any temperature, or any range of temperatures between about 20° C. and about 100° C.

The reducing agent can be any suitable reducing agent that can reduce leached platinum group metals, such as palladium, platinum, or rhodium, to metal. In an embodiment, the reducing agent comprises, consists essentially of, or consists of inorganic reducing agent. In some embodiments, the inorganic reducing agent comprises, consists essentially of, or consists of H₂, metal powder, metal strips, or a combination thereof. In some embodiments, the metal of the metal powder and/or metal strips comprises Al, Cu, Fe, Zn, or a combination thereof.

The concentration and/or amount of reducing agent used can be selected by a person skilled in the art based at least in part on the leached platinum group metal(s), the amount of metal to be reduced, and/or the reducing agent being used. In some embodiments, the reducing agent is in solution, for example an aqueous solution, and the concentration of the reducing agent in solution is at least 1%, or at least 10%, or at least 20%. In some embodiments, the reducing agent is used neat, and is contacted with the substance at a stoichiometric amount, or a greater than stoichiometric amount.

The conditions to reduce the leached platinum group metals to metal can be selected by a person skilled in the art based at least in part on the platinum group metal(s) to be reduced, and the reducing agent being used. In some embodiments, the conditions comprise contacting the leached platinum group metals with the reducing agent for any amount of time, at any temperature suitable to reduce the leached platinum group metals to metal. In some embodiments, the conditions comprise contacting the leached platinum group metals with the reducing agent for a time of about 0.1 min to about 24 hours, or about 0.1 min to about 12 hours, or about 0.1 min to about 6 hours, or about 0.1 min to about 3, or about 0.1 min to about 2 hours, or about 0.1 min to about 1 hour, or about 0.1 min to about 30 min; or at any time, or any range of time between about 0.1 min and about 24 hours. In some embodiments, the conditions comprise contacting the leached platinum group metals with the reducing agent at a temperature of about 20° C. to about 100° C., about 20° C. to about 90° C., about 20° C. to about 80° C., about 20° C. to about 70° C., about 20° C. to about 60° C., or about 20° C. to about 50° C., 20° C. to about 40° C.; 20° C. to about 30° C., 20° C. to about 25° C.; or at any temperature, or any range of temperatures between about 20° C. and about 100° C.

In some embodiments, the conditions comprise contacting the leached platinum group metals with the reducing agent under ambient pressure; or under pressures of less than 1 atm; or about 1 atm to about 100 atm, or at any pressure between less than 1 atm and about 100 atm.

In some embodiments, the reduced platinum group metals are simultaneously recovered. In some embodiments, the simultaneously recovered platinum group metals have a purity of about 90% to about 100%, or about 95% to about 99.9%, or about 98% to about 99.9%.

In some embodiments of the herein described post-treatment method, where at least palladium metal is recovered from the reduced platinum group metals, the herein described leach mixtures for palladium leaching (e.g., see section IIIA. Methods, Use, Processes of Leaching Palladium) may also be used as a refining mixture for refining the reduced palladium metal. In some embodiments, the refining mixture selectively dissolves the palladium metal from the reduced platinum group metals. In some embodiments, following the refining step, the selectively dissolved palladium is treated using the herein described post-treatment method to reduce the dissolved, refined palladium to palladium metal. In some embodiments, where the palladium has been refined and post-treated, the recovered palladium metal has a purity of about 90% to about 100%, or about 95% to about 99.9%, or about 98% to about 99.9%.

In some embodiments, the post-treatment method further comprises contacting at least the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

In some embodiments, the iodide ligand source comprises NaI, KI, HI, or a combination thereof. In some embodiments, the iodide ligand source is at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M.

In some embodiments, the oxidant comprises H₂O₂, I₂, NaIO₃, FeCl₃, O₂, CuCl₂, bubbled air, or a combination thereof. In some embodiments, the oxidant is at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M.

In some embodiments, the acid catalyst comprises a hydrogen halide, such as HCl or HI, sulfuric acid, or a combination thereof. In some embodiments, the acid catalyst has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M.

In some embodiments, the carboxylic acid stabilizer comprises acetic acid, citric acid, or a combination thereof. In some embodiments, the carboxylic acid stabilizer is at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

In some embodiments, the conditions to refine the palladium metal comprises contacting the palladium metal with the refining mixture for a time of about 0.1 min to about 18 hours, at a temperature of about 20° C. to about 120° C., under ambient pressure. In some embodiments, the conditions comprise a time of about 1 min to about 9 hours, or about 15 min to about 5 hours, or about 30 min to about 2 hours; and a temperature of about 20° C. to about 90° C., or about 20° C. to about 50° C., or about 20° C. to about 25° C.

In some embodiments, following contacting at least the palladium metal with the refining mixture under conditions to refine the palladium metal, the post-treatment method further comprises repeating the post-treatment method on the refined palladium to recover palladium metal.

In some embodiments of the herein described post-treatment method, that may be used to recover platinum group metals leached from a substance comprising platinum group metals following treatment with the herein described methods, uses, and processes and leach mixtures thereof, the simultaneous precipitation of the platinum group metals can occur at a relatively high rate of precipitation; for example, within minutes.

In some embodiments of the herein described post-treatment method, that may be used to recover platinum group metals leached from a substance comprising platinum group metals following treatment with the herein described methods, uses, and processes and leach mixtures thereof, the simultaneous precipitation of the platinum group metals, and thus the simultaneous recovery of the platinum group metals, may be inhibited by higher concentrations of water or aqueous solutions. For example, higher concentrations of water or aqueous solutions in the herein described post-treatment method can reduce the rate of precipitation of at least one platinum group metal relative to the other (e.g., Pd vs Pt), and can thus prevent simultaneous recovery of the platinum group metals. In some embodiments of the herein described post-treatment method, the type and amount of components used is selected to reduce the amount of water introduced into the post-treatment method, where higher concentrations of water may inhibit the simultaneous precipitation of the platinum group metals, and thus the simultaneous recovery of the platinum group metals. In some embodiments, components and amounts of the herein described leach mixtures of herein described methods, uses, and processes are selected to reduce the amount of water introduced into the post-treatment method, where higher concentrations of water may inhibit the simultaneous precipitation of the platinum group metals, and thus the simultaneous recovery of the platinum group metals.

### EXAMPLES

The following non-limiting examples are illustrative of the present disclosure:

### Example 1

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium and platinum content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium and Platinum Extraction from Spent Catalytic Converters

Spent gasoline-based catalytic converter (2 g, in biscuit form) was added to 20 mL glacial acetic acid containing either KI or NaI (0.2 M), and I₂ (0.05 M), and stirred at 200 rpm at room temperature under ambient pressure. After 18 hours, the obtained solution was separated from the treated catalytic converter, and analyzed by AAS to measure its palladium and platinum content.

The reaction was operated at a solid to liquid phase ratio of 1:10. The concentration of the oxidizing agent I₂ was maintained below 0.1 M, as it was observed that concentrations of 0.1 M or higher inhibited the efficiency of the leaching reaction.

Three different types of spent catalytic converters were used: Cat-1 (containing 4228 ppm Pd; 527 ppm Pt), Cat-2 (containing 2265 ppm Pd; 1142 ppm Pt), Cat-3 (containing 7635 ppm Pd; 64 ppm Pt). The treated catalytic converter was rinsed with water, then acetone, and finally dried and treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

Results and Discussion

It was observed that an extraction mixture of the present disclosure comprising glacial acetic acid as the water-miscible organic solvent, NaI or KI as the ligand source, and I₂ as the oxidizing agent could be used in a method of the present disclosure to selectively extract surface palladium from a spent catalytic converter comprising both surface palladium and surface platinum, leaving the surface platinum on the catalytic converter.

Particularly, when the spent catalytic converter was Cat-1, analysis indicated that approximately 1556 ppm Pd and approximately 529 ppm Pt remained on the surface of Cat-1 after approximately 18 hours, resulting in a 100% selectivity for palladium (within experimental error), and an extraction yield of 63.2%. When the spent catalytic converter was Cat-2, analysis indicated that approximately 910 ppm Pd and approximately 1139 ppm Pt remained on the surface of Cat-2 after approximately 18 hours, resulting in a 100% selectivity for palladium (within experimental error). When the spent catalytic converter was Cat-3, analysis indicated that approximately 2840 ppm Pd and approximately 68 ppm Pt remained on the surface of Cat-3 after approximately 18 hours, resulting in a 100% selectivity for palladium (within experimental error).

It was thus observed that an extraction mixture of the present disclosure, used in a method of the present disclosure, selectively leached surface palladium from a spent catalytic converter comprising both surface palladium and surface platinum, to the exclusion of the surface platinum.

Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) can be operated at ambient temperatures and pressures; (iii) provides an ability to be reused multiple times for the leaching of palladium, thereby reducing the amount of waste produced overall when leaching; (v) is stainless-steel compatible; (vi) provides for reduced downstream processing and refining requirements for the recovered Pd; (vii) provides a reduction in the operational and capital expenditures associated with carrying out the leaching (e.g., due to reduced reagent use, reduced chemical waste produced, stainless-steel compatibility, etc.); and (viii), minimizes or avoids the need to further purify the final palladium product (e.g., via separation of palladium from platinum) due to the selectivity for palladium.

### Example 2

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), H₂SO₄ 95% (0.1 M), and I₂ (0.05 M), and stirred at 200 rpm at room temperature under ambient pressure. After 18 hours, the obtained solution was separated from the treated catalytic converter, and analyzed by AAS to measure its palladium content.

The reaction was operated at a solid to liquid phase ratio of 1:10. The concentration of the oxidizing agent I₂ was maintained below 0.1 M, as it was observed that concentrations of 0.1 M or higher inhibited the efficiency of the leaching reaction.

Three different types of spent catalytic converters were used: Cat-1 (containing 4317 ppm Pd, 527 ppm Pt), Cat-2 (containing 2265 ppm Pd, 1142 ppm Pt), Cat-3 (containing 7635 ppm Pd, 64 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted, and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, H₂SO₄, and I₂. A spent catalytic converter (containing 4329 ppm Pd) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, I₂ as the oxidizing agent, and H₂SO₄ as the acid catalyst, could be used in a method of the present disclosure to extract a comparable percentage of surface palladium from a spent catalytic converter relative to an aqua regia extraction mixture.

Particularly, when the spent catalytic converter was Cat-1, analysis indicated that approximately 73.7% of the surface Pd was leached (1135 ppm Pd, 517 ppm Pt remained on the surface of Cat-1), that approximately 68% of the surface Pd was leached in 30 min, and indicated a 100% selectivity for palladium (within experimental error). When the spent catalytic converter was Cat-2, analysis indicated that approximately 64.8% of the surface Pd was (797 ppm Pd, 1122 ppm Pt remained on the surface of Cat-2), and indicated a 100% selectivity for palladium (within experimental error). When the spent catalytic converter was Cat-3, analysis indicated that approximately 71.5% of the surface Pd was leached (2176 ppm Pd, 66 ppm Pt remained on the surface of Cat-3), and indicated a 100% selectivity for palladium (within experimental error).

In contrast, aqua regia extracted 98.8% of the surface Pd within 120 min (52 ppm Pd remained on the surface of the catalytic converter). However, the method and extraction mixture of the present disclosure offers a much more environmentally-friendly, and user-friendly method and extraction mixture relative to aqua regia, while still offering comparable Pd extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium, thereby reducing the amount the operating costs of carrying out the leaching (e.g., in contrast to aqua regia, which is unstable and must be used immediately, and cannot be reused for a second time); (iv) is stainless-steel compatible; (vi) provides a reduction in the capital expenditures associated with carrying out the leaching (e.g., due to reduced reagent use, reduced chemical waste produced, stainless-steel compatibility, etc.); (vii) can be operated at ambient temperatures and pressures.

### Example 3

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), Citric Acid (0.05 M), and I₂ (0.05 M), and stirred at 200 rpm at room temperature under ambient pressure. After 18 hours, the obtained solution was separated from the treated catalytic converter, and analyzed by AAS to measure its palladium content.

The reaction was operated at a solid to liquid phase ratio of 1:10. The concentration of the oxidizing agent I₂ was maintained below 0.1 M, as it was observed that concentrations of 0.1 M or higher inhibited the efficiency of the leaching reaction.

Three different types of spent catalytic converters were used: Cat-1 (containing 4225 ppm Pd, 542 ppm Pt), Cat-2 (containing 2087 ppm Pd, 1169 ppm Pt), Cat-3 (containing 7440 ppm Pd, 63 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, Citric Acid, and I₂. A spent catalytic converter (containing 4133 ppm Pd) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, I₂ as the oxidizing agent, and Citric Acid as the stabilizer, could be used in a method of the present disclosure to extract a comparable percentage of surface palladium from a spent catalytic converter relative to an aqua regia extraction mixture.

Particularly, when the spent catalytic converter was Cat-1, analysis indicated that approximately 81.1% of the surface Pd was leached (798 ppm Pd, 526 ppm Pt remained on the surface of Cat-1), and indicated a 100% selectivity for palladium (within experimental error). When the spent catalytic converter was Cat-2, analysis indicated that approximately 71.8% of the surface Pd was leached (588 ppm Pd, 1177 ppm Pt remained on the surface of Cat-2), and indicated a 100% selectivity for palladium (within experimental error). When the spent catalytic converter was Cat-3, analysis indicated that approximately 80.8% of the surface Pd was leached (1428 ppm Pd, 62 ppm Pt remained on the surface of Cat-3), and indicated a 100% selectivity for palladium (within experimental error).

In contrast, aqua regia extracted 99.1% of the surface Pd within 120 min (37 ppm Pd remained on the surface of the catalytic converter). However, the method and extraction mixture of the present disclosure offers a much more environmentally-friendly, and user-friendly method and extraction mixture relative to aqua regia, while still offering comparable Pd extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium, thereby reducing the amount the operating costs of carrying out the leaching (e.g., in contrast to aqua regia, which is unstable and must be used immediately, and cannot be reused for a second time); (iv) is stainless-steel compatible; (vi) provides a reduction in the capital expenditures associated with carrying out the leaching (e.g., due to reduced reagent use, reduced chemical waste produced, stainless-steel compatibility, etc.); (vii) can be operated at ambient temperatures and pressures.

### Example 4

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), HCl 37% (0.1 M), and I₂ (0.05 M), and stirred at 200 rpm at room temperature under ambient pressure. Palladium content was measured every 2 min until 50% extraction was observed, which was after 9 min, following which the obtained solution was separated from the treated catalytic converter, and analyzed by AAS to measure its palladium content.

The reaction was operated at a solid to liquid phase ratio of 1:10. The concentration of the oxidizing agent I₂ was maintained below 0.1 M, as it was observed that concentrations of 0.1 M or higher inhibited the kinetics and efficiency of the leaching reaction.

Three different types of spent catalytic converters were used: Cat-1 (containing 4228 ppm Pd, 535 ppm Pt), Cat-2 (containing 2265 ppm Pd, 1208 ppm Pt), Cat-3 (containing 7635 ppm Pd, 59 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, and I₂. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, I₂ as the oxidizing agent, and HCl as the acid catalyst, could be used in a method of the present disclosure to extract approximately 50% of surface palladium from a spent catalytic converter in only 9 min. In contrast, it took 80 min for an aqua regia extraction mixture to do the same.

Particularly, when the spent catalytic converter was Cat-1, analysis indicated that approximately 50.1% of the surface Pd was leached within 9 min (2109 ppm Pd, 563 ppm Pt remained on the surface of Cat-1), and indicated a 100% selectivity for palladium (within experimental error). When the spent catalytic converter was Cat-2, analysis indicated that approximately 49.8% of the surface Pd was leached within 9 min (1137 ppm Pd, 1199 ppm Pt remained on the surface of Cat-2), that approximately 88.2% of the surface Pd was leached in 18 hours, and indicated a 100% selectivity for palladium (within experimental error). When the spent catalytic converter was Cat-3, analysis indicated that approximately 47.3% of the surface Pd was leached within 9 min (4023 ppm Pd, 61 ppm Pt remained on the surface of Cat-3), and indicated a 100% selectivity for palladium (within experimental error).

It was thus observed that an extraction mixture of the present disclosure, used in a method of the present disclosure, leached surface palladium from a spent catalytic converter nearly an order of magnitude faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) provides a safer and less toxic chemistry relative to the aqua regia extraction mixture (e.g., see the Background); (iii) can be operated at ambient temperatures and pressures; (iv) provides an ability to be reused multiple times for the leaching of palladium, thereby reducing the amount of waste produced overall when leaching; (v) is stainless-steel compatible; (vi) does not require any pre-processing of the catalytic converter prior to leaching (e.g., catalytic converter can be leached in biscuit form); and (vii) provides a reduction in the operational and capital expenditures associated with carrying out the leaching (e.g., due to reduced reagent use, reduced chemical waste produced, stainless-steel compatibility, etc.).

### Example 5

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), HCl 37% (0.1 M), Citric Acid (0.05M), and I₂ (0.05 M), and stirred at 200 rpm at room temperature under ambient pressure. Palladium content was measured every 2 min until 50% extraction was observed, which was after 3 min, following which the obtained solution was separated from the treated catalytic converter, and analyzed by AAS to measure its palladium content.

The reaction was operated at a solid to liquid phase ratio of 1:10. The concentration of the oxidizing agent I₂ was maintained below 0.1 M, as it was observed that concentrations of 0.1 M or higher inhibited the kinetics and efficiency of the leaching reaction.

Three different types of spent catalytic converters were used: Cat-1 (containing 4118 ppm Pd), Cat-2 (containing 2337 ppm Pd), Cat-3 (containing 7645 ppm Pd). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, Citric Acid, and I₂. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, I₂ as the oxidizing agent, Citric Acid as the stabilizer, and HCl as the acid catalyst, could be used in a method of the present disclosure to extract approximately 50% of surface palladium from a spent catalytic converter in only 3 min. In contrast, it took 80 min for an aqua regia extraction mixture to do the same.

Particularly, when the spent catalytic converter was Cat-1, analysis indicated that approximately 51.0% of the surface Pd was leached within 3 min (2017 ppm Pd remained on the surface of Cat-1). When the spent catalytic converter was Cat-2, analysis indicated that approximately 50.5% of the surface Pd was leached within 3 min (1156 ppm Pd remained on the surface of Cat-2), that approximately 91.7% of the surface Pd was leached in 30 min, and that approximately 99.6% of the surface Pd was leached in 50 min. When the spent catalytic converter was Cat-3, analysis indicated that approximately 50.3% of the surface Pd was leached within 3 min (3799 ppm Pd remained on the surface of Cat-3).

It was thus observed that an extraction mixture of the present disclosure, used in a method of the present disclosure, leached surface palladium from a spent catalytic converter an order of magnitude faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) provides a safer and less toxic chemistry relative to the aqua regia extraction mixture (e.g., see the Background); (iii) can be operated at ambient temperatures and pressures; (iv) provides an ability to be reused multiple times for the leaching of palladium, thereby reducing the amount of waste produced overall when leaching; (v) is stainless-steel compatible; (vi) does not require any pre-processing of the catalytic converter prior to leaching (e.g., catalytic converter can be leached in biscuit form); and (vii) provides a reduction in the operational and capital expenditures associated with carrying out the leaching (e.g., due to reduced reagent use, reduced chemical waste produced, stainless-steel compatibility, etc.).

### Example 6

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), HCl 37% (0.2 M), and H₂O₂ (0.01 M), and stirred at 200 rpm at room temperature under ambient pressure. The reaction was operated at a solid to liquid phase ratio of 1:10. Palladium content was measured every 2 min until 50% extraction was observed, which was after 13 min, following which the obtained solution was separated from the treated catalytic converter, and analyzed by AAS to measure its palladium content.

Three different types of spent catalytic converters were used: Cat-1 (containing 4098 ppm Pd), Cat-2 (containing 2188 ppm Pd), Cat-3 (containing 7214 ppm Pd). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, and H₂O₂. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, H₂O₂ as the oxidizing agent, and HCl as the acid catalyst, could be used in a method of the present disclosure to extract approximately 50% of surface palladium from a spent catalytic converter in only 13 min. In contrast, it took 80 min for an aqua regia extraction mixture to do the same.

Particularly, when the spent catalytic converter was Cat-1, analysis indicated that approximately 49.1% of the surface Pd was leached within 13 min (2086 ppm Pd remained on the surface of Cat-1). When the spent catalytic converter was Cat-2, analysis indicated that approximately 47.8% of the surface Pd was leached within 13 min (1142 ppm Pd remained on the surface of Cat-2), that approximately 79.5% of the surface Pd was leached in 30 min, and that approximately 93.2% of the surface Pd was leached in 18 hours. When the spent catalytic converter was Cat-3, analysis indicated that approximately 49.9% of the surface Pd was leached within 13 min (3614 ppm Pd remained on the surface of Cat-3).

It was thus observed that an extraction mixture of the present disclosure, used in a method of the present disclosure, leached surface palladium from a spent catalytic converter nearly an order of magnitude faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient temperatures and pressures; (iii) provides an ability to be reused multiple times for the leaching of palladium; (iv) is stainless-steel compatible; (v) does not require any pre-processing of the catalytic converter prior to leaching (e.g., catalytic converter can be leached in biscuit form); and (vi) provides a reduction in the operational and capital expenditures associated with carrying out the leaching (e.g., due to reduced reagent use, reduced chemical waste produced, stainless-steel compatibility, etc.).

### Example 7

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), FeCl₃ (0.02 M), and HCl (0.5 M), and stirred at 200 rpm at room temperature under ambient pressure. The reaction was operated at a solid to liquid phase ratio of 1:10. After 18 hours, the obtained solution was separated from the treated catalytic converter, and analyzed by AAS to measure its palladium content.

Three different types of spent catalytic converters were used: Cat-1 (containing 4310 ppm Pd, 543 ppm Pt), Cat-2 (containing 2301 ppm Pd, 1126 ppm Pt), Cat-3 (containing 7102 ppm Pd, 67 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, and FeCl₃. A spent catalytic converter (containing 4451 ppm Pd) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, FeCl₃ as the oxidizing agent, and HCl as the acid catalyst, could be used in a method of the present disclosure to extract a comparable percentage of surface palladium from a spent catalytic converter relative to an aqua regia extraction mixture.

Particularly, when the spent catalytic converter was Cat-1, analysis indicated that approximately 72.2% of the surface Pd was leached (1198 ppm Pd, 543 ppm Pt remained on the surface of Cat-1), and indicated a 100% selectivity for palladium (within experimental error). When the spent catalytic converter was Cat-2, analysis indicated that approximately 69.5% of the surface Pd was (702 ppm Pd remained, 1109 ppm Pt on the surface of Cat-2), and indicated a 100% selectivity for palladium (within experimental error). When the spent catalytic converter was Cat-3, analysis indicated that approximately 68.8% of the surface Pd was leached (2215 ppm Pd, 71 ppm Pt remained on the surface of Cat-3), and indicated a 100% selectivity for palladium (within experimental error).

In contrast, aqua regia extracted 97.9% of the surface Pd within 120 min (93 ppm Pd remained on the surface of the catalytic converter). However, the method and extraction mixture of the present disclosure offers a much more environmentally-friendly, and user-friendly method and extraction mixture relative to aqua regia, while still offering comparable Pd extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium, thereby reducing the amount the operating costs of carrying out the leaching (e.g., in contrast to aqua regia, which is unstable and must be used immediately, and cannot be reused for a second time); (iv) is stainless-steel compatible; (vi) provides a reduction in the capital expenditures associated with carrying out the leaching (e.g., due to reduced reagent use, reduced chemical waste produced, stainless-steel compatibility, etc.); (vii) can be operated at ambient temperatures and pressures.

### Example 8

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), HCl 37% (0.5 M), and CuCl₂ (0.02 M), and stirred at 200 rpm at room temperature under ambient pressure. The reaction was operated at a solid to liquid phase ratio of 1:10. Palladium content was measured every 2 min until 50% extraction was observed, which was after 6 min, following which the obtained solution was separated from the treated catalytic converter, and analyzed by AAS to measure its palladium content.

Three different types of spent catalytic converters were used: Cat-1 (containing 4339 ppm Pd), Cat-2 (containing 2227 ppm Pd), Cat-3 (containing 7298 ppm Pd). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, and CuCl₂. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, CuCl₂ as the oxidizing agent, and HCl as the acid catalyst, could be used in a method of the present disclosure to extract approximately 50% of surface palladium from a spent catalytic converter in only 6 min. In contrast, it took 80 min for an aqua regia extraction mixture to do the same.

Particularly, when the spent catalytic converter was Cat-1, analysis indicated that approximately 50.2% of the surface Pd was leached within 6 min (2161 ppm Pd remained on the surface of Cat-1), that approximately 81.5% of the surface Pd was leached in 30 min, and that approximately 92.2% of the surface Pd was leached in 18 hours. When the spent catalytic converter was Cat-2, analysis indicated that approximately 48.8% of the surface Pd was leached within 6 min (1087 ppm Pd remained on the surface of Cat-2). When the spent catalytic converter was Cat-3, analysis indicated that approximately 46.3% of the surface Pd was leached within 6 min (3919 ppm Pd remained on the surface of Cat-3).

It was thus observed that an extraction mixture of the present disclosure, used in a method of the present disclosure, leached surface palladium from a spent catalytic converter an order of magnitude faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) provides a safer and less toxic chemistry relative to the aqua regia extraction mixture (e.g., see the Background); (iii) can be operated at ambient temperatures and pressures; (iv) provides an ability to be reused multiple times for the leaching of palladium; (v) is stainless-steel compatible; and (vi) provides a reduction in the operational and capital expenditures associated with carrying out the leaching (e.g., due to reduced reagent use, reduced chemical waste produced, stainless-steel compatibility, etc.).

### Example 9

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium Extraction from Spent Catalytic Converters

Spent gasoline-based catalytic converter (2 g, in biscuit form) was added to 20 mL glacial acetic acid containing either KI or NaI (0.2 M), HCl 37% (0.1 M), and O₂ (from air), and stirred at 200 rpm at room temperature under ambient pressure. The reaction was operated at a solid to liquid phase ratio of 1:10. Palladium content was measured every 2 min until 50% extraction was observed, which was after 15 min, following which the obtained solution was separated from the treated catalytic converter, and analyzed by AAS to measure its palladium content.

Three different types of spent catalytic converters were used: Cat-1 (containing 4186 ppm Pd), Cat-2 (containing 2272 ppm Pd), Cat-3 (containing 7566 ppm Pd). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing KI or NaI, HCl, and O₂ (from air). Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium content.

Results and Discussion

It was observed that an extraction mixture of the present disclosure comprising glacial acetic acid as the water-miscible organic solvent, NaI or KI as the ligand source, O₂ (from air) as the oxidizing agent, and HCl as the acid catalyst, could be used in a method of the present disclosure to extract approximately 50% of surface palladium from a spent catalytic converter in only 15 min. In contrast, it took 80 min for an aqua regia extraction mixture to do the same.

Particularly, when the spent catalytic converter was Cat-1, analysis indicated that approximately 52.1% of the surface Pd was leached within 15 min (2005 ppm Pd remained on the surface of Cat-1). When the spent catalytic converter was Cat-2, analysis indicated that approximately 47.8% of the surface Pd was leached within 15 min (1186 ppm Pd remained on the surface of Cat-2). When the spent catalytic converter was Cat-3, analysis indicated that approximately 55.3% of the surface Pd was leached within 15 min (3382 ppm Pd remained on the surface of Cat-3), that approximately 89.9% of the surface Pd was leached in 30 min; and that approximately 99.9% of the surface Pd was leached in 50 min.

It was thus observed that an extraction mixture of the present disclosure, used in a method of the present disclosure, leached surface palladium from a spent catalytic converter nearly an order of magnitude faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) provides a safer and less toxic chemistry relative to the aqua regia extraction mixture (e.g., see the Background); (iii) can be operated at ambient temperatures and pressures; (iv) provides an ability to be reused multiple times for the leaching of palladium; (v) is stainless-steel compatible; (vi) does not require any pre-processing of the catalytic converter prior to leaching (e.g., catalytic converter can be leached in biscuit form); and (vii) provides a reduction in the operational and capital expenditures associated with carrying out the leaching (e.g., due to reduced reagent use, reduced chemical waste produced, stainless-steel compatibility, etc.).

### Example 10

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd solutions (1 ppm, 5 ppm, 10 ppm) were prepared from a commercial standard (1000 ppm Pd, purchased from SCP Science, Quebec). The digested metals in both aqua regia and studied solutions were analysed with the machine after proper dilution (diluted between >1 ppm to <10 ppm Pd). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Spent Catalytic Converters

Spent gasoline-based catalytic converter (2 g, in biscuit form) was added to 20 mL glacial acetic acid including appropriate amounts of ligand, oxidant, and stabilizer and/or acid catalyst, and stirred at 200 rpm for an appropriate time period at room temperature under ambient pressure. After completion of the reaction, the obtained solution was separated from the treated catalytic converter, and analyzed by AAS to measure its palladium and platinum content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium and Platinum Extraction from Spent Catalytic Converters

Spent gasoline-based catalytic converter (2 g, in biscuit form) was added to 20 mL glacial acetic acid containing either KI or NaI (0.2 M), HCl 37% (0.5 M), and NaIO₃ (0.02 M), and stirred at 200 rpm at room temperature under ambient pressure. The reaction was operated at a solid to liquid phase ratio of 1:10. After 30 min, the obtained solution was separated from the treated catalytic converter, and analyzed by AAS to measure its palladium and platinum content. In some instances, samples of the obtained solution was separated from the treated catalytic converter after 30 min and then again after 18 hours (overnight), and analyzed by AAS to measure its palladium and platinum content.

Three different types of spent catalytic converters were used: Cat-1 (containing 4145 ppm Pd; 503 ppm Pt), Cat-2 (containing 2108 ppm Pd; 1149 ppm Pt), Cat-3 (containing 7722 ppm Pd; 56 ppm Pt). The treated catalytic converter was rinsed with water, then acetone, and finally dried and ground to a fine powder. The obtained powder was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

Results and Discussion

It was observed that an extraction mixture of the present disclosure comprising glacial acetic acid as the water-miscible organic solvent, NaI or KI as the ligand source, NaIO₃ as the oxidizing agent, and HCl as the acid catalyst, could be used in a method of the present disclosure to selectively extract surface palladium from a spent catalytic converter comprising both surface palladium and surface platinum, leaving the surface platinum on the catalytic converter.

Particularly, when the spent catalytic converter was Cat-1, analysis indicated that approximately 2159 ppm Pd and approximately 504 ppm Pt remained on the surface of Cat-1 after 30 min, resulting in a 100% selectivity for palladium (within experimental error). When the spent catalytic converter was Cat-2, analysis indicated that approximately 1239 ppm Pd and approximately 1146 ppm Pt remained on the surface of Cat-2 after 30 min, resulting in a 100% selectivity for palladium (within experimental error). When the spent catalytic converter was Cat-3, analysis indicated that approximately 3992 ppm Pd and approximately 55 ppm Pt remained on the surface of Cat-3 after 30 min, resulting in a 100% selectivity for palladium (within experimental error).

Further, for samples of the obtained solution separated from the treated catalytic converter after 18 hours (overnight), and analyzed by AAS to measure its palladium and platinum content (see above), no platinum content was detected.

It was thus observed that an extraction mixture of the present disclosure, used in a method of the present disclosure, selectively leached surface palladium from a spent catalytic converter comprising both surface palladium and surface platinum, to the exclusion of the surface platinum

Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) can be operated at ambient temperatures and pressures; (iii) provides an ability to be reused multiple times for the leaching of palladium, thereby reducing the amount of waste produced overall when leaching; (v) is stainless-steel compatible; (vi) does not require any pre-processing of the catalytic converter prior to leaching (e.g., catalytic converter can be leached in biscuit form); (vii) provides a reduction in the operational and capital expenditures associated with carrying out the leaching (e.g., due to reduced reagent use, reduced chemical waste produced, stainless-steel compatibility, etc.); and (viii), minimizes or avoids the need to further purify the final palladium product (e.g., via separation of palladium from platinum) due to the selectivity for palladium.

### Example 11

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Intact Spent Catalytic Converters

Spent gasoline-based catalytic converter (2 g, in biscuit form) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content, base metal and/or ferrous metal content, and aluminum oxide content. The treated catalytic converter was rinsed with water, dried, and then treated with 40 mL hot aqua regia (90° C.) for 120 min to complete dissolution of the remaining metals/oxides. The obtained aqua regia solution was diluted and analysed with AAS.

Experimental for Palladium/Platinum Extraction from Intact Spent Catalytic Converters

Spent gasoline-based catalytic converter (2 g, in biscuit form) was added to 20 mL glacial acetic acid containing AlCl₃ (0.1 M), HCl 37% (0.2 M), and FeCl₃ (0.1 M), and stirred at 200 rpm at a temperature of 60° C. under ambient pressure. The reaction was operated at a solid to liquid phase ratio of 1:10. After 2 hours, the obtained solution was separated from the treated catalytic converter, and analyzed by AAS to measure its palladium/platinum, and aluminum oxide content.

Three different types of spent catalytic converters were used: Cat-1 (containing 4320 ppm Pd, 601 ppm Pt, 422000 ppm aluminum oxide), Cat-2 (containing 2085 ppm Pd, 1328 ppm Pt, 416800 ppm aluminum oxide), Cat-3 (containing 7318 ppm Pd, 67 ppm Pt, 438900 ppm aluminum oxide). The treated catalytic converter was rinsed with water, then acetone, and finally dried. The treated catalytic converter was then treated with 40 mL hot aqua regia (90° C.) for 120 min to complete dissolution of the remaining metals/oxides. The obtained aqua regia solution was diluted and analysed with AAS. Additionally, some samples were sent for ICP analysis to confirm the AAS analysis.

Results and Discussion

It was observed that an extraction mixture of the present disclosure comprising glacial acetic acid as the water-miscible organic solvent, AlCl₃ as the ligand source, FeCl₃ as the oxidizing agent, and HCl as the acid catalyst could be used in a method of the present disclosure to simultaneously and selectively extract surface palladium/platinum from a spent catalytic converter comprising surface palladium/platinum, and aluminum oxide, leaving the aluminum oxide in or on the catalytic converter.

Particularly, when the spent catalytic converter was Cat-1, analysis indicated that approximately 1421 ppm Pd, approximately 507 ppm Pt, approximately 421480 ppm aluminum oxide remained on the surface of, or within Cat-1 after approximately 2 hours, resulting in a selective and simultaneous extraction of surface palladium/platinum (within experimental error). When the spent catalytic converter was Cat-2, analysis indicated that approximately 690 ppm Pd, approximately 119 ppm Pt, approximately and approximately 415782 ppm aluminum oxide remained on the surface of, or within Cat-2 after approximately 2 hours, resulting in a selective and simultaneous extraction of surface palladium/platinum (within experimental error). When the spent catalytic converter was Cat-3, analysis indicated that approximately 2473 ppm Pd, approximately 56 ppm Pt, and approximately 437821 ppm aluminum oxide remained on the surface of, or within Cat-3 after approximately 2 hours, resulting in a selective and simultaneous extraction of surface palladium/platinum (within experimental error).

It was thus observed that an extraction mixture of the present disclosure, used in a method of the present disclosure, simultaneously and selectively leached surface palladium/platinum from a spent catalytic converter comprising surface palladium/platinum, and aluminum oxide, to the exclusion of the aluminum oxide.

Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) can be operated at ambient pressures; (iii) provides an ability to be reused multiple times for the leaching of palladium/platinum, thereby reducing the amount of waste produced overall when leaching; (v) is stainless-steel compatible; (vi) provides for reduced downstream processing and refining requirements for the recovered Pd/Pt; (vii) provides a reduction in the operational and capital expenditures associated with carrying out the leaching (e.g., due to reduced reagent use, reduced chemical waste produced, stainless-steel compatibility, etc.); (viii) minimizes or avoids the need to further purify the final palladium/platinum product (e.g., via separation of said metals from aluminum oxide) due to the selectivity for palladium/platinum; (ix) minimizes or avoids the need for multistage recovery processes given that the palladium/platinum are simultaneously leached; and (x) does not require any pre-processing of the catalytic converter prior to leaching (e.g., catalytic converter can be leached in biscuit form).

### Example 12

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Intact Spent Catalytic Converters

Spent gasoline-based catalytic converter (2 g, in biscuit form) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium/Platinum Extraction from Intact Spent Catalytic Converters

Spent gasoline-based catalytic converter (2 g, in biscuit form) was added to 20 mL glacial acetic acid containing AlCl₃ (0.1 M), H₂O₂ (0.1 M), and HCl 37% (0.2 M), and stirred at 200 rpm at a temperature of 60° C. under ambient pressure. The reaction was operated at a solid to liquid phase ratio of 1:10. After 2 hours, the obtained solution was separated from the treated catalytic converter, and analyzed by AAS to measure its palladium/platinum content.

Three different types of spent catalytic converters were used: Cat-1 (containing 4289 ppm Pd, 529 ppm Pt), Cat-2 (containing 2195 ppm Pd, 1183 ppm Pt), Cat-3 (containing 7545 ppm Pd, 65 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing AlCl₃, HCl, and H₂O₂. A spent catalytic converter (containing 4321 ppm Pd, 561 ppm Pt) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium/platinum content.

Results and Discussion

It was observed that an extraction mixture of the present disclosure comprising glacial acetic acid as the water-miscible organic solvent, AlCl₃ as the ligand source, H₂O₂ as the oxidizing agent, and HCl as the acid catalyst, could be used in a method of the present disclosure to extract a comparable percentage of surface palladium and/or platinum from a spent catalytic converter relative to an aqua regia extraction mixture.

Particularly, when the spent catalytic converter was Cat-1, analysis indicated that approximately 65.2% of the surface Pd was leached (1492 ppm Pd remained on the surface of Cat-1), 15.5% of the surface Pt was leached (447 ppm Pt remained on the surface of Cat-1). When the spent catalytic converter was Cat-2, analysis indicated that approximately 67.1% of the surface Pd was leached (722 ppm Pd remained on the surface of Cat-2), 15.6% of the surface Pt was leached (997 ppm Pt remained on the surface of Cat-2). When the spent catalytic converter was Cat-3, analysis indicated that approximately 66.8% of the surface Pd was leached (2505 ppm Pd remained on the surface of Cat-3), 15.7% of the surface Pt was leached (54 ppm Pt remained on the surface of Cat-3).

In contrast, within 120 min, aqua regia extracted 98.1% of the surface Pd (82 ppm Pd remained on the surface of the catalytic converter), 98.8% of the surface Pt was extracted (7 ppm Pt remained on the surface of the catalytic converter). However, the method and extraction mixture of the present disclosure offers a much more environmentally-friendly, and user-friendly method and extraction mixture relative to aqua regia, while still offering comparable Pd and/or Pt extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium/platinum, thereby reducing the amount the operating costs of carrying out the leaching (e.g., in contrast to aqua regia, which is unstable and must be used immediately, and cannot be reused for a second time); (iv) is stainless-steel compatible; (v) provides a reduction in the capital expenditures associated with carrying out the leaching (e.g., due to reduced reagent use, reduced chemical waste produced, stainless-steel compatibility, etc.); (vi) can be operated at ambient pressures; and (vii) is tolerant of greater than or equal to 10 wt % water, e.g., 30 wt %.

### Example 13

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Intact Spent Catalytic Converters

Spent gasoline-based catalytic converter (2 g, in biscuit form) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content, base metal and/or ferrous metal content, and aluminum oxide content. The treated catalytic converter was rinsed with water, dried, and then treated with 40 mL hot aqua regia (90° C.) for 120 min to complete dissolution of the remaining metals/oxides. The obtained aqua regia solution was diluted and analysed with AAS.

Experimental for Palladium/Platinum Extraction from Intact Spent Catalytic Converters

Spent gasoline-based catalytic converter (2 g, in biscuit form) was added to 20 mL glacial acetic acid containing HCl 37% (0.5 M), and FeCl₃ (0.1 M), and stirred at 200 rpm at a temperature of 60° C. under ambient pressure. The reaction was operated at a solid to liquid phase ratio of 1:10. After 2 hours, the obtained solution was separated from the treated catalytic converter, and analyzed by AAS to measure its palladium/platinum and aluminum oxide content.

Three different types of spent catalytic converters were used: Cat-1 (containing 4188 ppm Pd, 522 ppm Pt, 421970 ppm aluminum oxide), Cat-2 (containing 2232 ppm Pd, 1405 ppm Pt, 408300 ppm aluminum oxide), Cat-3 (containing 6973 ppm Pd, 59 ppm Pt, 433720 ppm aluminum oxide). The treated catalytic converter was rinsed with water, then acetone, and finally dried. The treated catalytic converter was then treated with 40 mL hot aqua regia (90° C.) for 120 min to complete dissolution of the remaining metals/oxides. The obtained aqua regia solution was diluted and analysed with AAS. Additionally, some samples were sent for ICP analysis to confirm the AAS analysis.

Results and Discussion

It was observed that an extraction mixture of the present disclosure comprising glacial acetic acid as the water-miscible organic solvent, FeCl₃ as the oxidizing agent, and HCl as the acid catalyst and ligand source could be used in a method of the present disclosure to simultaneously and selectively extract surface palladium/platinum from a spent catalytic converter comprising surface palladium/platinum, and aluminum oxide, leaving the aluminum oxide in or on the catalytic converter.

Particularly, when the spent catalytic converter was Cat-1, analysis indicated that approximately 1294 ppm Pd, approximately 438 ppm Pt, and approximately 421821 ppm aluminum oxide remained on the surface of, or within Cat-1 after approximately 2 hours, resulting in a selective and simultaneous extraction of surface palladium/platinum (within experimental error). When the spent catalytic converter was Cat-2, analysis indicated that approximately 710 ppm Pd, approximately 1181 ppm Pt, and approximately 407081 ppm aluminum oxide remained on the surface of, or within Cat-2 after approximately 2 hours, resulting in a selective and simultaneous extraction of surface palladium/platinum (within experimental error). When the spent catalytic converter was Cat-3, analysis indicated that approximately 2161 ppm Pd, approximately 50 ppm Pt, and approximately 432615 ppm aluminum oxide remained on the surface of, or within Cat-3 after approximately 2 hours, resulting in a selective and simultaneous extraction of surface palladium/platinum (within experimental error).

It was thus observed that an extraction mixture of the present disclosure, used in a method of the present disclosure, simultaneously and selectively leached surface palladium/platinum from a spent catalytic converter comprising surface palladium/platinum, and aluminum oxide, to the exclusion of the aluminum oxide.

Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) can be operated at ambient pressures; (iii) provides an ability to be reused multiple times for the leaching of palladium/platinum, thereby reducing the amount of waste produced overall when leaching; (v) is stainless-steel compatible; (vi) provides for reduced downstream processing and refining requirements for the recovered Pd/Pt; (vii) provides a reduction in the operational and capital expenditures associated with carrying out the leaching (e.g., due to reduced reagent use, reduced chemical waste produced, stainless-steel compatibility, etc.); (viii) minimizes or avoids the need to further purify the final palladium/platinum product (e.g., via separation of said metals from aluminum oxide) due to the selectivity for palladium/platinum; (ix) minimizes or avoids the need for multistage recovery processes given that the palladium/platinum are simultaneously leached; and (x) does not require any pre-processing of the catalytic converter prior to leaching (e.g., catalytic converter can be leached in biscuit form).

### Example 14

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Intact Spent Catalytic Converters

Spent gasoline-based catalytic converter (2 g, in biscuit form) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium/Platinum/Extraction from Intact Spent Catalytic Converters

Spent gasoline-based catalytic converter (2 g, in biscuit form) was added to 20 mL glacial acetic acid containing CuCl₂ (0.1 M), and HCl 37% (0.5 M), and stirred at 200 rpm at a temperature of 60° C. under ambient pressure. The reaction was operated at a solid to liquid phase ratio of 1:10. After 2 hours, the obtained solution was separated from the treated catalytic converter, and analyzed by AAS to measure its palladium/platinum content.

Three different types of spent catalytic converters were used: Cat-1 (containing 4175 ppm Pd, 511 ppm Pt), Cat-2 (containing 2198 ppm Pd, 1224 ppm Pt), Cat-3 (containing 7284 ppm Pd, 72 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing HCl, and CuCl₂. A spent catalytic converter (containing 4318 ppm Pd, 493 ppm Pt) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium/platinum/content.

Results and Discussion

It was observed that an extraction mixture of the present disclosure comprising glacial acetic acid as the water-miscible organic solvent, CuCl₂ as the oxidizing agent, and HCl as the acid catalyst and ligand source, could be used in a method of the present disclosure to extract a comparable percentage of surface palladium and/or platinum from a spent catalytic converter relative to an aqua regia extraction mixture.

Particularly, when the spent catalytic converter was Cat-1, analysis indicated that approximately 89.1% of the surface Pd was leached (455 ppm Pd remained on the surface of Cat-1), 39.2% of the surface Pt was leached (311 ppm Pt remained on the surface of Cat-1). When the spent catalytic converter was Cat-2, analysis indicated that approximately 88.7% of the surface Pd was leached (248 ppm Pd remained on the surface of Cat-2), 39.3% of the surface Pt was leached (743 ppm Pt remained on the surface of Cat-2). When the spent catalytic converter was Cat-3, analysis indicated that approximately 86.4% of the surface Pd was leached (990 ppm Pd remained on the surface of Cat-3), 37.7% of the surface Pt was leached (45 ppm Pt remained on the surface of Cat-3).

In contrast, within 120 min, aqua regia extracted 97.9% of the surface Pd (91 ppm Pd remained on the surface of the catalytic converter), and 96.4% of the surface Pt was extracted (18 ppm Pt remained on the surface of the catalytic converter). However, the method and extraction mixture of the present disclosure offers a much more environmentally-friendly, and user-friendly method and extraction mixture relative to aqua regia, while still offering comparable Pd and/or Pt extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium/platinum, thereby reducing the amount the operating costs of carrying out the leaching (e.g., in contrast to aqua regia, which is unstable and must be used immediately, and cannot be reused for a second time); (iv) is stainless-steel compatible; (v) provides a reduction in the capital expenditures associated with carrying out the leaching (e.g., due to reduced reagent use, reduced chemical waste produced, stainless-steel compatibility, etc.); (vi) can be operated at ambient pressures; and (vii) is tolerant of greater than or equal to 10 wt % water, e.g., 30 wt %.

### Example 15

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Intact Spent Catalytic Converters

Spent gasoline-based catalytic converter (2 g, in biscuit form) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium/Platinum Extraction from Intact Spent Catalytic Converters

Spent gasoline-based catalytic converter (2 g, in biscuit form) was added to 20 mL glacial acetic acid containing CaCl₂ (0.1 M), CuCl₂ (0.05 M), and HCl 37% (0.2 M), and stirred at 200 rpm at a temperature of 60° C. under ambient pressure. The reaction was operated at a solid to liquid phase ratio of 1:10. After 2 hours, the obtained solution was separated from the treated catalytic converter, and analyzed by AAS to measure its palladium/platinum content.

Three different types of spent catalytic converters were used: Cat-1 (containing 4366 ppm Pd, 588 ppm Pt), Cat-2 (containing 2099 ppm Pd, 1288 ppm Pt), Cat-3 (containing 7287 ppm Pd, 66 ppm Pt). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing CaCl₂, HCl, and CuCl₂. A spent catalytic converter (containing 7330 ppm Pd, 58 ppm Pt) was treated with aqua regia for 120 min. Particularly, the spent gasoline-based catalytic converter (2 g, in biscuit form) was added to 40 mL aqua regia (30 mL of HCl, 37%; and 10 ml of HNO₃, 68%) and stirred at 200 rpm at 85° C. under ambient pressure. After 2 hours, the obtained solution was separated from the treated catalytic converter, and analyzed by AAS to measure its palladium/platinum/content.

Results and Discussion

It was observed that an extraction mixture of the present disclosure comprising glacial acetic acid as the water-miscible organic solvent, CaCl₂ as the ligand source, CuCl₂ as the oxidizing agent, and HCl as the acid catalyst, could be used in a method of the present disclosure to extract a comparable percentage of surface palladium and/or platinum from a spent catalytic converter relative to an aqua regia extraction mixture.

Particularly, when the spent catalytic converter was Cat-1, analysis indicated that approximately 91.9% of the surface Pd was leached (423 ppm Pd remained on the surface of Cat-1), 56.1% of the surface Pt was leached (258 ppm Pt remained on the surface of Cat-1). When the spent catalytic converter was Cat-2, analysis indicated that approximately 90.3% of the surface Pd was leached (204 ppm Pd remained on the surface of Cat-2), 56.2% of the surface Pt was leached (564 ppm Pt remained on the surface of Cat-2). When the spent catalytic converter was Cat-3, analysis indicated that approximately 92.1% of the surface Pd was leached (576 ppm Pd remained on the surface of Cat-3), 55.4% of the surface Pt was leached (29 ppm Pt remained on the surface of Cat-3).

In contrast, within 120 min, aqua regia extracted 99.2% of the surface Pd (59 ppm Pd remained on the surface of the catalytic converter), 97.1% of the surface Pt was extracted (2 ppm Pt remained on the surface of the catalytic converter). However, the method and extraction mixture of the present disclosure offers a much more environmentally-friendly, and user-friendly method and extraction mixture relative to aqua regia, while still offering comparable Pd and/or Pt extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(|)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium/platinum, thereby reducing the amount the operating costs of carrying out the leaching (e.g., in contrast to aqua regia, which is unstable and must be used immediately, and cannot be reused for a second time); (iv) is stainless-steel compatible; (v) provides a reduction in the capital expenditures associated with carrying out the leaching (e.g., due to reduced reagent use, reduced chemical waste produced, stainless-steel compatibility, etc.); (vi) can be operated at ambient pressures; and (vii) is tolerant of greater than or equal to 10 wt % water, e.g., 30 wt %.

### Example 16

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and HNO₃ 68% (0.05 M), and stirred at 200 rpm at a temperature of 85° C.-90° C. under ambient pressure. The reaction was operated at a solid to liquid phase ratio of 1:10. Palladium/platinum/rhodium content was measured every 2 min until 50% extraction of palladium/platinum/rhodium was observed, which was after 12 min (Pd), 21 min (Pt), and 19 min (Rh), following which the obtained solution was separated from the treated catalytic converter, and analyzed by AAS to measure its palladium/platinum/rhodium content.

Three different types of spent catalytic converters were used: Cat-1 (containing 4133 ppm Pd, 524 ppm Pt, 74 ppm Rh), Cat-2 (containing 2243 ppm Pd, 1378 ppm Pt, 122 ppm Rh), Cat-3 (containing 7235 ppm Pd, 59 ppm Pt, 148 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for Fire assay analysis to confirm the AAS analysis.

A similar procedure was repeated using aqua regia as an extraction mixture, in place of the extraction mixture of glacial acetic acid containing CaCl₂, HCl, and HNO₃ at a temperature of 85° C.-90° C. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content. The treated catalytic converter was also sent for Fire assay analysis to measure the remaining Pd/Pt/Rh.

Results and Discussion

It was observed that an extraction mixture of the present disclosure comprising glacial acetic acid as the water-miscible organic solvent, CaCl₂ as the ligand source, HNO₃ as the oxidizing agent, and HCl as the acid catalyst, could be used in a method of the present disclosure to extract approximately 50% of palladium/platinum/rhodium from a spent catalytic converter in only 12 min (Pd), 21 min (Pt), and 19 min (Rh). In contrast, it took 45 min (Pd), 65 min (Pt), and 60 min (Rh) for an aqua regia extraction mixture to do the same.

Particularly, when the spent catalytic converter was Cat-1, analysis indicated that approximately 49.9% of the Pd was leached within 12 min (2070 ppm Pd remained in Cat-1), 50.1% of the Pt was leached within 21 min (261 ppm Pt remained in Cat-1), 49.3% of the Rh was leached within 19 min (37 ppm Rh remained in Cat-1). When the spent catalytic converter was Cat-2, analysis indicated that approximately 48.9% of the Pd was leached within 12 min (1378 ppm Pd remained in Cat-2), 50.6% of the Pt was leached within 21 min (680 ppm Pt remained in Cat-2), 50.1% of the Rh was leached within 19 min (61 ppm Rh remained in Cat-2). When the spent catalytic converter was Cat-3, analysis indicated that approximately 50.0% of the Pd was leached within 12 min (3616 ppm Pd remained in Cat-3), 48.8% of the Pt was leached within 21 min (30 ppm Pt remained in Cat-3), 50.4% of the Rh was leached within 19 min (73 ppm Rh remained in Cat-3).

It was thus observed that an extraction mixture of the present disclosure, used in a method of the present disclosure, leached palladium/platinum/rhodium from a spent catalytic converter about 3 times faster to about 4 times faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient pressures; (iii) provides an ability to be reused multiple times for the leaching of palladium/platinum/rhodium; (iv) is stainless-steel compatible; and (vi) provides a reduction in the operational and capital expenditures associated with carrying out the leaching (e.g., due to reduced reagent use, reduced chemical waste produced, stainless-steel compatibility, etc.); (vii) minimizes or avoids the need to further purify the final palladium/platinum/rhodium product (e.g., via separation of said metals from base metals or ferrous metals) due to the selectivity for palladium/platinum/rhodium; and (viii) provides an ability to operate at a lower concentration (e.g., at mmol concentrations) of chemical reagents, therefore reducing the amount (and costs) of reagents being consumed when carrying out leaching.

### Example 17

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and MnO₂ (0.05 M), and stirred at 200 rpm at a temperature of 85° C.-90° C. under ambient pressure. The reaction was operated at a solid to liquid phase ratio of 1:10. Palladium/platinum/rhodium content was measured every 2 min until 50% extraction of palladium/platinum/rhodium was observed, which was after 07 min (Pd), 11 min (Pt), and 10 min (Rh), following which the obtained solution was separated from the treated catalytic converter, and analyzed by AAS to measure its palladium/platinum/rhodium content.

Three different types of spent catalytic converters were used: Cat-1 (containing 4312 ppm Pd, 611 ppm Pt, 82 ppm Rh), Cat-2 (containing 2323 ppm Pd, 1238 ppm Pt, 135 ppm Rh), Cat-3 (containing 7389 ppm Pd, 77 ppm Pt, 138 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for Fire assay analysis to confirm the AAS analysis.

A similar procedure was repeated using aqua regia as an extraction mixture, in place of the extraction mixture of glacial acetic acid containing CaCl₂, HCl, and MnO₂ at a temperature of 85° C.-90° C. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content. The treated catalytic converter was also sent to Fire assay analysis to measure the remaining Pd/Pt/Rh.

Results and Discussion

It was observed that an extraction mixture of the present disclosure comprising glacial acetic acid as the water-miscible organic solvent, CaCl₂ as the ligand source, MnO₂ as the oxidizing agent, and HCl as the acid catalyst, could be used in a method of the present disclosure to extract approximately 50% of palladium/platinum/rhodium from a spent catalytic converter in only 07 min (Pd), 11 min (Pt), and 10 min (Rh). In contrast, it took 45 min (Pd), 65 min (Pt), and 60 min (Rh) for an aqua regia extraction mixture to do the same.

Particularly, when the spent catalytic converter was Cat-1, analysis indicated that approximately 50.6% of Pd was leached within 07 min (2130 ppm Pd remained in Cat-1), 49.4% of Pt was leached within 11 min (309 ppm Pt remained in Cat-1), 50.8% of Rh was leached within 10 min (40 ppm Rh remained in Cat-1); and that approximately 89.9% of the Pd was leached in 10 min, and that approximately 90.6% of the Pt was leached in 40 min. When the spent catalytic converter was Cat-2, analysis indicated that approximately 51.2% of Pd was leached within 07 min (1133 ppm Pd remained in Cat-2), 49.7% of Pt was leached within 11 min (623 ppm Pt remained in Cat-2), 51.3% of Rh was leached within 10 min (66 ppm Rh in Cat-2). When the spent catalytic converter was Cat-3, analysis indicated that approximately 50.9% of Pd was leached within 07 min (3628 ppm Pd remained in Cat-3), 51.6% of Pt was leached within 11 min (37 ppm Pt remained in Cat-3), 50.7% of Rh was leached within 10 min (68 ppm Rh remained in Cat-3).

It was thus observed that an extraction mixture of the present disclosure, used in a method of the present disclosure, leached palladium/platinum/rhodium from a spent catalytic converter about 6 times faster to about 7 times faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient pressures; (iii) provides an ability to be reused multiple times for the leaching of palladium/platinum/rhodium; (iv) is stainless-steel compatible; and (vi) provides a reduction in the operational and capital expenditures associated with carrying out the leaching (e.g., due to reduced reagent use, reduced chemical waste produced, stainless-steel compatibility); (vii) minimizes or avoids the need to further purify the final palladium/platinum/rhodium product (e.g., via separation of said metals from base metals or ferrous metals) due to the selectivity for palladium/platinum/rhodium; and (viii) provides an ability to operate at a lower concentration (e.g., at mmol concentrations) of chemical reagents, therefore reducing the amount (and costs) of reagents being consumed when carrying out leaching.

### Example 18

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and H₂O₂ (0.05 M), and stirred at 200 rpm at a temperature of 85° C.-90° C. under ambient pressure. The reaction was operated at a solid to liquid phase ratio of 1:10. Palladium/platinum/rhodium content was measured every 2 min until 50% extraction of palladium/platinum/rhodium was observed, which was after 3 min (Pd), 9 min (Pt), and 12 min (Rh), following which the obtained solution was separated from the treated catalytic converter, and analyzed by AAS to measure its palladium/platinum/rhodium content.

Three different types of spent catalytic converters were used: Cat-1 (containing 4189 ppm Pd, 558 ppm Pt, 68 ppm Rh), Cat-2 (containing 2411 ppm Pd, 1388 ppm Pt, 129 ppm Rh), Cat-3 (containing 7077 ppm Pd, 76 ppm Pt, 137 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for Fire assay analysis to confirm the AAS analysis.

A similar procedure was repeated using aqua regia as an extraction mixture, in place of the extraction mixture of glacial acetic acid containing CaCl₂, HCl, and H₂O₂ at a temperature of 85° C.-90° C. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content. The treated catalytic converter was also sent for Fire assay analysis to measure the remaining Pd/Pt/Rh.

Results and Discussion

It was observed that an extraction mixture of the present disclosure comprising glacial acetic acid as the water-miscible organic solvent, CaCl₂ as the ligand source, H₂O₂ as the oxidizing agent, and HCl as the acid catalyst, could be used in a method of the present disclosure to extract approximately 50% of palladium/platinum/rhodium from a spent catalytic converter in only 3 min (Pd), 9 min (Pt), and 12 min (Rh). In contrast, it took 45 min (Pd), 65 min (Pt), and 60 min (Rh) for an aqua regia extraction mixture to do the same.

Particularly, when the spent catalytic converter was Cat-1, analysis indicated that approximately 49.9% of Pd was leached within 3 min (2099 ppm Pd remained in Cat-1), 50.1% of Pt was leached within 9 min (278 ppm Pt remained in Cat-1), 48.8% of Rh was leached within 12 min (35 ppm Rh remained in Cat-1); and that approximately 97.9% of the Pd was leached in 10 min, and that approximately 91.2% of the Pt was leached in 40 min. When the spent catalytic converter was Cat-2, analysis indicated that approximately 50.2% of Pd was leached within 3 min (1201 ppm Pd remained in Cat-2), 47.3% of Pt was leached within 9 min (731 ppm Pt remained in Cat-2), 48.6% of Rh was leached within 12 min (66 ppm Rh remained in Cat-2). When the spent catalytic converter was Cat-3, analysis indicated that approximately 48.5% of Pd was leached within 3 min (3645 ppm Pd remained in Cat-3), 51.1% of Pt was leached within 9 min (37 ppm Pt remained in Cat-3), 49.8% of Rh was leached within 12 min (69 ppm Rh remained in Cat-3).

It was thus observed that an extraction mixture of the present disclosure, used in a method of the present disclosure, leached palladium/platinum/rhodium from a spent catalytic converter about 6 times faster to about 15 times faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient pressures; (iii) provides an ability to be reused multiple times for the leaching of palladium/platinum/rhodium; (iv) is stainless-steel compatible; and (vi) provides a reduction in the operational and capital expenditures associated with carrying out the leaching (e.g., due to reduced reagent use, reduced chemical waste produced, stainless-steel compatibility); (vii) minimizes or avoids the need to further purify the final palladium/platinum/rhodium product (e.g., via separation of said metals from base metals or ferrous metals) due to the selectivity for palladium/platinum/rhodium; and (viii) provides an ability to operate at a lower concentration (e.g., at mmol concentrations) of chemical reagents, therefore reducing the amount (and costs) of reagents being consumed when carrying out leaching.

### Example 19

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and CuCl₂ (0.05 M), and stirred at 200 rpm at a temperature of 85° C.-90° C. under ambient pressure. The reaction was operated at a solid to liquid phase ratio of 1:10. Palladium/platinum/rhodium content was measured every 2 min until 50% extraction of palladium/platinum/rhodium was observed, which was after 2 min (Pd), 60 min (Pt), and 19 min (Rh), following which the obtained solution was separated from the treated catalytic converter, and analyzed by AAS to measure its palladium/platinum/rhodium content.

Three different types of spent catalytic converters were used: Cat-1 (containing 4058 ppm Pd, 518 ppm Pt, 82 ppm Rh), Cat-2 (containing 2318 ppm Pd, 1408 ppm Pt, 141 ppm Rh), Cat-3 (containing 7388 ppm Pd, 72 ppm Pt, 143 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for Fire assay analysis to confirm the AAS analysis.

A similar procedure was repeated using aqua regia as an extraction mixture, in place of the extraction mixture of glacial acetic acid containing CaCl₂, HCl, and CuCl₂ at a temperature of 85° C.-90° C. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content. The treated catalytic converter was also sent to Fire assay analysis to measure the remaining Pd/Pt/Rh.

Results and Discussion

It was observed that an extraction mixture of the present disclosure comprising glacial acetic acid as the water-miscible organic solvent, CaCl₂ as the ligand source, CuCl₂ as the oxidizing agent, and HCl as the acid catalyst, could be used in a method of the present disclosure to extract approximately 50% of palladium/platinum/rhodium from a spent catalytic converter in only 2 min (Pd), 60 min (Pt), and 19 min (Rh). In contrast, it took 45 min (Pd), 65 min (Pt), and 60 min (Rh) for an aqua regia extraction mixture to do the same.

Particularly, when the spent catalytic converter was Cat-1, analysis indicated that approximately 48.8% of Pd was leached within 2 min (2078 ppm Pd remained in Cat-1), 47.2% of Pt was leached within 60 min (274 ppm Pt remained in Cat-1), 50.1% of Rh was leached within 19 min (41 ppm Rh remained in Cat-1). When the spent catalytic converter was Cat-2, analysis indicated that approximately 50.2% of Pd was leached within 2 min (1154 ppm Pd remained in Cat-2), 49.8% of Pt was leached within 60 min (707 ppm Pt remained in Cat-2), 51.3% of Rh was leached within 19 min (69 ppm Rh remained in Cat-2). When the spent catalytic converter was Cat-3, analysis indicated that approximately 52.2% of Pd was leached within 2 min (3531 ppm Pd remained in Cat-3), 48.8% of Pt was leached within 60 min (37 ppm Pt remained in Cat-3), 53.3% of Rh was leached within 19 min (68 ppm Rh remained in Cat-3).

It was thus observed that an extraction mixture of the present disclosure, used in a method of the present disclosure, leached palladium/platinum/rhodium from a spent catalytic converter about 1 times faster to about 22 times faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient pressures; (iii) provides an ability to be reused multiple times for the leaching of palladium/platinum/rhodium; (iv) is stainless-steel compatible; and (vi) provides a reduction in the operational and capital expenditures associated with carrying out the leaching (e.g., due to reduced reagent use, reduced chemical waste produced, stainless-steel compatibility, etc); (vii) minimizes or avoids the need to further purify the final palladium/platinum/rhodium product (e.g., via separation of said metals from base metals or ferrous metals) due to the selectivity for palladium/platinum/rhodium; and (viii) provides an ability to operate at a lower concentration (e.g., at mmol concentrations) of chemical reagents, therefore reducing the amount (and costs) of reagents being consumed when carrying out leaching.

### Example 20

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content, and aluminum oxide content. The treated catalytic converter was rinsed with water, dried, and then treated with 40 mL hot aqua regia (90° C.) for 120 min to complete dissolution of the remaining metals/oxides. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and O₂ (from air), and stirred at 200 rpm at a temperature of 85° C.-90° C. under ambient pressure. The reaction was operated at a solid to liquid phase ratio of 1:10. After 2 hours, the obtained solution was separated from the treated catalytic converter, and analyzed by AAS to measure its palladium, platinum, and/or rhodium content, and aluminum oxide content.

Three different types of spent catalytic converters were used: Cat-1 (containing 4322 ppm Pd, 566 ppm Pt, 79 ppm Rh, 426880 ppm aluminum oxide), Cat-2 (containing 2354 ppm Pd, 1289 ppm Pt, 122 ppm Rh, 430105 aluminum oxide), Cat-3 (containing 6887 ppm Pd, 68 ppm Pt, 137 ppm Rh, 428890 ppm aluminum oxide). The treated catalytic converter was rinsed with water, then acetone, and finally dried. The treated catalytic converter was then treated with 40 mL hot aqua regia (90° C.) for 120 min to complete dissolution of the remaining metals/oxides. The obtained aqua regia solution was diluted and analysed with AAS. Additionally, some samples were sent for ICP analysis to confirm the AAS analysis.

Results and Discussion

It was observed that an extraction mixture of the present disclosure comprising glacial acetic acid as the water-miscible organic solvent, CaCl₂ as the ligand source, O₂ (from air) as the oxidizing agent, and HCl as the acid catalyst could be used in a method of the present disclosure to simultaneously and selectively extract palladium/platinum/rhodium from a spent catalytic converter comprising palladium/platinum/rhodium, and aluminum oxide, leaving the aluminum oxide/silica in the catalytic converter.

Particularly, when the spent catalytic converter was Cat-1, analysis indicated that approximately 3375 ppm Pd, approximately 508 ppm Pt, approximately 76 ppm Rh, and approximately 426122 ppm aluminum oxide remained within Cat-1 after approximately 2 hours, resulting in a selective and simultaneous extraction of palladium/platinum/rhodium (within experimental error). When the spent catalytic converter was Cat-2, analysis indicated that approximately 1824 ppm Pd, approximately 1170 ppm Pt, approximately 117 ppm Rh, and approximately 429880 ppm aluminum oxide remained within Cat-2 after approximately 2 hours, resulting in a selective and simultaneous extraction of palladium/platinum/rhodium (within experimental error). When the spent catalytic converter was Cat-3, analysis indicated that approximately 5413 ppm Pd, approximately 60 ppm Pt, approximately 132 ppm Rh, and approximately 428345 ppm aluminum oxide remained within Cat-3 after approximately 2 hours, resulting in a selective and simultaneous extraction of palladium/platinum/rhodium. (within experimental error).

It was thus observed that an extraction mixture of the present disclosure, used in a method of the present disclosure, simultaneously and selectively leached palladium/platinum/rhodium from a spent catalytic converter comprising palladium/platinum/rhodium, and aluminum oxide, to the exclusion of the aluminum oxide.

Further, the method and extraction mixture of the present disclosure: (i) provides an ability to operate at a lower concentration (e.g., at mmol concentrations) of chemical reagents, therefore reducing the amount (and costs) of reagents being consumed when carrying out leaching; (ii) can be operated at ambient pressures; (iii) provides an ability to be reused multiple times for the leaching of palladium/platinum/rhodium, thereby reducing the amount of waste produced overall when leaching; (v) is stainless-steel compatible; (vi) provides for reduced downstream processing and refining requirements for the recovered Pd/Pt/Rh; (vii) provides a reduction in the operational and capital expenditures associated with carrying out the leaching (e.g., due to reduced reagent use, reduced chemical waste produced, stainless-steel compatibility); (viii) minimizes or avoids the need to further purify the final palladium/platinum/rhodium product (e.g., via separation of said metals from aluminum oxide) due to the selectivity for palladium/platinum/rhodium; and (ix) minimizes or avoids the need for multistage recovery processes given that the palladium/platinum/rhodium are simultaneously leached.

### Example 21

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Leaching Pulverized or Intact Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and was then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), HCl 37% (0.2 M), and FeCl₃ (0.05 M), and stirred at 200 rpm at a temperature of 85° C.-90° C. under ambient pressure. The reaction was operated at a solid to liquid phase ratio of 1:10. Palladium/platinum/rhodium content was measured every 2 min until 50% extraction of palladium/platinum/rhodium was observed, which was after 7 min (Pd), 22 min (Pt), and 15 min (Rh), following which the obtained solution was separated from the treated catalytic converter, and analyzed by AAS to measure its palladium/platinum/rhodium content.

Three different types of spent catalytic converters were used: Cat-1 (containing 4022 ppm Pd, 567 ppm Pt, 81 ppm Rh), Cat-2 (containing 2199 ppm Pd, 1289 ppm Pt, 136 ppm Rh), Cat-3 (containing 7248 ppm Pd, 71 ppm Pt, 133 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for Fire assay analysis to confirm the AAS analysis.

A similar procedure was repeated using aqua regia as an extraction mixture, in place of the extraction mixture of glacial acetic acid containing CaCl₂, HCl, and FeCl₃ at a temperature of 85° C.-90° C. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content. The treated catalytic converter was also sent to Fire assay analysis to measure the remaining Pd/Pt/Rh.

Results and Discussion

It was observed that an extraction mixture of the present disclosure comprising glacial acetic acid as the water-miscible organic solvent, CaCl₂ as the ligand source, FeCl₃ as the oxidizing agent, and HCl as the acid catalyst, could be used in a method of the present disclosure to extract approximately 50% of palladium/platinum/rhodium from a spent catalytic converter in only 7 min (Pd), 22 min (Pt), and 15 min (Rh). In contrast, it took 45 min (Pd), 65 min (Pt), and 60 min (Rh) for an aqua regia extraction mixture to do the same.

Particularly, when the spent catalytic converter was Cat-1, analysis indicated that approximately 49.9% of Pd was leached within 7 min (2015 ppm Pd remained in Cat-1), 51.3% of Pt was leached within 22 min (276 ppm Pt remained in Cat-1), 48.9% of Rh was leached within 15 min (41 ppm Rh remained in Cat-1). When the spent catalytic converter was Cat-2, analysis indicated that approximately 52.1% of Pd was leached within 7 min (1053 ppm Pd remained in Cat-2), 50.7% of Pt was leached within 22 min (635 ppm Pt remained in Cat-2), 47.9% of Rh was leached within 15 min (71 ppm Rh remained in Cat-2). When the spent catalytic converter was Cat-3, analysis indicated that approximately 48.9% of Pd was leached within 7 min (3704 ppm Pd remained in Cat-3), 49.5% of Pt was leached within 22 min (36 ppm Pt remained in Cat-3), 49.9% of Rh was leached within 15 min (67 ppm Rh remained in Cat-3).

It was thus observed that an extraction mixture of the present disclosure, used in a method of the present disclosure, leached palladium/platinum/rhodium from a spent catalytic converter about 3 times faster to about 6 times faster than an aqua regia extraction mixture.

Further, the method and extraction mixture of the present disclosure is a more environmentally-friendly method and extraction mixture relative to aqua regia, for example it provides milder reaction conditions. Further, the method and extraction mixture of the present disclosure: (i) provides a safer and less toxic chemistry relative to the aqua regia extraction mixture (e.g., see the Background); (ii) can be operated at ambient pressures; (iii) provides an ability to be reused multiple times for the leaching of palladium/platinum/rhodium; (iv) is stainless-steel compatible; and (vi) provides a reduction in the operational and capital expenditures associated with carrying out the leaching (e.g., due to reduced reagent use, reduced chemical waste produced, stainless-steel compatibility, etc.); (vii) minimizes or avoids the need to further purify the final palladium/platinum/rhodium product (e.g., via separation of said metals from base metals or ferrous metals) due to the selectivity for palladium/platinum/rhodium; and (viii) provides an ability to operate at a lower concentration (e.g., at mmol concentrations) of chemical reagents, therefore reducing the amount (and costs) of reagents being consumed when carrying out leaching.

### Example 22

Materials and Methods

Materials

All chemicals were purchased as reagent grade and used without further purification. All spent catalytic convertors were purchased from Big House Converters Ltd. in Calgary. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF and ICP-OES characterization on all catalytic converter samples were performed by the Loring Lab, Calgary.

Methods

Atomic Absorption Spectroscopy (AAS)

All chemical analysis in the lab was carried out using Fisher Scientific FAA-SpectrAA iCE3300 instrument. 247.6, 265.9 and 343.5 nm were used as selected wavelengths for palladium, platinum, and rhodium analysis respectively. Standard Pd, Pt, and/or Rh solutions (1 ppm, 5 ppm, 10 ppm) were prepared from a commercial standard (1000 ppm Pd, Pt, and/or Rh, purchased from SCP Science, Quebec). The digested metals in both aqua regia and studied solutions were analysed with the machine after proper dilution (diluted between >1 ppm to <10 ppm Pd/Pt/Rh). A mixture of air and acetylene was used for all analysis. All other parameters were automatically adjusted by the instrument itself. For example, the following parameters were set for palladium analysis: Lamp current (%): 75; Measurement time (s): 4.0; Bandpass (nm): 0.2; Fuel flow (L/min): 1.1; Burner height (mm): 7.0; Gas flow (L/min): 1.1.

General Experimental for Pulverized or Intact Leaching Spent Catalytic Converters

Spent gasoline-based catalytic converter in powder or biscuit form (2 g) was added to 20 mL glacial acetic acid including appropriate amounts of ligand, oxidant, and acid catalyst, and stirred at 200 rpm for an appropriate time period at a select temperature under ambient pressure. After completion of the reaction, the obtained solution was separated from the treated catalytic converter, and analyzed by AAS to measure its palladium, platinum, and/or rhodium content. The treated catalytic converter was rinsed with water, dried, and then treated with 40 mL hot aqua regia (90° C.) for 120 min to complete dissolution of the remaining precious metals. The obtained aqua regia solution was diluted and analysed with AAS.

Experimental for Palladium/Platinum/Rhodium Extraction from Pulverized Spent Catalytic Converters

Spent gasoline-based catalytic converter (2 g, in powder form) was added to 20 mL glacial acetic acid containing CaCl₂ (0.1 M), CuCl₂ (0.05 M), and HCl 37% (0.2 M), and stirred at 200 rpm at room temperature under ambient pressure. The reaction was operated at a solid to liquid phase ratio of 1:10. After 3 hours, the obtained solution was separated from the treated catalytic converter, and analyzed by AAS to measure its palladium/platinum/rhodium content.

Three different types of spent catalytic converters were used: Cat-1 (containing 4329 ppm Pd, 578 ppm Pt, 73 ppm Rh), Cat-2 (containing 2134 ppm Pd, 1242 ppm Pt, 128 ppm Rh), Cat-3 (containing 7083 ppm Pd, 72 ppm Pt, 135 ppm Rh). Treated catalytic converter was rinsed with water, then acetone, and finally dried. The treated catalytic converter was then treated with 40 mL hot aqua regia (90° C.) for 120 min to complete dissolution of the remaining precious metals. The obtained aqua regia solution was diluted and analysed with AAS. Additionally, some samples were sent for ICP analysis to confirm the AAS analysis.

A similar procedure was repeated using aqua regia as an extraction mixture, in place of the extraction mixture of glacial acetic acid containing CaCl₂, HCl, and CuCl₂. A spent catalytic converter (containing 2194 ppm Pd, 1377 ppm Pt, 137 ppm Rh) was treated with aqua regia for 120 min. Particularly, the spent gasoline-based catalytic converter (2 g, in powder form) was added to 40 mL aqua regia (30 mL of HCl, 37%; and 10 ml of HNO₃, 68%) and stirred at 200 rpm at 90° C. under ambient pressure. After 2 hours, the obtained solution was separated from the treated catalytic converter, and analyzed by AAS to measure its palladium/platinum/rhodium content.

Results and Discussion

It was observed that an extraction mixture of the present disclosure comprising glacial acetic acid as the water-miscible organic solvent, CaCl₂ as the ligand source, CuCl₂ as the oxidizing agent, and HCl as the acid catalyst, could be used in a method of the present disclosure to extract a comparable percentage of palladium, platinum, and/or rhodium from a spent catalytic converter relative to an aqua regia extraction mixture.

Particularly, when the spent catalytic converter was Cat-1, analysis indicated that approximately 49.8% of Pd was leached (2173 ppm Pd remained in Cat-1), 5.6% of Pt was leached (547 ppm Pt remained in Cat-1), 9.6% of Rh was leached (66 ppm Rh remained in Cat-1). When the spent catalytic converter was Cat-2, analysis indicated that approximately 46.4% of Pd was leached (1144 ppm Pd remained in Cat-2), 4.9% of Pt was leached (1181 ppm Pt remained in Cat-2), 10.1% of Rh was leached (115 ppm Rh remained in Cat-2). When the spent catalytic converter was Cat-3, analysis indicated that approximately 48.3% of Pd was leached (3662 ppm Pd remained in Cat-3), 7.2% of Pt was leached (67 ppm Pt remained in Cat-3), 9.8% of Rh was leached (122 ppm Rh remained in Cat-3).

In contrast, within 120 min, aqua regia extracted 99.1% of Pd (19 ppm Pd remained in the catalytic converter), 97.8% of Pt was extracted (31 ppm Pt remained in the catalytic converter), 87.1% of Rh was extracted (18 ppm Rh remained in the catalytic converter). However, the method and extraction mixture of the present disclosure offers a much more environmentally-friendly, and user-friendly method and extraction mixture relative to aqua regia, while still offering comparable Pd, Pt, and/or Rh extraction yields.

Particularly, the method and extraction mixture of the present disclosure provides milder, safer reaction conditions. Due to its constituents (3:1 HCl to HNO₃), aqua regia is an extremely corrosive mixture that generates Cl_{2(g)} during its formation:

HNO₃(aq)+3HCl(aq)→NOCl(g)+2H₂O(l)+Cl₂(g)

Following its formation, the nitrosyl chloride (NOCl) of aqua regia will decompose over time and generate more chlorine gas, as well as nitric oxide (NO). In turn, the nitric acid auto-oxidizes into nitrogen dioxide (NO₂):

2NOCl(g)→2NO(g)+Cl₂(g)

2NO(g)+O₂(g)→2NO₂(g)

Nitric acid (HNO₃), hydrochloric acid (HCl), and aqua regia are strong acids, and chlorine (Cl₂), nitric oxide (NO), and nitrogen dioxide (NO₂) are toxic. As such, preparing and handling aqua regia requires strict adherence to safety protocols; and, because aqua regia is unstable (e.g., NOCl decomposes, etc.), it is necessary to use aqua regia immediately. Further, because of aqua regia's instability, the same portion of aqua regia cannot be reused for multiple leachings.

The method and extraction mixture of the present disclosure, however: (i) provides a safer and less toxic chemistry relative to the aqua regia extraction mixture (e.g., no toxic gas generation, reduced quantities of strong acids, etc.); (ii) provides an ability to operate at a lower concentration (e.g., at mmol concentrations) of chemical reagents, therefore reducing the amount (and costs) of reagents being consumed when carrying out leaching; (iii) provides an ability to be reused multiple times for the leaching of palladium/platinum/rhodium, thereby reducing the amount the operating costs of carrying out the leaching (e.g., in contrast to aqua regia, which is unstable and must be used immediately, and cannot be reused for a second time); (iv) is stainless-steel compatible; (v) provides a reduction in the capital expenditures associated with carrying out the leaching (e.g., due to reduced reagent use, reduced chemical waste produced, stainless-steel compatibility, etc.); (vi) can be operated at ambient temperatures and pressures; and (vii) is tolerant of greater than or equal to 10 wt % water, e.g., 30 wt %.

### Example 23

Materials and Methods

Materials

All chemicals were purchased as reagent grade and used without further purification. All spent catalytic convertors were purchased from Big House Converters Ltd. in Calgary. The spent gasoline-based catalytic converters comprised palladium, platinum, rhodium. The spent diesel-based catalytic converters comprised palladium, platinum. All acids, solvents and stabilizers/acid catalysts including HCl 37%, HNO₃ 69.5%, H₂SO₄ 95%, citric acid, and glacial acetic acid were purchased from Fisher Scientific and used as received. All salt and ligand sources including KI, NaI, CaCl₂, CaO₂, NaCl, KCl, MgCl₂ and AlCl₃ were purchased from VWR. All oxidizing agents including I₂, H₂O₂ 30%, MnO₂, FeCl₃·2H₂O, CuCl₂, NaIO₃ and KMnO₄ were purchased from Fisher Scientific. Chemical analysis was carried out using Fisher Scientific FAA-SpectrAA iCE3300 instrument. XRF characterization on all catalytic converter samples were performed by the Loring Lab, Calgary. ICP-OES characterization on all catalytic converter samples were performed by the Loring Lab, Calgary or in-house.

Methods

(A) Experimental for Palladium, Platinum, Rhodium Extraction from Spent Catalytic Converters

Spent gasoline-based catalytic converter in powder form (7 g, containing 774 ppm Pt, 1694 ppm Pd, and 203 ppm Rh measured by XRF) was added to 70 mL glacial acetic acid containing HCl 37% (0.6 M), and CaO₂ (0.2 M), and stirred at 200 RPM at 85° C. and under ambient pressure for 90 min. The reaction was operated at a solid to liquid phase ratio of 1:10. Palladium/platinum/rhodium content was measured at the end of reaction by ICP-OES, showing 735 ppm Pt, 1681 ppm Pd, and 96 ppm Rh in solution. Treated catalytic converter was rinsed with water, then acetone, and finally dried. The treated catalytic converter was then analyzed with XRF machine, showing 89 ppm Pt, 107 ppm Pd and 113 ppm Rh. Respective extraction yields were calculated by comparing before and after metal concentrations (ppm) as measured by XRF. Extraction yield—88.5% (Pt), 93.7% (Pd), 44.3% (Rh).

(B) Experimental for Palladium, Platinum, Rhodium Extraction from Spent Catalytic Converters

Spent gasoline-based catalytic converter in powder form (7 g, containing 774 ppm Pt, 1694 ppm Pd, and 203 ppm Rh measured by XRF) was added to 70 mL glacial acetic acid containing HCl 37% (0.6 M), MnO₂ (0.1 M) and CaO₂ (0.1 M), and stirred at 200 rpm at 85° C. and under ambient pressure for 90 min. The reaction was operated at a solid to liquid phase ratio of 1:10. Palladium/platinum/rhodium content was measured at the end of reaction by ICP-OES, showing 745 ppm Pt, 1691 ppm Pd, and 118 ppm Rh in solution. Treated catalytic converter was rinsed with water, then acetone, and finally dried. The treated catalytic converter was then analyzed with XRF machine, showing 66 ppm Pt, 67 ppm Pd and 92 ppm Rh. Respective extraction yields were calculated by comparing before and after metal concentrations (ppm) as measured by XRF. Extraction yield—91.5% (Pt), 96% (Pd), 54.7% (Rh)

(C) Experimental for Palladium, Platinum Extraction from Spent Catalytic Converters

Spent diesel-based catalytic converter in powder form (7 g, containing 874 ppm Pt, and 394 ppm Pd, measured by XRF) was added to 70 mL glacial acetic acid containing HCl 37% (0.6 M), and CaO₂ (0.2 M), and stirred at 200 rpm at 85° C. and under ambient pressure for 90 min. The reaction was operated at a solid to liquid phase ratio of 1:10. Palladium/platinum content was measured at the end of reaction by ICP-OES, showing 812 ppm Pt, and 341 ppm Pd. Treated catalytic converter was rinsed with water, then acetone, and finally dried. The treated catalytic converter was then analyzed with XRF machine, showing 35 ppm Pt, and 17 ppm Pd. Respective extraction yields were calculated by comparing before and after metal concentrations (ppm) as measured by XRF. Extraction yield—96% (Pt), 95.7% (Pd)

(D) Leaching Efficiency Comparisons

The following examples illustrate the leaching efficiencies of herein described methods, uses, and/or processes and leach mixtures thereof (see Example D1), relative to the above-noted previously described method of leaching gold, palladium and/or platinum from a substance comprising gold, palladium and/or platinum (see Example D2-D3). When applied to the leaching of platinum group metals, such as palladium, platinum, it was found that the leaching efficiency of the herein described methods, uses, and/or processes and leach mixtures thereof was about 96%, and the highest leaching efficiency for the previously described method of leaching gold, palladium and/or platinum from a substance comprising gold, palladium and/or platinum was about 90%.

### Example D1

Spent diesel-based catalytic converter in powder form (7 g, containing 874 ppm Pt, and 394 ppm Pd measured by XRF) was added to 70 mL glacial acetic acid containing HCl 37% (0.6 M), MnO₂ (0.1 M) and CaO₂ (0.1 M), and stirred at 200 rpm at 85° C. and under ambient pressure for 90 min. The reaction was operated at a solid to liquid phase ratio of 1:10. Palladium/platinum content was measured at the end of reaction by ICP-OES, showing 815 ppm Pt, and 352 ppm Pd. Treated catalytic converter was rinsed with water, then acetone, and finally dried. The treated catalytic converter was then analyzed with XRF machine, showing 32 ppm Pt and 11 ppm Pd. Respective extraction yields were calculated by comparing before and after metal concentrations (ppm) as measured by XRF. Extraction yield—96.3% (Pt), 97.2% (Pd).

### Example D2

Spent diesel-based catalytic converter in powder form (7 g, containing 874 ppm Pt, and 394 ppm Pd measured by XRF) was added to 70 mL glacial acetic acid containing HCl 37% (0.6 M), H₂O₂ (0.2 M), and stirred at 200 rpm at 85° C. and under ambient pressure for 90 min. The reaction was operated at a solid to liquid phase ratio of 1:10. Palladium/platinum content was measured at the end of reaction by ICP-OES, showing 795 ppm Pt, and 342 ppm Pd. Treated catalytic converter was rinsed with water, then acetone, and finally dried. The treated catalytic converter was then analyzed with XRF machine, showing 74 ppm Pt, and 51 ppm Pd. Respective extraction yields were calculated by comparing before and after metal concentrations (ppm) as measured by XRF. Extraction yield—91.5% (Pt), 87.1% (Pd)

### Example D3

Spent diesel-based catalytic converter in powder form (7 g, containing 874 ppm Pt, and 394 ppm Pd as measured by XRF) was added to 70 mL glacial acetic acid containing HCl 37% (0.6 M), Ca(ClO)₂ (0.2 M), and stirred at 200 rpm at 85° C. and under ambient pressure for 90 min. The reaction was operated at a solid to liquid phase ratio of 1:10. Palladium/platinum content was measured at the end of reaction by ICP-OES, showing 785 ppm Pt, and 330 ppm Pd. Treated catalytic converter was rinsed with water, then acetone, and finally dried. The treated catalytic converter was then analyzed with XRF machine, showing 116 ppm Pt, and 81 ppm Pd. Respective extraction yields were calculated by comparing before and after metal concentrations (ppm) as measured by XRF. Extraction yield—86.7% (Pt), 79.4% (Pd)

(E) Re-Cycling Comparisons

The following examples illustrate the reusability and the efficiency of herein described methods, uses, and/or processes and leach mixtures thereof (see Example E1) compared to the above-noted previously described method of leaching gold, palladium and/or platinum from a substance comprising gold, palladium and/or platinum (see Example E2). When applied to the leaching of platinum group metals, such as palladium, platinum, it was found that herein described methods, uses, and/or processes and leach mixtures thereof could be reused for more than 6 cycles while maintaining leaching efficiency; which was found to be in contrast to the previously described method of leaching gold, palladium and/or platinum from a substance comprising gold, palladium and/or platinum.

### Example E1

Spent diesel-based catalytic converter in powder form (7 g, containing 874 ppm Pt, and 394 ppm Pd, as measured by XRF) was added to 70 mL glacial acetic acid containing HCl 37% (0.6 M), MnO₂ (0.1 M) and CaO₂ (0.1 M) and stirred at 200 rpm at 85° C. and under ambient pressure for 90 min. Reaction mixture was filtered to separate the pregnant solution from the powder. The powder was rinsed and analyzed by XRF (Table 1). The filtrate (e.g., pregnant leach solution) was levelled up to 70 ml by adding acetic acid, and recharged with half of leach mixture chemicals added in the first leaching step. Then, 7 g of new spent diesel-based catalytic converter in powder form was added to the pregnant solution and the mixture was stirred at 200 rpm at 85° C. under ambient pressure for 90 min. The reaction mixture was filtered again, and the filtrate (e.g., pregnant leach solution) was reused for another 4 cycles (6 cycles in total). Table 1 outlines the remaining Pt and Pd in the leached powder for each cycle after a proper rinse.

TABLE 1
Pt—Pd leftovers in the treated diesel-based catalytic
converter in powder form after each leaching step

| Cycle number | 1 | 2 | 3 | 4 | 5 | 6 |
|---|---|---|---|---|---|---|
| Pt—Pd Leftovers (ppm) | 30-12 | 28-11 | 36-13 | 27-11 | 29-14 | 37-13 |

About 80 mL of pregnant solution containing 440 ppm Pt and 200 ppm Pd was submitted to a precipitation step. 0.750 ml of dissolved ammonium chloride (7M in water) was added to the pregnant solution. The reaction mixture was mixed for 5 minutes, and the solution was analysed by ICP-OES, showing 4 ppm Pt and 2 ppm Pd. The precipitate was filtered, washed, and mixed with 10 ml water. 500 mg aluminum strips were added to the solution and mixed for 10 minutes. A black powder formed and was filtered, washed with dilute hydrochloric, and dried for further analysis. 42.6 mg of a fine black powder containing palladium and platinum with the purity of 97.6% was obtained as a final product.

### Example E2

Spent diesel-based catalytic converter in powder form (7 g, containing 874 ppm Pt, and 394 ppm Pd, measured by XRF) was added to 70 mL glacial acetic acid containing HCl 37% (0.6 M), H₂O₂ (0.2 M), and stirred at 200 rpm at 85° C. and under ambient pressure for 90 min. The reaction mixture was filtered to separate the pregnant solution from the powder. The powder was rinsed and analyzed by XRF (Table 2). The filtrate (e.g., pregnant leach solution) was levelled up to 70 ml by adding acetic acid, and recharged with half of the leach mixture chemicals added in the first leaching step. Then, 7 g of new spent diesel-based catalytic converter in powder form was added to the pregnant solution and the mixture was stirred at 200 rpm at 85° C. under ambient pressure for 90 min. The reaction mixture was filtered again, and the filtrate (e.g., pregnant leach solution) was reused for another 4 (6 cycles in total). Table 2 outlines the remaining Pt and Pd in the leached powder for each step after a proper rinse.

TABLE 2
Pt—Pd leftovers in the treated diesel-based catalytic
converter in powder form after each leaching step

| Cycle number | 1 | 2 | 3 | 4 | 5 | 6 |
|---|---|---|---|---|---|---|
| Pt—Pd Leftovers (ppm) | 58-45 | 56-47 | 75-62 | 84-76 | 97-89 | 102-104 |

About 80 mL of pregnant solution containing 396 ppm Pt and 180 ppm Pd was submitted to a precipitation step. 0.750 ml of dissolved ammonium chloride (7M in water) was added to the pregnant solution. The reaction mixture was mixed for 5 minutes, and the solution was analysed by ICP-OES, showing 14 ppm Pt and 43 ppm pd. The precipitate was filtered, washed, and mixed with 10 ml water. 500 mg aluminum powder was added to the solution and mixed for 10 minutes. A black powder formed and was filtered, washed with dilute hydrochloric, and dried for further analysis. 39.8 mg of a fine black powder containing palladium and platinum with the purity of 97.6% was obtained as a final product.

(F) Pre-Treatments

The following examples illustrate the effect of pre-treatments on leaching efficiency of herein described methods, uses, and/or processes and leach mixtures thereof; for example, a reduction pre-treatment step (see Examples F1-F3), and a decontaminating pre-treatment step (see Example F4). Generally, platinum group metals in, for example, catalytic converters can oxidize or become contaminated over time due to long-time exposure to oxygen and other materials at high temperature. However, it was found that pre-treatment steps—formic acid or citric acid in water at 80° C. can improve leaching efficiency of the herein described methods, uses, and/or processes and leach mixtures thereof.

### Example F1

Diesel oxidation catalyst (DOC) in powder form (7 g, containing 1768 ppm Pt, and 716 ppm Pd, measured by XRF) was treated using the leaching procedure outlined in Example D1. The treated powder was rinsed and then analyzed by XRF, showing 159 ppm Pt, and 156 ppm Pd.

Extraction Yield: 91% (Pt); 78.2% (Pd) Respective extraction yields were calculated by comparing before and after metal concentrations (ppm) as measured by XRF.

### Example F2

Diesel oxidation catalyst (DOC) in powder form (7 g, containing 1768 ppm Pt, and 716 ppm Pd, measured by XRF) was mixed with 35 ml water containing 20% formic acid. The mixture was stirred at 200 rpm at 80° C. and under ambient pressure for 3 h. The mixture was filtered, and the obtained reduced powder was rinsed with water and dried for the next step. The reduced powder was treated using the leaching procedure outlined in Example D1. The treated powder was rinsed and then analyzed by XRF, showing 105 ppm Pt, and 55 ppm Pd.

Extraction Yield: 94.1% (Pt); 92.3% (Pd) Respective extraction yields were calculated by comparing before and after metal concentrations (ppm) as measured by XRF.

### Example F3

Diesel oxidation catalyst (DOC) in powder form (7 g, containing 1768 ppm Pt, and 716 ppm Pd, measured by XRF) was mixed with 35 ml water containing 20% formic acid. The mixture was stirred at 200 rpm at 80° C. and under ambient pressure for 3 h. The mixture was filtered, and the obtained reduced powder was rinsed with water and dried for the next step. The reduced powder was treated using 70 mL glacial acetic acid containing HCl 37% (0.3 M), CuCl₂ (0.07 M) and CaCl₂ (0.2 M), and stirred at 200 rpm at 85° C. and under ambient pressure for 90 min.

The treated powder was rinsed and then analyzed by XRF, showing 205 ppm Pt, and 180 ppm Pd. Extraction Yield: 88.4% (Pt); 74.9% (Pd) For this example, the Pt—Pd leftovers without formic acid pre-treatment were 235 ppm Pt, and 198 ppm Pd. Extraction Yield: 86.7% (Pt); 72.3% (Pd) Respective extraction yields were calculated by comparing before and after metal concentrations (ppm) as measured by XRF.

### Example F4

Diesel oxidation catalyst (DOC) in powder form (7 g, containing 587 ppm Pt, and 468 ppm Pd, measured by XRF) was mixed with 35 ml water containing citric acid (1M; 6.72 g/L water). The mixture was stirred at 200 rpm at 80° C. and under ambient pressure for 6 h. The mixture was filtered, and the obtained powder was rinsed with water and dried for the next step. The treated powder was leached using the leaching procedure outlined in Example D1.

The treated powder was rinsed and then analyzed by XRF, showing 39 ppm Pt, and 34 ppm Pd. Extraction Yield: 93.4% (Pt); 92.7% (Pd). The Pt—Pd leftovers without citric acid pre-treatment were 58 ppm Pt, and 145 ppm Pd. Extraction Yield: 90.1% (Pt); 69.0% (Pd). Respective extraction yields were calculated by comparing before and after metal concentrations (ppm) as measured by XRF.

(G) Experimental for Palladium, Platinum, Rhodium Extraction from Spent Nitric Acid Catalysts

### Example G1

15.0 g of a spent nitric acid catalysts (containing 208,791 ppm Pt, 314,272 ppm Pd and 3831 ppm Rh) in a powder form (<100 microns) was pre-treated in 75 ml water containing 20% formic acid at 80° C. for 3 hours. The reaction mixture was filtered, and the powder was completely dried. The powder was leached in 600 ml of glacial acetic acid containing HCl 37% (2M) and sodium chlorate (0.1 M) at 85° C. for 60 min. The reaction mixture was filtered and rinsed with 50 ml acetic acid. The rinsed solution was combined with the leach solution and submitted to a precipitation step. The solution was charged with 15 ml of H₂O₂ (30%) and 50 ml of NH₄Cl solution (7M in water) at room temperature. The mixture was stirred for 5 minutes, and the bulky orange/red precipitate was filtered and rinsed with acetic acid. the filtrate was analyzed by ICP-OES, showing 5 ppm Pt, 0 ppm Pd and 0 ppm Rh. The precipitate was mixed with 500 ml water in a 1 liter beaker. 8.5 g Al strips was added to the mixture and stirred for 20 minutes until the solution turned colorless. The fine black powder was filtered and washed twice with 50 ml of 1M HCl (100 ml in total). 6.84 g of fine black powder was collected and analyzed showing the purity of 99.9% for Pt, Pd, and Rh, indicating that the collected powder contained Pd, Pt, Rh with only 0.1% impurity.

### Example G2

The fine black powder collected and showing a purity of 99.9% for Pt, Pd, and Rh obtained in G1 was further treated to refine palladium. The whole powder (6.84 g) was added to 100 ml glacial acetic acid containing KI (0.2 M) and HCl 37% (0.1) in air and stirred at ambient temperature for 45 minutes. The reaction mixture was sampled and analyzed by ICP-OES, showing 1 ppm Pt, 25,450 ppm Pd, and 0 ppm Rh. The reaction mixture was filtered, and the powder was rinsed with 20 ml acid containing (0.2 M KI and 0.1 M HCl in air) for two times. 0.1 g of the treated powder was dissolved in aqua regia and the solution was analyzed by ICP-OES, showing 878 ppm palladium. The rinse solution was combined with the leach solution and submitted to a precipitation step. 6.2 g of zinc powder (75 microns) was added to the combined rinse and leach solutions and stirred for 20 minutes. ICP-OES analysis of the solution showed 20 ppm palladium. The reaction was stopped, and the fine black powder was filtered and mixed with 100 ml water containing HCl (1M) and stirred in a beaker for 30 minutes. The mixture was filtered and the powder was rinsed with water. Around 2.45 g palladium powder with a purity of 98% was collected as a final product.

(H) Experimental for Palladium, Platinum, Rhodium Extraction from Spent Catalytic Converter—Re-Cycling

Spent catalytic converter (7.0 g, containing 774 ppm Pt, 1694 ppm Pd and 203 ppm Rh, as measured by XRF) was mixed with 25 ml water containing 20% formic acid. The mixture was stirred at 200 rpm at 80° C. and under ambient pressure for 3 h. The mixture was filtered, and the obtained powder was rinsed with 20 ml water and dried for the next step. The dried powder was mixed in 30 mL Acetic acid containing HCl 37% (1M), CaCl₂ (0.3M) and MnO₂ (0.03 M) and stirred at 85° C. for 60 min. The mixture was filtered, and the powder was rinsed with acetic acid and analyzed by XRF for the Pt—Pd—Rh leftovers (Cycle 1, Table 3). Then, the filtrate was recharged with the same amount of chemical added in first leaching cycle. 7.0 g of pre-treated spent catalyst was added to the filtrate and stirred at 85° C. for 60 min. The reaction mixture was filtered, and the powder was rinsed with acetic acid and analyzed by XRF for the Pt—Pd—Rh leftovers (Cycle 2, Table 3).

TABLE 3
Pt—Pd—Rh leftovers in the treated
powder after each leaching step

| Cycle number | 1 | 2 |
|---|---|---|
| Pt—Pd—Rh leftovers (ppm) | 78-184-140 | 85-191-143 |

The rinse and the leach solution were combined (33 ml) and submitted to a precipitation step. The solution was charged with 0.2 ml of H₂O₂ (30%) and 0.5 ml of NH₄Cl solution (7M in water) at room temperature. The mixture was stirred for 5 minutes, and the bulky orange/red precipitate was filtered and rinsed with acetic acid. The filtrate was analyzed by ICP-OES, showing 1 ppm Pt, 2 ppm Pd and 0 ppm Rh. The orange/red precipitate was mixed with 5 ml water in a 25 ml beaker. 0.5 g Al strips was added to the mixture and stirred for 20 minutes until the solution turned colorless. The fine black powder was filtered and washed twice with 10 ml of 1M HCl (20 ml in total). Finally, 27.4 mg of fine black powder (mixture of Pt, Pd, and Rh) with the purity of 99.9% was collected.

### Example 24

(A) Changing Acid Catalyst or Solvent - Pd Leaching Efficiency

| | | | Stabilizer/ | Pd Extraction |
|---|---|---|---|---|
| | Iodide Ligand | Oxidant | Acid catalyst | Yield % |
| Solvent | Source (M)** | (M) | (M) | (30 min-overnight) |
| Glacial Acetic | I⁻ (0.2) | I₂ (0.05) | HNO₃ (0.1) | 0.2-0.1 |
| Acid | | | | |
| H₂O | I⁻ (0.2) | I₂ (0.05) | HCl(0.1)/Citric | 1.7-2.1 |
| | | | Acid | |
| H₂O | I⁻ (0.2) | O₂ | HCl (0.1) | 0.9-0.6 |
| | | (from air) | | |

* All the reactions were done at ambient temperature and pressure, and in all cases, the solid/liquid phase ratio was 1:10
**Either KI or Nal used as ligand source

For a leach mixture comprising an iodide ligand source, an iodine oxidant, an acid catalyst, an optional carboxylic acid stabilizer, and acetic acid as a water-miscible organic solvent, preferably glacial acetic acid: (i) It was found that use of nitric acid as an acid catalyst resulted in negligible Pd leaching. Without wishing to be bound by theory, it was considered that the nitric acid may be reacting with, and destroying the I₂ oxidant. (II) It was also found that exchanging the acetic acid solvent for water—wherein the water as solvent comprises at least 50 wt % or more of the liquid phase of the leach mixture—resulted negligible Pd leaching.

(B) Changing Solvent - Pd/Pt Leaching Efficiency

| | Chloride | | Oxidizing | Stabilizer/ | |
|---|---|---|---|---|---|
| | Ligand | T | Agent | Acid catalyst | Extraction yield % |
| Solvent | Source (M) | (° C.) | (M) | (M) | (Pd − Pt)** |
| H₂O | CaCl₂ (0.1) | 90 | CuCl₂ (0.05) | HCl (0.2) | 19.4 − 6.2 |

* All the reactions were done at ambient pressure, and in all cases, the solid/liquid phase ratio was 1:10
**The reaction time was 10 min for Pd and 40 min for Pt

For a leach mixture comprising a chloride ligand source, an oxidizing agent, an acid catalyst, and acetic acid as a water-miscible organic solvent, preferably glacial acetic acid: It was found that exchanging the acetic acid solvent for water—wherein the water as solvent comprises at least 50 wt % or more of the liquid phase of the leach mixture—resulted low to negligible Pd/Pt leaching.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### FULL CITATIONS FOR DOCUMENTS REFERRED TO IN THE DISCLOSURE

¹ J. Mardsen, I. House, The Chemistry of Gold Extraction. 1992, West Sussex, England.
² (a) E. B. Amey, “Gold” USGS Mineral Yearbook 2004 (Washington, D.C., USGS, 2004), pp. 34.1-34.9; (b) (https://www.statista.com/statistics/238414/global-gold-production-since-2005/).
³ (a) Anonymous, “Gold” Mining Journal, (Jun. 11, 2004), pp. 19-24; (b) (https://www.nrcan.gc.ca/our-natural-resources/minerals-mining/minerals-metals-facts/gold-facts/20514).
⁴ A. C. Grosse, G. W. Dicinoski, M. J. Shaw, P. R. Haddad, Hydrometallurgy2003, 69, 1-21.
⁵ I. Chandra, M. I. Jeffrey, Hydrometallurgy 2005, 77, 191-201.
⁶ G. A. Munoz, J. D. Miller, Minerals and Metallurgical Processing, 2000, 17, 198-204.
⁷ Dai, X., Breuer, P. L., Jeffrey, M. I. Minerals & Metallurgical Processing, 2010, 27, 190-195.
⁸ M. D. Adams, B. Sceresini, Elsevier, 2005, 789-824.
⁹ J. Z. Jiang, W. J. Zhou, H. C. Gao, J. G. Wu, G. X. Xu, and J. Chen. J. Inorg. Chem. 2001, 17, 343-48.
¹⁰ P. D. Kondos, G. Deschenes, R. M. Morrison, Hydrometallurgy, 1995, 39, 235-250.
¹¹ F. Habashi, A Textbook of Hydrometallurgy, Métallurgie Extractive Québec, Québec City, Canada, second edition, 1999.
¹² G. Q. Lui, W. T. Yen, Minerals Engineering, 1995, 8, 111-123.
¹³ G. Deschenes, G. Wallingford, Minerals Engineering, 1995, 8, 923-931.
¹⁴ Grosse, A. C.; Dicinoski, G. W.; Shaw, M. J.; Haddad, P. R. Hydrometallurgy, 2003, 69, 1-21.
¹⁵ Dai, X., Breuer, P. L., Jeffrey, M. I. Minerals & Metallurgical Processing, 2010, 27, 190-195.
¹⁶ Grosse, A. C. Dicinoski, G. W. Shaw, M. J. Haddad, P. R. Hydrometallurgy, 2003, 69, 1-21.
¹⁷ J. Z. Jiang, W. J. Zhou, H. C. Gao, J. G. Wu, G. X. Xu, and J. Chen. J. Inorg. Chem. 2001, 17, 343-48.
¹⁸ X. M. Zhang, G. Senanayake, M. J. Nicol, Hydrometallurgy, 2004, 74, 243.
¹⁹ G. Rabai, I. R. Epstein, Inorg. Chem. 1992, 31, 3239.
²⁰ S. Zhang, M. J. Nicol, J Appl. Electrochem, 2003, 33, 767.
²¹ Ritchie, I. M., Nicol, M. J., Staunton, W. P., Young, C. (Ed.), Cyanide: Social and Economic Aspects. TMS, Warrendale, 2001, pp. 427-440.
²² Berezowsky, R. M. G. S., Sefton, V. B., 108th AIME Annual Meeting, New Orleans, Louisiana, 1979, pp. 1-17.
²³ Aylmore, M. G., Muir, D. M, Miner. Eng. 2001, 14, 135-174.
²⁴ Breuer, P. L., Jeffrey, M. I., Hydrometallurgy, 2003, 70, 163-173.
²⁵ Feng, D., van Deventer, J. S. J., Hydrometallurgy, 2006, 82, 126-132.
²⁶ Kazakov, V. P.; Lapshin, A. I.; Peshchevitskii, B. I. Russ. J. Inorg. Chem. 1964, 9, 708.
²⁷ Plaskin, I. N. and Kozhukhova, M. A, Sbornik Nauchnyhk Trudov, Institut Tsvetnykh Metallov, 1960, 33, 107-119.
²⁸ Preisler, P. W. and Berger, L., Journal of the American Chemical Society, 1947, 69, 322-325.
²⁹ Schulze, R. G., 1984, Journal of Metals, 1984, 36, 62-65.
³⁰ Groenewald, T., Hydrometallurgy, 1976, 1, 277-290.
³¹ Gonen, N., Hydrometallurgy, 2003, 69, 169-176.
³² Krzewska, S. and Podsiadly, H., Journal of Inorganic and Nuclear Chemistry, 1980, 42, 83-86.
³³ Orgul, S., Atalay, Ü. Hydrometallurgy, 2002, 67, 71-77.
³⁴ J. W. Mellor, A Comprehensive Treatise of Inorganic and Theoretical Chemistry (London: Longman Green & Co., 1923), p. 499.
³⁵ F. Habashi, Principles of Extractive Metallurgy, Vol. 2^{nd} ed. (New York: Gordon and Breach, 1980), p. 39.
³⁶ Finkelstein, N. P., Hoare, R. M., James, G. S., Howat, D. D., Journal of the South African Institute of Mining and Metallurgy, 1996, 67, 196-215.
³⁷ Filmer, A. O., Lawrence, P. R., Hoffman, W., 1984. A comparison of cyanide, thiourea, and chlorine as lixiviants for gold. Gold—Mining, Metallurgy, and Geology. Australasian Institute of Mining and Metallurgy, Melbourne, pp. 279-287.
³⁸ Ikiz, D., Gulfen, M., Aydin, A. O. Minerals Engineering, 2006, 19, 972-974.
³⁹ Jeffrey, M. I., Breuer, P. L., Choo, W. L. Metall. Mater. Trans. 2001, B 32, 979-986.
⁴⁰ Nesbitt, C. C., Milosavljevic, E. B., Hendrix, J. L., Chem. Res. 1990, 29, 1696-1700.
⁴¹ Ghobeiti Hasab, M., Rashchi, F., Raygan, Sh. Miner. Eng. 2013, 50-51, 140-142.
⁴² Ghobeiti Hasab, M., Raygan, Sh., Rashchi, F., Hydrometallurgy, 2013, 138, 59-64.
⁴³ Cheng, Y. Shen, S. Zhang, J. Chen, S. Xiong, L. Liu J. Ind. Eng. Chem. Res. 2013, 52, 16622-16629.
⁴⁴ Parker, A. J. Muir, D. J. Smart, Y. C. Avraamides, J. Hydrometallurgy, 1981, 7, 213-233.
⁴⁵ Yoshimura, A. Takai, M. Matsuno, Y. Hydrometallurgy, 2014, 149, 177-182.
⁴⁶ Gill, J. B. Goodall, D. C. Jeffreys, B. Hydrometallurgy, 1984, 13, 221-226.
⁴⁷ Lin, W. Zhang, R. W. Jang, S. S. Wong, C. P. Hong, J. Angew. Chem. Int. Ed. 2010, 49, 7929-7932.
⁴⁸ Yukimichi, N. J. Chem. Soc., Chem. Commun. 1992, 426-427.

1. A method of selectively leaching palladium from a substance comprising platinum group metals, the method comprising:
contacting the substance with a leach mixture comprising
an iodide ligand source,
an iodine oxidant,
an optional acid catalyst,
an optional carboxylic acid stabilizer, and
a water-miscible organic solvent such as acetic acid, glacial acetic acid, acetonitrile, ethyl acetate, tetrahydrofuran, or combinations thereof, preferably glacial acetic acid,
under conditions to selectively leach the palladium from the substance comprising platinum group metals;
selectively leaching the palladium from the substance; and
forming a leach solution comprising leached palladium.

2. The method of claim 1, wherein the iodide ligand source comprises NaI, KI, HI, NH₄I, CsI, or a combination thereof; or preferably NaI, KI, HI, or a combination thereof; or more preferably NaI, KI, or a combination thereof.

3. The method of claim 1 or 2, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

4. The method of any one of claims 1 to 3, wherein the iodine oxidant comprises I₂; and optionally, the method further comprises generating the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.

5. The method of claim 4, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the solvent, preferably between about 0.01 to about 0.1 M.

6. The method of any one of claims 1 to 5, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.

7. The method of any one of claims 1 to 6, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

8. The method of any one of claims 1 to 7, wherein the carboxylic acid stabilizer comprises acetic acid, citric acid, or a combination thereof.

9. The method of claim 8, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.

10. The method of any one of claims 1 to 9, wherein the water-miscible organic solvent makes up at least 50 wt % of the liquid phase of the leach mixture.

11. The method of any one of claims 1 to 10, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.

12. The method of claim 11, wherein the conditions to selectively leach the palladium further comprise contacting the substance with the leach mixture at a solid to liquid phase ratio of 1:10.

13. The method of claim 11 or 12, wherein the conditions to selectively leach the palladium are tolerant of up to about 10 wt % water, or between about 10 wt % to less than 50 wt % water, such as 30 wt % water.

14. The method of any one of claims 1 to 13, wherein the substance comprising platinum group metals further comprises oxidized platinum group metals, and the method further comprises contacting the substance with a reductant under conditions to at least partially reduce the oxidized platinum group metals; and at least partially reducing the oxidized platinum group metals.

15. The method of claim 14, wherein the reductant comprises organic reductants, such as ascorbic acid, formic acid, oxalic acid, or salts thereof, or a combination thereof;
inorganic reductants, such as H₂, NaBH₄, FeCl₂, hydrazine hydrochloride, hydroxylamine hydrochloride, or a combination thereof; or a combination thereof.

16. The method of claim 14 or 15, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

17. The method of any one of claims 1 to 16, wherein the platinum group metals of the substance comprising platinum group metals comprise a contaminant, the method further comprising contacting the substance with a chelating agent under conditions to at least partially remove the contaminant; and at least partially decontaminating the platinum group metals.

18. The method of claim 17, wherein the chelating agent comprises citric acid, oxalic acid, or salts thereof, or a combination thereof; preferably citric acid and/or salt thereof.

19. The method of claim 17 or 18, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

20. The method of any one of claims 17 to 19, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

21. The method of any one of claims 1 to 20, wherein the method selectively leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9%, of the palladium in the substance.

22. The method of any one of claims 1 to 21, further comprising adding an oxidant and a polyatomic salt to the leach solution under conditions to precipitate the leached palladium; and precipitating the leached palladium.

23. The method of claim 22, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

24. The method of claim 22 or 23, wherein the polyatomic salt comprises an ammonium salt, such as ammonium chloride, ammonium sulfate, ammonium nitrate, or combinations thereof.

25. The method of any one of claims 22 to 24, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

26. The method of any one of claims 22 to 25, further comprising contacting the leached palladium with a reducing agent under conditions to reduce the leached palladium to palladium metal; and reducing the leached palladium to palladium metal.

27. The method of claim 26, wherein contacting the leached palladium with the reducing agent comprises forming an aqueous mixture comprising the leached palladium, and adding the reducing agent to the aqueous mixture.

28. The method of claim 26 or 27, wherein the reducing agent comprises H₂, metal powder, metal strips, or a combination thereof, the metal comprising Al, Cu, Fe, Zn, or a combination thereof.

29. The method of any one of claims 26 to 28, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

30. The method of any one of claims 26 to 29, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

31. The method of claim 30, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M;
and/or (iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

32. The method of claim 30 or 31, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

33. The method of any one of claims 22 to 32, wherein the palladium metal has a purity of about 90% to about 100%, or about 95% to about 99.9%, or about 98% to about 99.9%.

34. The method of any one of claims 1 to 33, wherein the substance comprising platinum group metals is a platinum group metal ore, a platinum group metal concentrate, electronic or electrical waste, a spent catalyst, or a catalytic converter; preferably a spent catalyst or catalytic converter.

35. The method of any one of claims 1 to 34, wherein the platinum group metals of the substance comprising platinum group metals comprise palladium, palladium and platinum, or palladium, platinum, and rhodium.

36. A process of selectively leaching palladium from a substance comprising platinum group metals, the process comprising:
contacting the substance with a leach mixture comprising
an iodide ligand source,
an iodine oxidant,
an optional acid catalyst,
an optional carboxylic acid stabilizer, and
a water-miscible organic solvent such as acetic acid, glacial acetic acid, acetonitrile, ethyl acetate, tetrahydrofuran, or combinations thereof, preferably glacial acetic acid,
under conditions to selectively leach the palladium from the substance comprising platinum group metals;
selectively leaching the palladium from the substance to form a leach solution comprising leached palladium and a leached substance;
separating the leach solution from the leached substance; and
treating the leach solution comprising leached palladium under conditions to form palladium metal.

37. The process of claim 36, wherein the iodide ligand source comprises NaI, KI, HI, NH₄I, CsI, or a combination thereof; or preferably NaI, KI, HI, or a combination thereof; or more preferably NaI, KI, or a combination thereof.

38. The process of claim 36 or 37, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

39. The process of any one of claims 36 to 38, wherein the iodine oxidant comprises l₂; and optionally, the process further comprises generating the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.

40. The process of claim 39, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the glacial acetic acid solvent, preferably between about 0.01 to about 0.1 M.

41. The process of any one of claims 36 to 40, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.

42. The process of any one of claims 36 to 41, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

43. The process of any one of claims 36 to 42, wherein the carboxylic acid stabilizer comprises acetic acid, citric acid, or a combination thereof.

44. The process of claim 43, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.

45. The process of any one of claims 36 to 44, wherein the water-miscible organic solvent makes up at least 50 wt % of the liquid phase of the leach mixture.

46. The process of any one of claims 36 to 45, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.

47. The process of claim 46, wherein the conditions to selectively leach the palladium further comprise contacting the substance with the leach mixture at a solid to liquid phase ratio of 1:10.

48. The process of claim 46 or 47, wherein the conditions to selectively leach the palladium are tolerant of up to about 10 wt % water, or between about 10 wt % to less than 50 wt % water, such as 30 wt % water.

49. The process of any one of claims 36 to 48, wherein the substance comprising platinum group metals further comprises oxidized platinum group metals, and the process further comprises contacting the substance with a reductant under conditions to at least partially reduce the oxidized platinum group metals; and at least partially reducing the oxidized platinum group metals.

50. The process of claim 49, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

51. The process of claim 49 or 50, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

52. The process of any one of claims 36 to 51, wherein the platinum group metals of the substance comprising platinum group metals comprise a contaminant, the process further comprising contacting the substance with a chelating agent under conditions to at least partially remove the contaminant; and at least partially decontaminating the platinum group metals.

53. The process of claim 52, wherein the chelating agent comprises citric acid, oxalic acid, or salts thereof, or a combination thereof; preferably citric acid and/or salt thereof.

54. The process of claim 52 or 53, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

55. The process of any one of claims 52 to 54, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

56. The process of any one of claims 36 to 55, wherein the process selectively leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the substance.

57. The process of any one of claims 36 to 56, wherein treating the leach solution comprising leached palladium under conditions to form palladium metal comprises adding an oxidant and a polyatomic salt to the leach solution under conditions to precipitate the leached palladium; and precipitating the leached palladium.

58. The process of claim 57, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

59. The process of claim 57 or 58, wherein the polyatomic salt comprises an ammonium salt, such as ammonium chloride, ammonium sulfate, ammonium nitrate, or combinations thereof.

60. The process of any one of claims 57 to 59, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

61. The process of any one of claims 57 to 60, wherein treating the leach solution comprising leached palladium under conditions to form palladium metal further comprises contacting the leached palladium with a reducing agent under conditions to reduce the leached palladium to palladium metal; and reducing the leached palladium to palladium metal.

62. The process of claim 61, wherein contacting the leached palladium with the reducing agent comprises forming an aqueous mixture comprising the leached palladium, and adding the reducing agent to the aqueous mixture.

63. The process of claim 61 or 62, wherein the reducing agent comprises H₂, metal powder, metal strips, or a combination thereof, the metal comprising Al, Cu, Fe, Zn, or a combination thereof.

64. The process of any one of claims 61 to 63, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

65. The process of any one of claims 61 to 64, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

66. The process of claim 65, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

67. The process of claim 65 or 66, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

68. The process of any one of claims 57 to 67, wherein the palladium metal has a purity of about 90% to about 100%, or about 95% to about 99.9%, or about 98% to about 99.9%.

69. The process of any one of claims 36 to 68, wherein the substance comprising platinum group metals is a platinum group metal ore, a platinum group metal concentrate, electronic or electrical waste, a spent catalyst, or a catalytic converter; preferably a spent catalyst or catalytic converter.

70. The process of any one of claims 36 to 69, wherein the platinum group metals of the substance comprising platinum group metals comprise palladium, palladium and platinum, or palladium, platinum, and rhodium.

71. A method of simultaneously and selectively leaching at least two of palladium, platinum, and rhodium from a substance comprising platinum group metals, the method comprising:
contacting the substance with a leach mixture comprising
a chloride ligand source,
an oxidizing agent,
an acid catalyst, and
a water-miscible organic solvent such as acetic acid, glacial acetic acid, acetonitrile, ethyl acetate, tetrahydrofuran, or combinations thereof, preferably glacial acetic acid,
under conditions to simultaneously and selectively leach at least two of the palladium, platinum, and rhodium from the substance comprising platinum group metals;
simultaneously and selectively leaching at least two of the palladium, platinum, and rhodium from the substance; and
forming a leach solution comprising at least two of leached palladium, platinum, and rhodium.

72. The method of claim 71, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.

73. The method of claim 71 or 72, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

74. The method of any one of claims 71 to 73, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.

75. The method of claim 74, wherein the oxidizing agent has a concentration of from about 0.01 M to about 2.5 M in the solvent, preferably between about 0.01 to about 1 M.

76. The method of any one of claims 71 to 75, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.

77. The method of any one of claims 71 to 76, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

78. The method of any one of claims 71 to 77, wherein the water-miscible organic solvent makes up at least 50 wt % of the liquid phase of the leach mixture.

79. The method of any one of claims 71 to 78, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.

80. The method of claim 79, wherein the conditions to simultaneously and selectively leach at least two of palladium, platinum, and rhodium further comprise contacting the substance with the leach mixture at a solid to liquid phase ratio of 1:10.

81. The method of claim 79 or 80, wherein the conditions to simultaneously and selectively leach at least two of palladium, platinum, and rhodium are tolerant of up to about 10 wt % water, or between about 10 wt % to less than 50 wt % water, such as 30 wt % water.

82. The method of any one of claims 71 to 81, wherein the substance comprising platinum group metals further comprises oxidized platinum group metals, and the method further comprises contacting the substance with a reductant under conditions to at least partially reduce the oxidized platinum group metals; and at least partially reducing the oxidized platinum group metals.

83. The method of claim 82, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

84. The method of claim 82 or 83, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

85. The method of any one of claims 71 to 84, wherein the platinum group metals of the substance comprising platinum group metals comprise a contaminant, the method further comprising contacting the substance with a chelating agent under conditions to at least partially remove the contaminant; and at least partially decontaminating the platinum group metals.

86. The method of claim 85, wherein the chelating agent comprises citric acid, oxalic acid, or salts thereof, or a combination thereof; preferably citric acid and/or salt thereof.

87. The method of claim 86 or 86, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

88. The method of any one of claims 85 to 87, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

89. The method of any one of claims 71 to 88, wherein the method leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.

90. The method of any one of claims 71 to 89, further comprising adding an oxidant and a polyatomic salt to the leach solution under conditions to precipitate the leached palladium, platinum, and/or rhodium; and precipitating the leached palladium, platinum, and/or rhodium.

91. The method of claim 90, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

92. The method of claim 90 or 91, wherein the polyatomic salt comprises an ammonium salt, such as ammonium chloride, ammonium sulfate, ammonium nitrate, or combinations thereof.

93. The method of any one of claims 90 to 92, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

94. The method of any one of claims 90 to 93, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

95. The method of claim 94, wherein contacting the leached palladium, platinum, and/or rhodium with the reducing agent comprises forming an aqueous mixture comprising the leached palladium, platinum, and/or rhodium, and adding the reducing agent to the aqueous mixture.

96. The method of claim 94 or 95, wherein the reducing agent comprises H₂, metal powder, metal strips, or a combination thereof, the metal comprising Al, Cu, Fe, Zn, or a combination thereof.

97. The method of any one of claims 94 to 96, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

98. The method of any one of claims 94 to 97, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

99. The method of claim 98, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

100. The method of claim 98 or 99, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

101. The method of any one of claims 90 to 100, wherein at least one of the palladium, platinum, and/or rhodium metal has a purity of about 90% to about 100%, or about 95% to about 99.9%, or about 98% to about 99.9%.

102. The method of any one of claims 71 to 101, wherein the substance comprising platinum group metals is a platinum group metal ore, a platinum group metal concentrate, electronic or electrical waste, a spent catalyst, or a catalytic converter; preferably a spent catalyst or catalytic converter.

103. The method of any one of claims 71 to 102, wherein the platinum group metals of the substance comprising platinum group metals comprise palladium, platinum, and/or rhodium.

104. Use of a leach mixture for simultaneously and selectively leaching at least two of palladium, platinum, and rhodium from a substance comprising platinum group metals, under conditions to simultaneously and selectively leach at least two of the palladium, platinum, and rhodium from the substance comprising platinum group metals, and forming a leach solution comprising at least two of leached palladium, platinum, and rhodium, the leach mixture comprising
a chloride ligand source,
an oxidizing agent,
an acid catalyst, and
a water-miscible organic solvent such as acetic acid, glacial acetic acid, acetonitrile, ethyl acetate, tetrahydrofuran, or combinations thereof, preferably glacial acetic acid.

105. The use of claim 104, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.

106. The use of claim 104 or 105, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

107. The use of any one of claims 104 to 105, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.

108. The use of claim 107, wherein the oxidizing agent has a concentration of from about 0.01 M to about 2.5 M in the solvent, preferably between about 0.01 to about 1 M.

109. The use of any one of claims 104 to 108, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.

110. The use of any one of claims 104 to 109, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

111. The use of any one of claims 104 to 110, wherein the water-miscible organic solvent makes up at least 50 wt % of the liquid phase of the leach mixture.

112. The use of any one of claims 104 to 111, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.

113. The use of claim 112, wherein the conditions to simultaneously and selectively leach at least two of palladium, platinum, and rhodium further comprise contacting the substance with the leach mixture at a solid to liquid phase ratio of 1:10.

114. The use of claim 112 or 113, wherein the conditions to simultaneously and selectively leach at least two of palladium, platinum, and rhodium are tolerant of up to about 10 wt % water, or between about 10 wt % to less than 50 wt % water, such as 30 wt % water.

115. The use of any one of claims 104 to 114, wherein the substance comprising platinum group metals further comprises oxidized platinum group metals, and the use further comprises use of a reductant for contacting the substance under conditions to at least partially reduce the oxidized platinum group metals; and at least partially reducing the oxidized platinum group metals.

116. The use of claim 115, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

117. The use of claim 115 or 116, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

118. The use of any one of claims 104 to 117, wherein the platinum group metals of the substance comprising platinum group metals comprise a contaminant, the use further comprising use of a chelating agent for contacting the substance under conditions to at least partially remove the contaminant; and at least partially decontaminating the platinum group metals.

119. The use of claim 118, wherein the chelating agent comprises citric acid, oxalic acid, or salts thereof, or a combination thereof; preferably citric acid and/or salt thereof.

120. The use of claim 118 or 119, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

121. The use of any one of claims 118 to 120, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

122. The use of any one of claims 104 to 121, wherein the leach mixture leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.

123. The use of any one of claims 104 to 122, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.

124. The use of claim 123, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

125. The use of claim 123 or 124, wherein the polyatomic salt comprises an ammonium salt, such as ammonium chloride, ammonium sulfate, ammonium nitrate, or combinations thereof.

126. The use of any one of claims 123 to 125, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

127. The use of any one of claims 123 to 126, further comprising use of a reducing agent for reducing the leached palladium, platinum, and/or rhodium by contacting the leached palladium, platinum, and/or rhodium with the reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

128. The use of claim 127, wherein contacting the leached palladium, platinum, and/or rhodium with the reducing agent comprises forming an aqueous mixture comprising the precipitated leached palladium, platinum, and/or rhodium, and adding the reducing agent to the aqueous mixture.

129. The use of claim 127, wherein the reducing agent comprises H₂, metal powder, metal strips, or a combination thereof, the metal comprising Al, Cu, Fe, Zn, or a combination thereof.

130. The use of claim 127 or 128, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

131. The use of any one of claims 127 to 130, wherein the palladium, platinum, and/or rhodium metal at least comprises palladium metal, the use further comprising use of a refining mixture for refining the palladium metal of the palladium, platinum, and/or rhodium metals under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

132. The use of claim 131, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

133. The use of claim 131 or 132, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

134. The use of any one of claims 123 to 133, wherein at least one of the palladium, platinum, and/or rhodium metal has a purity of about 90% to about 100%, or about 95% to about 99.9%, or about 98% to about 99.9%.

135. The use of any one of claims 104 to 134, wherein the substance comprising platinum group metals is a platinum group metal ore, a platinum group metal concentrate, electronic or electrical waste, a spent catalyst, or a catalytic converter; preferably a spent catalyst or catalytic converter.

136. The use of any one of claims 104 to 135, wherein the platinum group metals of the substance comprising platinum group metals comprise palladium, platinum, and/or rhodium.

137. A process of simultaneously and selectively leaching at least two of palladium, platinum, and rhodium from a substance comprising platinum group metals, the process comprising:
contacting the substance with a leach mixture comprising
a chloride ligand source,
an oxidizing agent,
an acid catalyst, and
a water-miscible organic solvent such as acetic acid, glacial acetic acid, acetonitrile, ethyl acetate, tetrahydrofuran, or combinations thereof, preferably glacial acetic acid,
under conditions to simultaneously and selectively leach at least two of the palladium, platinum, and rhodium from the substance comprising platinum group metals;
simultaneously and selectively leaching at least two of the palladium, platinum, and rhodium from the substance to form a leach solution comprising leached palladium, platinum, and/or rhodium and a leached substance;
separating the leach solution from the leached substance; and
treating the leach solution comprising leached palladium, platinum, and/or rhodium under conditions to form palladium, platinum, and/or rhodium metal.

138. The process of claim 137, wherein the chloride ligand source comprises HCl, MgCl₂, AlCl₃, CaCl₂, or a combination thereof; or preferably HCl, AlCl₃, CaCl₂, or a combination thereof; or more preferably HCl, CaCl₂, or a combination thereof.

139. The process of claim 137 or 138, wherein the chloride ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

140. The process of any one of claims 137 to 139, wherein the oxidizing agent comprises H₂O₂, NaClO₂, NaClO₃, NaClO, K₂Cr₂O₇, KMnO₄, Ca(ClO)₂, Cl₂, HNO₃, CaO₂, MnO₂, CaO₂ and MnO₂, CuCl₂, FeCl₃, O₂, bubbled air, or a combination thereof; preferably H₂O₂, Cl₂, HNO₃, CaO₂, MnO₂, CaO₂ and MnO₂, CuCl₂, FeCl₃, O₂, bubbled air, or a combination thereof; more preferably H₂O₂, Cl₂, CaO₂, MnO₂, CaO₂ and MnO₂, CuCl₂, FeCl₃, or a combination thereof.

141. The process of claim 140, wherein the oxidizing agent has a concentration of from about 0.01 M to about 2.5 M in the solvent, preferably between about 0.01 to about 1 M.

142. The process of any one of claims 137 to 141, wherein the acid catalyst comprises a hydrogen halide, sulfuric acid, phosphoric acid, or a combination thereof; or preferably HCl, H₂SO₄, or a combination thereof; or more preferably HCl; and optionally, the acid catalyst is the chloride ligand source.

143. The process of any one of claims 137 to 142, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

144. The process of any one of claims 137 to 143, wherein the water-miscible organic solvent makes up at least 50 wt % of the liquid phase of the leach mixture.

145. The process of any one of claims 137 to 144, wherein the conditions to simultaneously and selectively leach at least two of palladium, platinum, and rhodium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 5 hours; and the temperature is about 60° C. to about 90° C.

146. The process of claim 145, wherein the conditions to simultaneously and selectively leach at least two of palladium, platinum, and rhodium further comprise contacting the substance with the leach mixture at a solid to liquid phase ratio of 1:10.

147. The process of claim 145 or 146, wherein the conditions to simultaneously and selectively leach at least two of palladium, platinum, and rhodium are tolerant of up to about 10 wt % water, or between about 10 wt % to less than 50 wt % water, such as 30 wt % water.

148. The process of any one of claims 137 to 147, wherein the substance comprising platinum group metals further comprises oxidized platinum group metals, and the process further comprises contacting the substance with a reductant under conditions to at least partially reduce the oxidized platinum group metals; and at least partially reducing the oxidized platinum group metals.

149. The process of claim 148, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

150. The process of claim 148 or 149, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

151. The process of any one of claims 137 to 150, wherein the platinum group metals of the substance comprising platinum group metals comprise a contaminant, the process further comprising contacting the substance with a chelating agent under conditions to at least partially remove the contaminant; and at least partially decontaminating the platinum group metals.

152. The process of claim 151, wherein the chelating agent comprises citric acid, oxalic acid, or salts thereof, or a combination thereof; preferably citric acid and/or salt thereof.

153. The process of claim 151 or 152, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

154. The process of any one of claims 151 to 153, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

154. The process of any one of claims 137 to 154, wherein the process leaches about leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the substance, preferably at least two of the palladium, platinum, and rhodium.

155. The process of any one of claims 137 to 154, wherein treating the leach solution comprising leached palladium, platinum, and/or rhodium under conditions to form palladium, platinum, and/or rhodium metal comprises adding an oxidant and a polyatomic salt to the leach solution under conditions to precipitate the leached palladium, platinum, and/or rhodium; and precipitating the leached palladium, platinum, and/or rhodium.

156. The process of claim 155, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

157. The process of claim 155 or 156, wherein the polyatomic salt comprises an ammonium salt, such as ammonium chloride, ammonium sulfate, ammonium nitrate, or combinations thereof.

158. The process of any one of claims 155 to 157, wherein the conditions to precipitate the leached palladium, platinum, and/or rhodium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

159. The process of any one of claims 155 to 158, wherein treating the leach solution comprising leached palladium, platinum, and/or rhodium under conditions to form palladium, platinum, and/or rhodium metal further comprises contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

160. The process of claim 159, wherein contacting the leached palladium, platinum, and/or rhodium with the reducing agent comprises forming an aqueous mixture comprising the leached palladium, platinum, and/or rhodium, and adding the reducing agent to the aqueous mixture.

161. The process of claim 159 or 160, wherein the reducing agent comprises H₂, metal powder, metal strips, or a combination thereof, the metal comprising Al, Cu, Fe, Zn, or a combination thereof.

162. The process of any one of claims 159 to 161, wherein the conditions to reduce the leached palladium, platinum, and/or rhodium to palladium, platinum, and/or rhodium metal comprises contacting the leached palladium, platinum, and/or rhodium with a reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

163. The process of any one of claims 159 to 162, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

164. The process of claim 163, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

165. The process of claim 163 or 164, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

166. The process of any one of claims 155 to 165, wherein at least one of the palladium, platinum, and/or rhodium metal has a purity of about 90% to about 100%, or about 95% to about 99.9%, or about 98% to about 99.9%.

167. The process of any one of claims 137 to 166, wherein the substance comprising platinum group metals is a platinum group metal ore, a platinum group metal concentrate, electronic or electrical waste, a spent catalyst, or a catalytic converter; preferably a spent catalyst or catalytic converter.

168. The process of any one of claims 137 to 167, wherein the platinum group metals of the substance comprising platinum group metals comprise palladium, platinum, and/or rhodium.

169. A method of selectively leaching palladium from a spent catalyst comprising palladium and platinum, the method comprising:
contacting the spent catalyst with a leach mixture comprising
an metal iodide ligand source,
an iodine-based oxidizing agent,
an optional acid catalyst, and
acetic acid as a water-miscible organic solvent, preferably glacial acetic acid,
under conditions to selectively leach the palladium from the spent catalyst comprising palladium and platinum;
selectively leaching the palladium from the spent catalyst; and
forming a leach solution comprising leached palladium.

170. The method of claim 169, wherein the metal iodide ligand source NaI, KI, or a combination thereof.

171. The method of claim 169 or 170, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

172. The method of any one of claims 169 to 171, wherein the iodine-based oxidizing agent comprises I₂, NaIO₃, or a combination thereof.

173. The method of claim 172, wherein the iodine-based oxidizing agent has a concentration of from about 0.01 M to about 0.1 M in the acetic acid solvent, preferably a concentration from about 0.01 to about 0.05 M.

174. The method of any one of claims 169 to 173, wherein the acid catalyst comprises a hydrogen halide; preferably HCl.

175. The method of any one of claims 169 to 174, wherein the acid catalyst has a concentration of from about 0.01 M to about 1 M in the acetic acid solvent; or preferably has a concentration of from about 0.1 M to about 0.5 M.

176. The method of any one of claims 169 to 175, wherein the acetic acid as the water-miscible organic solvent makes up at least 50 wt % of the liquid phase of the leach mixture.

177. The method of any one of claims 169 to 176, wherein the conditions to selectively leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.

178. The method of claim 177, wherein the conditions to selectively leach the palladium further comprise contacting the spent catalyst with the leach mixture at a solid to liquid phase ratio of 1:10.

179. The method of claim 177 or 178, wherein the conditions to selectively leach the palladium are tolerant of up to about 10 wt % water.

180. The method of any one of claims 169 to 179, wherein the spent catalyst comprises oxidized palladium and platinum, and the method further comprises contacting the spent catalyst with a reductant under conditions to at least partially reduce the oxidized palladium and platinum; and at least partially reducing the oxidized palladium and platinum.

181. The method of claim 180, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

182. The method of claim 180 or 181, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

183. The method of any one of claims 169 to 182, wherein the palladium and platinum of the spent catalyst comprise a contaminant, the method further comprising contacting the spent catalyst with a chelating agent under conditions to at least partially remove the contaminant; and at least partially decontaminating the palladium and platinum.

184. The method of claim 183, wherein the chelating agent comprises citric acid, oxalic acid, or salts thereof, or a combination thereof; preferably citric acid and/or salt thereof.

185. The method of claim 183 or 184, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

186. The method of any one of claims 183 to 185, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

187. The method of any one of claims 169 to 186, wherein the method selectively leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.

188. The method of any one of claims 169 to 187, further comprising adding an oxidant and a polyatomic salt to the leach solution under conditions to precipitate the leached palladium; and precipitating the leached palladium.

189. The method of claim 188, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

190. The method of claim 188 or 189, wherein the polyatomic salt comprises an ammonium salt, such as ammonium chloride, ammonium sulfate, ammonium nitrate, or combinations thereof.

191. The method of any one of claims 188 to 190, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

192. The method of any one of claims 188 to 191, further comprising contacting the leached palladium with a reducing agent under conditions to reduce the leached palladium to palladium metal; and reducing the leached palladium to palladium metal.

193. The method of claim 192, wherein contacting the leached palladium with the reducing agent comprises forming an aqueous mixture comprising the leached palladium, and adding the reducing agent to the aqueous mixture.

194. The method of claim 192 or 193, wherein the reducing agent comprises H₂, metal powder, metal strips, or a combination thereof, the metal comprising Al, Cu, Fe, Zn, or a combination thereof.

195. The method of any one of claims 192 to 194, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

196. The method of any one of claims 192 to 195, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

197. The method of claim 196, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

198. The method of claim 196 or 197, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

199. The method of any one of claims 188 to 198, wherein the palladium metal has a purity of about 90% to about 100%, or about 95% to about 99.9%, or about 98% to about 99.9%.

200. The method of any one of claims 169 to 199, wherein the spent catalyst is a catalytic converter; preferably a gasoline-based or diesel-based catalytic converter in biscuit form.

201. Use of a leach mixture for selectively leaching palladium from a spent catalyst comprising palladium and platinum under conditions to selectively leach the palladium from the spent catalyst comprising palladium and platinum, and forming a leach solution comprising leached palladium, the leach mixture comprising
an metal iodide ligand source,
an iodine-based oxidizing agent,
an optional acid catalyst, and
acetic acid as a water-miscible organic solvent, preferably glacial acetic acid,
under conditions to selectively leach the palladium from the spent catalyst comprising palladium and platinum;
selectively leaching the palladium from the spent catalyst; and
forming a leach solution comprising leached palladium.

202. The use of claim 201, wherein the metal iodide ligand source NaI, KI, or a combination thereof.

203. The use of claim 201 or 202, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

204. The use of any one of claims 201 to 203, wherein the iodine-based oxidizing agent comprises I₂, NaIO₃, or a combination thereof.

205. The use of claim 204, wherein the iodine-based oxidizing agent has a concentration of from about 0.01 M to about 0.1 M in the acetic acid solvent, preferably a concentration from about 0.01 to about 0.05 M.

206. The use of any one of claims 201 to 205, wherein the acid catalyst comprises a hydrogen halide; preferably HCl.

207. The use of any one of claims 201 to 206, wherein the acid catalyst has a concentration of from about 0.01 M to about 1 M in the acetic acid solvent; or preferably has a concentration of from about 0.1 M to about 0.5 M.

208. The use of any one of claims 201 to 207, wherein the acetic acid as the water-miscible organic solvent makes up at least 50 wt % of the liquid phase of the leach mixture.

209. The use of any one of claims 201 to 208, wherein the conditions to selectively leach the palladium from the spent catalyst comprises contacting the spent catalyst with the leach mixture for a time of about 10 min to about 18 hours, at a temperature of about 20° C. to about 30° C., under ambient pressure; wherein preferably, the time is about 30 min to about 18 hours; and the temperature is about 20° C. to about 25° C.

210. The use of claim 209, wherein the conditions to selectively leach the palladium further comprise contacting the spent catalyst with the leach mixture at a solid to liquid phase ratio of 1:10.

211. The use of claim 209 or 210, wherein the conditions to selectively leach the palladium are tolerant of up to about 10 wt % water.

212. The use of any one of claims 201 to 211, wherein the spent catalyst further comprises oxidized palladium and platinum, and the use further comprises use of a reductant for contacting the spent catalyst under conditions to at least partially reduce the oxidized palladium and platinum; and at least partially reducing the oxidized palladium and platinum.

213. The use of claim 212, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

214. The use of claim 212 or 213, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

215. The use of any one of claims 201 to 214, wherein the palladium and platinum of the spent catalyst comprise a contaminant, the use further comprising use of a chelating agent for contacting the spent catalyst under conditions to at least partially remove the contaminant; and at least partially decontaminating the palladium and platinum.

216. The use of claim 215, wherein the chelating agent comprises citric acid, oxalic acid, or salts thereof, or a combination thereof; preferably citric acid and/or salt thereof.

217. The use of claim 215 or 216, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

218. The use of any one of claims 215 to 217, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

219. The use of any one of claims 201 to 218, wherein the leach mixture selectively leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.

220. The use of any one of claims 201 to 219, further comprising use of an oxidant and a polyatomic salt for precipitating the leached palladium by adding an oxidant and a polyatomic salt to the leach solution under conditions to precipitate the leached palladium; and precipitating the leached palladium.

221. The use of claim 220, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

222. The use of claim 220 or 221, wherein the polyatomic salt comprises an ammonium salt, such as ammonium chloride, ammonium sulfate, ammonium nitrate, or combinations thereof.

223. The use of any one of claims 220 to 222, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

224. The use of any one of claims 220 to 223, further comprising use of a reducing agent for reducing the leached palladium to palladium metal by contacting the leached palladium with the reducing agent under conditions to reduce the leached palladium to palladium metal; and reducing the leached palladium to palladium metal.

225. The use of claim 224, wherein contacting the leached palladium with the reducing agent comprises forming an aqueous mixture comprising the leached palladium, and adding the reducing agent to the aqueous mixture.

226. The use of claim 224 or 225, wherein the reducing agent comprises H₂, metal powder, metal strips, or a combination thereof, the metal comprising Al, Cu, Fe, Zn, or a combination thereof.

227. The use of any one of claims 224 to 226, wherein the conditions to reduce the leached palladium to palladium metal comprises contacting the leached palladium with a reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

228. The use of any one of claims 224 to 227, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

229. The use of claim 228, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

230. The use of claim 228 or 229, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

231. The use of any one of claims 220 to 230, wherein the palladium metal has a purity of about 90% to about 100%, or about 95% to about 99.9%, or about 98% to about 99.9%.

232. The use of any one of claims 201 to 231, wherein the spent catalyst is a catalytic converter; preferably a gasoline-based or diesel-based catalytic converter in biscuit form.

233. A process of recycling palladium from a spent catalyst comprising palladium and platinum, the process comprising:
contacting the spent catalyst with a leach mixture comprising
an metal iodide ligand source,
an iodine-based oxidizing agent,
an optional acid catalyst, and
acetic acid as a water-miscible organic solvent, preferably glacial acetic acid,
under conditions to leach the palladium from the spent catalyst comprising palladium and platinum;
leaching the palladium from the spent catalyst to form a leach solution comprising leached palladium and a leached spent catalyst; and
separating the leach solution from the leached spent catalyst; and
treating the leach solution comprising leached palladium under conditions to form palladium metal.

234. The process of cl233, wherein the metal iodide ligand source NaI, KI, or a combination thereof.

235. The process of claim 233 or 234, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

236. The process of any one of claims 233 to 235, wherein the iodine-based oxidizing agent comprises I₂, NaIO₃, or a combination thereof.

237. The process of claim 236, wherein the iodine-based oxidizing agent has a concentration of from about 0.01 M to about 0.1 M in the acetic acid solvent, preferably a concentration from about 0.01 to about 0.05 M.

238. The process of any one of claims 233 to 237, wherein the acid catalyst comprises a hydrogen halide; preferably HCl.

239. The process of any one of claims 233 to 238, wherein the acid catalyst has a concentration of from about 0.01 M to about 1 M in the acetic acid solvent; or preferably has a concentration of from about 0.1 M to about 0.5 M.

240. The process of any one of claims 233 to 239, wherein the acetic acid as the water-miscible organic solvent makes up at least 50 wt % of the liquid phase of the leach mixture.

241. The process of any one of claims 233 to 240, wherein the conditions to leach the palladium from the spent catalyst comprises contacting the spent catalyst with the leach mixture for a time of about 10 min to about 18 hours, at a temperature of about 20° C. to about 30° C., under ambient pressure; wherein preferably, the time is about 30 min to about 18 hours; and the temperature is about 20° C. to about 25° C.

242. The process of claim 241, wherein the conditions to leach the palladium further comprise contacting the spent catalyst with the leach mixture at a solid to liquid phase ratio of 1:10.

243. The process of claim 241 or 242, wherein the conditions to leach the palladium are tolerant of up to about 10 wt % water.

244. The process of any one of claims 233 to 243, wherein the spent catalyst further comprises oxidized palladium and platinum, and the process further comprises contacting the spent catalyst with a reductant under conditions to at least partially reduce the oxidized palladium and platinum; and at least partially reducing the oxidized palladium and platinum.

245. The process of claim 244, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

246. The process of claim 244 or 245, wherein the conditions to at least partially reduce the oxidized palladium and platinum comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

247. The process of any one of claims 233 to 246, wherein the palladium and platinum of the spent catalyst comprise a contaminant, the process further comprising contacting the spent catalyst with a chelating agent under conditions to at least partially remove the contaminant; and at least partially decontaminating the palladium and platinum.

248. The process of claim 247, wherein the chelating agent comprises citric acid, oxalic acid, or salts thereof, or a combination thereof; preferably citric acid and/or salt thereof.

249. The process of claim 247 or 248, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

250. The process of any one of claims 247 to 249, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

251. The process of any one of claims 233 to 250, wherein the process leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9% of the palladium in the spent catalyst.

252. The process of any one of claims 233 to 251, wherein treating the leach solution comprising leached palladium under conditions to form palladium metal comprises adding an oxidant and a polyatomic salt to the leach solution under conditions to precipitate the leached palladium; and precipitating the leached palladium.

253. The process of claim 252, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

254. The process of claim 252 or 253, wherein the polyatomic salt comprises an ammonium salt, such as ammonium chloride, ammonium sulfate, ammonium nitrate, or combinations thereof.

255. The process of any one of claims 252 to 254, wherein the conditions to precipitate the leached palladium comprise contacting the leach mixture with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

256. The process of any one of claims 252 to 255, wherein treating the leach solution comprising leached palladium under conditions to form palladium metal further comprises contacting the leached palladium with a reducing agent under conditions to reduce the leached palladium to palladium metal; and reducing the leached palladium to palladium metal.

257. The process of claim 256, wherein contacting the leached palladium with the reducing agent comprises forming an aqueous mixture comprising the leached palladium, and adding the reducing agent to the aqueous mixture.

258. The process of claim 256 or 257, wherein the reducing agent comprises H₂, metal powder, metal strips, or a combination thereof, the metal comprising Al, Cu, Fe, Zn, or a combination thereof.

259. The process of any one of claims claim 256 to 258, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

260. The process of any one of claims 256 to 259, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

261. The process of claim 260, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

262. The process of claim 260 or 261, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

263. The process of any one of claims 252 to 262, wherein the palladium metal has a purity of about 90% to about 100%, or about 95% to about 99.9%, or about 98% to about 99.9%.

264. The process of any one of claims 233 to 263, wherein the spent catalyst is a catalytic converter; preferably a gasoline-based or diesel-based catalytic converter in biscuit form.

265. A method of leaching about 40% or more, or about 50% or more of palladium from a spent catalyst comprising palladium in about 20 min or less, the method comprising contacting the spent catalyst with a leach mixture comprising:
an metal iodide ligand source,
an inorganic oxidizing agent,
an acid catalyst,
an optional stabilizer, and
acetic acid as a water-miscible organic solvent, preferably glacial acetic acid,
under conditions to leach the palladium from the spent catalyst;
leaching the palladium from the spent catalyst; and
forming a leach solution comprising leached palladium.

266. A method of leaching palladium from a spent catalyst comprising palladium at a leaching rate about an order of magnitude faster than aqua regia, the method comprising contacting the spent catalyst with a leach mixture comprising:
an metal iodide ligand source,
an inorganic oxidizing agent,
an acid catalyst,
an optional stabilizer, and
acetic acid as a water-miscible organic solvent, preferably glacial acetic acid,
under conditions to leach the palladium from the spent catalyst;
leaching the palladium from the spent catalyst; and
forming a leach solution comprising leached palladium.

267. The method of claim 265 or 266, wherein the metal iodide ligand source NaI, KI, or a combination thereof.

268. The method of any one of claims 265 to 267, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

269. The method of any one of claims 265 to 268, wherein the inorganic oxidizing agent comprises I₂, H₂O₂, CuCl₂, O₂, bubbled air or a combination thereof.

270. The method of claim 269, wherein the inorganic oxidizing agent has a concentration of from about 0.01 M to about 0.1 M in the acetic acid solvent, preferably a concentration from about 0.01 to about 0.05 M.

271. The method of any one of claims 265 to 270, wherein the acid catalyst comprises a hydrogen halide; preferably HCl.

272. The method of any one of claims 2651 to 271, wherein the acid catalyst has a concentration of from about 0.01 M to about 1 M in the acetic acid solvent; or preferably has a concentration of from about 0.1 M to about 0.5 M.

273. The method of any one of claims 265 to 272, wherein the carboxylic acid stabilizer comprises acetic acid, citric acid, or a combination thereof; preferably citric acid.

274. The method of claim 273, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

275. The method of any one of claims 265 to 274, wherein the acetic acid as the water-miscible organic solvent makes up at least 50 wt % of the liquid phase of the leach mixture.

276. The method of any one of claims 265 to 275, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.

277. The method of claim 276, wherein the conditions to leach the palladium further comprise contacting the spent catalyst with the leach mixture at a solid to liquid phase ratio of 1:10.

278. The method of claim 276 or 277, wherein the conditions to leach the palladium are tolerant of up to about 10 wt % water.

279. The method of any one of claims 265 to 278, wherein the spent catalyst further comprises oxidized palladium, and the method further comprises contacting the spent catalyst with a reductant under conditions to at least partially reduce the oxidized palladium; and at least partially reducing the oxidized palladium.

280. The method of claim 279, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

281. The method of claim 279 or 280, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

282. The method of any one of claims 265 to 281, wherein the palladium of the spent catalyst comprises a contaminant, the method further comprising contacting the spent catalyst with a chelating agent under conditions to at least partially remove the contaminant; and at least partially decontaminating the palladium.

283. The method of claim 282, wherein the chelating agent comprises citric acid, oxalic acid, or salts thereof, or a combination thereof; preferably citric acid and/or salt thereof.

284. The method of claim 282 or 283, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

285. The method of any one of claims 282 to 284, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

286. The method of any one of claims 265 to 285, wherein the method leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.

287. The method of any one of claims 265 to 286, further comprising adding an oxidant and a polyatomic salt to the leach solution under conditions to precipitate the leached palladium; and precipitating the leached palladium.

288. The method of claim 287, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

289. The method of claim 287 or 288, wherein the polyatomic salt comprises an ammonium salt, such as ammonium chloride, ammonium sulfate, ammonium nitrate, or combinations thereof.

290. The method of any one of claims 287 to 289, wherein the conditions to precipitate the leached palladium comprise contacting the leach solution with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

291. The method of any one of claims 287 to 290, further comprising contacting the leached palladium with a reducing agent under conditions to reduce the leached palladium to palladium metal; and reducing the leached palladium to palladium metal.

292. The method of claim 291, wherein contacting the leached palladium with the reducing agent comprises forming an aqueous mixture comprising the leached palladium, and adding the reducing agent to the aqueous mixture.

293. The method of claim 291 or 292, wherein the reducing agent comprises H₂, metal powder, metal strips, or a combination thereof, the metal comprising Al, Cu, Fe, Zn, or a combination thereof.

294. The method of any one of claims 291 to 293, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

295. The method of any one of claims 291 to 294, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

296. The method of claim 295, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

297. The method of claim 295 or 296, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

298. The method of any one of claims 287 to 297, wherein the palladium metal has a purity of about 90% to about 100%, or about 95% to about 99.9%, or about 98% to about 99.9%.

299. The method of any one of claims 265 to 298, wherein the spent catalyst further comprises platinum and/or rhodium, and the method selectively leaches the palladium from the spent catalyst.

300. The method of any one of claims 265 to 299, wherein the spent catalyst is a catalytic converter; preferably a gasoline-based or diesel-based catalytic converter in biscuit form.

301. Use of a leach mixture for leaching about 40% or more, or about 50% or more of palladium from a spent catalyst comprising palladium in about 20 min or less, under conditions to leach the palladium from the spent catalyst, and form a leach solution comprising leached palladium, the leach mixture comprising:
an metal iodide ligand source,
an inorganic oxidizing agent,
an acid catalyst,
an optional stabilizer, and
acetic acid as a water-miscible organic solvent, preferably glacial acetic acid.

302. Use of a leach mixture for leaching palladium from a spent catalyst comprising palladium at a leaching rate about an order of magnitude faster than aqua regia, under conditions to leach the palladium from the spent catalyst, and form a leach solution comprising leached palladium, the leach mixture comprising:
an metal iodide ligand source,
an inorganic oxidizing agent,
an acid catalyst,
an optional stabilizer, and
acetic acid as a water-miscible organic solvent, preferably glacial acetic acid.

303. The use of claim 301 or 302, wherein the metal iodide ligand source NaI, KI, or a combination thereof.

304. The use of any one of claims 301 to 303, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

305. The use of any one of claims 301 to 304, wherein the inorganic oxidizing agent comprises I₂, H₂O₂, CuCl₂, O₂, bubbled air or a combination thereof.

306. The use of claim 305, wherein the inorganic oxidizing agent has a concentration of from about 0.01 M to about 0.1 M in the acetic acid solvent, preferably a concentration from about 0.01 to about 0.05 M.

307. The use of any one of claims 301 to 306, wherein the acid catalyst comprises a hydrogen halide; preferably HCl.

308. The use of any one of claims 301 to 307, wherein the acid catalyst has a concentration of from about 0.01 M to about 1 M in the acetic acid solvent; or preferably has a concentration of from about 0.1 M to about 0.5 M.

309. The use of any one of claims 301 to 308, wherein the carboxylic acid stabilizer comprises acetic acid, citric acid, or a combination thereof; preferably citric acid.

310. The use of claim 309, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

311. The use of any one of claims 301 to 310, wherein the acetic acid as the water-miscible organic solvent makes up at least 50 wt % of the liquid phase of the leach mixture.

312. The use of any one of claims 301 to 311, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.

313. The use of claim 312, wherein the conditions to leach the palladium further comprise contacting the spent catalyst with the leach mixture at a solid to liquid phase ratio of 1:10.

314. The use of claim 312 or 313, wherein the conditions to leach the palladium are tolerant of up to about 10 wt % water.

315. The use of any one of claims 301 to 314, wherein the spent catalyst further comprises oxidized palladium, and the use further comprises use of a reductant for contacting the spent catalyst under conditions to at least partially reduce the oxidized palladium; and at least partially reducing the oxidized palladium.

316. The use of claim 315, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

317. The use of claim 315 or 316, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

318. The use of any one of claims 301 to 317, wherein the palladium of the spent catalyst comprises a contaminant, the use further comprising use of a chelating agent for contacting the spent catalyst under conditions to at least partially remove the contaminant; and at least partially decontaminating the palladium.

319. The use of claim 318, wherein the chelating agent comprises citric acid, oxalic acid, or salts thereof, or a combination thereof; preferably citric acid and/or salt thereof.

320. The use of claim 318 or 319, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

321. The use of any one of claims 318 to 320, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

322. The use of any one of claims 301 to 321, wherein the leach mixture leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.

323. The use of any one of claims 301 to 322, further comprising use of an oxidant and a polyatomic salt for precipitating the leached palladium by adding the oxidant and polyatomic salt to the leach solution under conditions to precipitate the leached palladium; and precipitating the leached palladium.

324. The use of claim 323, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

325. The use of claim 323 or 324, wherein the polyatomic salt comprises an ammonium salt, such as ammonium chloride, ammonium sulfate, ammonium nitrate, or combinations thereof.

326. The use of any one of claims 323 to 325, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

327. The use of any one of claims 323 to 326, further comprising use of a reducing agent for reducing the leached palladium to palladium metal by contacting the leached palladium with a reducing agent under conditions to reduce the leached palladium to palladium metal; and reducing the leached palladium to palladium metal.

328. The use of claim 327, wherein contacting the leached palladium with the reducing agent comprises forming an aqueous mixture comprising the leached palladium, and adding the reducing agent to the aqueous mixture.

329. The use of claim 327 or 328, wherein the reducing agent comprises H₂, metal powder, metal strips, or a combination thereof, the metal comprising Al, Cu, Fe, Zn, or a combination thereof.

330. The use of any one of claims 327 to 329, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

331. The use of any one of claims 327 to 330, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

332. The use of claim 331, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

333. The use of claim 331 or 332, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

334. The use of any one of claims 323 to 333, wherein the palladium metal has a purity of about 90% to about 100%, or about 95% to about 99.9%, or about 98% to about 99.9%.

335. The use of any one of claims 301 to 334, wherein the spent catalyst further comprises platinum and/or rhodium, and the leach mixture selectively leaches the palladium from the spent catalyst.

336. The use of any one of claims 301 to 335, wherein the spent catalyst is a catalytic converter; preferably a gasoline-based or diesel-based catalytic converter in biscuit form.

337. A process of recycling palladium from a spent catalyst comprising palladium, the process comprising:
contacting the spent catalyst with a leach mixture comprising
an metal iodide ligand source,
an inorganic oxidizing agent,
an acid catalyst,
an optional stabilizer, and
acetic acid as a water-miscible organic solvent, preferably glacial acetic acid,
under conditions to leach the palladium from the spent catalyst comprising palladium;
leaching about 40% or more, or about 50% or more of the palladium from the spent catalyst in about 20 min or less to form a leach solution comprising leached palladium and a leached spent catalyst; and
separating the leach solution from the leached spent catalyst; and
treating the leach solution comprising leached palladium under conditions to form palladium metal.

338. A process of recycling palladium from a spent catalyst comprising palladium, the process comprising:
contacting the spent catalyst with a leach mixture comprising
an metal iodide ligand source,
an inorganic oxidizing agent,
an acid catalyst,
an optional stabilizer, and
acetic acid as a water-miscible organic solvent, preferably glacial acetic acid,
under conditions to leach the palladium from the spent catalyst comprising palladium;
leaching the palladium from the spent catalyst at a leaching rate of about an order or magnitude faster than aqua regia to form a leach solution comprising leached palladium and a leached spent catalyst; and
separating the leach solution from the leached spent catalyst; and
treating the leach solution comprising leached palladium under conditions to form palladium metal.

339. The process of claim 337 or 338, wherein the metal iodide ligand source NaI, KI, or a combination thereof.

340. The process of any one of claims 337 to 339, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

341. The process of any one of claims 337 to 340, wherein the inorganic oxidizing agent comprises I₂, H₂O₂, CuCl₂, O₂, bubbled air or a combination thereof.

342. The process of claim 341, wherein the inorganic oxidizing agent has a concentration of from about 0.01 M to about 0.1 M in the acetic acid solvent, preferably a concentration from about 0.01 to about 0.05 M.

343. The process of any one of claims 337 to 342, wherein the acid catalyst comprises a hydrogen halide; preferably HCl.

344. The process of any one of claims 337 to 343, wherein the acid catalyst has a concentration of from about 0.01 M to about 1 M in the acetic acid solvent; or preferably has a concentration of from about 0.1 M to about 0.5 M.

345. The process of any one of claims 337 to 344, wherein the carboxylic acid stabilizer comprises acetic acid, citric acid, or a combination thereof; preferably citric acid.

346. The process of claim 345, wherein carboxylic acid stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

347. The process of any one of claims 337 to 346, wherein the acetic acid as the water-miscible organic solvent makes up at least 50 wt % of the liquid phase of the leach mixture.

348. The process of any one of claims 337 to 347, wherein the conditions to leach the palladium from the spent catalyst comprises contacting the spent catalyst with the leach mixture for a time of about 0.1 min to about 20 min, at a temperature of about 20° C. to about 30° C., under ambient pressure; wherein preferably, the time is about 1 min to about 15 min, or about 1 min to about 10 min, or about 1 min to about 8 min, or about 1 min to about 5 min; and the temperature is about 20° C. to about 25° C.

349. The process of claim 348, wherein the conditions to leach the palladium further comprise contacting the spent catalyst with the leach mixture at a solid to liquid phase ratio of 1:10.

350. The process of claim 348 or 349, wherein the conditions to leach the palladium are tolerant of up to about 10 wt % water.

351. The process of any one of claims 337 to 350, wherein the spent catalyst further comprises oxidized palladium, and the process further comprises contacting the spent catalyst with a reductant under conditions to at least partially reduce the oxidized palladium; and at least partially reducing the oxidized palladium.

352. The process of claim 351, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

353. The process of claim 351 or 352, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

354. The process of any one of claims 337 to 353, wherein the palladium of the spent catalyst comprises a contaminant, the process further comprising contacting the spent catalyst with a chelating agent under conditions to at least partially remove the contaminant; and at least partially decontaminating the palladium.

355. The process of claim 354, wherein the chelating agent comprises citric acid, oxalic acid, or salts thereof, or a combination thereof; preferably citric acid and/or salt thereof.

356. The process of claim 354 or 355, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

357. The process of any one of claims 354 to 356, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

358. The process of any one of claims 337 to 357, wherein the process selectively leaches about 40% to about 100%, or about 50% to about 99.9%, or about 60% to about 99.9%, or about 70% to about 99.9%, or about 80% to about 99.9%, or about 90% to about 99.9% of the palladium in the spent catalyst.

359. The process of any one of claims 337 to 358, further comprising adding an oxidant and a polyatomic salt to the leach solution under conditions to precipitate the leached palladium; and precipitating the leached palladium.

360. The process of claim 359, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

361. The process of claim 359 or 360, wherein the polyatomic salt comprises an ammonium salt, such as ammonium chloride, ammonium sulfate, ammonium nitrate, or combinations thereof.

362. The process of any one of claims 359 to 361, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

363. The process of any one of claims 359 to 362, further comprising contacting the leached palladium with a reducing agent under conditions to reduce the leached palladium to palladium metal; and reducing the leached palladium to palladium metal.

364. The process of claim 363, wherein contacting the leached palladium with the reducing agent comprises forming an aqueous mixture comprising the leached palladium, and adding the reducing agent to the aqueous mixture.

365. The process of claim 363 or 364, wherein the reducing agent comprises H₂, metal powder, metal strips, or a combination thereof, the metal comprising Al, Cu, Fe, Zn, or a combination thereof.

366. The process of any one of claims 363 to 365, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

367. The process of any one of claims 363 to 366, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

368. The process of claim 367, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

369. The process of claim 367 or 368, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

370. The process of any one of claims 359 to 369, wherein the palladium metal has a purity of about 90% to about 100%, or about 95% to about 99.9%, or about 98% to about 99.9%.

371. The process of any one of claims 337 to 370, wherein the spent catalyst further comprises platinum and/or rhodium, and the process selectively leaches the palladium from the spent catalyst.

372. The process of any one of claims 337 to 371, wherein the spent catalyst is a catalytic converter; preferably a gasoline-based or diesel-based catalytic converter in biscuit form.

373. A method of leaching at least 60% of surface palladium from a spent catalyst comprising palladium, the method comprising contacting the spent catalyst with a leach mixture comprising:
an metal iodide ligand source,
an halide-based oxidizing agent,
an optional acid catalyst,
an optional stabilizer, and
acetic acid as a water-miscible organic solvent, preferably glacial acetic acid,
under conditions to leach the palladium from the spent catalyst comprising palladium and platinum;
leaching the palladium from the spent catalyst; and
forming a leach solution comprising leached palladium.

374. A method of leaching at least 60% of surface palladium from a spent catalyst comprising palladium, the method comprising contacting the spent catalyst with a leach mixture comprising:
an metal iodide ligand source,
an halide-based oxidizing agent,
an optional acid catalyst,
an optional stabilizer, and
acetic acid as a water-miscible organic solvent, preferably glacial acetic acid,
under conditions to leach the palladium from the spent catalyst;
leaching the palladium from the spent catalyst; and
forming a leach solution comprising leached palladium;
wherein the method is milder and less toxic relative to a method of leaching having aqua regia as a leach mixture.

375. The method of claim 373 or 374, wherein the metal iodide ligand source NaI, KI, or a combination thereof.

376. The method of any one of claims 373 to 375, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

377. The method of any one of claims 373 to 376, wherein the halide-based oxidizing agent comprises I₂, FeCl₃, or a combination thereof.

378. The method of claim 377, wherein the halide-based oxidizing agent has a concentration of from about 0.01 M to about 0.1 M in the acetic acid solvent, preferably a concentration from about 0.01 to about 0.05 M.

379. The method of any one of claims 373 to 378, wherein the acid catalyst comprises a hydrogen halide, such as HCl; H₂SO₄, or a combination thereof.

380. The method of any one of claims 373 to 379, wherein the acid catalyst has a concentration of from about 0.01 M to about 1 M in the acetic acid solvent; or preferably has a concentration of from about 0.1 M to about 0.5 M.

381. The method of any one of claims 373 to 380, wherein the stabilizer comprises acetic acid, citric acid, or a combination thereof; preferably citric acid.

382. The method of claim 381, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

383. The method of any one of claims 373 to 382, wherein the acetic acid as the water-miscible organic solvent makes up at least 50 wt % of the liquid phase of the leach mixture.

384. The method of any one of claims 373 to 383, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.

385. The method of claim 384, wherein the conditions to leach the palladium further comprise contacting the spent catalyst with the leach mixture at a solid to liquid phase ratio of 1:10.

386. The method of claim 384 or 385, wherein the conditions to leach the palladium are tolerant of up to about 10 wt % water.

387. The method of any one of claims 373 to 386, wherein the spent catalyst further comprises oxidized palladium, and the method further comprises contacting the spent catalyst with a reductant under conditions to at least partially reduce the oxidized palladium; and at least partially reducing the oxidized palladium.

388. The method of claim 387, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

389. The method of claim 387 or 388, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

390. The method of any one of claims 373 to 389, wherein the palladium of the spent catalyst comprises a contaminant, the method further comprising contacting the spent catalyst with a chelating agent under conditions to at least partially remove the contaminant; and at least partially decontaminating the palladium.

391. The method of claim 390, wherein the chelating agent comprises citric acid, oxalic acid, or salts thereof, or a combination thereof; preferably citric acid and/or salt thereof.

392. The method of claim 390 or 391, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

393. The method of any one of claims 390 to 392, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

394. The method of any one of claims 373 to 393, wherein the method leaches about 60% to about 99.9%, or about 70% to about 99.9%, or about 80% to about 99.9%, or about 90% to about 99.9% of the palladium in the spent catalyst.

395. The method of any one of claims 373 to 394, further comprising adding an oxidant and a polyatomic salt to the leach solution under conditions to precipitate the leached palladium; and precipitating the leached palladium.

396. The method of claim 395, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

397. The method of claim 394 or 396, wherein the polyatomic salt comprises an ammonium salt, such as ammonium chloride, ammonium sulfate, ammonium nitrate, or combinations thereof.

398. The method of any one of claims 395 to 397, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

399. The method of any one of claims 395 to 398, further comprising contacting the leached palladium with a reducing agent under conditions to reduce the leached palladium to palladium metal; and reducing the leached palladium to palladium metal.

400. The method of claim 399, wherein contacting the leached palladium with the reducing agent comprises forming an aqueous mixture comprising the leached palladium, and adding the reducing agent to the aqueous mixture.

401. The method of claim 399 or 400, wherein the reducing agent comprises H₂, metal powder, metal strips, or a combination thereof, the metal comprising Al, Cu, Fe, Zn, or a combination thereof.

402. The method of any one of claims 399 to 401, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

403. The method of any one of claims 399 to 402, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

404. The method of claim 403, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

405. The method of claim 403 or 404, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

406. The method of any one of claims 395 to 405, wherein the palladium metal has a purity of about 90% to about 100%, or about 95% to about 99.9%, or about 98% to about 99.9%.

407. The method of any one of claims 373 to 406, wherein the spent catalyst further comprises platinum and/or rhodium, and the method selectively leaches the palladium from the spent catalyst.

408. The method of any one of claims 373 to 407, wherein the spent catalyst is a catalytic converter; preferably a gasoline-based or diesel-based catalytic converter in biscuit form.

409. Use of a leach mixture for leaching at least 60% of surface palladium from a spent catalyst comprising palladium, under conditions to leach the palladium from the spent catalyst, and form a leach solution comprising leached palladium, leach mixture comprising:
an metal iodide ligand source,
an halide-based oxidizing agent,
an optional acid catalyst,
an optional stabilize, and
acetic acid as a water-miscible organic solvent, preferably glacial acetic acid.

410. Use of a leach mixture for leaching at least 60% of surface palladium from a spent catalyst comprising palladium, under conditions to leach the palladium from the spent catalyst, and form a leach solution comprising leached palladium, leach mixture comprising:
an metal iodide ligand source,
an halide-based oxidizing agent,
an optional acid catalyst,
an optional stabilize, and
acetic acid as a water-miscible organic solvent, glacial acetic acid;
wherein use of the leach mixture is milder and less toxic relative to a use of aqua regia as a leach mixture.

411. The use of claim 409 or 410, wherein the metal iodide ligand source NaI, KI, or a combination thereof.

412. The use of any one of claims 409 to 411, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

413. The use of any one of claims 409 to 412, wherein the halide-based oxidizing agent comprises I₂, FeCl₃, or a combination thereof.

414. The use of claim 413, wherein the halide-based oxidizing agent has a concentration of from about 0.01 M to about 0.1 M in the acetic acid solvent, preferably a concentration from about 0.01 to about 0.05 M.

415. The use of any one of claims 409 to 414, wherein the acid catalyst comprises a hydrogen halide, such as HCl; H₂SO₄, or a combination thereof.

416. The use of any one of claims 409 to 415, wherein the acid catalyst has a concentration of from about 0.01 M to about 1 M in the acetic acid solvent; or preferably has a concentration of from about 0.1 M to about 0.5 M.

417. The use of any one of claims 409 to 416, wherein the stabilizer comprises acetic acid, citric acid, or a combination thereof; preferably citric acid.

418. The use of claim 417, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

419. The use of any one of claims 409 to 418, wherein the acetic acid as the water-miscible organic solvent makes up at least 50 wt % of the liquid phase of the leach mixture.

420. The use of any one of claims 409 to 419, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.

421. The use of claim 420, wherein the conditions to leach the palladium further comprise contacting the spent catalyst with the leach mixture at a solid to liquid phase ratio of 1:10.

422. The use of claim 420 or 421, wherein the conditions to leach the palladium are tolerant of up to about 10 wt % water.

423. The use of any one of claims 409 to 422, wherein the spent catalyst further comprises oxidized palladium, and the use further comprises use of a reductant for contacting the spent catalyst under conditions to at least partially reduce the oxidized palladium; and at least partially reducing the oxidized palladium.

424. The use of claim 423, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

425. The use of claim 423 or 424, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

426. The use of any one of claims 409 to 425, wherein the palladium of the spent catalyst comprises a contaminant, the use further comprising use of a chelating agent for contacting the spent catalyst under conditions to at least partially remove the contaminant; and at least partially decontaminating the palladium.

427. The use of claim 426, wherein the chelating agent comprises citric acid, oxalic acid, or salts thereof, or a combination thereof; preferably citric acid and/or salt thereof.

428. The use of claim 426 or 427, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

429. The use of any one of claims 426 to 428, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

430. The use of any one of claims 409 to 429, wherein the leach mixture leaches about 60% to about 99.9%, or about 70% to about 99.9%, or about 80% to about 99.9%, or about 90% to about 99.9% of the palladium in the spent catalyst.

431. The use of any one of claims 409 to 430, further comprising use of an oxidant and a polyatomic salt for precipitating the leached palladium by adding the oxidant and polyatomic salt to the leach solution under conditions to precipitate the leached palladium; and precipitating the leached palladium.

432. The use of claim 431, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

432. The use of claim 431 or 432, wherein the polyatomic salt comprises an ammonium salt, such as ammonium chloride, ammonium sulfate, ammonium nitrate, or combinations thereof.

433. The use of any one of claims 431 to 432, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

434. The use of any one of claims 431 to 433, further comprising use of a reducing agent for reducing the leached palladium to palladium metal by contacting the leached palladium with a reducing agent under conditions to reduce the leached palladium to palladium metal; and reducing the leached palladium to palladium metal.

435. The use of claim 434, wherein contacting the leached palladium with the reducing agent comprises forming an aqueous mixture comprising the leached palladium, and adding the reducing agent to the aqueous mixture.

436. The use of claim 434 or 435, wherein the reducing agent comprises H₂, metal powder, metal strips, or a combination thereof, the metal comprising Al, Cu, Fe, Zn, or a combination thereof.

437. The use of any one of claims 434 to 436, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

438. The use of any one of claims 434 to 437, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

439. The use of claim 438, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

440. The use of claim 438 or 439, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

441. The use of any one of claims 431 to 440, wherein the palladium metal has a purity of about 90% to about 100%, or about 95% to about 99.9%, or about 98% to about 99.9%.

443. The use of any one of claims 409 to 441, wherein the spent catalyst further comprises platinum and/or rhodium, and the leach mixture selectively leaches the palladium from the spent catalyst.

444. The use of any one of claims 409 to 443, wherein the spent catalyst is a catalytic converter; preferably a gasoline-based or diesel-based catalytic converter in biscuit form.

445. A process of recycling at least 60% of surface palladium from a spent catalyst comprising palladium, the process comprising:
contacting the spent catalyst with a leach mixture comprising
an metal iodide ligand source,
an halide-based oxidizing agent,
an optional acid catalyst,
an optional stabilizer, and
acetic acid as a water-miscible organic solvent, preferably glacial acetic acid,
under conditions to leach the palladium from the spent catalyst;
leaching the palladium from the spent catalyst to form a leach solution comprising leached palladium and a leached spent catalyst; and
separating the leach solution from the leached spent catalyst; and
treating the leach solution comprising leached palladium under conditions to form palladium metal.

446. A process of recycling at least 60% of surface palladium from a spent catalyst comprising palladium, the process comprising:
contacting the spent catalyst with a leach mixture comprising
an metal iodide ligand source,
an halide-based oxidizing agent,
an optional acid catalyst,
an optional stabilizer, and
acetic acid as a water-miscible organic solvent, preferably glacial acetic acid,
under conditions to leach the palladium from the spent catalyst;
leaching the palladium from the spent catalyst to form a leach solution comprising leached palladium and a leached spent catalyst; and
separating the leach solution from the leached spent catalyst; and
treating the leach solution comprising leached palladium under conditions to form palladium metal,
wherein the process is milder and less toxic relative to a process having aqua regia as a leach mixture.

447. The process of claim 445 or 446, wherein the metal iodide ligand source NaI, KI, or a combination thereof.

448. The process of any one of claims 445 to 447, wherein the metal iodide ligand source has a concentration of about 0.1 M to about 0.5 M, 0.1 to about 0.4 M, or about 0.1 M to about 0.3 M, or about 0.1 to about 0.2 M in the acetic acid solvent.

449. The process of any one of claims 445 to 448, wherein the halide-based oxidizing agent comprises I₂, FeCl₃, or a combination thereof.

450. The process of claim 449, wherein the halide-based oxidizing agent has a concentration of from about 0.01 M to about 0.1 M in the acetic acid solvent, preferably a concentration from about 0.01 to about 0.05 M.

451. The process of any one of claims 445 to 450, wherein the acid catalyst comprises a hydrogen halide, such as HCl; H₂SO₄, or a combination thereof.

452. The process of any one of claims 445 to 451, wherein the acid catalyst has a concentration of from about 0.01 M to about 1 M in the acetic acid solvent; or preferably has a concentration of from about 0.1 M to about 0.5 M.

453. The process of any one of claims 445 to 452, wherein the stabilizer comprises acetic acid, citric acid, or a combination thereof; preferably citric acid.

454. The process of claim 453, wherein stabilizer has a concentration of from about 0.1 M to about 1 M in the acetic acid solvent, preferably a concentration from about 0.1 M to about 0.8 M, or about 0.3 to about 0.7 M, or about 0.4 M to about 0.6 M.

455. The process of any one of claims 445 to 454, wherein the acetic acid as the water-miscible organic solvent makes up at least 50 wt % of the liquid phase of the leach mixture.

456. The process of any one of claims 445 to 455, wherein the conditions to leach the palladium from the spent catalyst comprises contacting the spent catalyst with the leach mixture for a time of about 0.1 min to about 18 hours, at a temperature of about 20° C. to about 30° C., under ambient pressure; wherein preferably, the time is about 30 min to about 18 hours; and the temperature is about 20° C. to about 25° C.

457. The process of claim 456, wherein the conditions to leach the palladium further comprise contacting the spent catalyst with the leach mixture at a solid to liquid phase ratio of 1:10.

458. The process of claim 456 or 457, wherein the conditions to leach the palladium are tolerant of up to about 10 wt % water.

459. The process of any one of claims 445 to 458, wherein the spent catalyst further comprises oxidized palladium, and the process further comprises contacting the spent catalyst with a reductant under conditions to at least partially reduce the oxidized palladium; and at least partially reducing the oxidized palladium.

460. The process of claim 459, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

461. The process of claim 459 or 460, wherein the conditions to at least partially reduce the oxidized palladium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

462. The process of any one of claims 445 to 461, wherein the palladium of the spent catalyst comprises a contaminant, the process further comprising contacting the spent catalyst with a chelating agent under conditions to at least partially remove the contaminant; and at least partially decontaminating the palladium.

463. The process of claim 462, wherein the chelating agent comprises citric acid, oxalic acid, or salts thereof, or a combination thereof; preferably citric acid and/or salt thereof.

464. The process of claim 462 or 463, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

465. The process of any one of claims 462 to 464, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

466. The process of any one of claims 445 to 465, wherein the process leaches about 60% to about 99.9%, or about 70% to about 99.9%, or about 80% to about 99.9%, or about 90% to about 99.9% of the palladium in the spent catalyst.

467. The process of any one of claims 445 to 466, wherein treating the leach solution comprising leached palladium under conditions to form palladium metal comprises adding an oxidant and a polyatomic salt to the leach solution under conditions to precipitate the leached palladium; and precipitating the leached palladium.

468. The process of claim 467, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

469. The process of claim 467 or 468, wherein the polyatomic salt comprises an ammonium salt, such as ammonium chloride, ammonium sulfate, ammonium nitrate, or combinations thereof.

470. The process of any one of claims 467 to 469, wherein the conditions to precipitate the leached palladium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

471. The process of any one of claims 467 to 470, wherein treating the leach solution comprising leached palladium under conditions to form palladium metal further comprises contacting the leached palladium with a reducing agent under conditions to reduce the leached palladium to palladium metal; and reducing the leached palladium to palladium metal.

472. The process of claim 471, wherein contacting the leached palladium with the reducing agent comprises forming an aqueous mixture comprising the leached palladium, and adding the reducing agent to the aqueous mixture.

473. The process of claim 471 or 472, wherein the reducing agent comprises H₂, metal powder, metal strips, or a combination thereof, the metal comprising Al, Cu, Fe, Zn, or a combination thereof.

474. The process of any one of claims 471 to 473, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

475. The process of any one of claims 471 to 474, further comprising contacting the palladium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

476. The process of claim 475, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

477. The process of claim 475 or 476, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

478. The process of any one of claims 467 to 477, wherein the palladium metal has a purity of about 90% to about 100%, or about 95% to about 99.9%, or about 98% to about 99.9%.

479. The process of any one of claims 445 to 478, wherein the spent catalyst further comprises platinum and/or rhodium, and the process selectively leaches the palladium from the spent catalyst.

480. The process of any one of claims 445 to 479, wherein the spent catalyst is a catalytic converter; preferably a gasoline-based or diesel-based catalytic converter in biscuit form.

481. A method of simultaneously and selectively leaching at least two of palladium, platinum, and rhodium from a spent catalyst comprising aluminum oxide and at least two of palladium, platinum, and rhodium, the method comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to simultaneously and selectively leach at least two of the palladium, platinum, and rhodium from the spent catalyst;
simultaneously and selectively leaching at least two of the palladium, platinum, and rhodium from the spent catalyst; and
forming a leach solution comprising at least two of leached palladium, platinum, and rhodium.

482. The method of claim 481, wherein the chloride ligand source comprises HCl, AlCl₃, CaCl₂, or a combination thereof; or more preferably AlCl₃, CaCl₂, or a combination thereof.

483. The method of claim 481 or 482, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

484. The method of any one of claims 481 to 483, wherein the oxidizing agent comprises FeCl₃, O₂, bubbled air, or a combination thereof.

485. The method of claim 484, wherein the oxidizing agent has a concentration of from about 0.01 M to about 0.2 M in the acetic acid solvent, preferably between about 0.01 to about 0.1 M.

486. The method of any one of claims 481 to 485, wherein the acid catalyst comprises a hydrogen halide, preferably HCl; and optionally, the acid catalyst is the chloride ligand source.

487. The method of any one of claims 481 to 486, wherein the acid catalyst has a concentration of from about 0.01 M to about 1 M in the acetic acid solvent; or preferably has a concentration of from about 0.1 M to about 0.5 M.

488. The method of any one of claims 481 to 487, wherein the acetic acid as the water-miscible organic solvent makes up at least 50 wt % of the liquid phase of the leach mixture.

489. The method of any one of claims 481 to 488, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

490. The method of claim 489, wherein the conditions to simultaneously and selectively leach at least two of palladium, platinum, and rhodium further comprise contacting the spent catalyst with the leach mixture at a solid to liquid phase ratio of 1:10.

491. The method of claim 489 or 490, wherein the conditions to simultaneously and selectively leach at least two of palladium, platinum, and rhodium are tolerant of up to about 10 wt % water, or between about 10 wt % to less than 50 wt % water, such as 30 wt % water.

492. The method of any one of claims 481 to 491, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.

493. The method of claim 492, wherein the reductant comprises organic reductants, such as ascorbic acid, formic acid, oxalic acid, or salts thereof, or a combination thereof; inorganic reductants, such as NaBH₄, FeCl₂, hydrazine hydrochloride, hydroxylamine hydrochloride, or a combination thereof; or a combination thereof.

494. The method of claim 492 or 493, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

495. The method of any one of claims 481 to 494, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.

496. The method of claim 495, wherein the chelating agent comprises citric acid, oxalic acid, or salts thereof, or a combination thereof; preferably citric acid and/or salt thereof.

497. The method of claim 495 or 496, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

498. The method of any one of claims 495 to 497, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

499. The method of any one of claims 481 to 498, wherein the method leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.

500. The method of any one of claims 481 to 499, further comprising adding an oxidant and a polyatomic salt to the leach solution under conditions to precipitate the leached palladium, platinum, and/or rhodium; and precipitating the leached palladium, platinum, and/or rhodium.

501. The method of claim 500, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

502. The method of claim 500 or 501, wherein the polyatomic salt comprises an ammonium salt, such as ammonium chloride, ammonium sulfate, ammonium nitrate, or combinations thereof.

503. The method of any one of claims 500 to 502, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

504. The method of any one of claims 500 to 503, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

505. The method of claim 504, wherein contacting the leached palladium, platinum, and/or rhodium with the reducing agent comprises forming an aqueous mixture comprising the leached palladium, platinum, and/or rhodium, and adding the reducing agent to the aqueous mixture.

506. The method of claim 504 or 505, wherein the reducing agent comprises H₂, metal powder, metal strips, or a combination thereof, the metal comprising Al, Cu, Fe, Zn, or a combination thereof.

507. The method of any one of claims 504 to 506, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

508. The method of any one of claims 504 to 507, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

509. The method of claim 508, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

510. The method of claim 508 or 509, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

511. The method of any one of claims 500 to 510, wherein at least one of the palladium, platinum, and/or rhodium metal has a purity of about 90% to about 100%, or about 95% to about 99.9%, or about 98% to about 99.9%.

512. The method of any one of claims 481 to 511, the wherein the spent catalyst is a catalytic converter; preferably a gasoline-based or diesel-based catalytic converter in biscuit or powder form.

513. Use of a leach mixture for simultaneously and selectively leaching at least two of palladium, platinum, and rhodium from a spent catalyst comprising aluminum oxide and at least two of palladium, platinum, and rhodium, under conditions to simultaneously and selectively leach at least two of the palladium, platinum, and rhodium from the spent catalyst and forming a leach solution comprising at least two of leached palladium, platinum, and rhodium, the leach mixture comprising:
an metal chloride ligand source,
an inorganic oxidizing agent,
an acid catalyst, and
acetic acid as a water-miscible organic solvent, preferably glacial acetic acid.

514. The use of claim 513, wherein the chloride ligand source comprises HCl, AlCl₃, CaCl₂, or a combination thereof; or more preferably AlCl₃, CaCl₂, or a combination thereof.

515. The use of claim 513 or 514, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

516. The use of any one of claims 513 to 515, wherein the oxidizing agent comprises FeCl₃, O₂, bubbled air, or a combination thereof.

517. The use of claim 516, wherein the oxidizing agent has a concentration of from about 0.01 M to about 0.2 M in the acetic acid solvent, preferably between about 0.01 to about 0.1 M.

518. The use of any one of claims 513 to 517, wherein the acid catalyst comprises a hydrogen halide, preferably HCl; and optionally, the acid catalyst is the chloride ligand source.

519. The use of any one of claims 513 to 518, wherein the acid catalyst has a concentration of from about 0.01 M to about 1 M in the acetic acid solvent; or preferably has a concentration of from about 0.1 M to about 0.5 M.

520. The use of any one of claims 513 to 519, wherein the acetic acid as the water-miscible organic solvent makes up at least 50 wt % of the liquid phase of the leach mixture.

521. The use of any one of claims 513 to 520, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

522. The use of claim 521, wherein the conditions to simultaneously and selectively leach at least two of palladium, platinum, and rhodium further comprise contacting the spent catalyst with the leach mixture at a solid to liquid phase ratio of 1:10.

523. The use of claim 521 or 522, wherein the conditions to simultaneously and selectively leach at least two of palladium, platinum, and rhodium are tolerant of up to about 10 wt % water, or between about 10 wt % to less than 50 wt % water, such as 30 wt % water.

524. The use of any one of claims 513 to 523, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.

525. The use of claim 524, wherein the reductant comprises organic reductants, such as ascorbic acid, formic acid, oxalic acid, or salts thereof, or a combination thereof; inorganic reductants, such as NaBH₄, FeCl₂, hydrazine hydrochloride, hydroxylamine hydrochloride, or a combination thereof; or a combination thereof.

526. The use of claim 524 or 525, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

527. The use of any one of claims 513 to 526, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.

528. The use of claim 527, wherein the chelating agent comprises citric acid, oxalic acid, or salts thereof, or a combination thereof; preferably citric acid and/or salt thereof.

529. The use of claim 527 or 528, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

530. The use of any one of claims 527 to 529, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

531. The use of any one of claims 513 to 530, wherein the leach mixture leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.

532. The use of any one of claims 513 to 531, further comprising use of an oxidant and a polyatomic salt for precipitating the leached palladium, platinum, and/or rhodium by adding the oxidant and polyatomic salt to the leach solution under conditions to precipitate the leached palladium, platinum, and/or rhodium; and precipitating the leached palladium, platinum, and/or rhodium.

533. The use of claim 532, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

534. The use of claim 532 or 533, wherein the polyatomic salt comprises an ammonium salt, such as ammonium chloride, ammonium sulfate, ammonium nitrate, or combinations thereof.

535. The use of any one of claims 532 to 534, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

536. The use of any one of claims 532 to 535, further comprising use of a reducing agent reducing the leached palladium, platinum, and/or rhodium by contacting the leached palladium, platinum, and/or rhodium with the reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

537. The use of claim 536, wherein contacting the leached palladium, platinum, and/or rhodium with the reducing agent comprises forming an aqueous mixture comprising the leached palladium, platinum, and/or rhodium, and adding the reducing agent to the aqueous mixture.

538. The use of claim 536 or 537, wherein the reducing agent comprises H₂, metal powder, metal strips, or a combination thereof, the metal comprising Al, Cu, Fe, Zn, or a combination thereof.

539. The use of any one of claims 536 to 538, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

540. The use of any one of claims 536 to 539, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

541. The use of claim 540, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

542. The use of claim 540 or 541, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

543. The use of any one of claims 532 to 542, wherein at least one of the palladium, platinum, and/or rhodium metal has a purity of about 90% to about 100%, or about 95% to about 99.9%, or about 98% to about 99.9%.

544. The use of any one of claims 513 to 543, the wherein the spent catalyst is a catalytic converter; preferably a gasoline-based or diesel-based catalytic converter in biscuit or powder form.

545. A process of recycling at least two of palladium, platinum, and rhodium from a spent catalyst comprising aluminum oxide and at least two of palladium, platinum, and rhodium, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to simultaneously and selectively leach at least two of the palladium, platinum, and rhodium from the spent catalyst;
simultaneously and selectively leaching at least two of the palladium, platinum, and rhodium from the spent catalyst to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal

546. The process of claim 545, wherein the chloride ligand source comprises HCl, AlCl₃, CaCl₂, or a combination thereof; or more preferably AlCl₃, CaCl₂, or a combination thereof.

547. The process of claim 545 or 546, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

548. The process of any one of claims 545 to 547, wherein the oxidizing agent comprises FeCl₃, O₂, bubbled air, or a combination thereof.

549. The process of claim 548, wherein the oxidizing agent has a concentration of from about 0.01 M to about 0.2 M in the acetic acid solvent, preferably between about 0.01 to about 0.1 M.

550. The process of any one of claims 545 to 549, wherein the acid catalyst comprises a hydrogen halide, preferably HCl; and optionally, the acid catalyst is the chloride ligand source.

551. The process of any one of claims 545 to 550, wherein the acid catalyst has a concentration of from about 0.01 M to about 1 M in the acetic acid solvent; or preferably has a concentration of from about 0.1 M to about 0.5 M.

552. The process of any one of claims 545 to 551, wherein the acetic acid as the water-miscible organic solvent makes up at least 50 wt % of the liquid phase of the leach mixture.

553. The process of any one of claims 545 to 552, wherein the conditions to simultaneously and selectively leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

554. The process of claim 553, wherein the conditions to simultaneously and selectively leach at least two of palladium, platinum, and rhodium further comprise contacting the spent catalyst with the leach mixture at a solid to liquid phase ratio of 1:10.

555. The process of claim 553 or 554, wherein the conditions to simultaneously and selectively leach at least two of palladium, platinum, and rhodium are tolerant of up to about 10 wt % water, or between about 10 wt % to less than 50 wt % water, such as 30 wt % water.

556. The process of any one of claims 545 to 555, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.

557. The process of claim 556, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

558. The process of claim 556 or 557, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

559. The process of any one of claims 545 to 558, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.

560. The process of claim 559, wherein the chelating agent comprises citric acid, oxalic acid, or salts thereof, or a combination thereof; preferably citric acid and/or salt thereof.

561. The process of claim 559 or 560, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

562. The process of any one of claims 559 to 561, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

563. The process of any one of claims 545 to 562, wherein the process leaches about 10% to about 100%, or about 20% to about 99.9%, or about 30% to about 99.9%, or about 40% to about 99.9%, or about 50% to about 99.9%, or about 60% to about 99.9%, or about 60% to about 70% of at least one of the palladium, platinum, and rhodium in the spent catalyst, preferably at least two of the palladium, platinum, and rhodium.

564. The process of any one of claims 545 to 563, where treating the leach solution comprising leached palladium, platinum, and/or rhodium under conditions to form palladium, platinum, and/or rhodium metal comprises adding an oxidant and a polyatomic salt to the leach solution under conditions to precipitate the leached palladium, platinum, and/or rhodium; and precipitating the leached palladium, platinum, and/or rhodium.

565. The process of claim 564, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

567. The process of claim 564 or 565, wherein the polyatomic salt comprises an ammonium salt, such as ammonium chloride, ammonium sulfate, ammonium nitrate, or combinations thereof.

568. The process of any one of claims 564 to 567, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

569. The process of any one of claims 564 to 568, wherein treating the leach solution comprising leached palladium, platinum, and/or rhodium under conditions to form palladium, platinum, and/or rhodium metal further comprises contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

570. The process of claim 569, wherein contacting the leached palladium, platinum, and/or rhodium with the reducing agent comprises forming an aqueous mixture comprising the leached palladium, platinum, and/or rhodium, and adding the reducing agent to the aqueous mixture.

571. The process of claim 569 or 570, wherein the reducing agent comprises H₂, metal powder, metal strips, or a combination thereof, the metal comprising Al, Cu, Fe, Zn, or a combination thereof.

572. The process of any one of claims 569 to 571, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

573. The process of any one of claims 569 to 572, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

574. The process of claim 573, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

575. The process of claim 573 or 574, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

576. The process of any one of claims 564 to 575, wherein at least one of the palladium, platinum, and/or rhodium metal has a purity of about 90% to about 100%, or about 95% to about 99.9%, or about 98% to about 99.9%.

577. The process of any one of claims 545 to 576, the wherein the spent catalyst is a catalytic converter; preferably a gasoline-based or diesel-based catalytic converter in biscuit or powder form.

578. A method of leaching about 40% or more, or about 50% or more of at least two of palladium, platinum, and rhodium from a spent catalyst in about 30 min or less, the method comprising: contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least two of the palladium, platinum, and rhodium from the spent catalyst;
leaching of at least two of the palladium, platinum, and rhodium from the spent catalyst; and
forming a leach solution comprising at least two of leached palladium, platinum, and rhodium.

579. A method of leaching at least two of palladium, platinum, and rhodium from a spent catalyst at a leaching rate at least 1 time, or at least 5 times, or at least 15 times, or at least 20 times faster than aqua regia, the method comprising:
contacting the spent catalyst with a leach mixture comprising
an metal chloride ligand source,
an inorganic oxidizing agent,
an acid catalyst, and
acid as a water-miscible organic solvent, preferably glacial acetic acid,
under conditions to leach at least two of the palladium, platinum, and rhodium from the spent catalyst;
leaching at least two of the palladium, platinum, and rhodium from the spent catalyst; and
forming a leach solution comprising at least two of leached palladium, platinum, and rhodium.

580. The method of claim 578 or 579, wherein the chloride ligand source comprises HCl, CaCl₂, or a combination thereof; or more preferably CaCl₂.

581. The method of any one of claims 578 to 580, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

582. The method of any one of claims 578 to 581, wherein the oxidizing agent comprises FeCl₃, CuCl₂, HNO₃, MnO₂, H₂O₂, or a combination thereof.

583. The method of claim 582, wherein the oxidizing agent has a concentration of from about 0.01 M to about 0.2 M in the acetic acid solvent, preferably between about 0.01 to about 0.1 M.

584. The method of any one of claims 578 to 583, wherein the acid catalyst comprises a hydrogen halide, preferably HCl.

585. The method of any one of claims 578 to 584, wherein the acid catalyst has a concentration of from about 0.01 M to about 1 M in the acetic acid solvent; or preferably has a concentration of from about 0.1 M to about 0.2 M.

586. The method of any one of claims 578 to 585, wherein the acetic acid as the water-miscible organic solvent makes up at least 50 wt % of the liquid phase of the leach mixture.

587. The method of any one of claims 578 to 586, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.

588. The method of claim 587, wherein the conditions to leach at least two of palladium, platinum, and rhodium further comprise contacting the spent catalyst with the leach mixture at a solid to liquid phase ratio of 1:10.

589. The method of claim 587 or 588, wherein the conditions to leach at least two of palladium, platinum, and rhodium are tolerant of up to about 10 wt % water, or between about 10 wt % to less than 50 wt % water, such as 30 wt % water.

590. The method of any one of claims 578 to 589, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.

591. The method of claim 590, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

592. The method of claim 590 or 591, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

593. The method of any one of claims 578 to 592, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.

594. The method of claim 593, wherein the chelating agent comprises citric acid, oxalic acid, or salts thereof, or a combination thereof; preferably citric acid and/or salt thereof.

595. The method of claim 593 or 594, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

596. The method of any one of claims 593 to 595, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

597. The method of any one of claims 578 to 595, wherein the method leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.

598. The method of any one of claims 578 to 596, further comprising adding an oxidant and a polyatomic salt to the leach solution under conditions to precipitate the leached palladium, platinum, and/or rhodium; and precipitating the leached palladium, platinum, and/or rhodium.

599. The method of claim 597, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

600. The method of claim 597 or 598, wherein the polyatomic salt comprises an ammonium salt, such as ammonium chloride, ammonium sulfate, ammonium nitrate, or combinations thereof.

601. The method of any one of claims 597 to 599, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

602. The method of any one of claims 597 to 600, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

603. The method of claim 601, wherein contacting the leached palladium, platinum, and/or rhodium with the reducing agent comprises forming an aqueous mixture comprising the leached palladium, platinum, and/or rhodium, and adding the reducing agent to the aqueous mixture.

604. The method of claim 601 or 602, wherein the reducing agent comprises H₂, metal powder, metal strips, or a combination thereof, the metal comprising Al, Cu, Fe, Zn, or a combination thereof.

605. The method of any one of claims 601 to 603, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

606. The method of any one of claims 601 to 604, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

607. The method of claim 605, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

608. The method of claim 605 or 606, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

609. The method of any one of claims 597 to 607, wherein at least one of the palladium, platinum, and/or rhodium metal has a purity of about 90% to about 100%, or about 95% to about 99.9%, or about 98% to about 99.9%.

610. The method of any one of claims 578 to 609, wherein the spent catalyst further comprises aluminium oxide, and the method selectively leaches the at least two of palladium, platinum, and rhodium from the spent catalyst.

611. The method of any one of claims 578 to 610, the wherein the spent catalyst is a catalytic converter; preferably a gasoline-based or diesel-based catalytic converter in biscuit or powder form.

612. Use of a leach mixture for leaching about 40% or more, or about 50% or more of at least two of palladium, platinum, and rhodium from a spent catalyst in about 30 min or less, under conditions to leach at least two of the palladium, platinum, and rhodium from the spent catalyst and form a leach solution comprising at least two of leached palladium, platinum, and rhodium, the leach mixture comprising
an metal chloride ligand source,
an inorganic oxidizing agent,
an acid catalyst, and
acetic acid as a water-miscible organic solvent, preferably glacial acetic acid.

613. Use of a leach mixture for leaching at least two of palladium, platinum, and rhodium from a spent catalyst at a leaching rate at least 1 time, or at least 5 times, or at least 15 times, or at least 20 times faster than aqua regia, under conditions to leach at least two of the palladium, platinum, and rhodium from the spent catalyst and form a leach solution comprising at least two of leached palladium, platinum, and rhodium, the leach mixture comprising
an metal chloride ligand source,
an inorganic oxidizing agent,
an acid catalyst, and
acid as a water-miscible organic solvent, preferably glacial acetic acid.

614. The use of claim 612 or 613, wherein the chloride ligand source comprises HCl, CaCl₂, or a combination thereof; or more preferably CaCl₂.

615. The use of any one of claims 612 to 614, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

616. The use of any one of claims 612 to 615, wherein the oxidizing agent comprises FeCl₃, CuCl₂, HNO₃, MnO₂, H₂O₂, or a combination thereof.

617. The use of claim 616, wherein the oxidizing agent has a concentration of from about 0.01 M to about 0.2 M in the acetic acid solvent, preferably between about 0.01 to about 0.1 M.

618. The use of any one of claims 612 to 617, wherein the acid catalyst comprises a hydrogen halide, preferably HCl.

619. The use of any one of claims 612 to 618, wherein the acid catalyst has a concentration of from about 0.01 M to about 1 M in the acetic acid solvent; or preferably has a concentration of from about 0.1 M to about 0.2 M.

620. The use of any one of claims 612 to 619, wherein the acetic acid as the water-miscible organic solvent makes up at least 50 wt % of the liquid phase of the leach mixture.

621. The use of any one of claims 612 to 620, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.

622. The use of claim 621, wherein the conditions to leach at least two of palladium, platinum, and rhodium further comprise contacting the spent catalyst with the leach mixture at a solid to liquid phase ratio of 1:10.

623. The use of claim 621 or 622, wherein the conditions to leach at least two of palladium, platinum, and rhodium are tolerant of up to about 10 wt % water, or between about 10 wt % to less than 50 wt % water, such as 30 wt % water.

624. The use of any one of claims 612 to 623, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.

625. The use of claim 624, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

626. The use of claim 624 or 625, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

627. The use of any one of claims 612 to 626, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.

628. The use of claim 627, wherein the chelating agent comprises citric acid, oxalic acid, or salts thereof, or a combination thereof; preferably citric acid and/or salt thereof.

629. The use of claim 627 or 628, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

630. The use of any one of claims 627 to 629, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

631. The use of any one of claims 612 to 630, wherein the leach mixture leaches about 40% to about 99.9%, or about 50% to about 99.9%, or about 60% to about 99.9%, or about 70% to about 99.9%, or about 80% to about 99.9%, or about 90% to about 99.9%, of at least one of the palladium, platinum, and rhodium in the spent catalyst, preferably at least two of the palladium, platinum, and rhodium.

632. The use of any one of claims 612 to 631, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.

633. The use of claim 632, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

634. The use of claim 632 or 633, wherein the polyatomic salt comprises an ammonium salt, such as ammonium chloride, ammonium sulfate, ammonium nitrate, or combinations thereof.

635. The use of any one of claims 632 to 634, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

636. The use of any one of claims 632 to 635, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

637. The use of claim 636, wherein contacting the leached palladium, platinum, and/or rhodium with the reducing agent comprises forming an aqueous mixture comprising the leached palladium, platinum, and/or rhodium, and adding the reducing agent to the aqueous mixture.

638. The use of claim 636 or 637, wherein the reducing agent comprises H₂, metal powder, metal strips, or a combination thereof, the metal comprising Al, Cu, Fe, Zn, or a combination thereof.

639. The use of any one of claims 636 to 638, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

640. The use of any one of claims 636 to 639, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

641. The use of claim 640, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

642. The use of claim 640 or 641, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

643. The use of any one of claims 632 to 642, wherein at least one of the palladium, platinum, and/or rhodium metal has a purity of about 90% to about 100%, or about 95% to about 99.9%, or about 98% to about 99.9%.

644. The use of any one of claims 612 to 643, wherein the spent catalyst further comprises aluminium oxide, and the leach mixture selectively leaches the at least two of palladium, platinum, and rhodium from the spent catalyst.

645. The use of any one of claims 612 to 644, the wherein the spent catalyst is a catalytic converter; preferably a gasoline-based or diesel-based catalytic converter in biscuit or powder form.

646. A process of recycling at least two of palladium, platinum, and rhodium from a spent catalyst, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least two of the palladium, platinum, and rhodium from the spent catalyst;
leaching about 40% or more, or about 50% or more of at least two of the palladium, platinum, and rhodium from the spent catalyst in about 30 min or less to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal.

647. A process of recycling at least two of palladium, platinum, and rhodium from a spent catalyst, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least two of the palladium, platinum, and rhodium from the spent catalyst;
leaching at least two of the palladium, platinum, and rhodium from the spent catalyst at a leaching rate at least 1 time, or at least 5 times, or at least 15 times, or at least 20 times faster than aqua regia to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal.

648. The process of claim 646 or 647, wherein the chloride ligand source comprises HCl, CaCl₂, or a combination thereof; or more preferably CaCl₂.

649. The process of any one of claims 646 to 648, wherein the chloride li651gand source has a concentration of about 0.1 M to about 0.5 M, or about 0.1 to about 0.4 M, or from about 0.1 M to about 0.3 M, or about 0.1 to about 0.2 M, in the acetic acid solvent.

650. The process of any one of claims 646 to 649, wherein the oxidizing agent comprises FeCl₃, CuCl₂, HNO₃, MnO₂, H₂O₂, or a combination thereof.

651. The process of claim 650, wherein the oxidizing agent has a concentration of from about 0.01 M to about 0.2 M in the acetic acid solvent, preferably between about 0.01 to about 0.1 M.

652. The process of any one of claims 646 to 6, wherein the acid catalyst comprises a hydrogen halide, preferably HCl.

653. The process of any one of claims 646 to 652, wherein the acid catalyst has a concentration of from about 0.01 M to about 1 M in the acetic acid solvent; or preferably has a concentration of from about 0.1 M to about 0.2 M.

654. The process of any one of claims 646 to 653, wherein the acetic acid as the water-miscible organic solvent makes up at least 50 wt % of the liquid phase of the leach mixture.

655. The process of any one of claims 646 to 654, wherein the conditions to leach at least two of palladium, platinum, and rhodium from the spent catalyst comprises contacting the spent catalyst with the leach mixture for a time of about 0.1 min to about 25 min, at a temperature of about 20° C. to about 120° C., under ambient pressure; wherein preferably, the time is about 1 min to about 20 min, or about 1 min to about 15 min, about 1 min to about 10 min, about 1 min to about 5 min; and the temperature is about 80° C. to about 90° C.

656. The process of claim 655, wherein the conditions to leach at least two of palladium, platinum, and rhodium further comprise contacting the spent catalyst with the leach mixture at a solid to liquid phase ratio of 1:10.

657. The process of claim 655 or 656, wherein the conditions to leach at least two of palladium, platinum, and rhodium are tolerant of up to about 10 wt % water, or between about 10 wt % to less than 50 wt % water, such as 30 wt % water.

658. The process of any one of claims 646 to 657, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.

659. The process of claim 658, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

660. The process of claim 658 or 659, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; 663 wherein preferably, the time is about 2 to 4 hours; and the temperature is about 70° C. to about 90° C.

661. The process of any one of claims 646 to 660, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.

662. The process of claim 661, wherein the chelating agent comprises citric acid, oxalic acid, or salts thereof, or a combination thereof; preferably citric acid and/or salt thereof.

663. The process of claim 661 or 662, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

664. The process of any one of claims 661 to 663, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

665. The process of any one of claims 646 to 664, wherein the process leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.

666. The process of any one of claims 646 to 665, further comprising adding an oxidant and a polyatomic salt to the leach solution under conditions to precipitate the leached palladium, platinum, and/or rhodium; and precipitating the leached palladium, platinum, and/or rhodium.

667. The process of claim 666, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

668. The process of claim 666 or 667, wherein the polyatomic salt comprises an ammonium salt, such as ammonium chloride, ammonium sulfate, ammonium nitrate, or combinations thereof.

669. The process of any one of claims 666 to 668, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

670. The process of any one of claims 666 to 669, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

671. The process of claim 670, wherein contacting the leached palladium, platinum, and/or rhodium with the reducing agent comprises forming an aqueous mixture comprising the leached palladium, platinum, and/or rhodium, and adding the reducing agent to the aqueous mixture.

672. The process of claim 670 or 671, wherein the reducing agent comprises H₂, metal powder, metal strips, or a combination thereof, the metal comprising Al, Cu, Fe, Zn, or a combination thereof.

673. The process of any one of claims 670 to 672, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

674. The process of any one of claims 670 to 673, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

675. The process of claim 674, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

676. The process of claim 674 or 675, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

677. The process of any one of claims 666 to 676, wherein at least one of the palladium, platinum, and/or rhodium metal has a purity of about 90% to about 100%, or about 95% to about 99.9%, or about 98% to about 99.9%.

678. The process of any one of claims 646 to 677, wherein the spent catalyst further comprises aluminium oxide, and the process selectively leaches the at least two of palladium, platinum, and rhodium from the spent catalyst.

679. The process of any one of claims 646 to 678, the wherein the spent catalyst is a catalytic converter; preferably a gasoline-based or diesel-based catalytic converter in biscuit or powder form.

680. A method of leaching at least 40% of at least one of palladium, platinum, and rhodium from a spent catalyst, the method comprising:
contacting the spent catalyst with a leach mixture comprising an metal chloride ligand source,
an inorganic oxidizing agent,
an acid catalyst, and
acetic acid as a water-miscible organic solvent, preferably glacial acetic acid,
under conditions to leach at least one of the palladium, platinum, and rhodium from the spent catalyst;
leaching at least one of the palladium, platinum, and rhodium from the spent catalyst; and
forming a leach solution comprising at least one of leached palladium, platinum, and rhodium.

681. A method of leaching at least 40% of at least one of palladium, platinum, and rhodium from a spent catalyst, the method comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least one of the palladium, platinum, and rhodium from the spent catalyst;
leaching at least one of the palladium, platinum, and rhodium from the spent catalyst; and
forming a leach solution comprising at least one of leached palladium, platinum, and rhodium;
wherein the method is milder and less toxic relative to a method of leaching having aqua regia as a leach mixture.

682. The method of claim 680 or 681, wherein the chloride ligand source comprises HCl, AlCl₃, CaCl₂, or a combination thereof.

683. The method of any one of claims 680 to 682, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

684. The method of any one of claims 680 to 683, wherein the oxidizing agent comprises CuCl₂, H₂O₂, or a combination thereof.

685. The method of claim 684, wherein the oxidizing agent has a concentration of from about 0.01 M to about 0.2 M in the acetic acid solvent, preferably between about 0.01 to about 0.1 M.

686. The method of any one of claims 680 to 685, wherein the acid catalyst comprises a hydrogen halide, preferably HCl; and optionally, the acid catalyst is the chloride ligand source.

687. The method of any one of claims 680 to 686, wherein the acid catalyst has a concentration of from about 0.01 M to about 1 M in the acetic acid solvent; or preferably has a concentration of from about 0.1 M to about 0.5 M.

688. The method of any one of claims 680 to 687, wherein the acetic acid as the water-miscible organic solvent makes up at least 50 wt % of the liquid phase of the leach mixture.

689. The method of any one of claims 680 to 688, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.

690. The method of claim 689, wherein the conditions to leach at least one of palladium, platinum, and rhodium further comprise contacting the spent catalyst with the leach mixture at a solid to liquid phase ratio of 1:10.

691. The method of claim 689 or 690, wherein the conditions to leach at least one of palladium, platinum, and rhodium are tolerant of up to about 10 wt % water, or between about 10 wt % to less than 50 wt % water, such as 30 wt % water.

692. The method of any one of claims 680 to 691, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.

693. The method of claim 692, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

694. The method of claim 692 or 693, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

695. The method of any one of claims 680 to 694, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.

696. The method of claim 695, wherein the chelating agent comprises citric acid, oxalic acid, or salts thereof, or a combination thereof; preferably citric acid and/or salt thereof.

697. The method of claim 695 or 696, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

698. The method of any one of claims 695 to 697, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

699. The method of any one of claims 680 to 698, wherein the method leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.

700. The method of any one of claims 680 to 699, further comprising adding an oxidant and a polyatomic salt to the leach solution under conditions to precipitate the leached palladium, platinum, and/or rhodium; and precipitating the leached palladium, platinum, and/or rhodium.

701. The method of claim 700, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

702. The method of claim 700 or 701, wherein the polyatomic salt comprises an ammonium salt, such as ammonium chloride, ammonium sulfate, ammonium nitrate, or combinations thereof.

703. The method of any one of claims 700 to 703, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

704. The method of any one of claims 700 to 703, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

705. The method of claim 704, wherein contacting the leached palladium, platinum, and/or rhodium with the reducing agent comprises forming an aqueous mixture comprising the leached palladium, platinum, and/or rhodium, and adding the reducing agent to the aqueous mixture.

706. The method of claim 704 or 705, wherein the reducing agent comprises H₂, metal powder, metal strips, or a combination thereof, the metal comprising Al, Cu, Fe, Zn, or a combination thereof.

707. The method of any one of claims 704 to 706, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

708. The method of any one of claims 704 to 707, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

709. The method of claim 708, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

710. The method of claim 708 or 709, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

711. The method of any one of claims 700 to 710, wherein at least one of the palladium, platinum, and/or rhodium metal has a purity of about 90% to about 100%, or about 95% to about 99.9%, or about 98% to about 99.9%.

712. The method of any one of claims 680 to 711, wherein the spent catalyst further comprises aluminium oxide, and the method selectively leaches the at least two of palladium, platinum, and rhodium from the spent catalyst.

713. The method of any one of claims 1680 to 712, the wherein the spent catalyst is a catalytic converter; preferably a gasoline-based or diesel-based catalytic converter in biscuit or powder form.

714. Use of a leach mixture for leaching at least 40% of at least one of palladium, platinum, and rhodium from a spent catalyst, under conditions to leach at least one of the palladium, platinum, and rhodium from the spent catalyst and form a leach solution comprising at least one of leached palladium, platinum, and rhodium, the leach mixture comprising
an metal chloride ligand source,
an inorganic oxidizing agent,
an acid catalyst, and
acetic acid as a water-miscible organic solvent, preferably glacial acetic acid.

715. Use of a leach mixture for leaching at least 40% of at least one of palladium, platinum, and rhodium from a spent catalyst, under conditions to leach at least one of the palladium, platinum, and rhodium from the spent catalyst and form a leach solution comprising at least one of leached palladium, platinum, and rhodium, the leach mixture comprising
an metal chloride ligand source,
an inorganic oxidizing agent,
an acid catalyst, and
acetic acid as a water-miscible organic solvent, preferably glacial acetic acid;
wherein use of the leach mixture is milder and less toxic relative to use of aqua regia as a leach mixture.

716. The use of claim 714 or 715, wherein the chloride ligand source comprises HCl, AlCl₃, CaCl₂, or a combination thereof.

717. The use of any one of claims 714 to 716, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

718. The use of any one of claims 714 to 717, wherein the oxidizing agent comprises CuCl₂, H₂O₂, or a combination thereof.

719. The use of claim 718, wherein the oxidizing agent has a concentration of from about 0.01 M to about 0.2 M in the acetic acid solvent, preferably between about 0.01 to about 0.1 M.

720. The use of any one of claims 714 to 719, wherein the acid catalyst comprises a hydrogen halide, preferably HCl; and optionally, the acid catalyst is the chloride ligand source.

721. The use of any one of claims 714 to 720, wherein the acid catalyst has a concentration of from about 0.01 M to about 1 M in the acetic acid solvent; or preferably has a concentration of from about 0.1 M to about 0.5 M.

722. The use of any one of claims 714 to 721, wherein the acetic acid as the water-miscible organic solvent makes up at least 50 wt % of the liquid phase of the leach mixture.

723. The use of any one of claims 714 to 722, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.

724. The use of claim 723, wherein the conditions to leach at least one of palladium, platinum, and rhodium further comprise contacting the spent catalyst with the leach mixture at a solid to liquid phase ratio of 1:10.

725. The use of claim 723 or 724, wherein the conditions to leach at least one of palladium, platinum, and rhodium are tolerant of up to about 10 wt % water, or between about 10 wt % to less than 50 wt % water, such as 30 wt % water.

726. The use of any one of claims 714 to 725, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.

727. The use of claim 726, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

728. The use of claim 726 or 727, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

729. The use of any one of claims 714 to 728, wherein palladium, platinum, and/or rhodium of the spent catalyst comprise a contaminant, the use further comprising use of a chelating agent for contacting the spent catalyst with a chelating agent under conditions to at least partially remove the contaminant; and at least partially decontaminating the palladium, platinum, and/or rhodium.

730. The use of claim 729, wherein the chelating agent comprises citric acid, oxalic acid, or salts thereof, or a combination thereof; preferably citric acid and/or salt thereof.

731. The use of claim 729 or 1730, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

732. The use of any one of claims 729 to 731, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

733. The use of any one of claims 714 to 732, wherein the leach mixture leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.

734. The use of any one of claims 714 to 733, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.

735. The use of claim 734, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

736. The use of claim 734 or 735, wherein the polyatomic salt comprises an ammonium salt, such as ammonium chloride, ammonium sulfate, ammonium nitrate, or combinations thereof.

737. The use of any one of claims 734 to 736, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

738. The use of any one of claims 734 to 737, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

739. The use of claim 738, wherein contacting the leached palladium, platinum, and/or rhodium with the reducing agent comprises forming an aqueous mixture comprising the leached palladium, platinum, and/or rhodium, and adding the reducing agent to the aqueous mixture.

740. The use of claim 738 or 739, wherein the reducing agent comprises H₂, metal powder, metal strips, or a combination thereof, the metal comprising Al, Cu, Fe, Zn, or a combination thereof.

741. The use of any one of claims 738 to 40, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

742. The use of any one of claims 738 to 741, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

743. The use of claim 742, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

744. The use of claim 742 or 743, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

745. The use of any one of claims 734 to 744, wherein at least one of the palladium, platinum, and/or rhodium metal has a purity of about 90% to about 100%, or about 95% to about 99.9%, or about 98% to about 99.9%.

746. The use of any one of claims 714 to 745, wherein the spent catalyst further comprises aluminium oxide, and the leach mixture selectively leaches the at least two of palladium, platinum, and rhodium from the spent catalyst.

747. The use of any one of claims 714 to 746, the wherein the spent catalyst is a catalytic converter; preferably a gasoline-based or diesel-based catalytic converter in biscuit or powder form.

748. A process of recycling at least one of palladium, platinum, and rhodium from a spent catalyst, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least one of the palladium, platinum, and rhodium from the spent catalyst;
leaching at least 40% of at least one of the palladium, platinum, and rhodium from the spent catalyst to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal.

749. A process of recycling at least one of palladium, platinum, and rhodium from a spent catalyst, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least one of the palladium, platinum, and rhodium from the spent catalyst;
leaching at least 40% of at least one of the palladium, platinum, and rhodium from the spent catalyst to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal,
wherein the process is milder and less toxic relative to a process having aqua regia as a leach mixture.

750. The process of claim 748 or 749, wherein the chloride ligand source comprises HCl, AlCl₃, CaCl₂, or a combination thereof.

751. The process of any one of claims 748 to 750, wherein the chloride ligand source has a concentration of about 0.1 M to about 0.5 M, or about 0.1 to about 0.4 M, or from about 0.1 M to about 0.3 M, or about 0.1 to about 0.2 M, in the acetic acid solvent.

752. The process of any one of claims 748 to 751, wherein the oxidizing agent comprises CuCl₂, H₂O₂, or a combination thereof.

753. The process of claim 752, wherein the oxidizing agent has a concentration of from about 0.01 M to about 0.2 M in the acetic acid solvent, preferably between about 0.01 to about 0.1 M.

754. The process of any one of claims 748 to 753, wherein the acid catalyst comprises a hydrogen halide, preferably HCl; and optionally, the acid catalyst is the chloride ligand source.

756. The process of any one of claims 748 to 754, wherein the acid catalyst has a concentration of from about 0.01 M to about 1 M in the acetic acid solvent; or preferably has a concentration of from about 0.1 M to about 0.5 M.

757. The process of any one of claims 748 to 756, wherein the acetic acid as the water-miscible organic solvent makes up at least 50 wt % of the liquid phase of the leach mixture.

758. The process of any one of claims 748 to 757, wherein the conditions to leach at least one of palladium, platinum, and rhodium from the spent catalyst comprises contacting the spent catalyst with the leach mixture for a time of about 0.1 min to about 4 hours, at a temperature of about 20° C. to about 90° C., under ambient pressure; wherein preferably, the time is about 30 min to about 3 hours; and the temperature is about 20° C. to about 60° C.

759. The process of claim 758, wherein the conditions to leach at least one of palladium, platinum, and rhodium further comprise contacting the spent catalyst with the leach mixture at a solid to liquid phase ratio of 1:10.

760. The process of claim 758 or 759, wherein the conditions to leach at least one of palladium, platinum, and rhodium are tolerant of up to about 10 wt % water, or between about 10 wt % to less than 50 wt % water, such as 30 wt % water.

761. The process of any one of claims 748 to 760, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.

762. The process of claim 761, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

763. The process of claim 761 or 762, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

764. The process of any one of claims 748 to 763, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.

765. The process of claim 764, wherein the chelating agent comprises citric acid, oxalic acid, or salts thereof, or a combination thereof; preferably citric acid and/or salt thereof.

767. The process of claim 764 or 765, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

768. The process of any one of claims 764 to 767, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

769. The process of any one of claims 748 to 768, wherein the process leaches about 40% to about 99.9%, or about 50% to about 99.9%, or about 60% to about 99.9%, or about 70% to about 99.9%, or about 80% to about 99.9%, or about 90% to about 99.9% of at least one of the palladium, platinum, and rhodium in the spent catalyst, preferably at least two of the palladium, platinum, and rhodium.

770. The process of any one of claims 748 to 769, further comprising adding an oxidant and a polyatomic salt to the leach solution under conditions to precipitate the leached palladium, platinum, and/or rhodium; and precipitating the leached palladium, platinum, and/or rhodium.

771. The process of claim 770, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

772. The process of claim 770 or 771, wherein the polyatomic salt comprises an ammonium salt, such as ammonium chloride, ammonium sulfate, ammonium nitrate, or combinations thereof.

773. The process of any one of claims 771 to 772, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

774. The process of any one of claims 770 to 773, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

775. The process of claim 774, wherein contacting the leached palladium, platinum, and/or rhodium with the reducing agent comprises forming an aqueous mixture comprising the leached palladium, platinum, and/or rhodium, and adding the reducing agent to the aqueous mixture.

776. The process of claim 774 or 775, wherein the reducing agent comprises H₂, metal powder, metal strips, or a combination thereof, the metal comprising Al, Cu, Fe, Zn, or a combination thereof.

777. The process of any one of claims 774 to 776, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

778. The process of any one of claims 774 to 777, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

779. The process of claim 778, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

780. The process of claim 778 or 779, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

781. The process of any one of claims 770 to 780, wherein at least one of the palladium, platinum, and/or rhodium metal has a purity of about 90% to about 100%, or about 95% to about 99.9%, or about 98% to about 99.9%.

782. The process of any one of claims 748 to 781, wherein the spent catalyst further comprises aluminium oxide, and the process selectively leaches the at least two of palladium, platinum, and rhodium from the spent catalyst.

783. The process of any one of claims 748 to 782, the wherein the spent catalyst is a catalytic converter; preferably a gasoline-based or diesel-based catalytic converter in biscuit or powder form.

784. A method of leaching at least 80% of at least two of palladium, platinum, and rhodium from a spent catalyst, the method comprising:
contacting the spent catalyst with a leach mixture comprising
an metal chloride ligand source,
at least one inorganic oxidizing agent,
an acid catalyst, and
acetic acid as a water-miscible organic solvent, preferably glacial acetic acid,
under conditions to leach at least two of the palladium, platinum, and rhodium from the spent catalyst;
leaching at least two of the palladium, platinum, and rhodium from the spent catalyst; and
forming a leach solution comprising at least two of the leached palladium, platinum, and rhodium.

785. The method of claim 784, wherein the chloride ligand source comprises HCl, CaCl₂, or a combination thereof; or more preferably HCl.

786. The method of claim 784 or 785, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.

787. The method of any one of claims 784 to 786, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.

788. The method of claim 787, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.

789. The method of any one of claims 784 to 788, wherein the acid catalyst comprises a hydrogen halide, preferably HCl; and optionally, the acid catalyst is the chloride ligand source.

790. The method of any one of claims 784 to 789, wherein the acid catalyst has a concentration of from about 0.01 M to about 2 M in the acetic acid solvent; or preferably has a concentration of from about 0.1 M to about 1 M, or 0.5 M to about 1 M.

791. The method of any one of claims 784 to 790, wherein the acetic acid as the water-miscible organic solvent makes up at least 50 wt % of the liquid phase of the leach mixture.

792. The method of any one of claims 784 to 791, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

793. The method of claim 792, wherein the conditions to leach at least two of palladium, platinum, and rhodium further comprise contacting the spent catalyst with the leach mixture at a solid to liquid phase ratio of 1:10.

794. The method of claim 792 or 793, wherein the conditions to leach at least two of palladium, platinum, and rhodium are tolerant of up to about 10 wt % water, or between about 10 wt % to less than 50 wt % water, such as 30 wt % water.

795. The method of any one of claims 784 to 794, wherein the spent catalyst comprises oxidized palladium, platinum, and/or rhodium, and the method further comprises contacting the spent catalyst with a reductant under conditions to at least partially reduce the oxidized palladium, platinum, and/or rhodium; and at least partially reducing the oxidized palladium, platinum, and/or rhodium.

796. The method of claim 795, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

797. The method of claim 795 or 796, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

798. The method of any one of claims 784 to 797, wherein palladium, platinum, and/or rhodium of the spent catalyst comprise a contaminant, the method further comprising contacting the spent catalyst with a chelating agent under conditions to at least partially remove the contaminant; and at least partially decontaminating the palladium, platinum, and/or rhodium.

799. The method of claim 798, wherein the chelating agent comprises citric acid, oxalic acid, or salts thereof, or a combination thereof; preferably citric acid and/or salt thereof.

800. The method of claim 798 or 799, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

801. The method of any one of claims 798 to 800, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

802. The method of any one of claims 784 to 801, wherein the method leaches about 80% to about 99.9%, or about 85% to about 99.9%, or about 90% to about 99.9%, or about 95% to about 99.9% of at least two of the palladium, platinum, and rhodium in the spent catalyst.

803. The method of any one of claims 784 to 802, further comprising adding an oxidant and a polyatomic salt to the leach solution under conditions to precipitate the leached palladium, platinum, and/or rhodium; and precipitating the leached palladium, platinum, and/or rhodium.

804. The method of claim 803, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

805. The method of claim 803 or 804, wherein the polyatomic salt comprises an ammonium salt, such as ammonium chloride, ammonium sulfate, ammonium nitrate, or combinations thereof.

806. The method of any one of claims 803 to 805, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

807. The method of any one of claims 803 to 806, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

808. The method of claim 807, wherein contacting the leached palladium, platinum, and/or rhodium with the reducing agent comprises forming an aqueous mixture comprising the leached palladium, platinum, and/or rhodium, and adding the reducing agent to the aqueous mixture.

809. The method of claim 807 or 808, wherein the reducing agent comprises H₂, metal powder, metal strips, or a combination thereof, the metal comprising Al, Cu, Fe, Zn, or a combination thereof.

810. The method of any one of claims 807 to 809, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

811. The method of any one of claims 807 to 810, wherein the palladium, platinum, and/or rhodium metal at least comprises palladium metal, the method further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

812. The method of claim 811, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

813. The method of claim 811 or 812, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

814. The method of any one of claims 803 to 813, wherein at least one of the palladium, platinum, and/or rhodium metal has a purity of about 90% to about 100%, or about 95% to about 99.9%, or about 98% to about 99.9%.

815. The method of any one of claims 784 to 814, wherein the spent catalyst further comprises aluminium oxide, and the method selectively leaches the at least two of palladium, platinum, and rhodium from the spent catalyst.

816. The method of any one of claims 1 to 815, the wherein the spent catalyst is a catalytic converter; preferably a gasoline-based or diesel-based catalytic converter in biscuit or powder form.

817. Use of a leach mixture for leaching at least 80% of at least two of palladium, platinum, and rhodium from a spent catalyst, under conditions to leach at least two of the palladium, platinum, and rhodium from the spent catalyst and form a leach solution comprising at least two of leached palladium, platinum, and rhodium, the leach mixture comprising
an metal chloride ligand source,
at least one inorganic oxidizing agent,
an acid catalyst, and
acetic acid as a water-miscible organic solvent, preferably glacial acetic acid.

818. The use of claim 817, wherein the chloride ligand source comprises HCl, CaCl₂, or a combination thereof; or more preferably HCl.

819. The use of claim 817 or 818, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.

820. The use of any one of claims 817 to 819, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.

821. The use of claim 820, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.

822. The use of any one of claims 817 to 821, wherein the acid catalyst comprises a hydrogen halide, preferably HCl; and optionally, the acid catalyst is the chloride ligand source.

823. The use of any one of claims 817 to 822, wherein the acid catalyst has a concentration of from about 0.01 M to about 2 M in the acetic acid solvent; or preferably has a concentration of from about 0.1 M to about 1 M, or 0.5 M to about 1 M.

824. The use of any one of claims 817 to 823, wherein the acetic acid as the water-miscible organic solvent makes up at least 50 wt % of the liquid phase of the leach mixture.

825. The use of any one of claims 817 to 824, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

826. The use of claim 825, wherein the conditions to leach at least two of palladium, platinum, and rhodium further comprise contacting the spent catalyst with the leach mixture at a solid to liquid phase ratio of 1:10.

827. The use of claim 825 or 826, wherein the conditions to leach at least two of palladium, platinum, and rhodium are tolerant of up to about 10 wt % water, or between about 10 wt % to less than 50 wt % water, such as 30 wt % water.

828. The use of any one of claims 817 to 827, wherein the spent catalyst comprises oxidized palladium, platinum, and/or rhodium, and the use further comprises use of a reductant for contacting the spent catalyst under conditions to at least partially reduce the oxidized palladium, platinum, and/or rhodium; and at least partially reducing the oxidized palladium, platinum, and/or rhodium.

829. The use of claim 828, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

830. The use of claim 828 or 829, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

831. The use of any one of claims 817 to 830, wherein palladium, platinum, and/or rhodium of the spent catalyst comprise a contaminant, the use further comprising use of a chelating agent for contacting the spent catalyst under conditions to at least partially remove the contaminant; and at least partially decontaminating the palladium, platinum, and/or rhodium.

832. The use of claim 831, wherein the chelating agent comprises citric acid, oxalic acid, or salts thereof, or a combination thereof; preferably citric acid and/or salt thereof.

833. The use of claim 831 or 832, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

834. The use of any one of claims 831 to 833, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

835. The use of any one of claims 817 to 834, wherein about 80% to about 99.9%, or about 85% to about 99.9%, or about 90% to about 99.9%, or about 95% to about 99.9% of at least two of the palladium, platinum, and rhodium in the spent catalyst.

836. The use of any one of claims 817 to 835, further comprising use of an oxidant and a polyatomic salt for precipitating the leached palladium, platinum, and/or rhodium by adding the oxidant and the polyatomic salt to the leach solution under conditions to precipitate the leached palladium, platinum, and/or rhodium; and precipitating the leached palladium, platinum, and/or rhodium.

837. The use of claim 836, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

838. The use of claim 836 or 837, wherein the polyatomic salt comprises an ammonium salt, such as ammonium chloride, ammonium sulfate, ammonium nitrate, or combinations thereof.

839. The use of any one of claims 836 to 838, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

840. The use of any one of claims 836 to 839, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

841. The use of claim 840, wherein contacting the leached palladium, platinum, and/or rhodium with the reducing agent comprises forming an aqueous mixture comprising the leached palladium, platinum, and/or rhodium, and adding the reducing agent to the aqueous mixture.

842. The use of claim 840, wherein the reducing agent comprises H₂, metal powder, metal strips, or a combination thereof, the metal comprising Al, Cu, Fe, Zn, or a combination thereof.

843. The use of any one of claim 840 to 842, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

844. The use of any one of claims 840 to 843, wherein the palladium, platinum, and/or rhodium metal at least comprises palladium metal, the use further comprising use of a refining mixture for refining the palladium metal of the palladium, platinum, and/or rhodium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

845. The use of claim 844, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

846. The use of claim 844 or 845, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

847. The use of any one of claims 836 to 846, wherein at least one of the palladium, platinum, and/or rhodium metal has a purity of about 90% to about 100%, or about 95% to about 99.9%, or about 98% to about 99.9%.

848. The use of any one of claims 817 to 847, wherein the spent catalyst further comprises aluminium oxide, and the leach mixture selectively leaches the at least two of palladium, platinum, and rhodium from the spent catalyst.

849. The use of any one of claims 817 to 848, the wherein the spent catalyst is a catalytic converter; preferably a gasoline-based or diesel-based catalytic converter in biscuit or powder form.

850. A process of recycling at least two of palladium, platinum, and rhodium from a spent catalyst, the process comprising:
contacting the spent catalyst with a leach mixture comprising
an metal chloride ligand source,
an inorganic oxidizing agent,
an acid catalyst, and
acetic acid as a water-miscible organic solvent, preferably glacial acetic acid,
under conditions to leach at least two of the palladium, platinum, and rhodium from the spent catalyst;
leaching at least 80% of at least two of the palladium, platinum, and rhodium from the spent catalyst to form a leach solution comprising leached palladium, platinum, and/or rhodium and a leached spent catalyst;
separating the leach solution from the leached spent catalyst; and
treating the leach solution comprising leached palladium, platinum, and/or rhodium under conditions to form palladium, platinum, and/or rhodium metal.

851. The process of claim 850, wherein the chloride ligand source comprises HCl, CaCl₂, or a combination thereof; or more preferably HCl.

852. The process of claim 850 or 851, wherein the chloride ligand source has a concentration of about 0.01 M to about 4 M, or about 0.1 to about 2 M, or from about 0.1 M to about 1 M, or about 0.1 M to about 0.5 M, in the acetic acid solvent.

853. The process of any one of claims 850 to 852, wherein the oxidizing agent comprises HNO₃, MnO₂, H₂O₂, CaO₂, MnO₂ and CaO₂, or a combination thereof, preferably MnO₂, CaO₂, MnO₂ and CaO₂, or a combination thereof.

854. The process of claim 853, wherein the oxidizing agent has a concentration of from about 0.01 M to about 1 M in the acetic acid solvent, preferably between about 0.01 M to about 0.5 M, or about 0.03 M to about 0.5 M, or about 0.1 M to about 0.5 M.

855. The process of any one of claims 850 to 854, wherein the acid catalyst comprises a hydrogen halide, preferably HCl; and optionally, the acid catalyst is the chloride ligand source.

856. The process of any one of claims 850 to 855, wherein the acid catalyst has a concentration of from about 0.01 M to about 2 M in the acetic acid solvent; or preferably has a concentration of from about 0.1 M to about 1 M, or 0.5 M to about 1 M.

857. The process of any one of claims 850 to 856, wherein the acetic acid as the water-miscible organic solvent makes up at least 50 wt % of the liquid phase of the leach mixture.

858. The process of any one of claims 850 to 857, wherein the conditions to leach at least two of palladium, platinum, and rhodium from the spent catalyst comprises contacting the spent catalyst with the leach mixture for a time of about 0.1 min to about 4 hours, at a temperature of about 20° C. to about 120° C., under ambient pressure; wherein preferably, the time is about 30 min to about 2 hours; and the temperature is about 60° C. to about 90° C.

859. The process of claim 858, wherein the conditions to leach at least two of palladium, platinum, and rhodium further comprise contacting the spent catalyst with the leach mixture at a solid to liquid phase ratio of 1:10.

860. The process of claim 858 or 859, wherein the conditions to leach at least two of palladium, platinum, and rhodium are tolerant of up to about 10 wt % water, or between about 10 wt % to less than 50 wt % water, such as 30 wt % water.

861. The process of any one of claims 850 to 860, wherein the spent catalyst comprises oxidized palladium, platinum, and/or rhodium, and the process further comprises contacting the spent catalyst with a reductant under conditions to at least partially reduce the oxidized palladium, platinum, and/or rhodium; and at least partially reducing the oxidized palladium, platinum, and/or rhodium.

862. The process of claim 861, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

863. The process of claim 861 or 862, wherein the conditions to at least partially reduce the oxidized palladium, platinum, and/or rhodium comprise contacting the spent catalyst with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

864. The process of any one of claims 850 to 863, wherein palladium, platinum, and/or rhodium of the spent catalyst comprise a contaminant, the process further comprising contacting the spent catalyst with a chelating agent under conditions to at least partially remove the contaminant; and at least partially decontaminating the palladium, platinum, and/or rhodium.

865. The process of claim 864, wherein the chelating agent comprises citric acid, oxalic acid, or salts thereof, or a combination thereof; preferably citric acid and/or salt thereof.

866. The process of claim 864 or 865, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

867. The process of any one of claims 864 to 866, wherein the conditions to at least partially remove the contaminant comprise contacting the spent catalyst with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

868. The process of any one of claims 850 to 867, wherein the process leaches about 80% to about 99.9%, or about 85% to about 99.9%, or about 90% to about 99.9%, or about 95% to about 99.9% of at least two of the palladium, platinum, and rhodium in the spent catalyst.

869. The process of any one of claims 850 to 868, further comprising adding an oxidant and a polyatomic salt to the leach solution under conditions to precipitate the leached palladium, platinum, and/or rhodium; and precipitating the leached palladium, platinum, and/or rhodium.

870. The process of claim 869, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

871. The process of claim 869 or 870, wherein the polyatomic salt comprises an ammonium salt, such as ammonium chloride, ammonium sulfate, ammonium nitrate, or combinations thereof.

872. The process of any one of claims 869 to 871, wherein the conditions to precipitate the leached palladium, platinum, and/or rhodium comprise contacting the spent catalyst with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

873. The process of any one of claims 869 to 872, further comprising contacting the leached palladium, platinum, and/or rhodium with a reducing agent under conditions to reduce the leached palladium, platinum, and/or rhodium to palladium, platinum, and/or rhodium metal; and reducing the leached palladium, platinum, and/or rhodium to palladium, platinum, and/or rhodium metal.

874. The process of claim 873, wherein contacting the leached palladium, platinum, and/or rhodium with the reducing agent comprises forming an aqueous mixture comprising the leached palladium, platinum, and/or rhodium, and adding the reducing agent to the aqueous mixture.

875. The process of claim 873 or 874, wherein the reducing agent comprises H₂, metal powder, metal strips, or a combination thereof, the metal comprising Al, Cu, Fe, Zn, or a combination thereof.

876. The process of any one of claims 874 to 875, wherein the conditions to reduce the leached palladium, platinum, and/or rhodium to palladium, platinum, and/or rhodium metal comprises contacting the leached palladium, platinum, and/or rhodium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

877. The process of any one of claims 874 to 876, wherein the palladium, platinum, and/or rhodium metal at least comprises palladium metal, the process further comprising contacting the palladium, platinum, and/or rhodium metal with a refining mixture under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

878. The process of claim 977, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably at a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

879. The process of claim 877 or 878, wherein the conditions to refine the palladium metal comprises contacting the palladium, platinum, and/or rhodium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

880. The process of any one of claims 869 to 879, wherein at least one of the palladium, platinum, and/or rhodium metal has a purity of about 90% to about 100%, or about 95% to about 99.9%, or about 98% to about 99.9%.

881. The process of any one of claims 850 to 880, wherein the spent catalyst further comprises aluminium oxide, and the process selectively leaches the at least two of palladium, platinum, and rhodium from the spent catalyst.

882. The process of any one of claims 850 to 881, the wherein the spent catalyst is a catalytic converter; preferably a gasoline-based or diesel-based catalytic converter in biscuit or powder form.

883. Use of a leach mixture for selectively leaching palladium from a substance comprising platinum group metals under conditions to selectively leach the palladium from the substance comprising platinum group metals, and forming a leach solution comprising leached palladium, the leach mixture comprising
an iodide ligand source,
an iodine oxidant,
an optional acid catalyst,
an optional carboxylic acid stabilizer, and
a water-miscible organic solvent such as acetic acid, glacial acetic acid, acetonitrile, ethyl acetate, tetrahydrofuran, or combinations thereof, preferably glacial acetic acid.

884. The use of claim 883, wherein the iodide ligand source comprises NaI, KI, HI, NH₄I, CsI, or a combination thereof; or preferably NaI, KI, HI, or a combination thereof; or more preferably NaI, KI, or a combination thereof.

885. The use of claim 883 or 884, wherein the iodide ligand source has a concentration of from about 0.1 M to about 4 M in the solvent, preferably between about 0.1 M to about 1 M, or about 0.1 M to about 0.5 M, or about 0.1 to about 0.4 M, or from about 0.1 M to about 0.3 M, or about 0.1 to about 0.2 M.

886. The use of any one of claims 883 to 885, wherein the iodine oxidant comprises l₂; and optionally, the use further comprises using the leach mixture to generate the iodine oxidant in-situ by reacting the iodide ligand source with an oxidizing agent comprising H₂O₂, I₂, NaIO₃, HClO₄, FeCl₃, O₂, CuCl₂, MnO₂, K₂Cr₂O₇, KMnO₄, bubbled air, or a combination thereof; the oxidizing agent preferably comprising H₂O₂, NaIO₃, FeCl₃, CuCl₂, O₂, bubbled air, or a combination thereof.

887. The use of claim 886, wherein the iodine oxidant has a concentration of from about 0.01 M to about 2.5 M in the solvent, preferably a concentration from about 0.01 to about 0.1 M; and optionally the oxidizing agent has a concentration of from about 0.01 M to about 2.5 M in the solvent, preferably between about 0.01 to about 0.1 M.

888. The use of any one of claims 883 to 887, wherein the acid catalyst comprises a hydrogen halide, sulfuric acid, phosphoric acid, perchloric acid, or a combination thereof; or preferably HCl, H₂SO₄, HI, or a combination thereof; or more preferably HCl, H₂SO₄, or a combination thereof.

889. The use of any one of claims 883 to 889, wherein the acid catalyst has a concentration of from about 0.01 M to about 4 M in the solvent; or preferably has a concentration of from about 0.1 M to about 2 M, or from about 0.1 M to about 1 M, or from about 0.1 M to about 0.5 M, or from about 0.1 M to about 0.2 M.

890. The use of any one of claims 883 to 889, wherein the carboxylic acid stabilizer comprises acetic acid, citric acid, or a combination thereof.

891. The use of claim 890, wherein carboxylic acid stabilizer has a concentration of from about 0.1 M to about 2.5 M in the solvent, preferably a concentration from about 0.1 M to about 1 M, or about 0.2 M to about 0.8 M, or about 0.3 to about 0.7 M, or about 0.4 M to about 0.6 M.

892. The use of any one of claims 883 to 891, wherein the water-miscible organic solvent makes up at least 50 wt % of the liquid phase of the leach mixture.

893. The use of any one of claims 883 to 892, wherein the conditions to selectively leach the palladium from the substance comprising platinum group metals comprises contacting the substance with the leach mixture for a time of about 0.1 min to about 18 hours, at a temperature of about 20° C. to about 120° C., under ambient pressure; wherein preferably, the time is about 1 min to about 18 hours; and the temperature is about 20° C. to about 90° C.

894. The use of claim 893, wherein the conditions to selectively leach the palladium further comprise contacting the substance with the leach mixture at a solid to liquid phase ratio of 1:10.

895. The use of claim 893 or 894, wherein the conditions to selectively leach the palladium are tolerant of up to about 10 wt % water, or between about 10 wt % to less than 50 wt % water, such as 30 wt % water.

896. The use of any one of claims 883 to 895, wherein the substance comprising platinum group metals further comprises oxidized platinum group metals, and the use further comprises use of a reductant for contacting the substance under conditions to at least partially reduce the oxidized platinum group metals, and at least partially reducing the oxidized platinum group metals.

897. The use of claim 896, wherein the reductant comprises organic reductants, such as ascorbic acid, formic acid, oxalic acid, or salts thereof, or a combination thereof; inorganic reductants, such as H₂, NaBH₄, FeCl₂, hydrazine hydrochloride, hydroxylamine hydrochloride, or a combination thereof; or a combination thereof.

898. The use of claim 896 or 897, wherein the conditions to at least partially reduce the oxidized platinum group metals comprise contacting the substance with the reductant for a time of about 1 hour to about 6 hours, at a temperature of about 20° C. to about 90° C., under ambient pressure; wherein preferably, the time is about 2 to 4 hours; and the temperature is about 70° C. to about 90° C.

899. The use of any one of claims 883 to 898, wherein the platinum group metals of the substance comprising platinum group metals comprise a contaminant, the use further comprising use of a chelating agent for contacting the substance under conditions to at least partially remove the contaminant; and at least partially decontaminating the platinum group metals.

900. The use of claim 899, wherein the chelating agent comprises citric acid, oxalic acid, or salts thereof, or a combination thereof; preferably citric acid and/or salt thereof.

901. The use of claim 899 or 900, wherein the contaminant comprises carbon deposits, hydrocarbons, sulfur-based compounds, phosphorous-based compounds, silicon-based compound, and metals such as Pb, Ca, Zn, Fe, Cu, Ni, or a combination thereof.

902. The use of any one of claims 899 to 901, wherein the conditions to at least partially remove the contaminant comprise contacting the substance with the chelating agent for a time of about 1 hour to about 12 hours, at a temperature of about 20° C. to about 90° C., under ambient pressure; wherein preferably, the time is about 2 to 8 hours; and the temperature is about 70° C. to about 90° C.

903. The use of any one of claims 883 to 902, wherein the leach mixture selectively leaches leaches about 10% to about 100%, or about 20% to about 99.9%, or about 30% to about 99.9%, or about 40% to about 99.9%, or about 50% to about 99.9%, or about 60% to about 99.9%, or about 70% to about 99.9%, or about 80% to about 99.9%, or about 90% to about 99.9%, of the palladium in the substance.

904. The use of any one of claims 883 to 903, further comprising use of an oxidant and a polyatomic salt for precipitating the leached palladium by adding the oxidant and the polyatomic salt to the leach solution under conditions to precipitate the leached palladium; and precipitating the leached palladium.

905. The use of claim 904, wherein the oxidant comprises H₂O₂, CaO₂, Cl₂, I₂, HNO₃, CaO₂, MnO₂, NaIO₃, CuCl₂, FeCl₃, HClO₄, NaClO₂, NaClO₃, NaClO, K₂Cr₂O₇, KMnO₄, Ca(ClO)₂, O₂ from air, or combinations thereof; preferably H₂O₂, CaO₂, NaClO₂, NaClO₃, NaClO, or combinations thereof.

906. The use of claim 904 or 905, wherein the polyatomic salt comprises an ammonium salt, such as ammonium chloride, ammonium sulfate, ammonium nitrate, or combinations thereof.

907. The use of any one of claims 904 to 906, wherein the conditions to precipitate the leached palladium comprise contacting the substance with the oxidant and polyatomic salt for a time of about 0.1 min to about 1 hour, at a temperature of about 20° C. to about 90° C., under ambient pressure; wherein preferably, the time is about 0.1 min to about 5 min; and the temperature is about 20° C. to about 25° C.

908. The use of any one of claims 904 to 907, further comprising use of a reducing agent for reducing the leached palladium to palladium metal by contacting the leached palladium with the reducing agent under conditions to reduce the leached palladium to palladium metal; and reducing the leached palladium to palladium metal.

909. The use of claim 908, wherein contacting the leached palladium with the reducing agent comprises forming an aqueous mixture comprising the leached palladium, and adding the reducing agent to the aqueous mixture.

910. The use of claim 908 or 909, wherein the reducing agent comprises H₂, metal powder, metal strips, or a combination thereof, the metal comprising Al, Cu, Fe, Zn, or a combination thereof.

911. The use of any one of claims 908 to 910, wherein the conditions to reduce the leached palladium to palladium metal comprises contacting the leached palladium with the reducing agent for a time of about 0.1 min to about 2 hour, at a temperature of about 20° C. to about 90° C., under ambient pressure; wherein preferably, the time is about 0.1 min to about 20 min; and the temperature is about 20° C. to about 25° C.

912. The use of any one of claims 908 to 911, further comprising use of a refining mixture for refining the palladium metal under conditions to refine the palladium metal, the refining mixture comprising (i) an iodide ligand source, (ii) an oxidant, (iii) an optional acid catalyst, (iv) an optional carboxylic acid stabilizer, and acetic acid as a water-miscible organic solvent, preferably glacial acetic acid.

913. The use of claim 912, wherein
(i) the iodide ligand source comprises NaI, KI, HI, or a combination thereof, preferably at a concentration in the acetic acid solvent between about 0.1 M to about 4 M, or about 0.1 M to about 2 M, or about 0.1 to about 1 M, or from about 0.1 M to about 0.5M, or about 0.1 to about 0.2 M;
(ii) the oxidant comprises H₂O₂, I₂, NaIO₃, FeCl₃, O₂, CuCl₂, bubbled air, or a combination thereof, preferably a concentration in the acetic acid solvent from about 0.01 to about 2.5 M, or about 0.1 M to about 2 M, or about 0.1 to about 1 M, or from about 0.1 M to about 0.5M, or about 0.1 to about 0.2 M;
(iii) the acid catalyst comprises a hydrogen halide, such as HCl or HI, sulfuric acid, or a combination thereof, preferably has a concentration in the acetic acid solvent of from about 0.1 M to about 4 M, or from about 0.1 M to about 2 M, or from about 0.1 M to about 1 M, or from about 0.1 M to about 0.5 M, or from about 0.1 M to about 0.2 M; and/or
(iv) the carboxylic acid stabilizer comprises acetic acid, citric acid, or a combination thereof, preferably at a concentration in the acetic acid solvent of from about 0.1 M to about 2.5 M, or about 0.1 M to about 1 M, or about 0.2 M to about 0.8 M, or about 0.3 to about 0.7 M, or about 0.4 M to about 0.6 M.

914. The use of claim 912 or 913, wherein the conditions to refine the palladium metal comprises contacting the palladium metal with the refining mixture for a time of about 0.1 min to about 18 hours, at a temperature of about 20° C. to about 120° C., under ambient pressure; wherein preferably, the time is about 1 min to about 9 hours, or about 15 min to about 5 hours, or about 30 min to about 2 hours; and the temperature is about 20° C. to about 90° C., or about 20° C. to about 50° C., or about 20° C. to about 25° C.

915. The use of any one of claims 904 to 914, wherein the palladium metal has a purity of about 90% to about 100%, or about 95% to about 99.9%, or about 98% to about 99.9%.

916. The use of any one of claims 883 to 915, wherein the substance comprising platinum group metals is a platinum group metal ore, a platinum group metal concentrate, electronic or electrical waste, a spent catalyst, or a catalytic converter; preferably a spent catalyst or catalytic converter.

917. The use of any one of claims 883 to 916, wherein the platinum group metals of the substance comprising platinum group metals comprise palladium, palladium and platinum, or palladium, platinum, and rhodium.
